(19) United States
(12) Patent Application Publication
(10) Pub. No.: US 2024/0402892 A1
(43) Pub. Date: Dec. 5, 2024

(54) Devices, Methods, and Graphical User Interfaces for Configuring and Displaying User Interfaces with Wallpapers

(71) Applicant: Apple Inc., Cupertino, CA (US)

(72) Inventors: Eric Lance Wilson, San Jose, CA (US); Andrew P. Clymer, San Jose, CA (US); Gregory M. Apodaca, Colbert, WA (US); William M. Tyler, San Francisco, CA (US); Christopher P. Foss, San Francisco, CA (US); Vincent M. Lane, San Francisco, CA (US); Bryant A. Jow, San Mateo, CA (US)

(21) Appl. No.: 18/657,421

(22) Filed: May 7, 2024

Related U.S. Application Data
(60) Provisional application No. 63/470,964, filed on Jun. 4, 2023.
(60) Provisional application No. 63/465,209, filed on May 9, 2023.

(51) Int. Cl. G06F 3/04845; G06F 3/0482; G06F 3/0486

(52) U.S. Cl. CPC G06F 3/04845; G06F 3/0482; G06F 3/0486

(57) ABSTRACT

An electronic device receives a request to display a first user interface. The electronic device, in response to receiving the request to display the first user interface, displays the first user interface that includes a plurality of widgets, including: in accordance with a determination that the first user interface is displayed in a first orientation, displaying a first version of the first user interface that includes a first set of widgets; and in accordance with a determination that the first user interface is displayed in a second orientation that is different from the first orientation, displaying a second version of the first user interface that includes a second set of widgets, wherein the widgets included in the second set of widgets are different from the widgets included in the first set of widgets.

### RELATED APPLICATIONS

This application claims priority to U.S. Provisional Patent Application No. 63/470,964, filed Jun. 4, 2023 and U.S. Provisional Patent Application No. 63/465,209, filed May 9, 2023, each of which is hereby incorporated by reference in its entirety.

### TECHNICAL FIELD

This relates generally to electronic devices with touch-sensitive surfaces, including but not limited to electronic devices with touch-sensitive surfaces that display user interfaces with wallpapers.

### BACKGROUND

The use of touch-sensitive surfaces as input devices for computers and other electronic computing devices has increased significantly in recent years. Example touch-sensitive surfaces include touchpads and touch-screen displays. Such surfaces are widely used to manipulate user interfaces and objects therein on a display. Example user interface objects include digital images, video, text, icons, widgets, and control elements such as buttons and other graphics.

Example manipulations include adjusting the position and/or size of one or more user interface objects or activating buttons or opening files/applications represented by user interface objects, as well as associating metadata with one or more user interface objects or otherwise manipulating user interfaces. Example user interface objects include digital images, video, text, icons, widgets and control elements such as buttons and other graphics. A user will, in some circumstances, need to perform such manipulations on user interface objects while configuring a system user interface (e.g., a wake screen user interface and/or home screen user interface), and/or in a file management program (e.g., Finder from Apple Inc. of Cupertino, California), an image management application (e.g., Aperture, iPhoto, Photos from Apple Inc. of Cupertino, California), a digital content (e.g., videos and music) management application (e.g., iTunes from Apple Inc. of Cupertino, California), a drawing application, a presentation application (e.g., Keynote from Apple Inc. of Cupertino, California), a word processing application (e.g., Pages from Apple Inc. of Cupertino, California), or a spreadsheet application (e.g., Numbers from Apple Inc. of Cupertino, California).

But methods for performing these manipulations are cumbersome and inefficient. For example, using a sequence of mouse based inputs to select one or more user interface objects and perform one or more actions on the selected user interface objects is tedious and creates a significant cognitive burden on a user. In addition, these methods take longer than necessary, thereby wasting energy. This latter consideration is particularly important in battery-operated devices.

### SUMMARY

Accordingly, there is a need for electronic devices with faster, more efficient methods and interfaces for configuring and interacting with wallpapers and user interface elements overlaid on wallpapers. Such methods and interfaces optionally complement or replace conventional methods for configuring and interacting with wallpapers and user interface elements overlaid on wallpapers. Such methods and interfaces reduce the number, extent, and/or nature of the inputs from a user and produce a more efficient human-machine interface. For battery-operated devices, such methods and interfaces conserve power and increase the time between battery charges.

The above deficiencies and other problems associated with user interfaces for electronic devices (or more generally, computer systems) with touch-sensitive surfaces are reduced or eliminated by the disclosed devices. In some embodiments, the device is a desktop computer. In some embodiments, the device is portable (e.g., a notebook computer, tablet computer, or handheld device). In some embodiments, the device is a personal electronic device (e.g., a wearable electronic device, such as a watch). In some embodiments, the device has a touchpad. In some embodiments, the device has a touch-sensitive display (also known as a “touch screen” or “touch-screen display”). In some embodiments, the device has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a non-transitory computer readable storage medium or other computer program product configured for execution by one or more processors.

In accordance with some embodiments, a method includes receiving a request to display a first user interface. The method includes, in response to receiving the request to display the first user interface, displaying the first user interface that includes a set of user interface elements displayed overlaid on a wallpaper, including: in accordance with a determination that the wallpaper has a first set of one or more wallpaper foreground elements, the wallpaper has a first wallpaper background with an automatically selected appearance that was automatically selected, based on the first set of one or more wallpaper foreground elements; and in accordance with a determination that the wallpaper has a second set of one or more wallpaper foreground elements that are different from the first set of one or more wallpaper foreground elements, the wallpaper has a second wallpaper background with an automatically selected appearance that was automatically selected, based on the second set of one or more wallpaper foreground elements.

In accordance with some embodiments, a method includes receiving a request to display a first user interface and in response to receiving the request to display the first user interface, displaying the first user interface with a set of user interface elements overlaid on a wallpaper that includes a plurality of selectable element. The method further includes, while displaying the first user interface, detecting a first user input directed the wallpaper while a first selectable element and a second selectable element of the plurality of selectable elements are concurrently displayed in the wallpaper. The method includes, in response to detecting the first user input directed to the wallpaper: in accordance with a determination that the first user input meets selection criteria and is directed to the first selectable element of the plurality of selectable elements, updating the wallpaper of the first user interface to include the first selectable element, without including the second selectable element of the plurality of selectable elements; and in accordance with a determination that the first user input meets the selection criteria and is directed to the second selectable element of the plurality of selectable elements, updating the wallpaper of the first user interface to include the second selectable element, without including the first selectable element of the plurality of selectable elements.

In accordance with some embodiments, a method includes receiving a request to display a first user interface. The method includes, in response to receiving the request to display the first user interface, displaying the first user interface that includes a plurality of widgets, including: in accordance with a determination that the first user interface is displayed in a first orientation, displaying a first version of the first user interface that includes a first set of widgets; and in accordance with a determination that the first user interface is displayed in a second orientation that is different from the first orientation, displaying a second version of the first user interface that includes a second set of widgets, wherein the widgets included in the second set of widgets are different from the widgets included in the first set of widgets.

In accordance with some embodiments, a method includes, while a computer system is in a low power state in which respective user-captured media with multiple frames is selected as a background for a wake screen, the computer system detects an event that corresponds to a trigger to wake the computer system to a higher power state. In response to detecting the event, the computer system displays, via the one or more display generation components, a wake screen that includes device status information and the background, wherein displaying the background for the wake screen includes playing through a plurality of frames of the respective user-captured media.

In accordance with some embodiments, an electronic device (or computer system more generally) includes a display, a touch-sensitive surface, optionally one or more sensors to detect intensities of contacts with the touch-sensitive surface, optionally one or more tactile output generators, one or more processors, and memory storing one or more programs; the one or more programs are configured to be executed by the one or more processors and the one or more programs include instructions for performing or causing performance of the operations of any of the methods described herein. In accordance with some embodiments, a computer readable storage medium has stored therein instructions that, when executed by an electronic device with a display, a touch-sensitive surface, optionally one or more sensors to detect intensities of contacts with the touch-sensitive surface, and optionally one or more tactile output generators, cause the device to perform or cause performance of the operations of any of the methods described herein. In accordance with some embodiments, a graphical user interface on an electronic device with a display, a touch-sensitive surface, optionally one or more sensors to detect intensities of contacts with the touch-sensitive surface, optionally one or more tactile output generators, a memory, and one or more processors to execute one or more programs stored in the memory includes one or more of the elements displayed in any of the methods described herein, which are updated in response to inputs, as described in any of the methods described herein. In accordance with some embodiments, an electronic device includes: a display, a touch-sensitive surface, optionally one or more sensors to detect intensities of contacts with the touch-sensitive surface, and optionally one or more tactile output generators; and means for performing or causing performance of the operations of any of the methods described herein. In accordance with some embodiments, an information processing apparatus, for use in an electronic device with a display, a touch-sensitive surface, optionally one or more sensors to detect intensities of contacts with the touch-sensitive surface, and optionally one or more tactile output generators, includes means for performing or causing performance of the operations of any of the methods described herein.

Thus, electronic devices and other computer systems with displays, touch-sensitive surfaces, optionally one or more sensors to detect intensities of contacts with the touch-sensitive surface, optionally one or more tactile output generators, optionally one or more device orientation sensors, and optionally an audio system, are provided with improved methods and interfaces for configuring and displaying user interfaces with wallpapers, thereby increasing the effectiveness, efficiency, and user satisfaction with such devices. Such methods and interfaces may complement or replace conventional methods for configuring and displaying user interfaces with wallpapers.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating example components for event handling in accordance with some embodiments.

FIG. 2 illustrates a portable multifunction device having a touch screen in accordance with some embodiments.

FIG. 3 is a block diagram of an example multifunction device with a display and a touch-sensitive surface in accordance with some embodiments.

FIG. 4A illustrates an example user interface for a menu of applications on a portable multifunction device in accordance with some embodiments.

FIG. 4B illustrates an example user interface for a multifunction device with a touch-sensitive surface that is separate from the display in accordance with some embodiments.

FIGS. 4C1-4C2 illustrate an example state diagram of navigation between various user interfaces of the multifunction devices in accordance with some embodiments.

FIGS. 5A-5S illustrate example user interfaces updating a wallpaper background of a user interface in accordance with a selected wallpaper foreground element, in accordance with some embodiments.

FIGS. 6A-6V illustrate example user interfaces for selecting a user interface object displayed in a wallpaper background of a user interface and updating the user interface in accordance with the selection, in accordance with some embodiments.

FIGS. 7A-7Z illustrate example user interfaces for configuring a user interface while the device is in different orientations in accordance with some embodiments.

FIGS. 8A-8D are flow diagrams of a process for automatically updating a wallpaper background of a user interface in accordance with a selected wallpaper foreground element in accordance with some embodiments.

FIGS. 9A-9F are flow diagrams of a process for automatically updating a wallpaper displayed in a user interface in response to a user selecting a user interface object from a set of user interface objects displayed in the wallpaper in accordance with some embodiments.

FIGS. 10A-10F are flow diagrams of a process for displaying different configurations of a user interface while the device is in different orientations in accordance with some embodiments.

FIGS. 11A-11I illustrate example user interfaces for displaying and editing a background that includes media with multiple frames in accordance with some embodiments.

FIGS. 12A-12E are flow diagrams of a process for waking a device from a low power state and displaying a wake screen with a background that includes media with multiple frames in accordance with some embodiments.

### DESCRIPTION OF EMBODIMENTS

Many electronic devices have graphical user interfaces that are customizable for a user. Providing the user with additional options to configure various graphical user interfaces, including configuring different wallpapers that are displayed on various graphical user interfaces, improves the user experience and enables the user to have more control over their device. For example, automatically updating features and providing suggested wallpaper backgrounds for a wallpaper based on one or more inputs from the user, provides real-time feedback to the user without requiring the user to manually configure the wallpaper.

The methods, devices, and GUIs described herein use haptic feedback to improve user interface interactions in multiple ways. For example, they make it easier to: drag and drop objects and indicate device orientation.

The processes described below enhance the operability of the devices and make the user-device interfaces more efficient (e.g., by helping the user to provide proper inputs and reducing user mistakes when operating/interacting with the device) through various techniques, including by providing improved visual, audio, and/or tactile feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

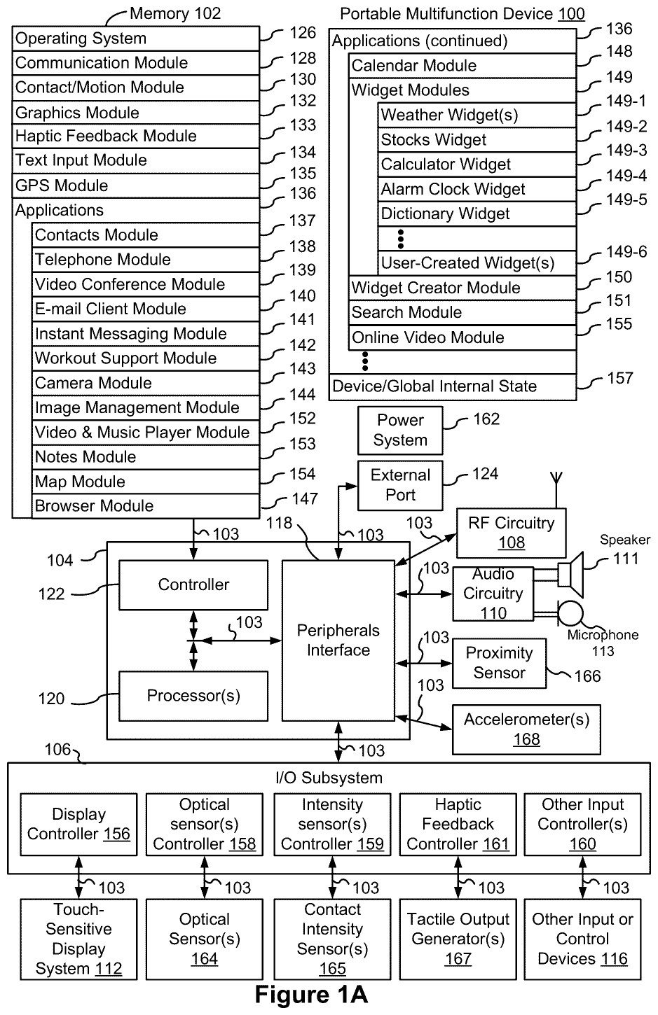

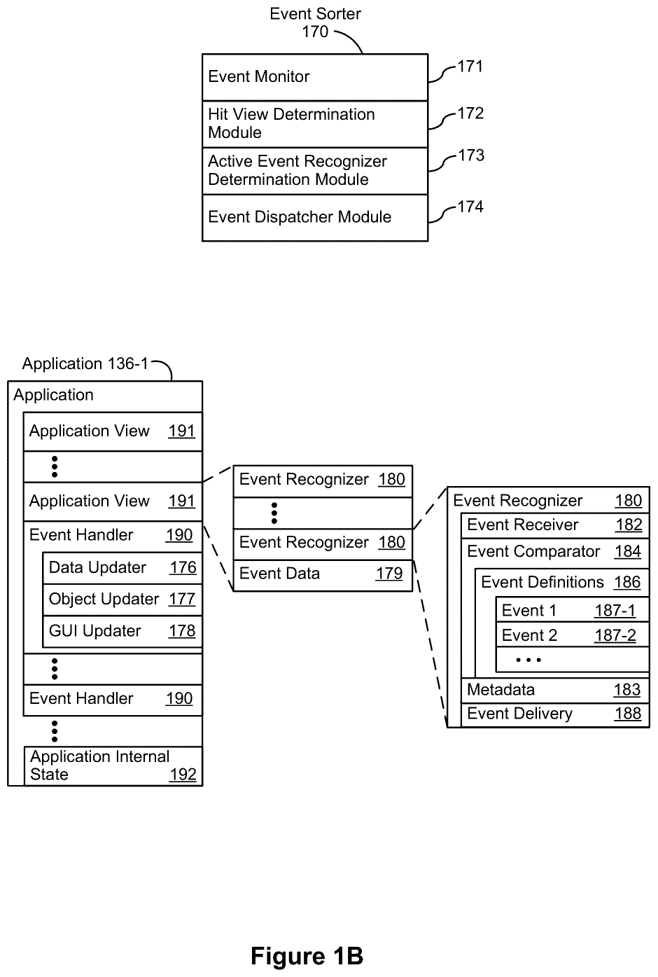

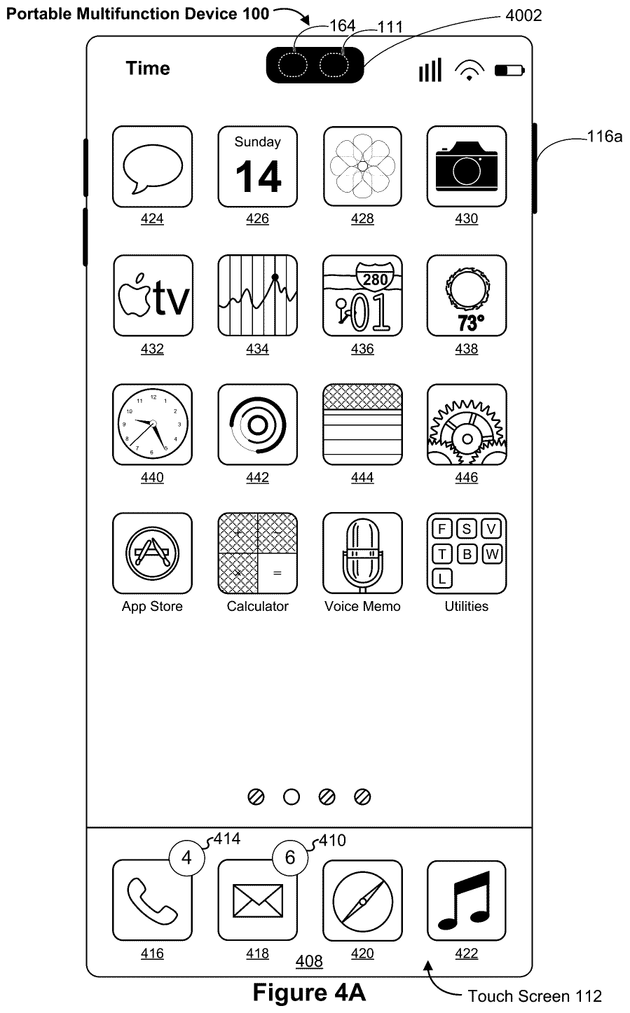

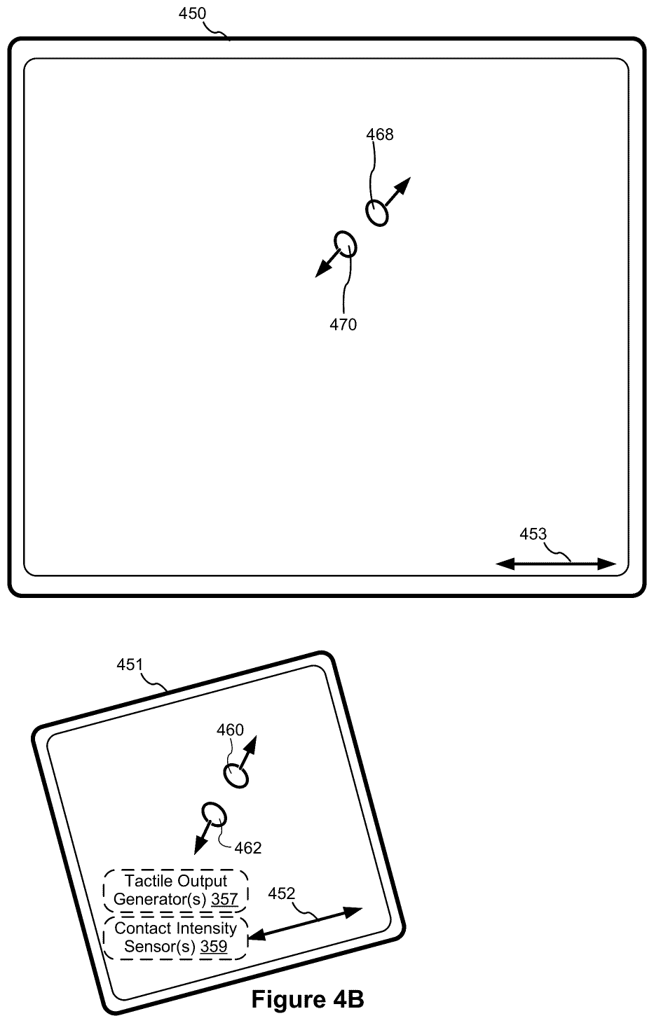

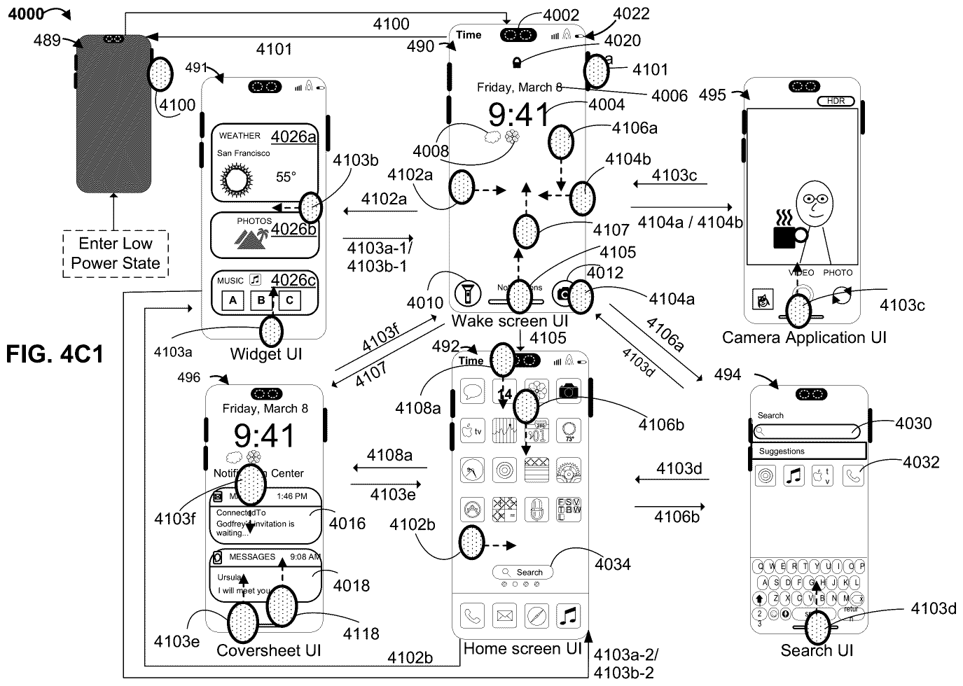

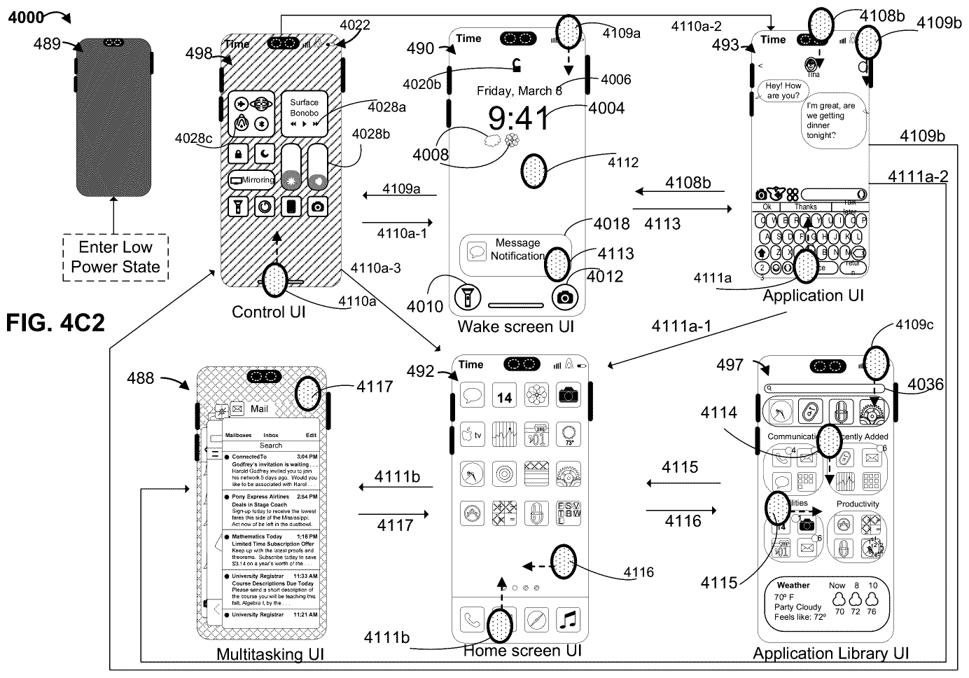

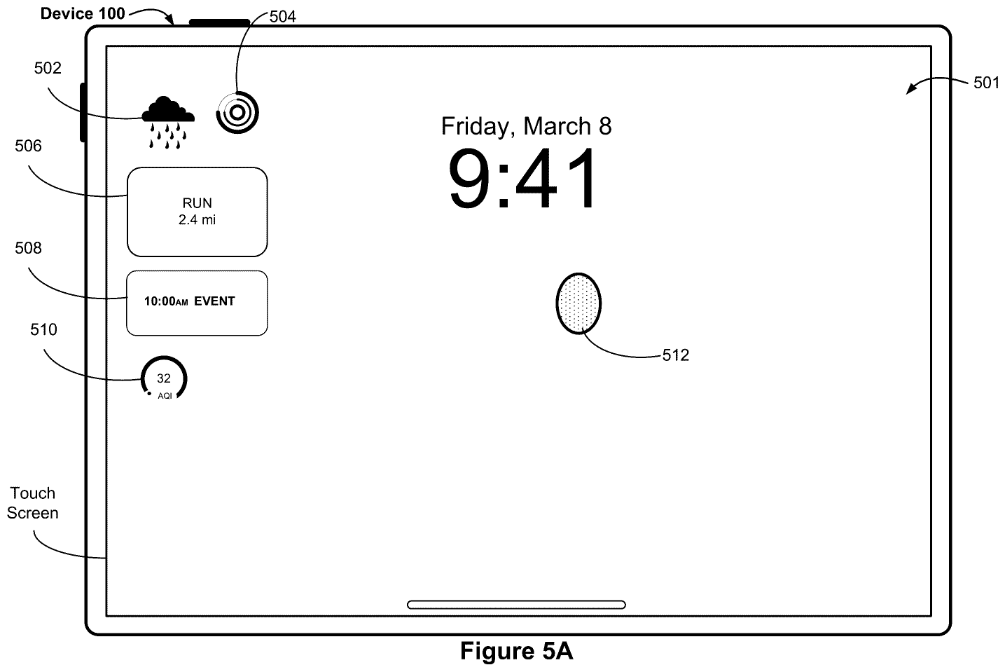

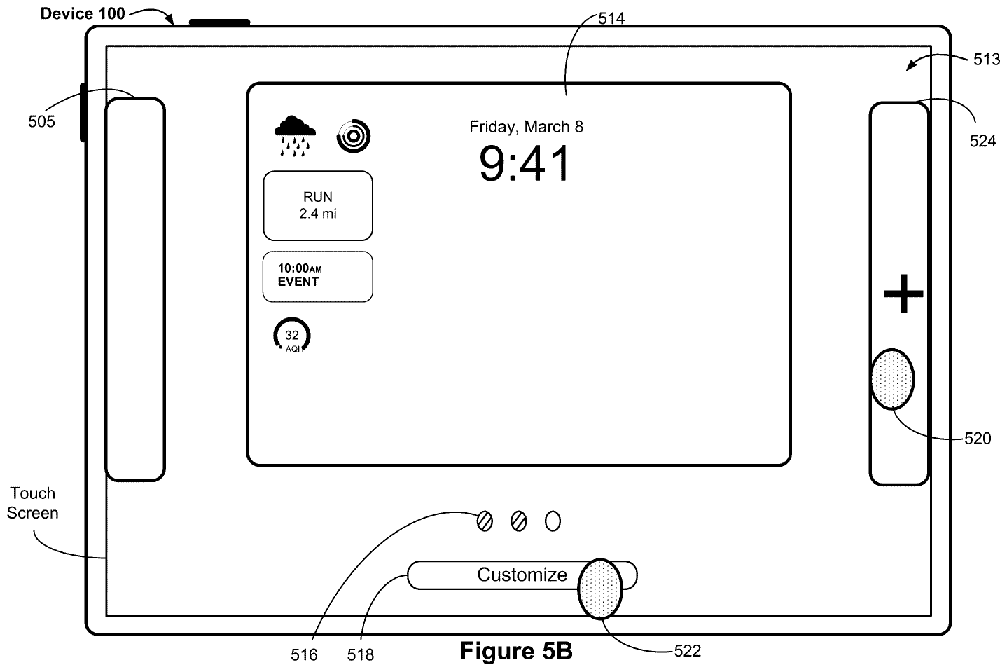

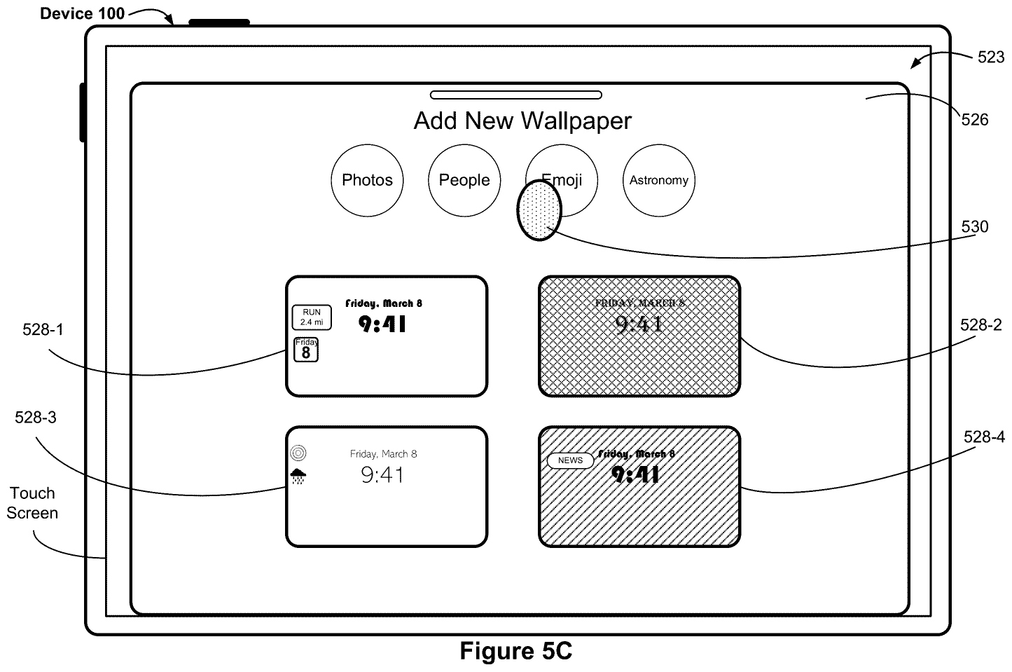

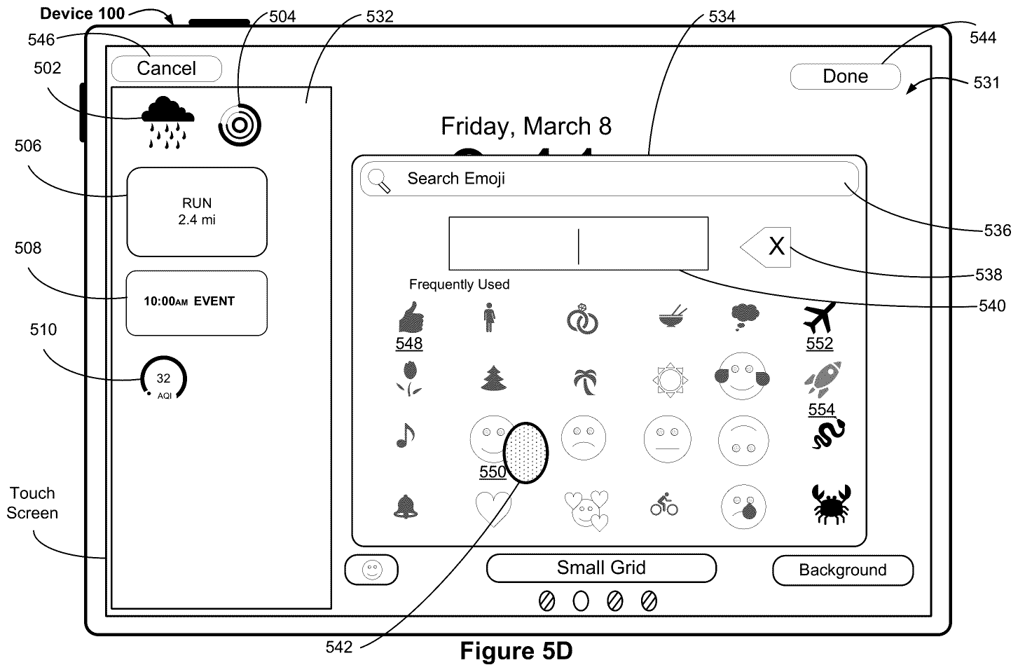

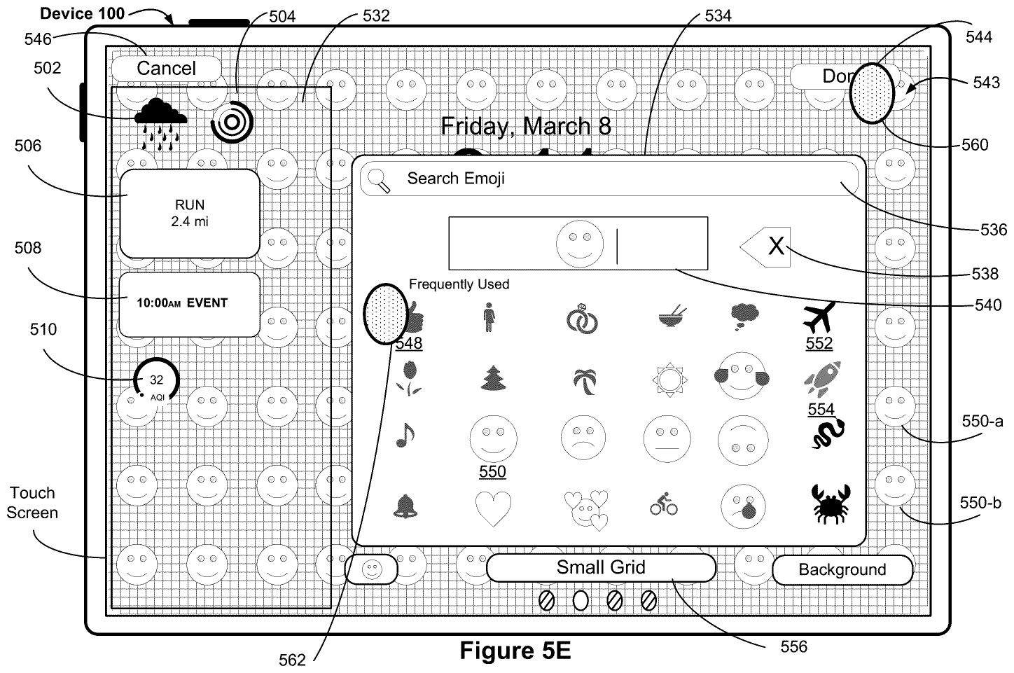

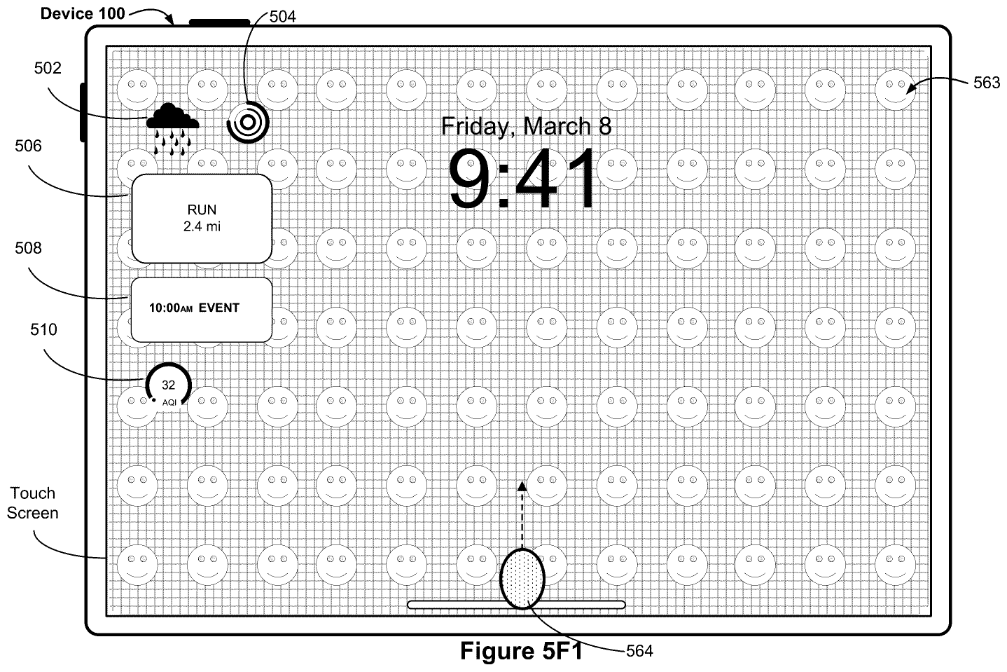

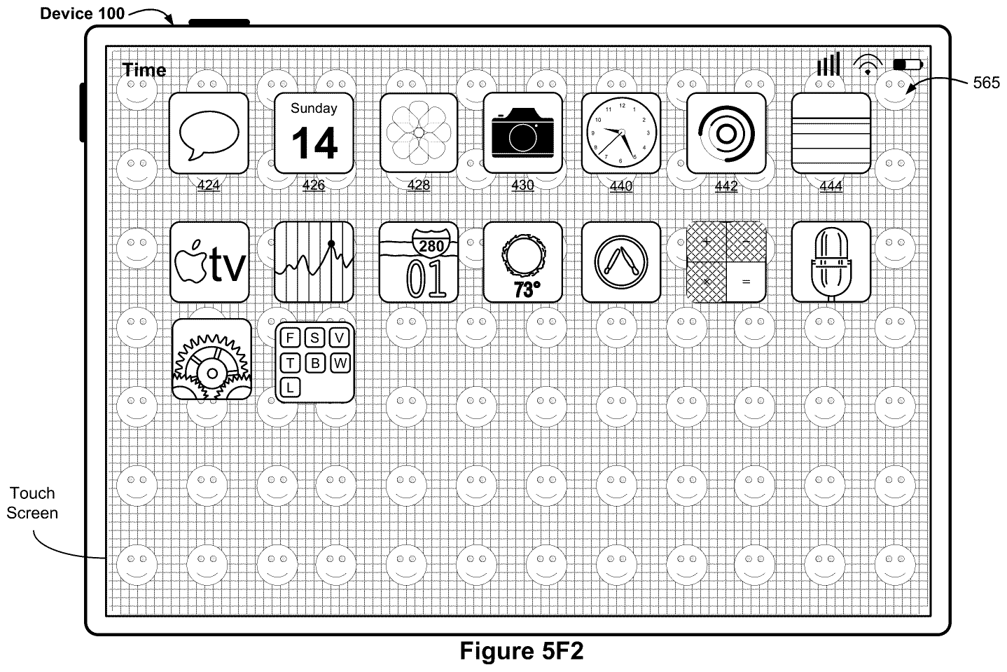

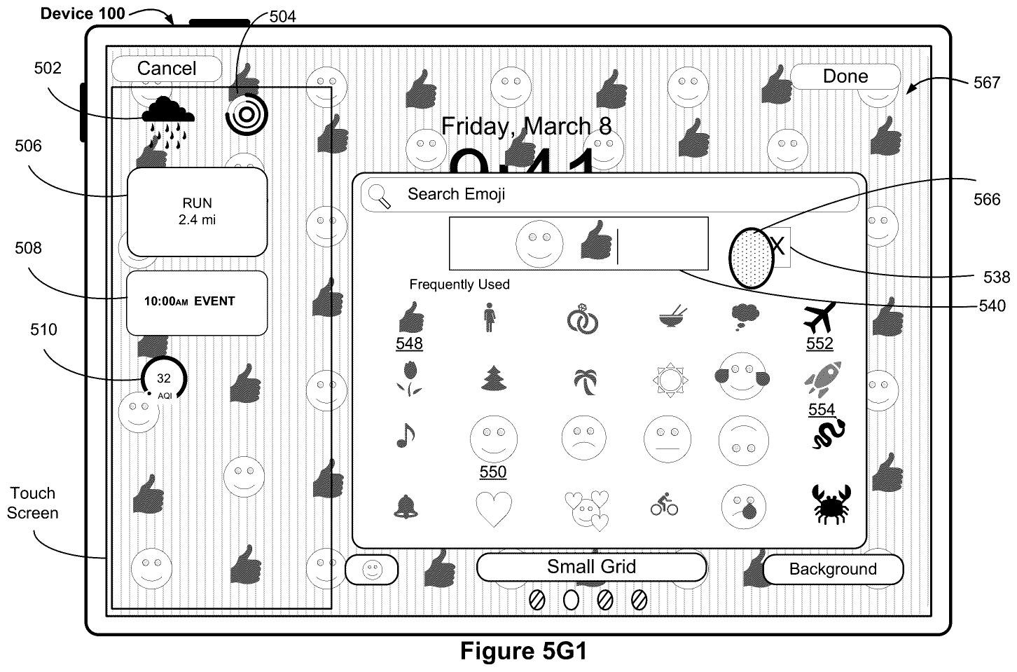

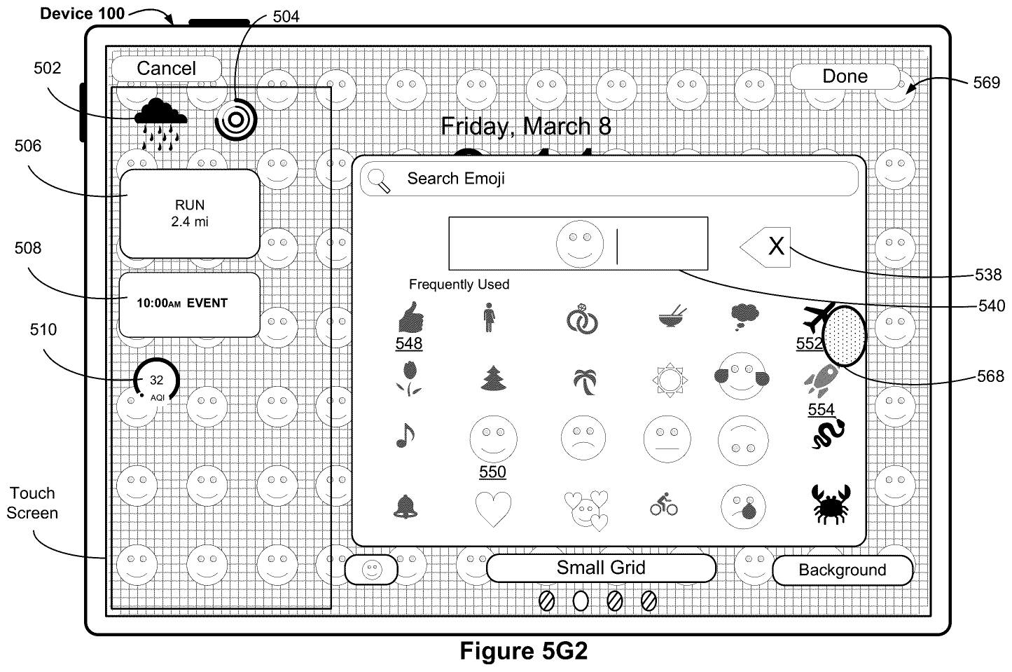

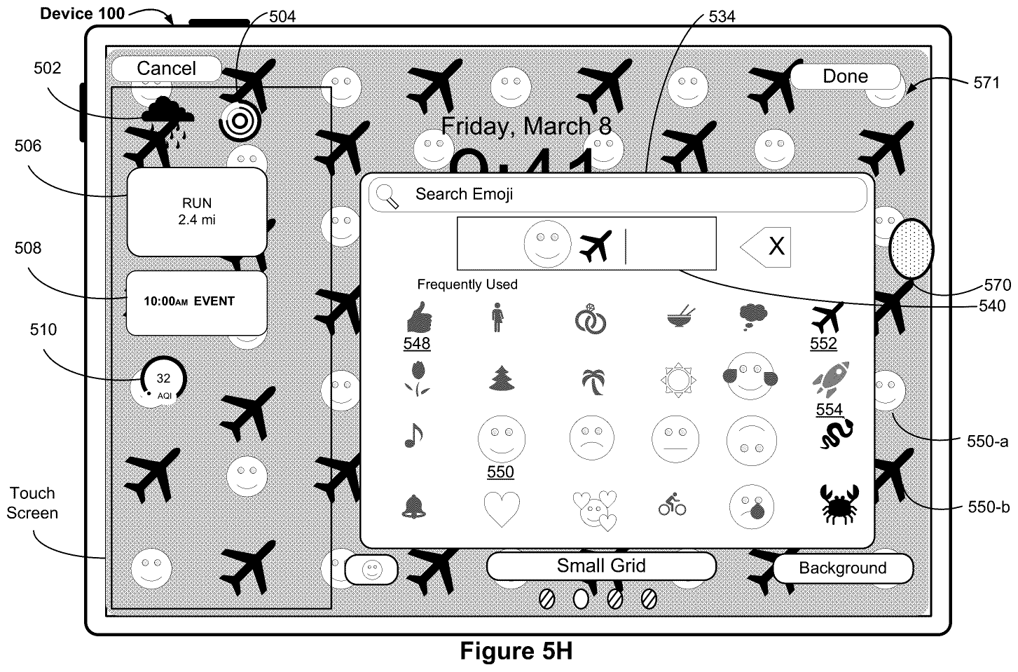

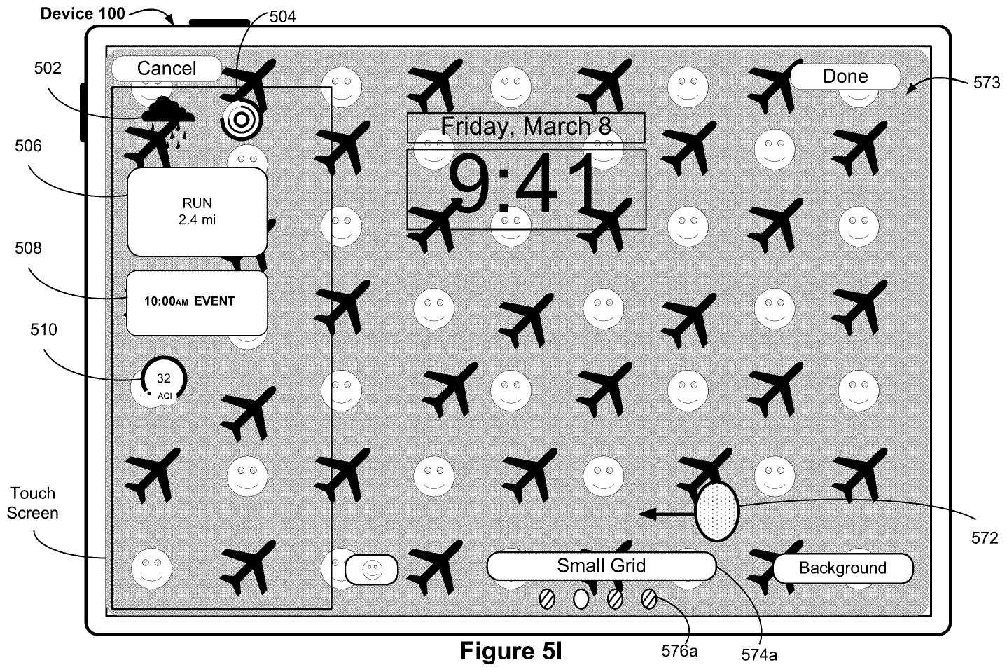

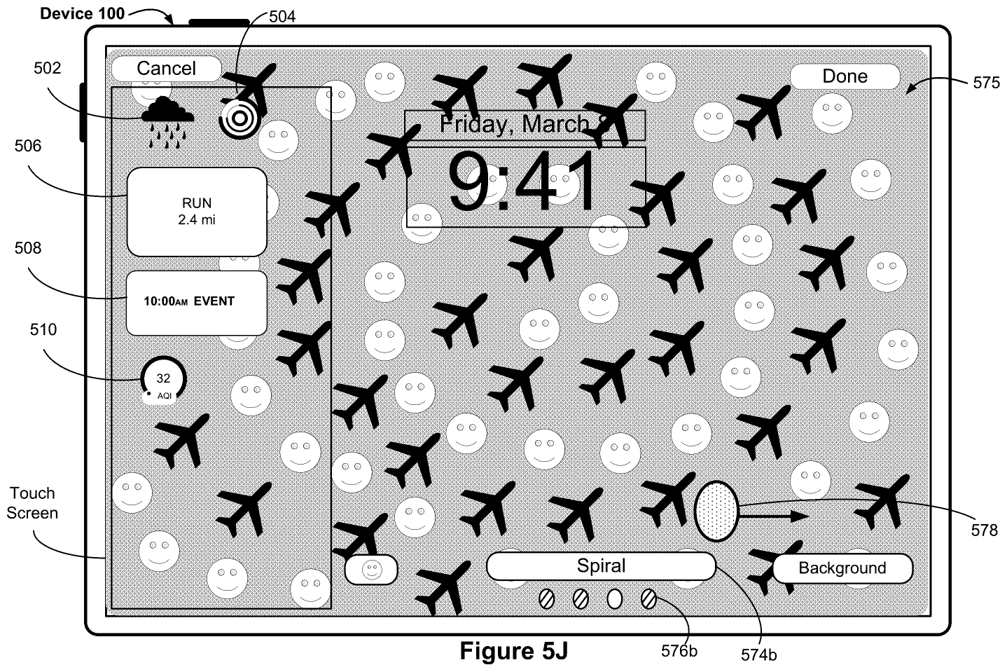

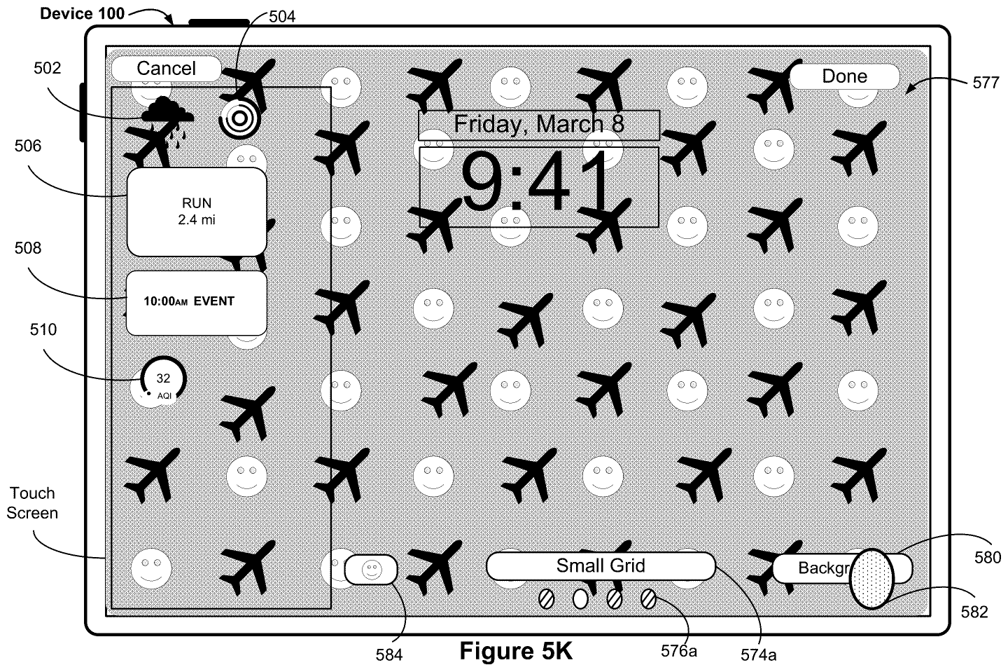

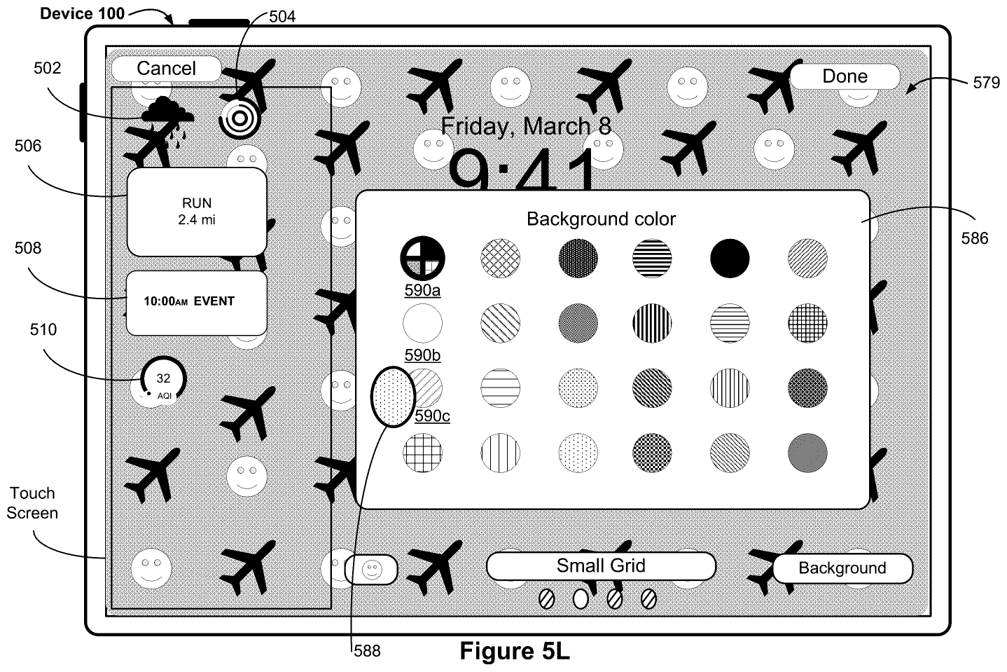

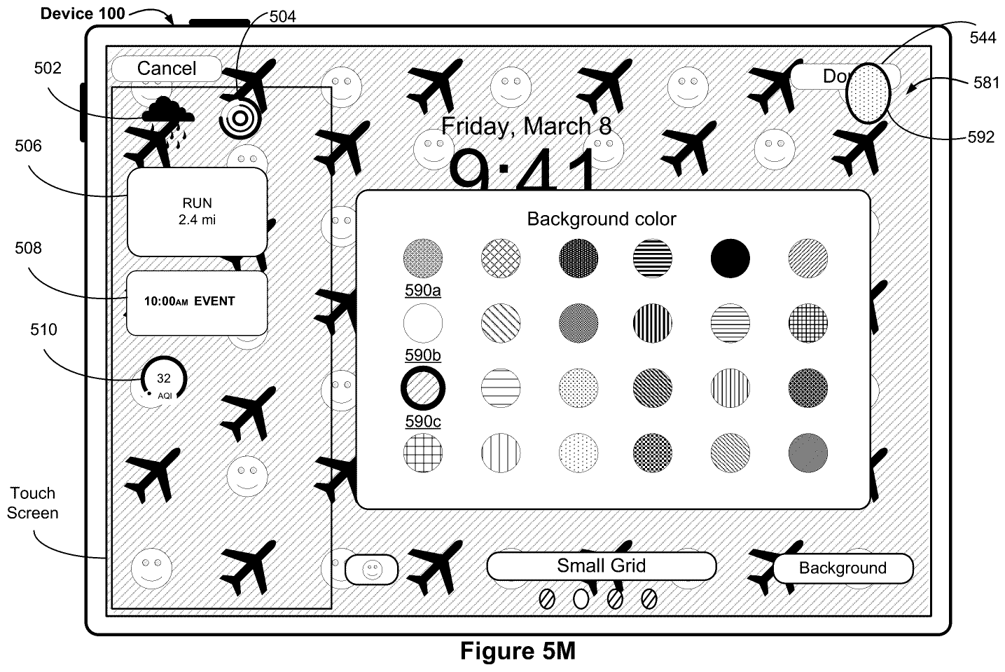

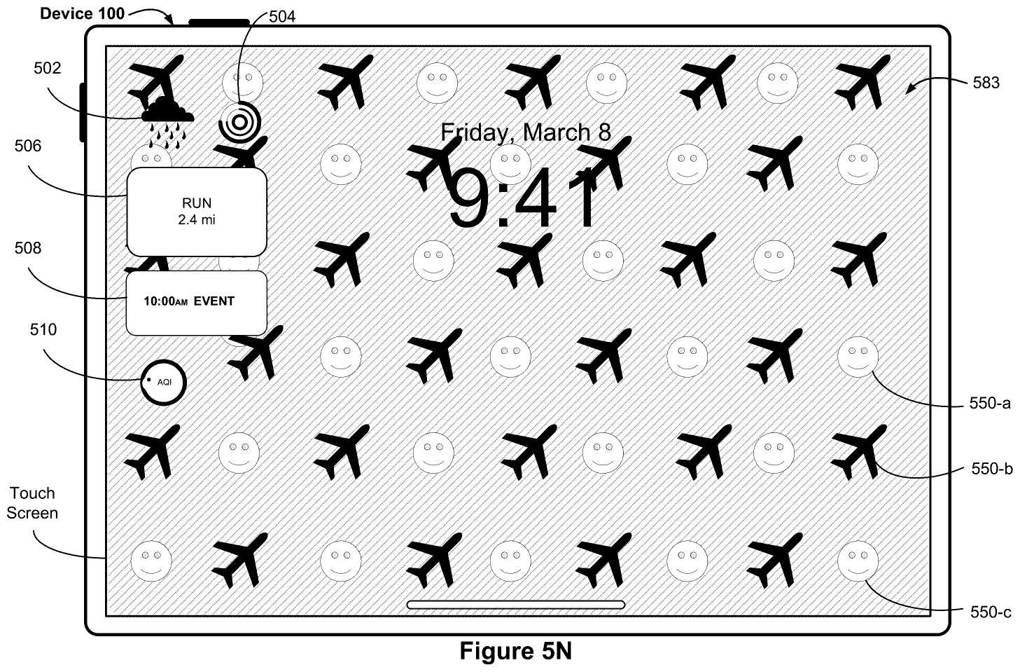

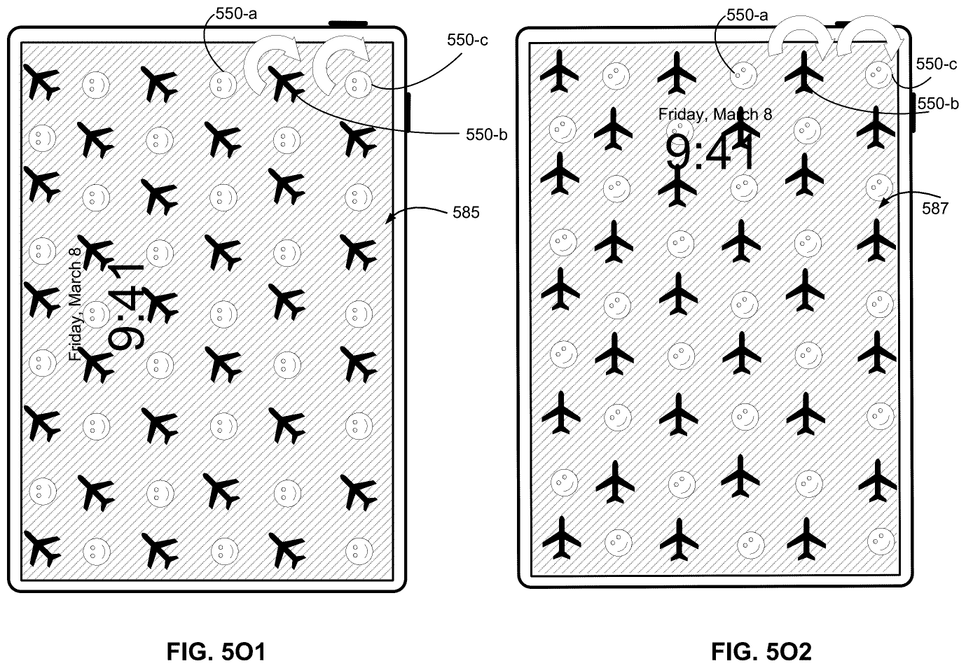

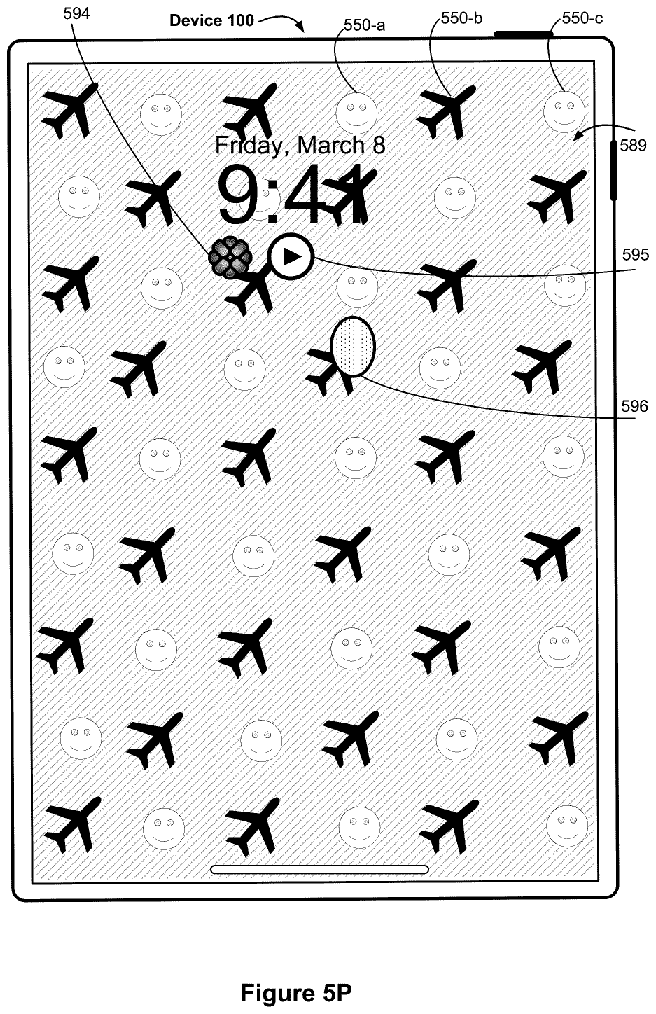

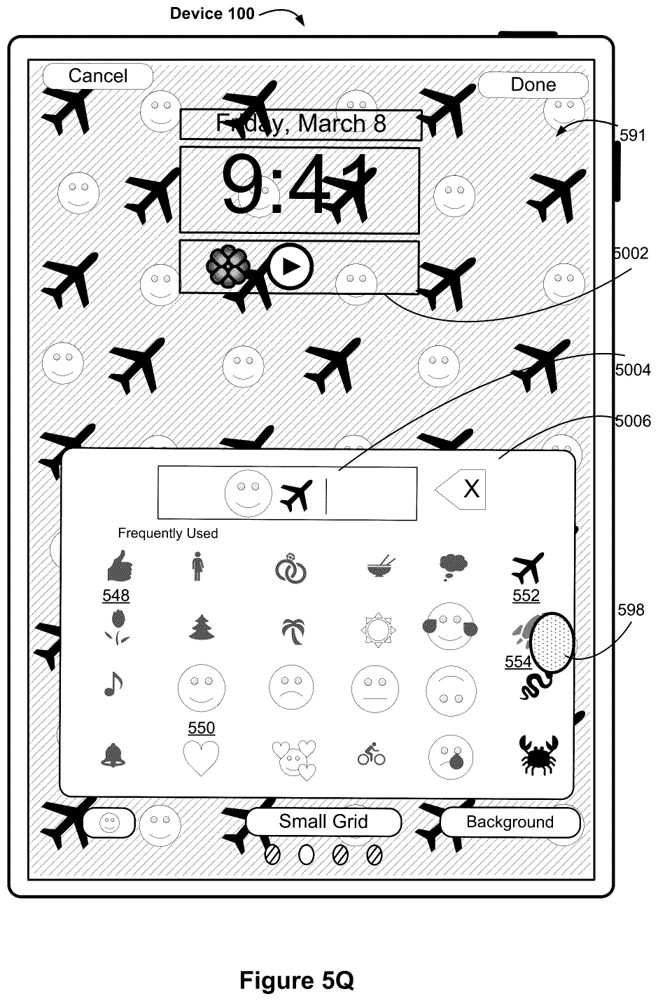

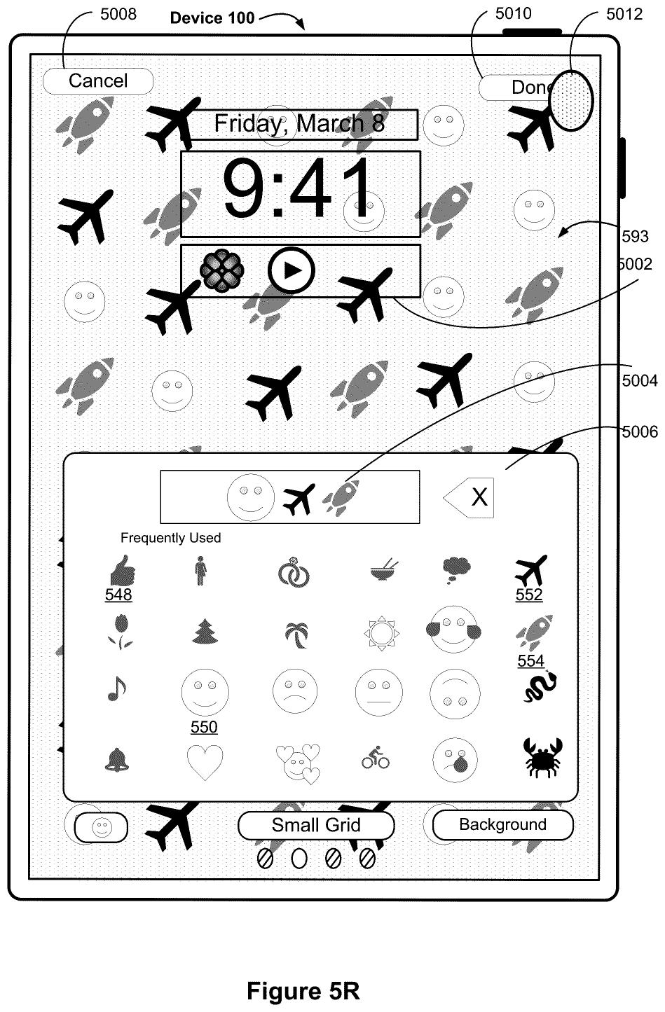

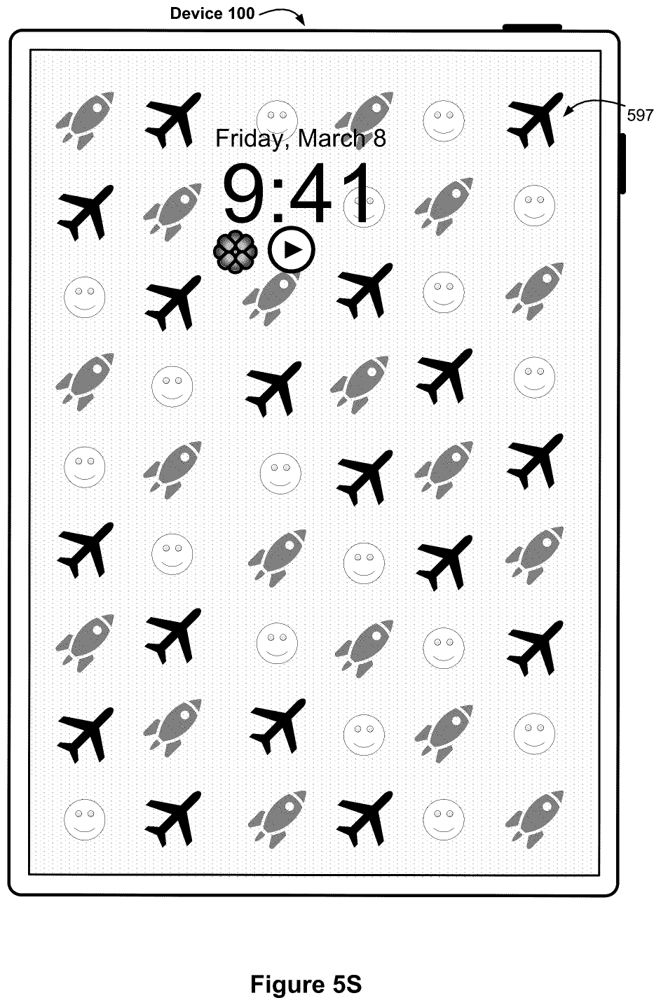

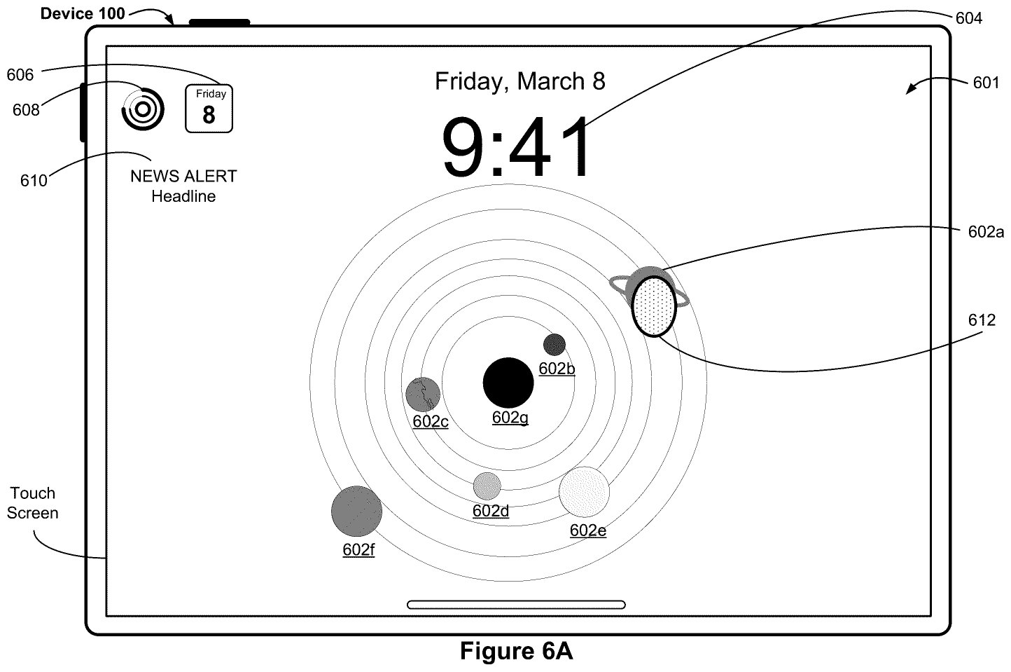

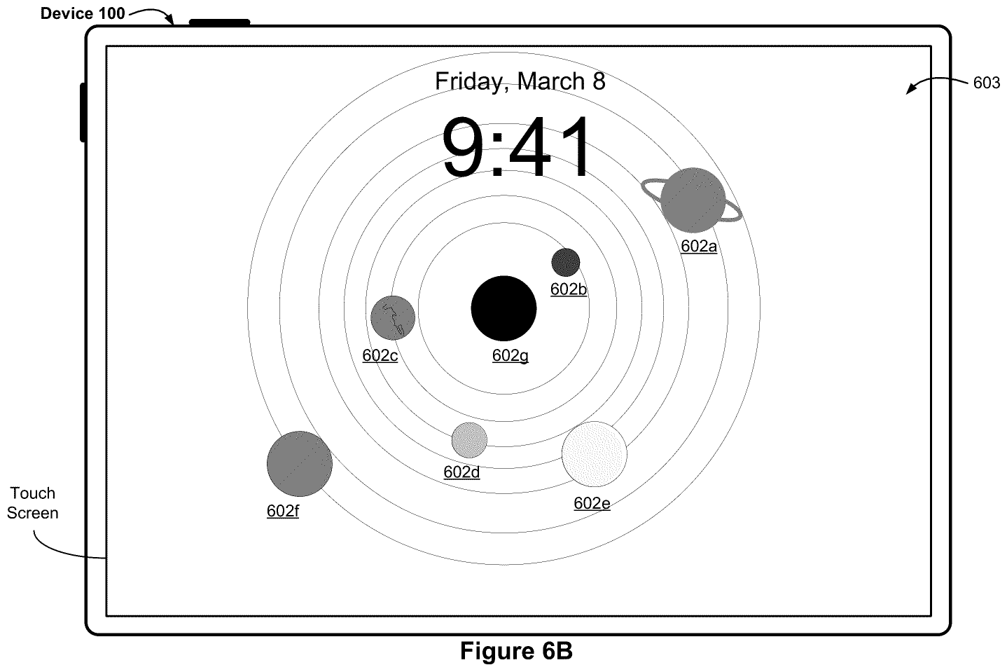

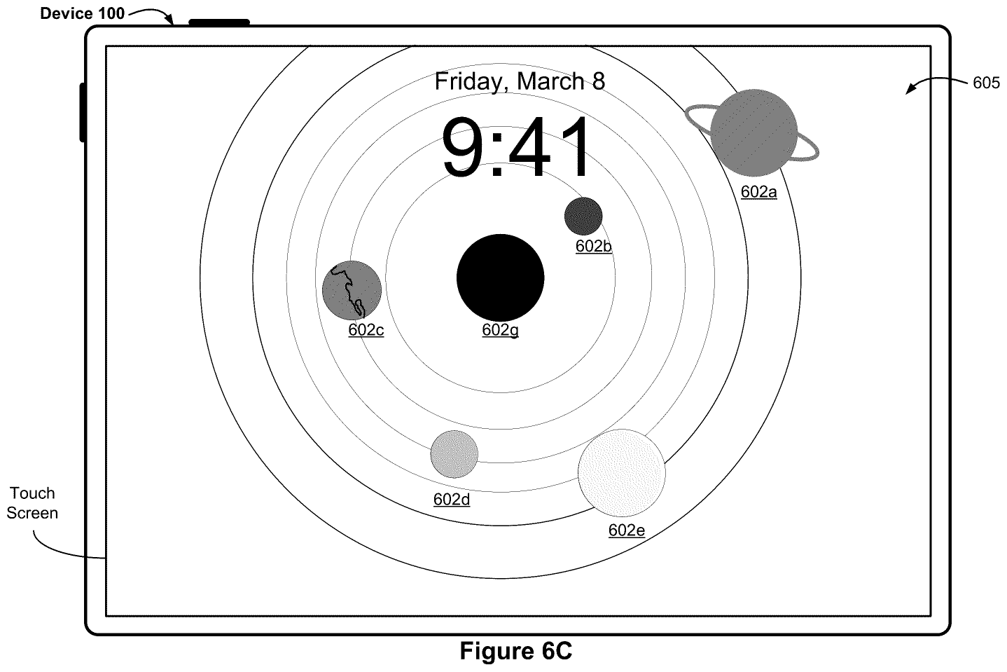

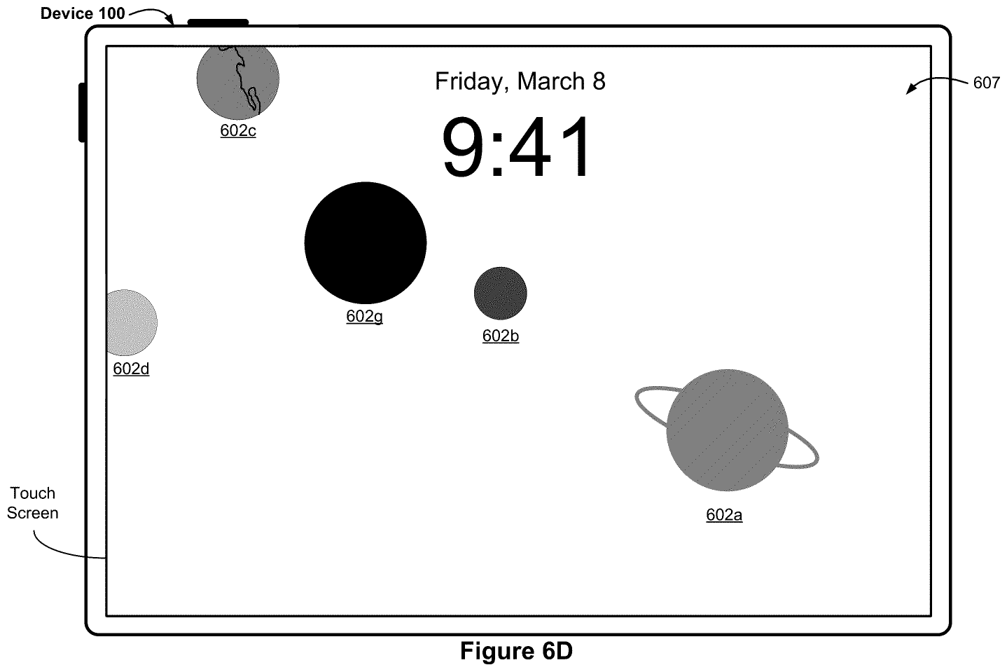

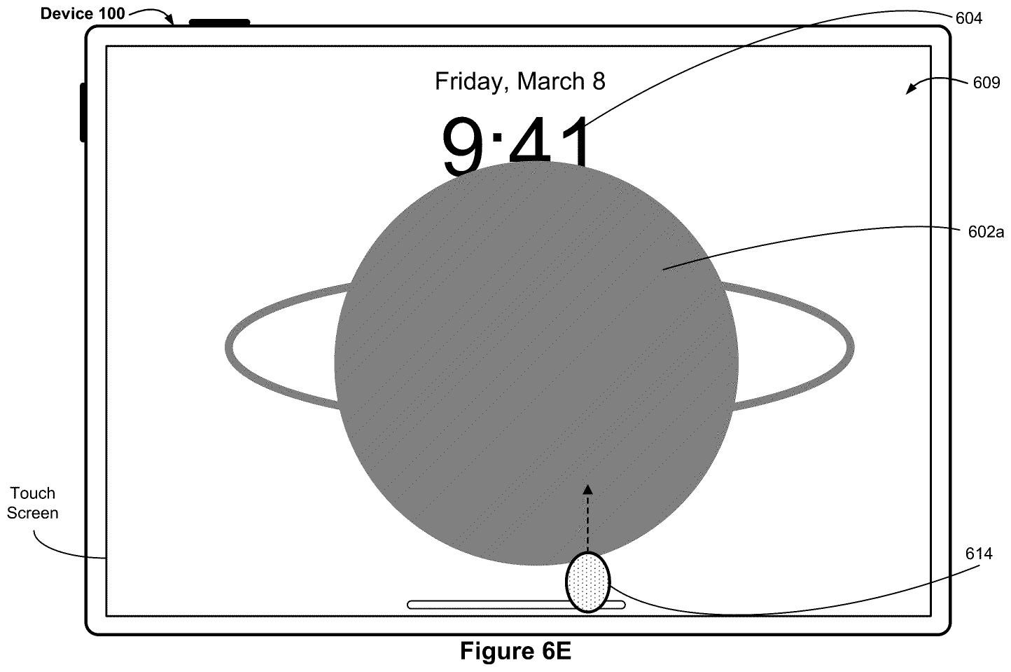

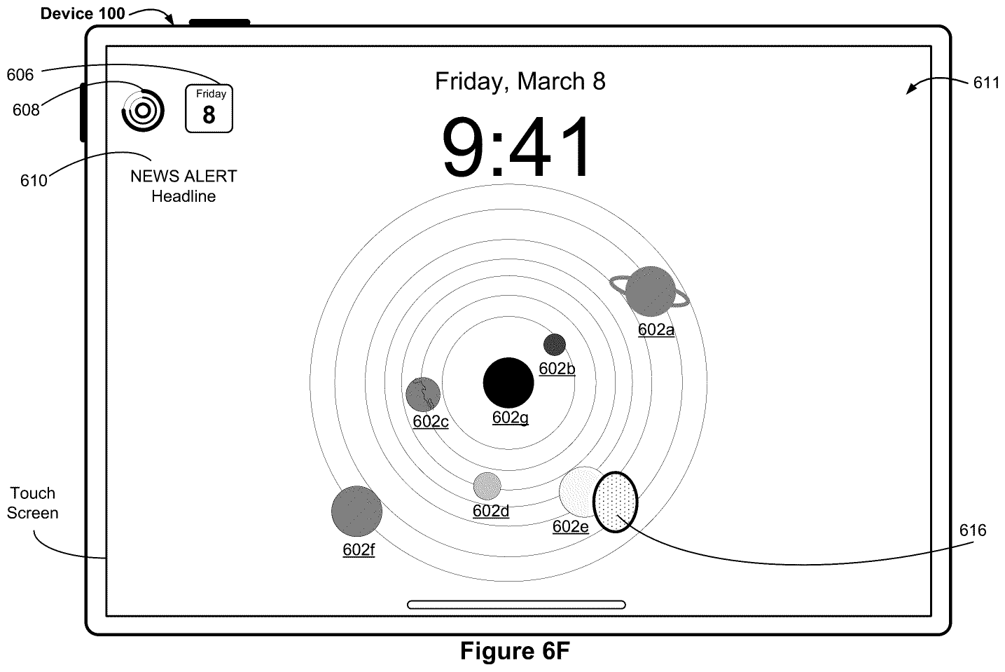

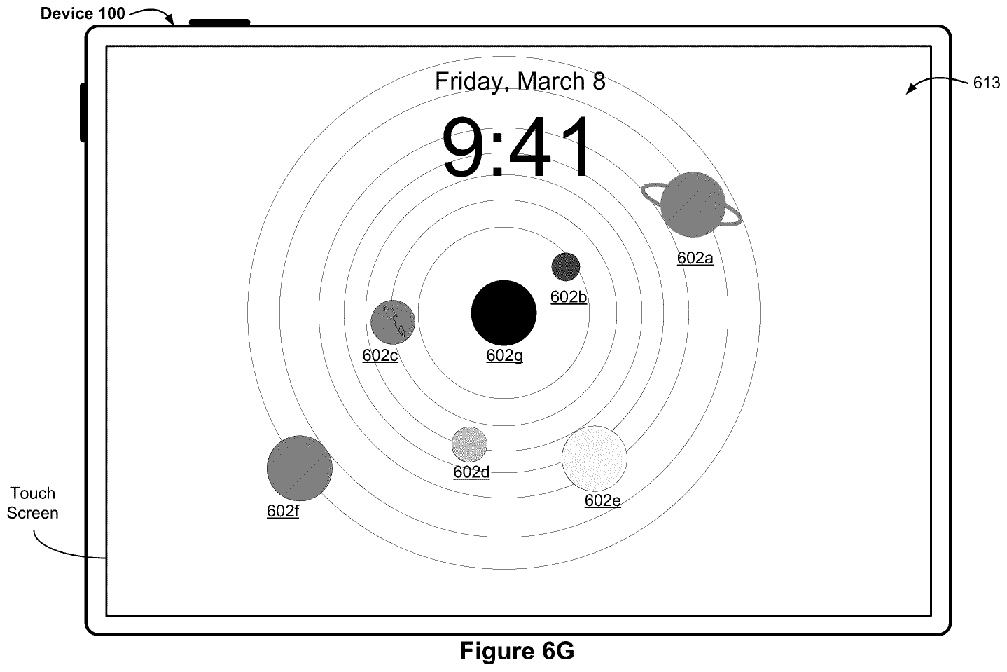

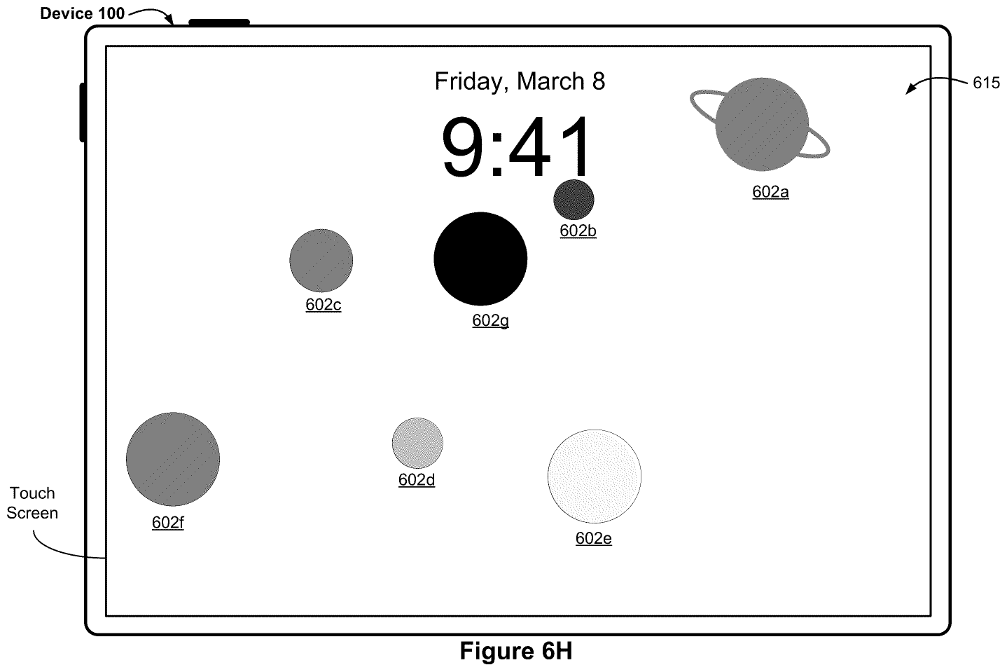

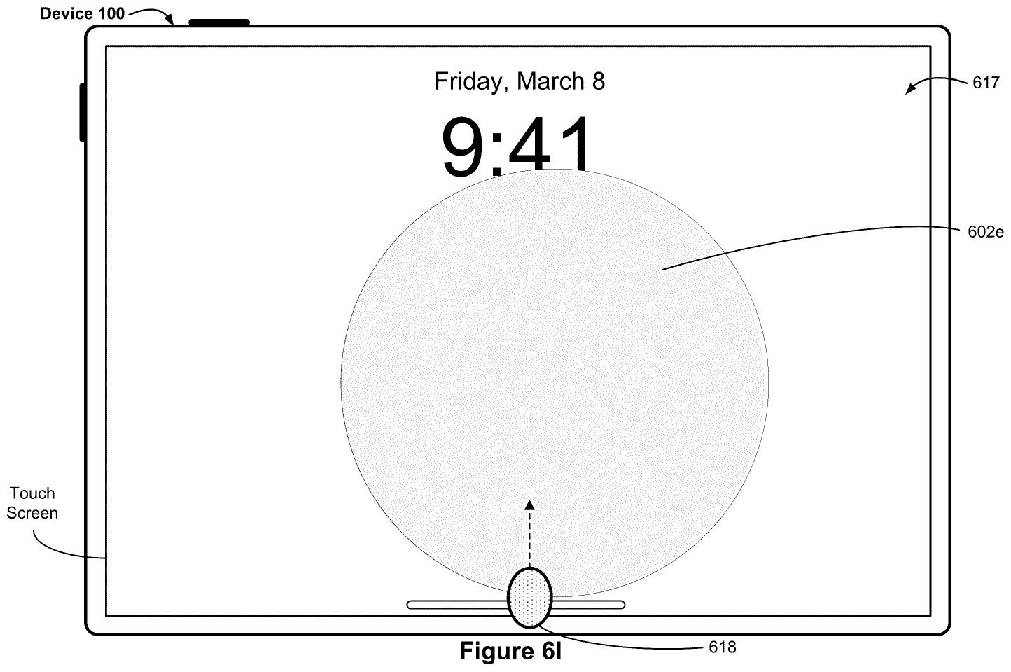

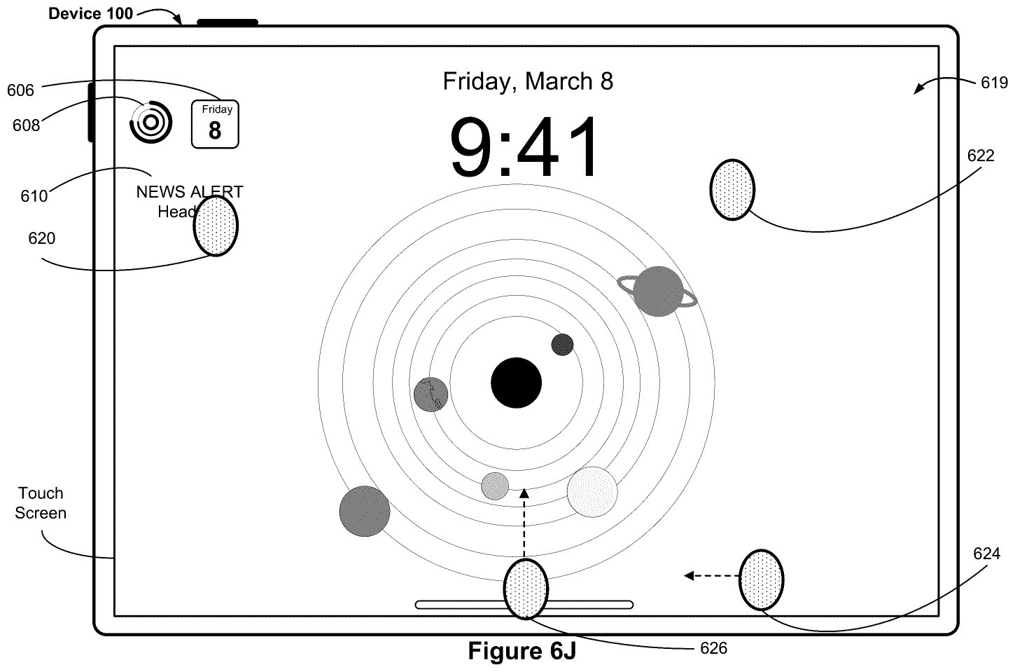

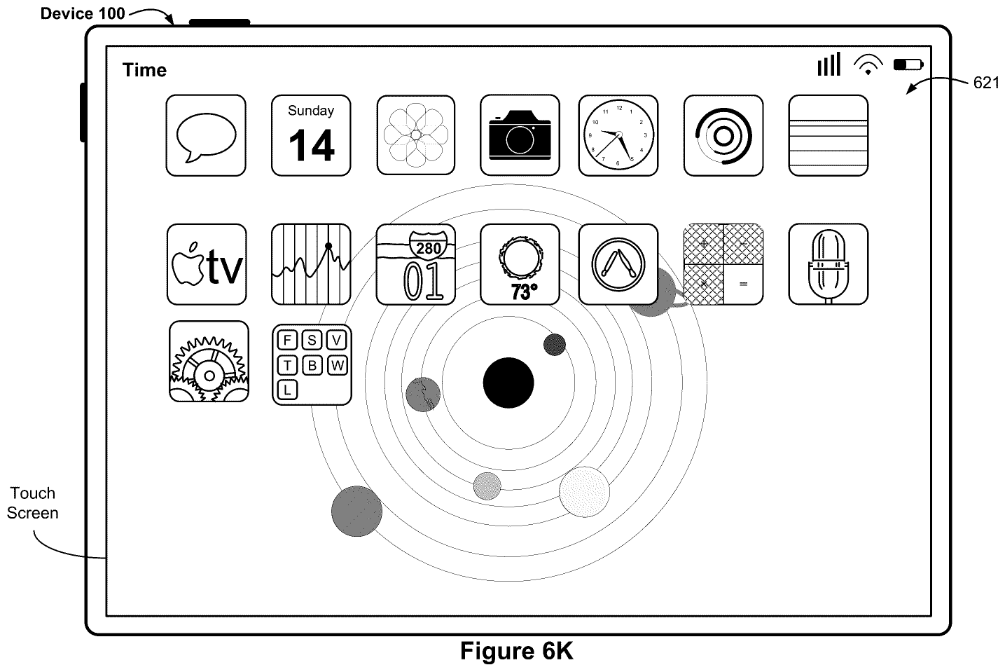

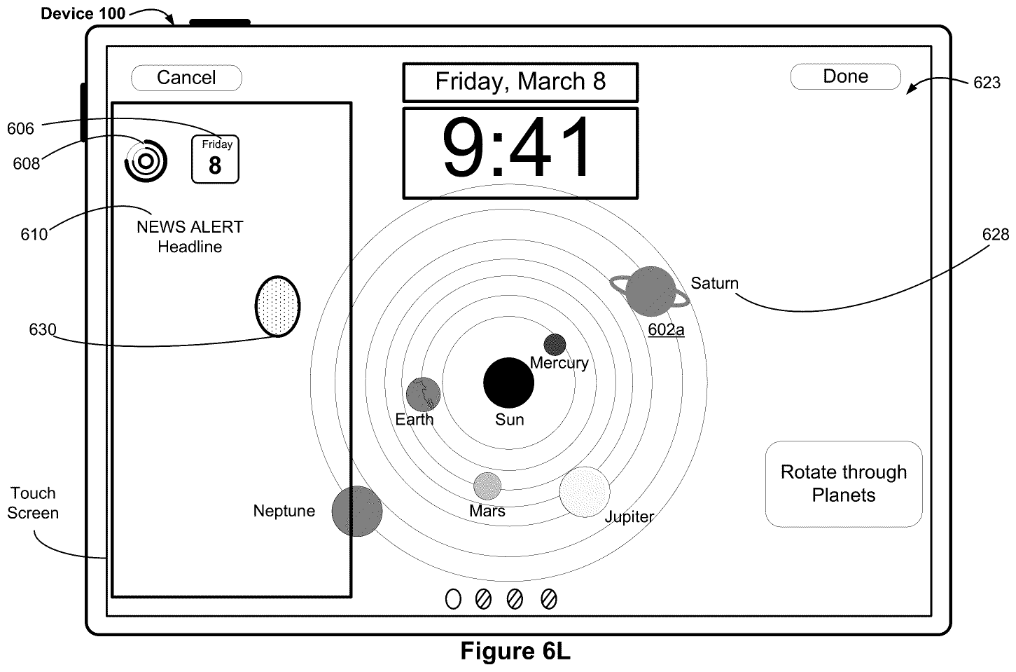

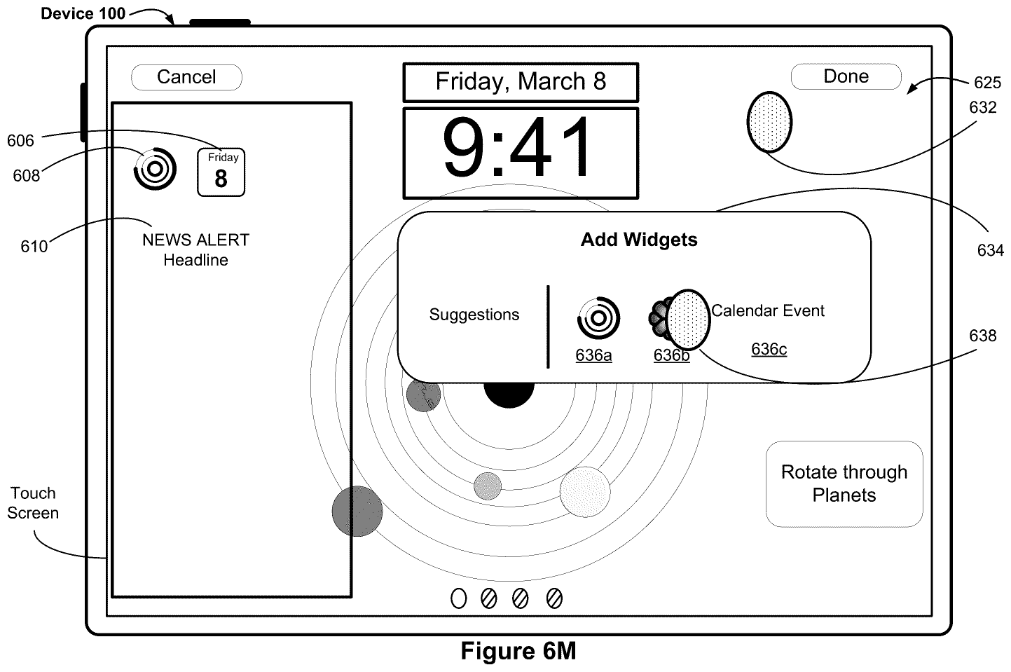

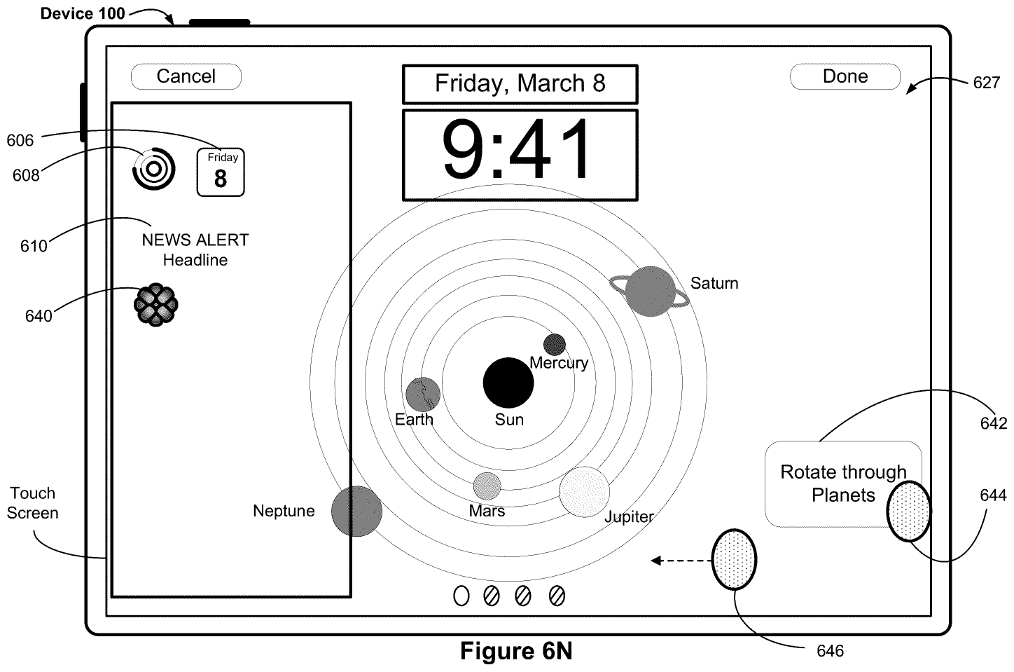

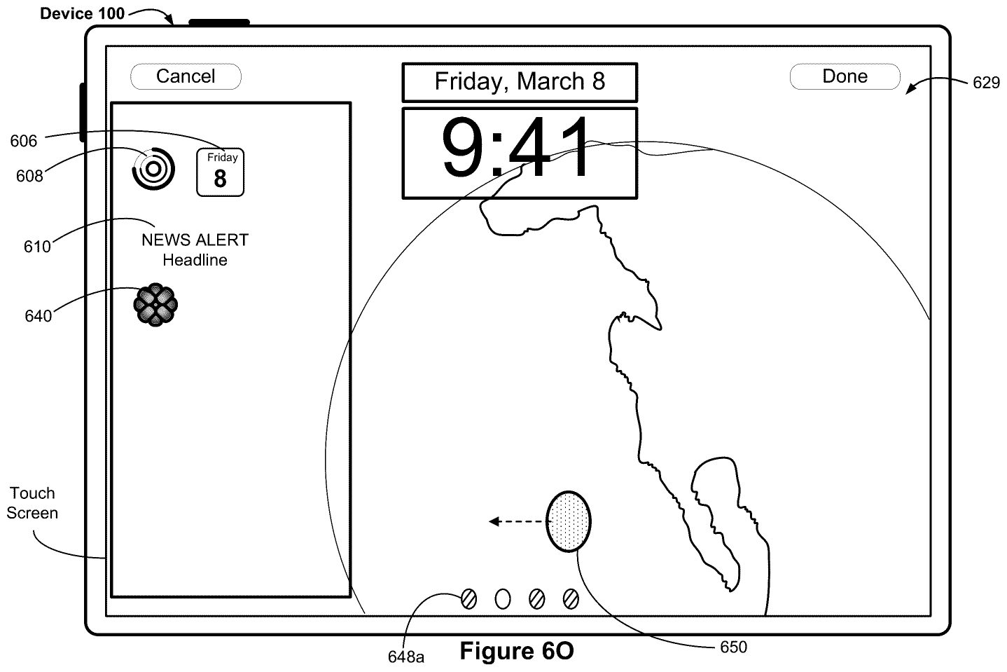

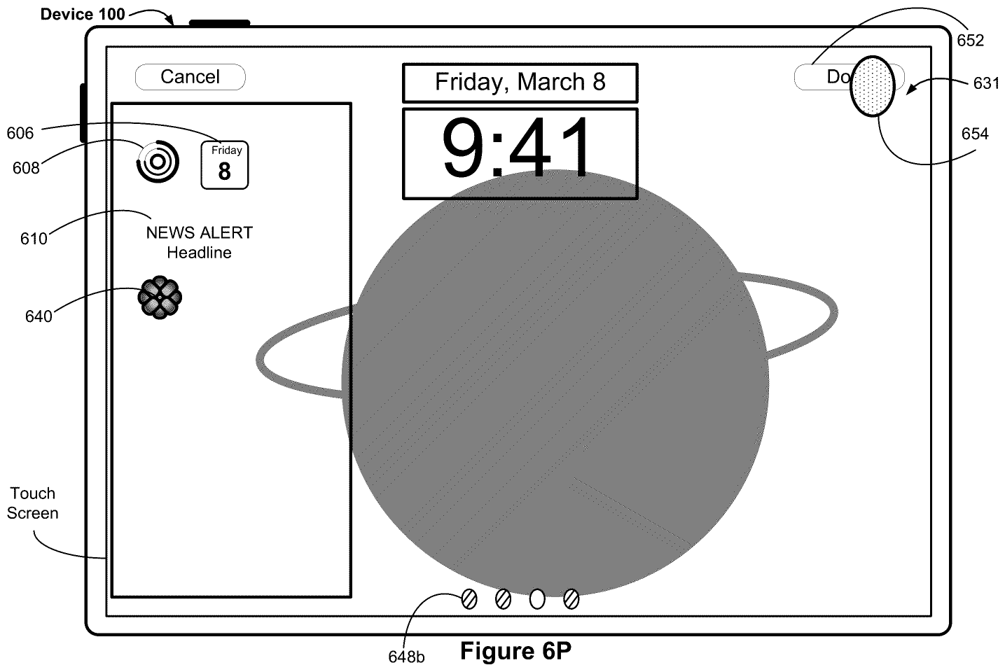

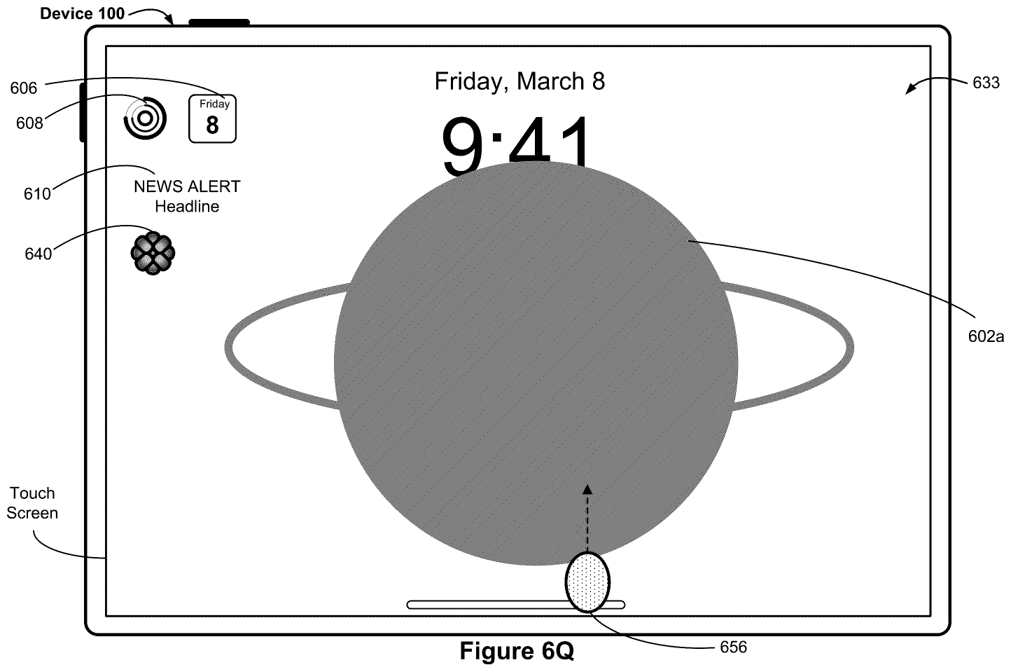

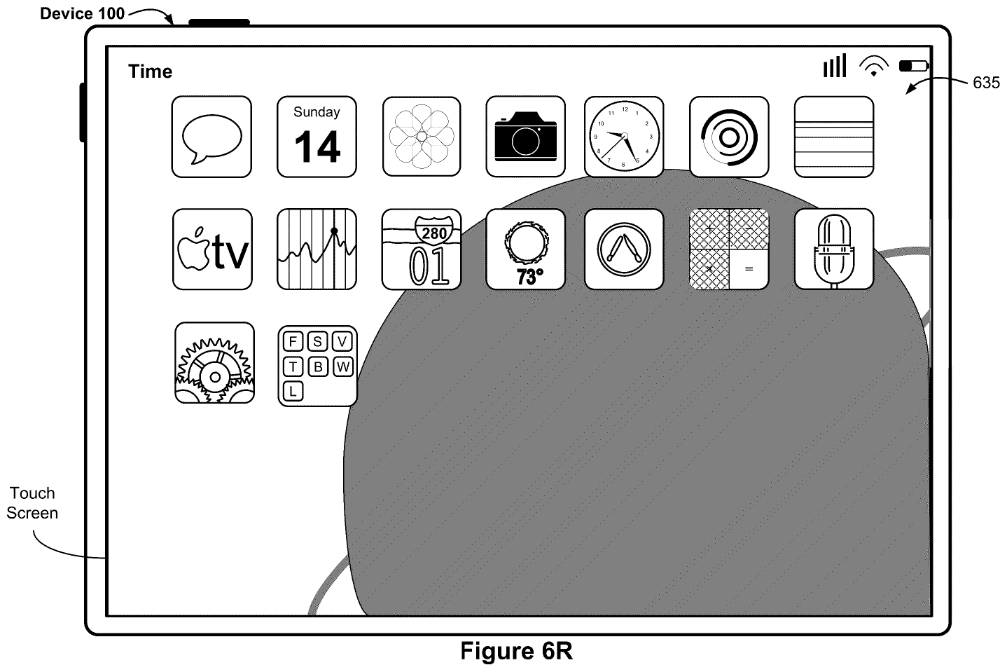

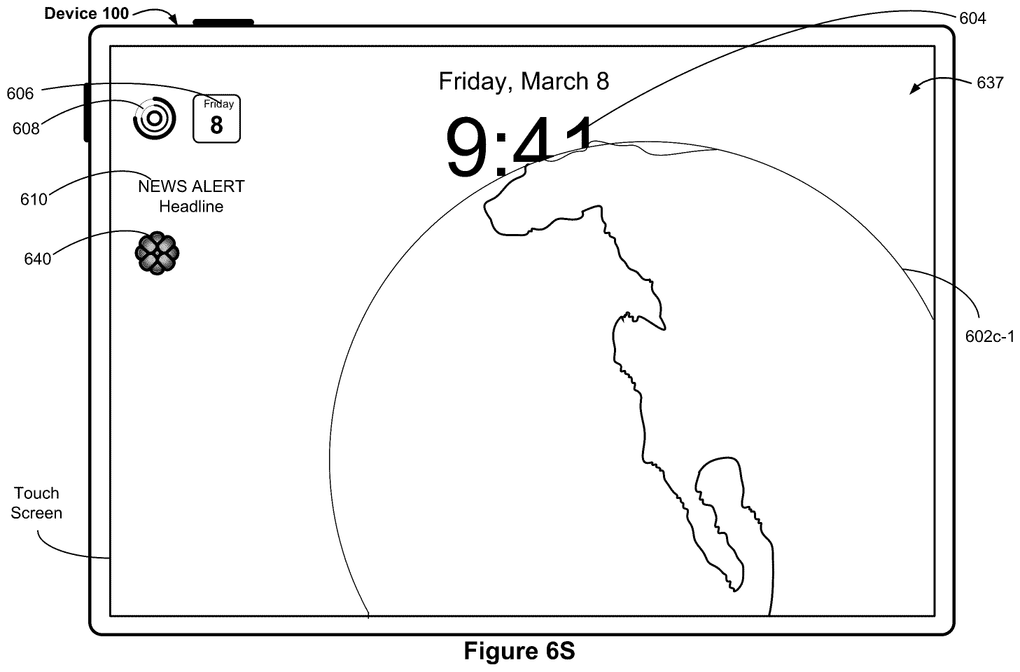

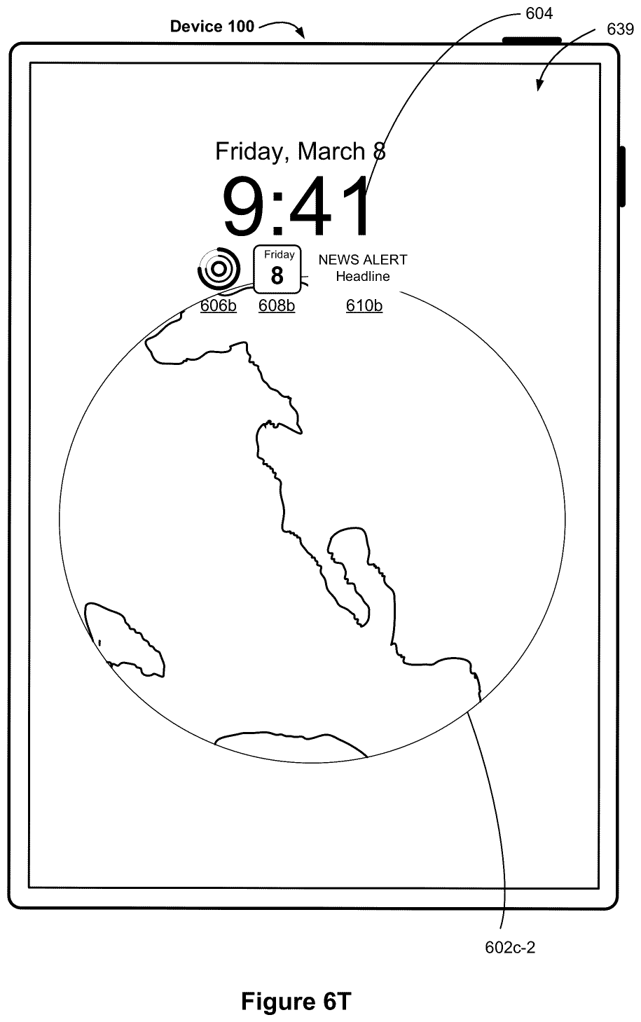

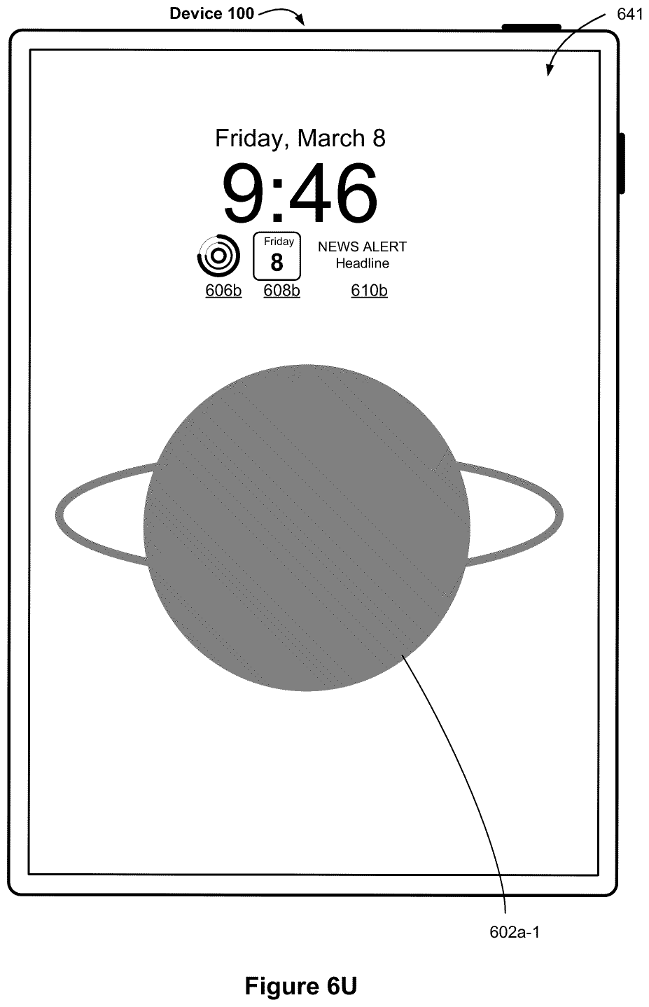

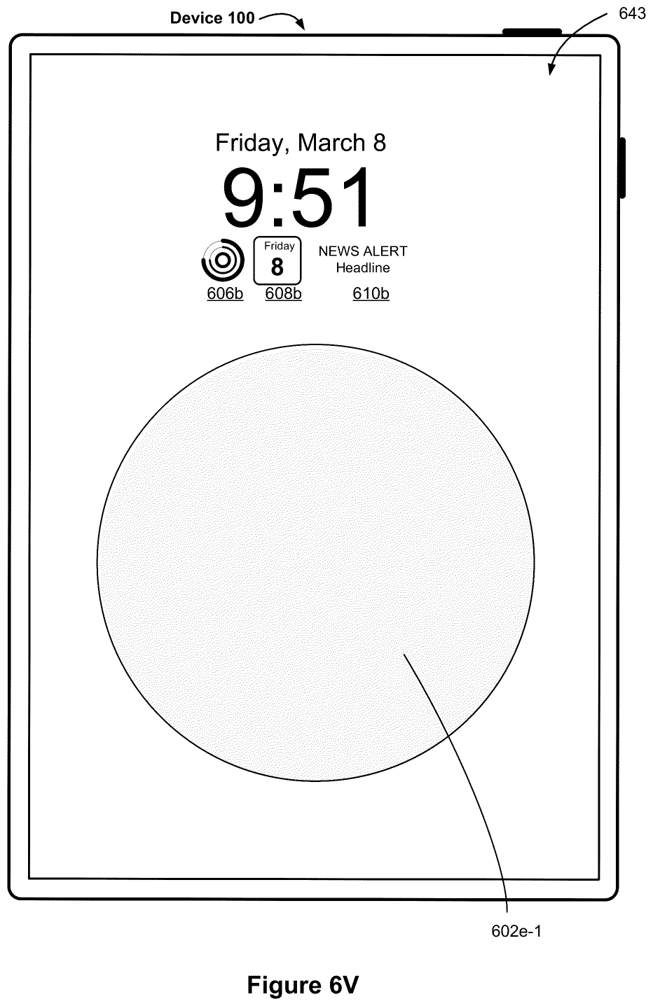

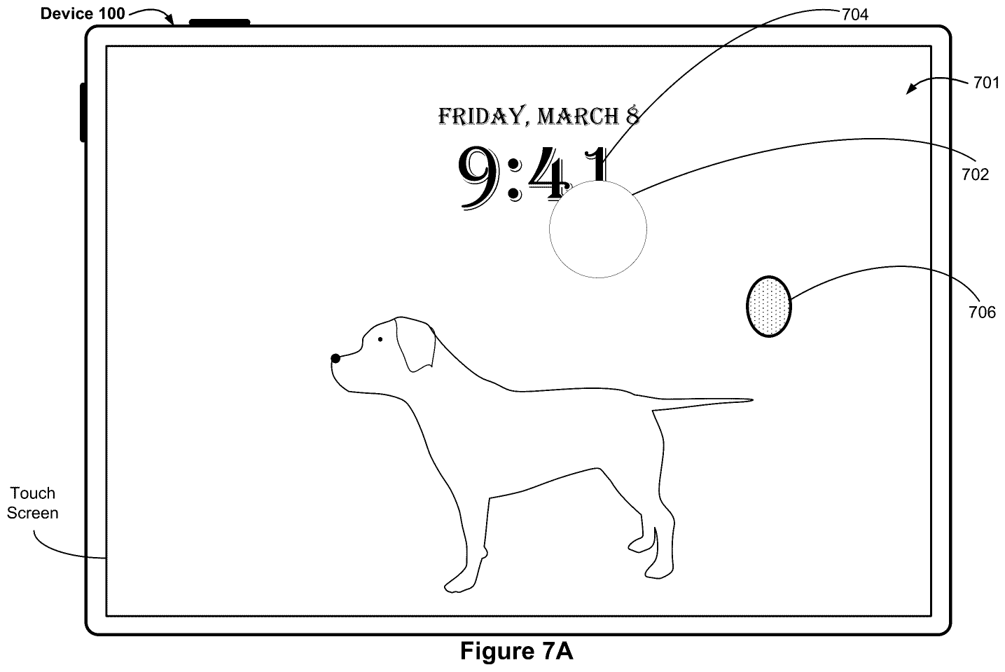

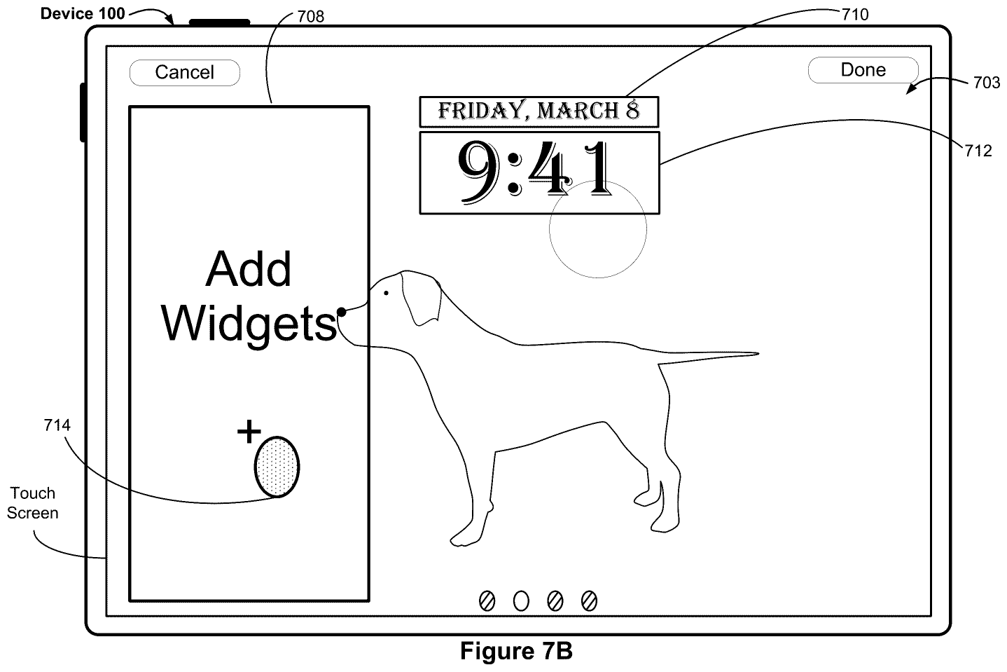

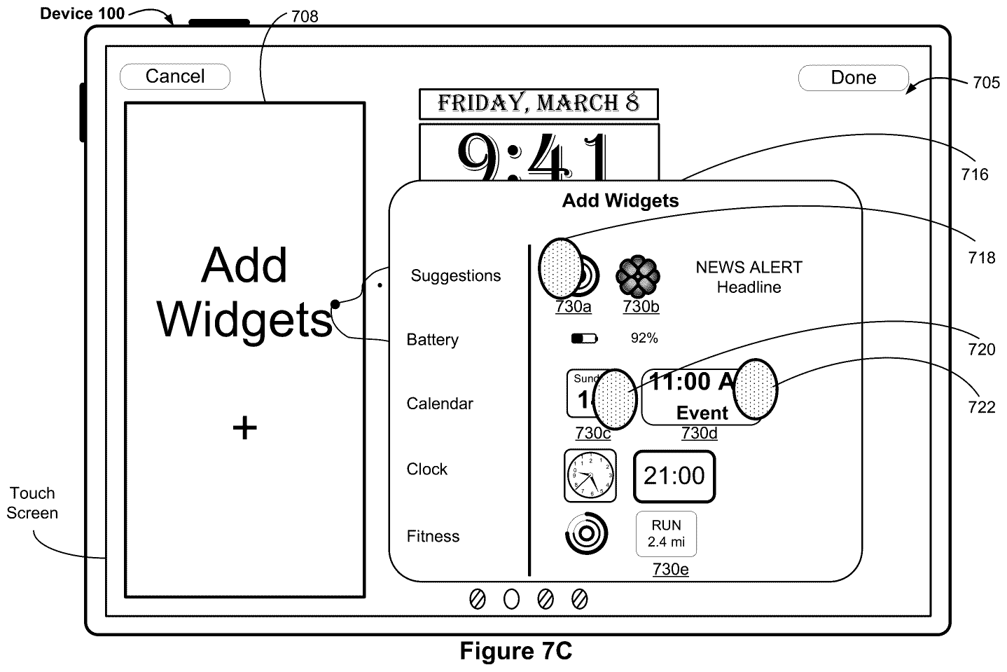

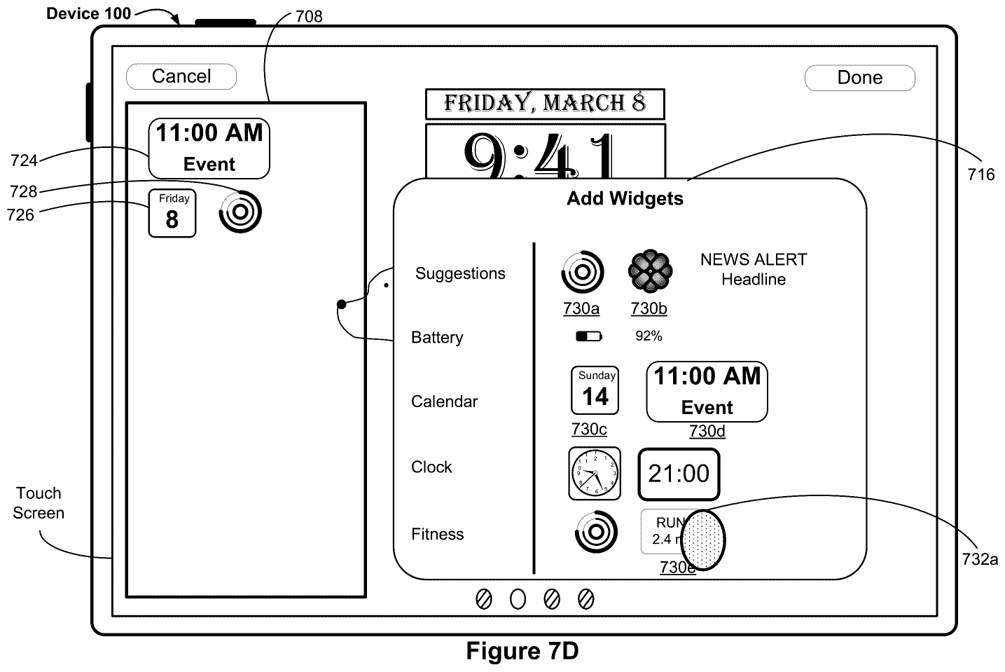

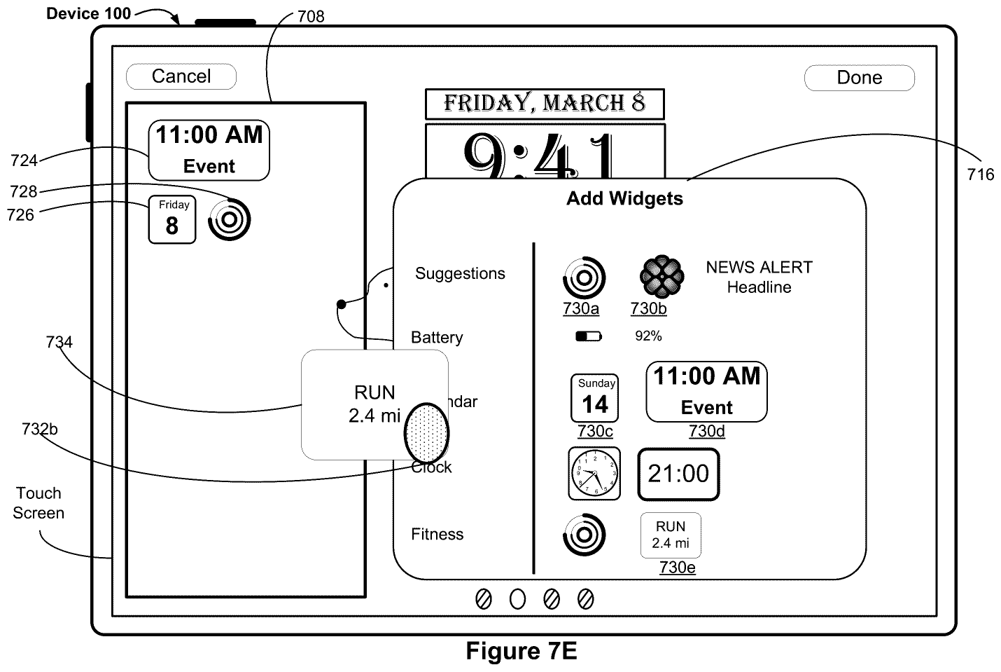

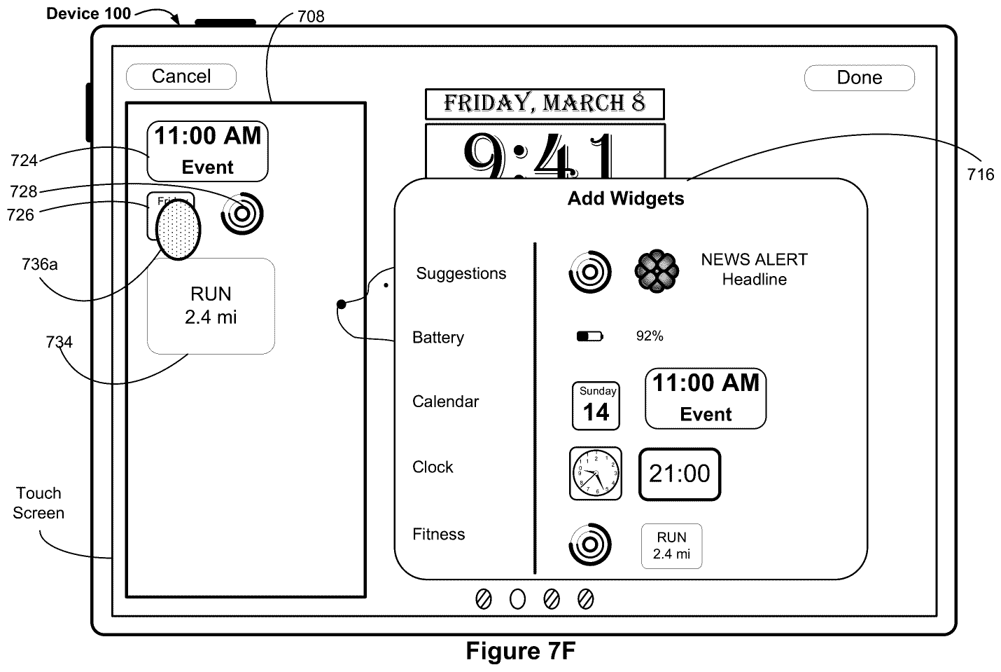

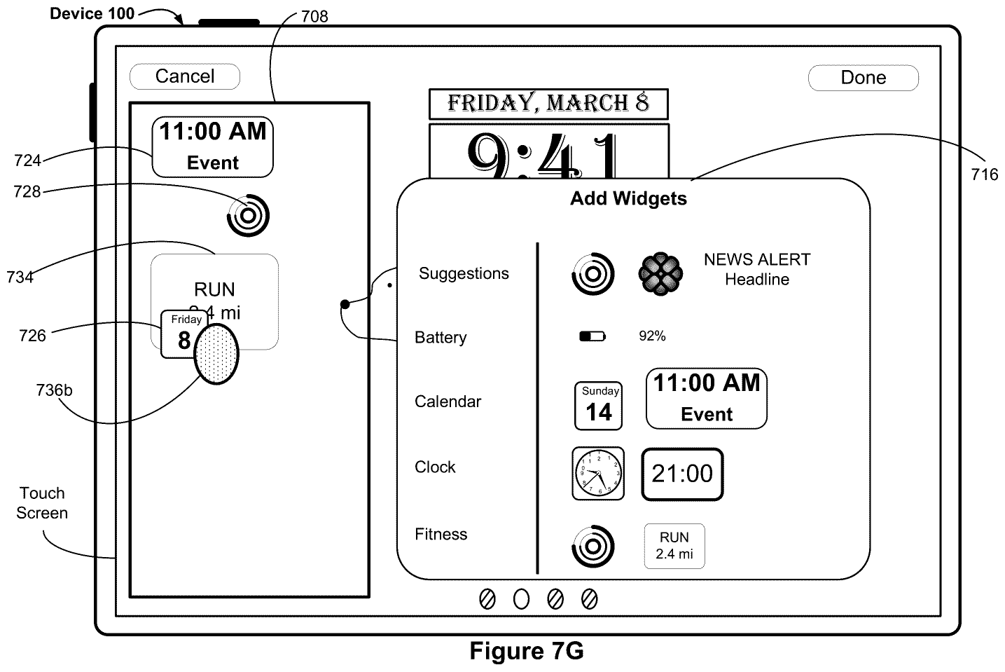

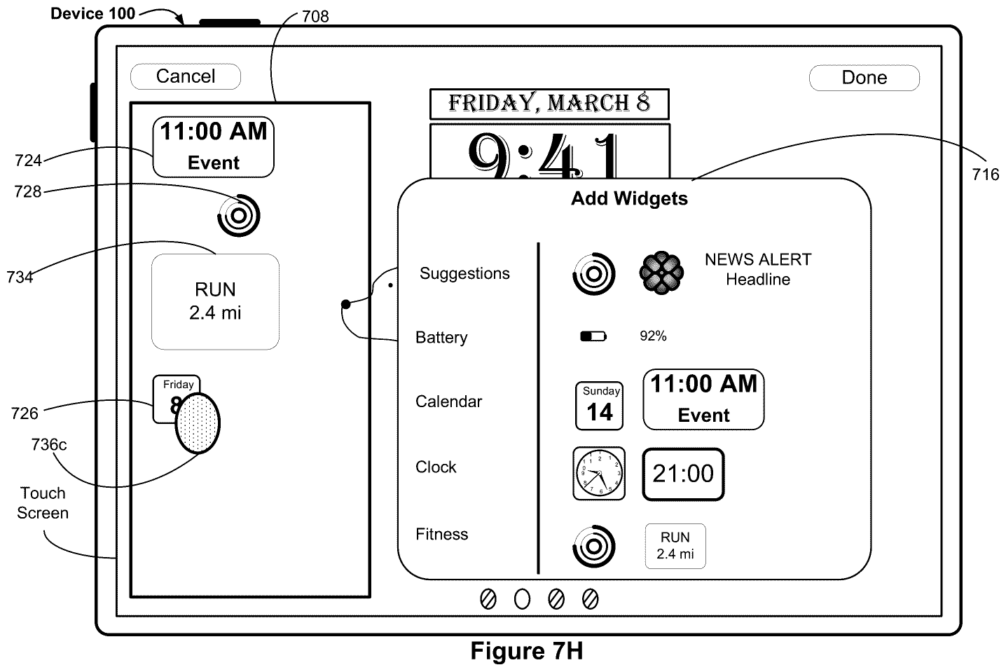

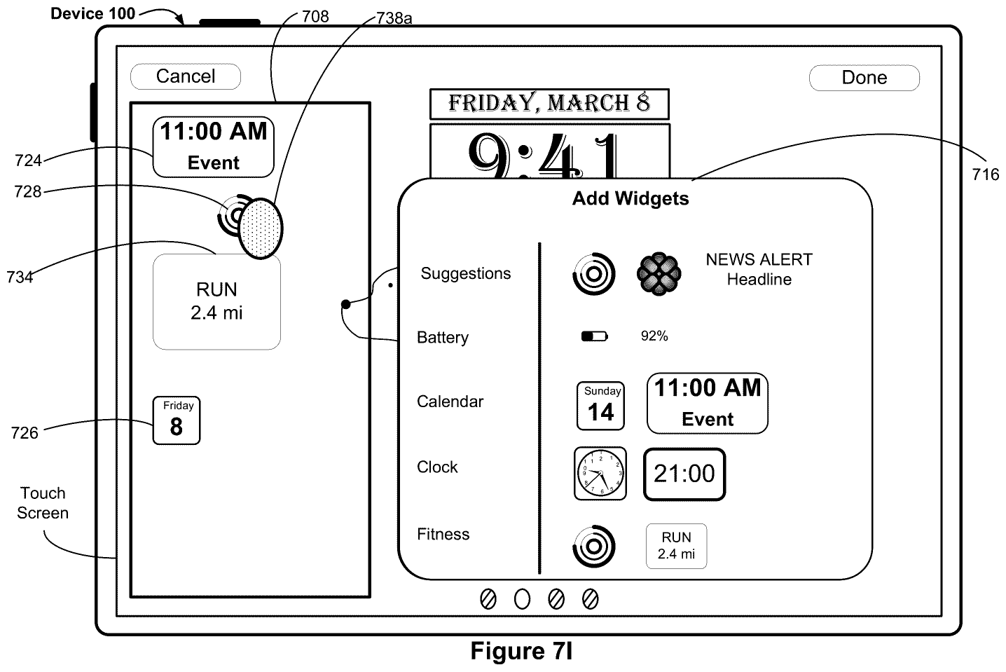

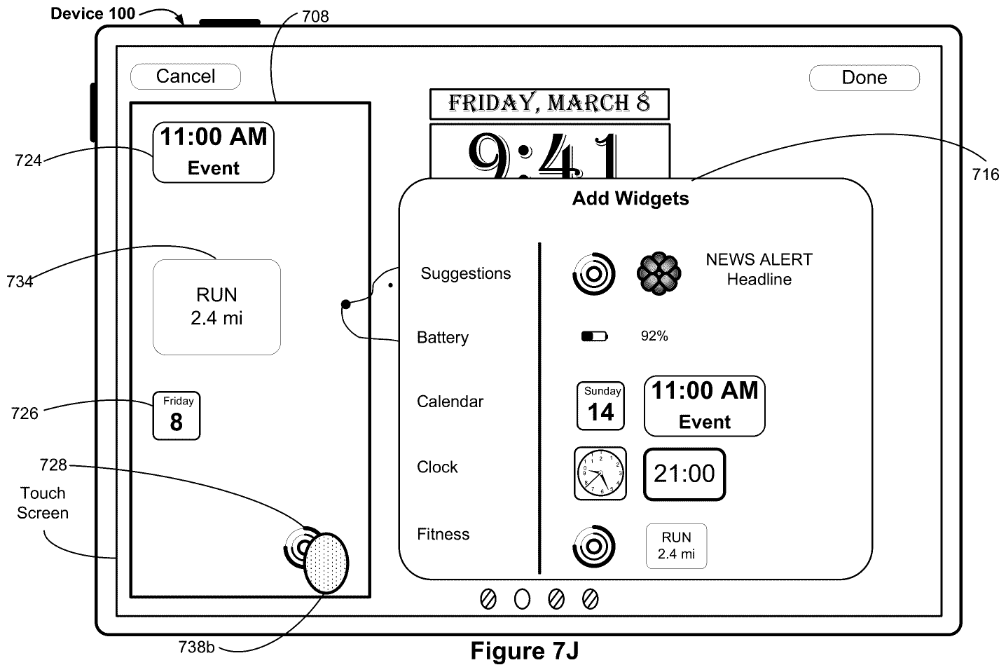

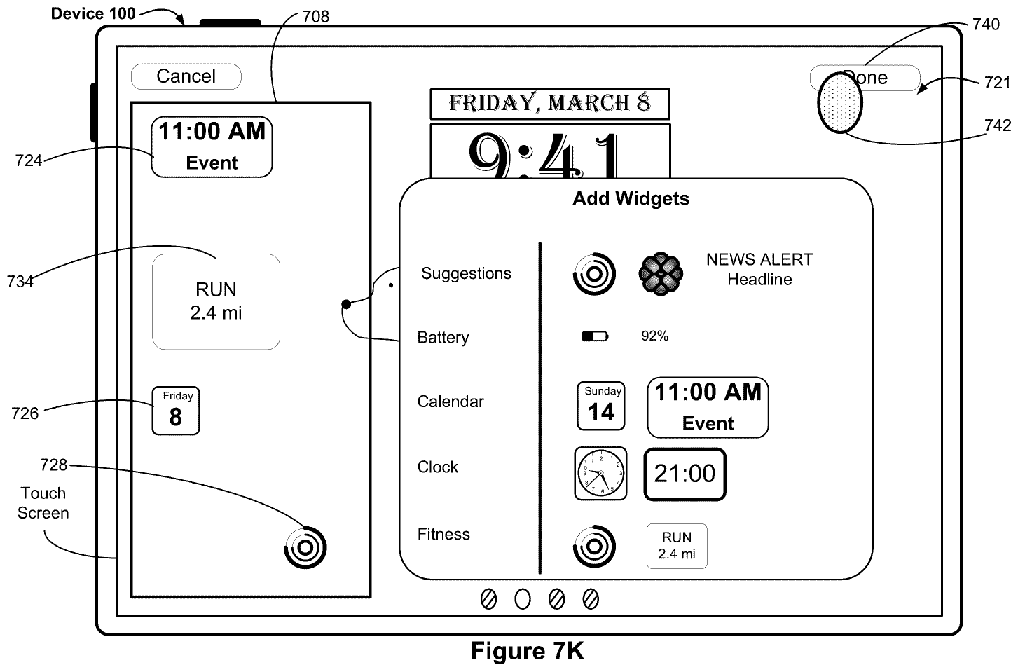

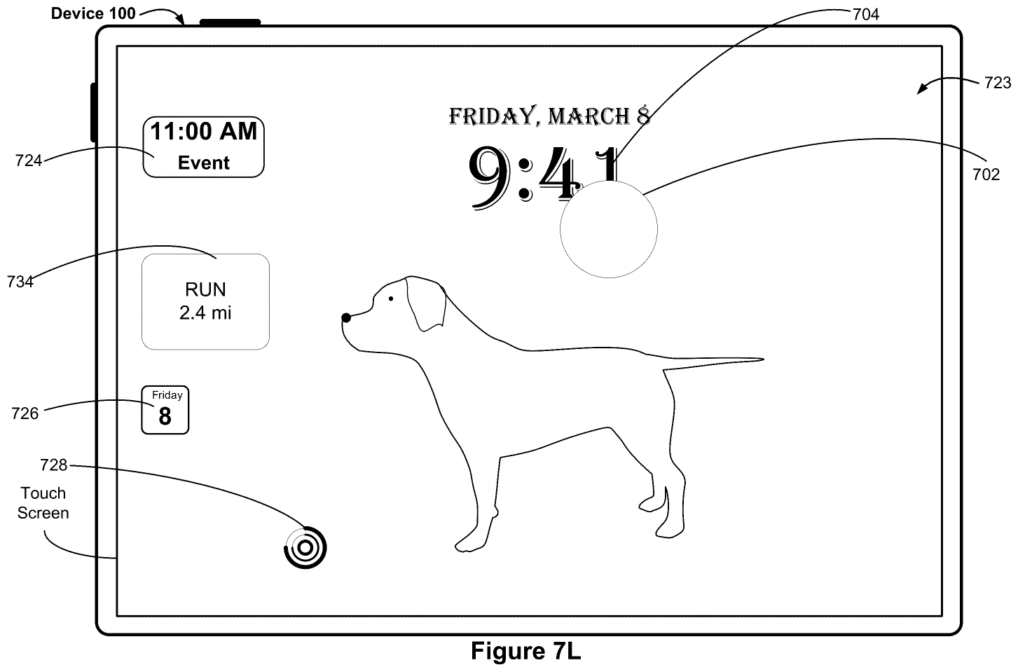

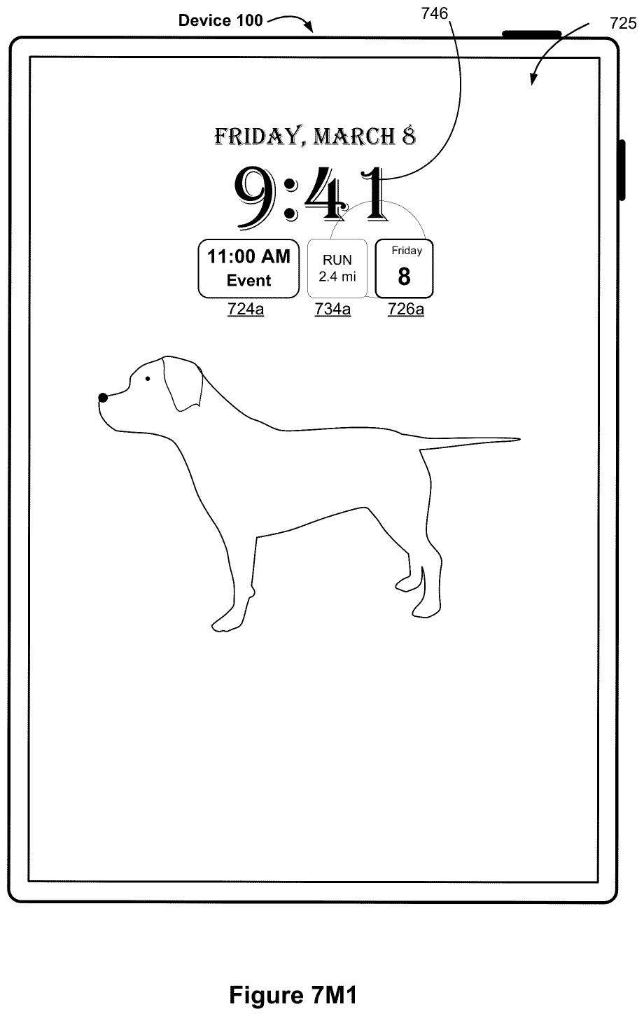

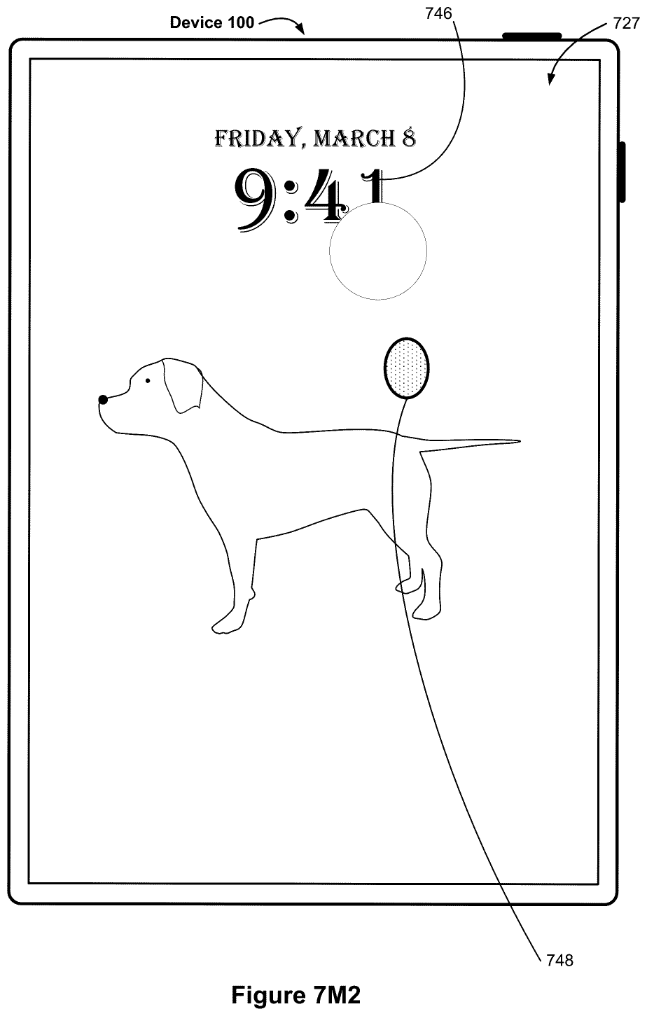

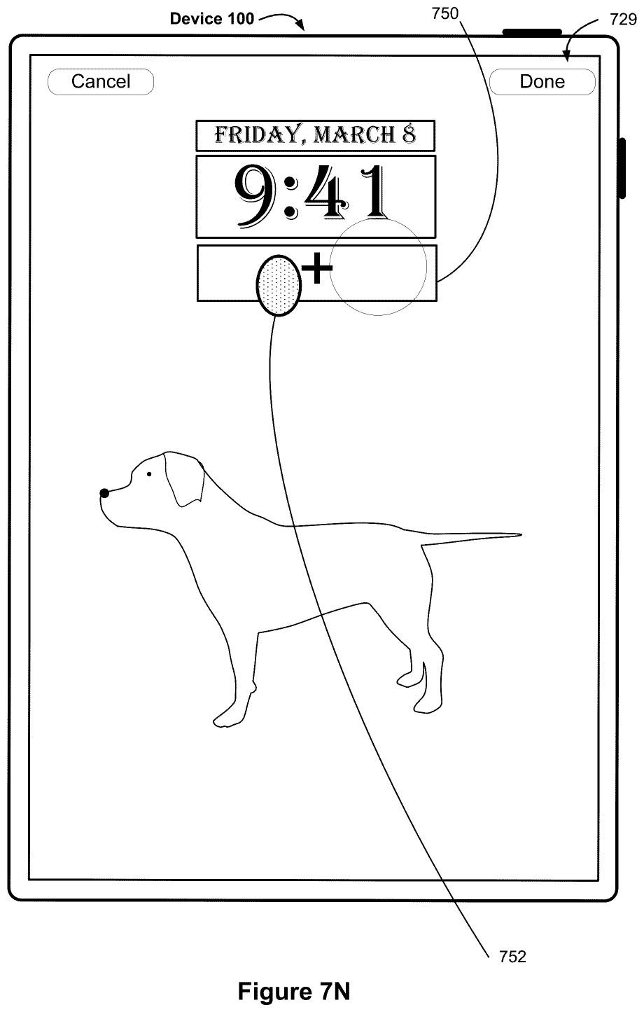

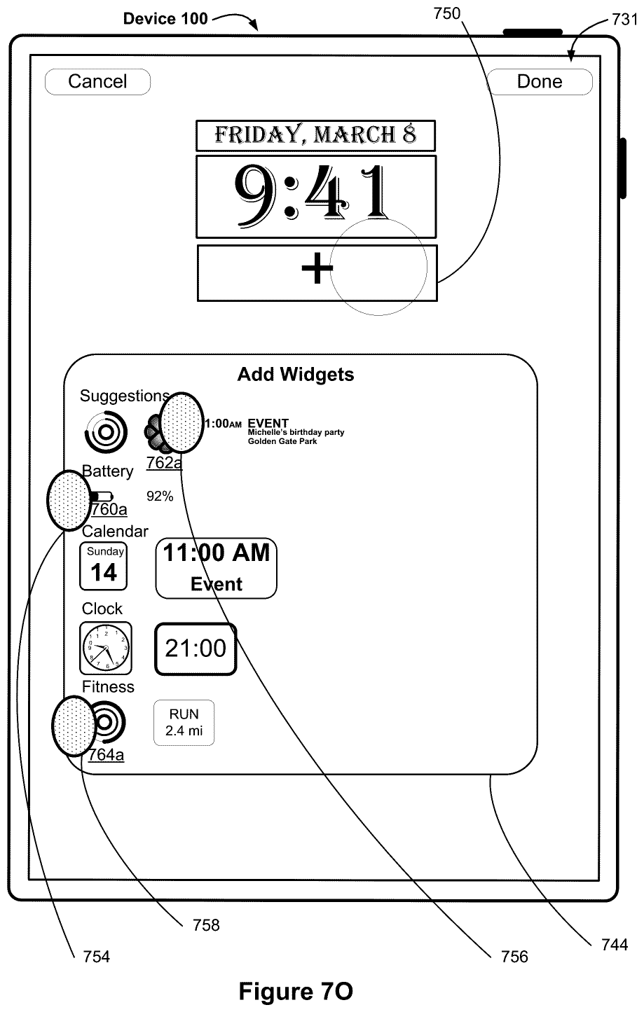

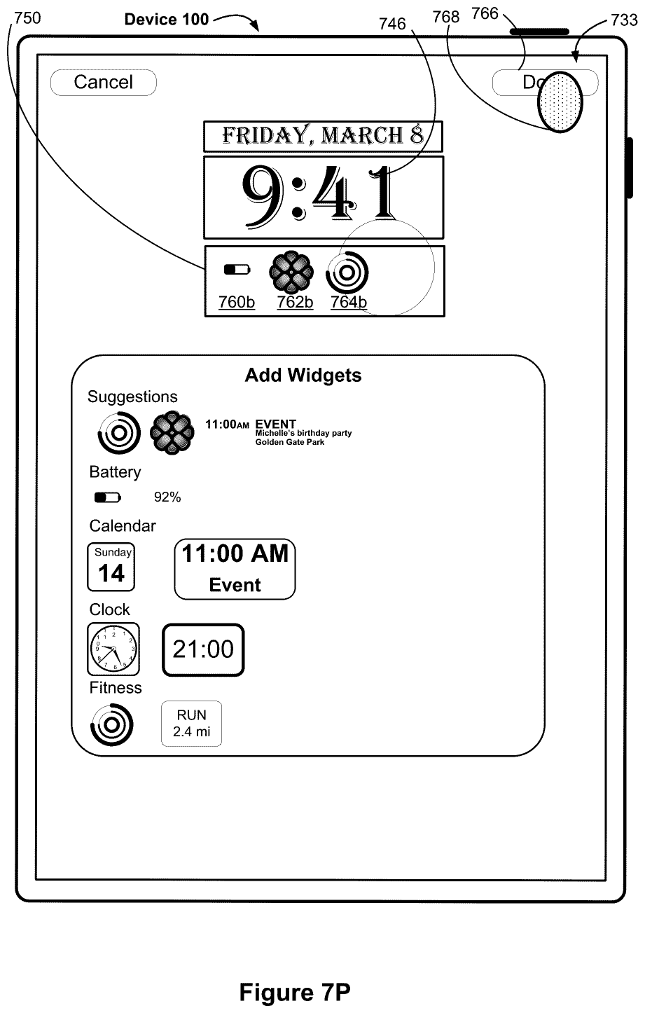

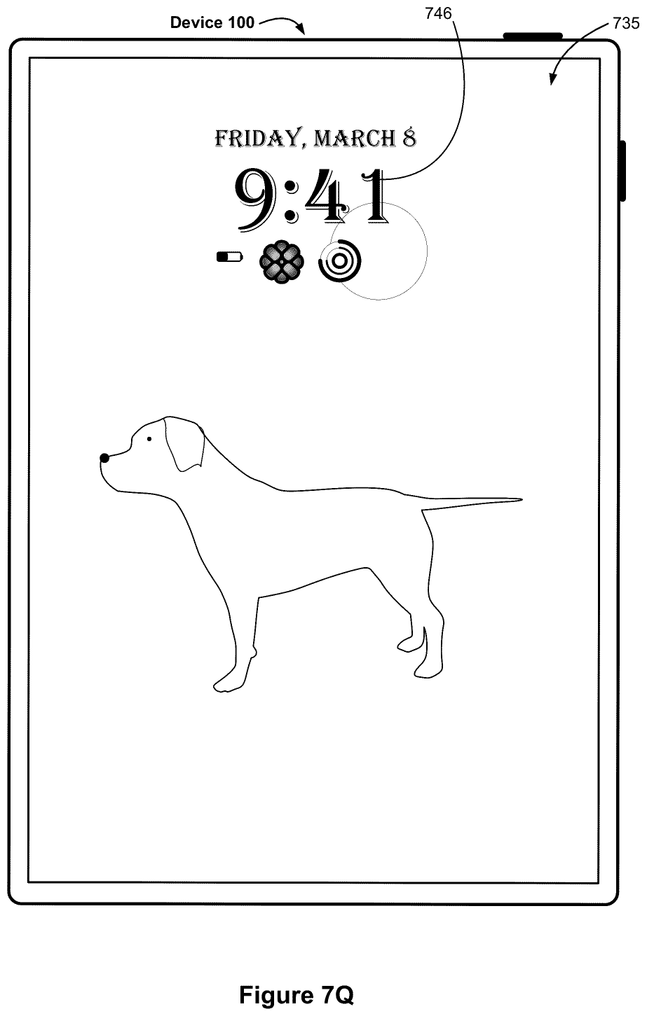

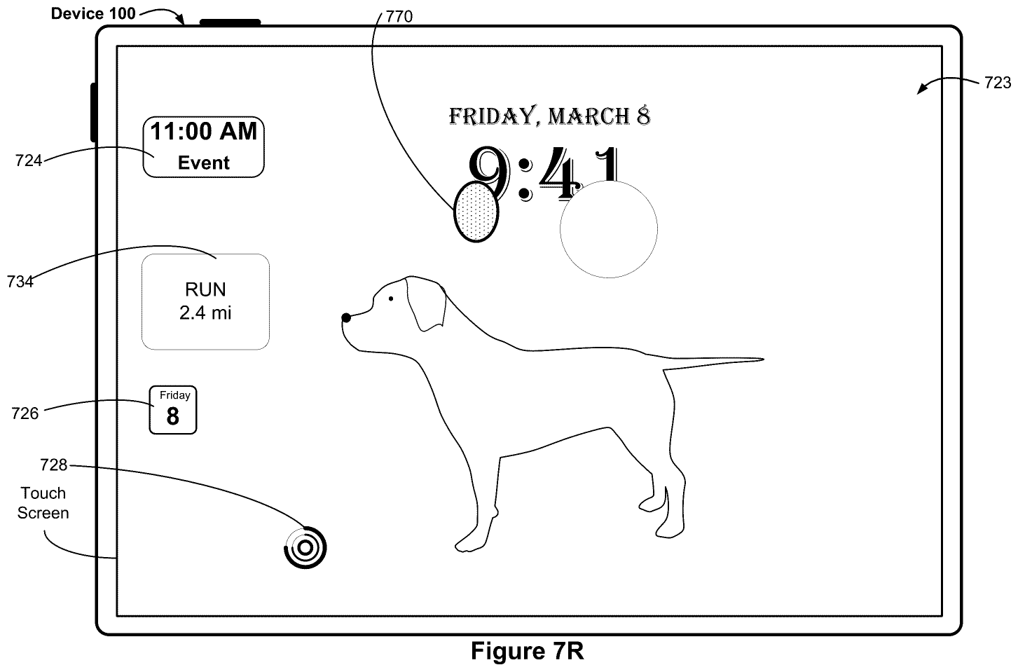

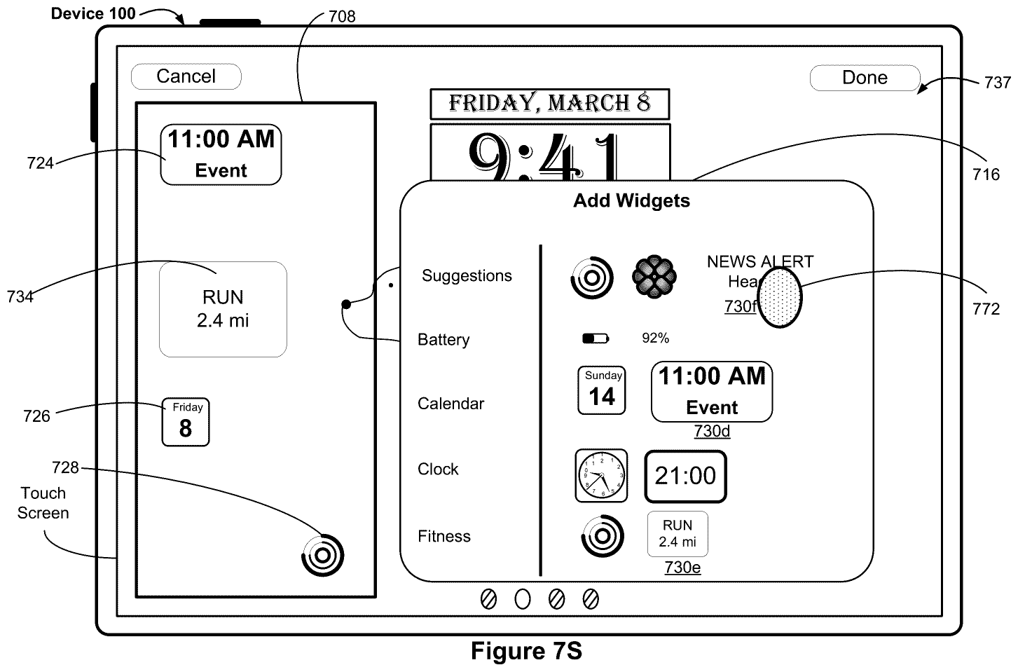

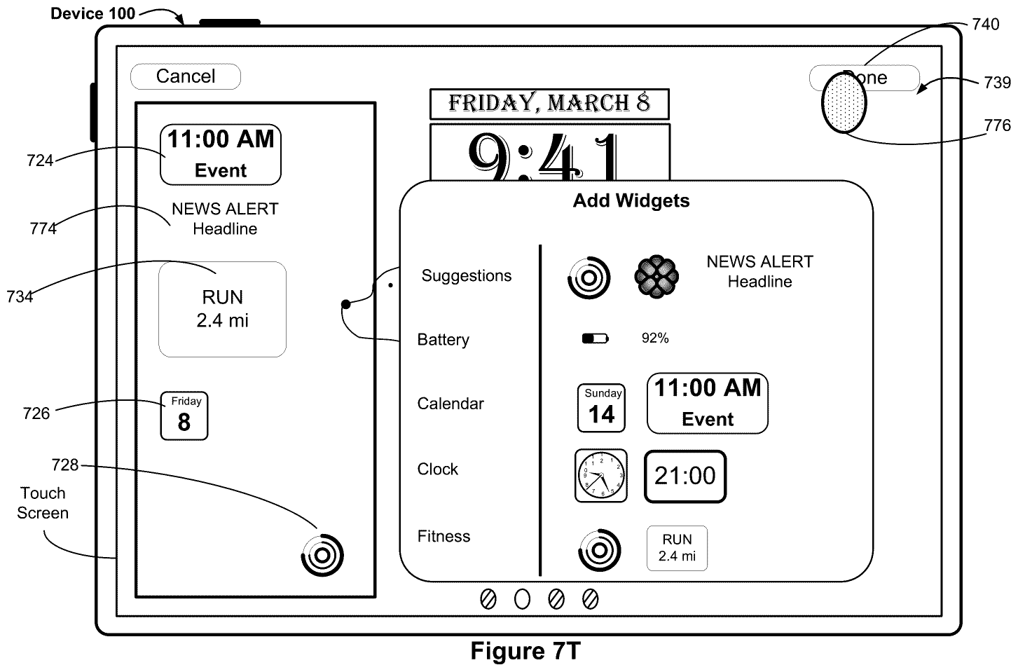

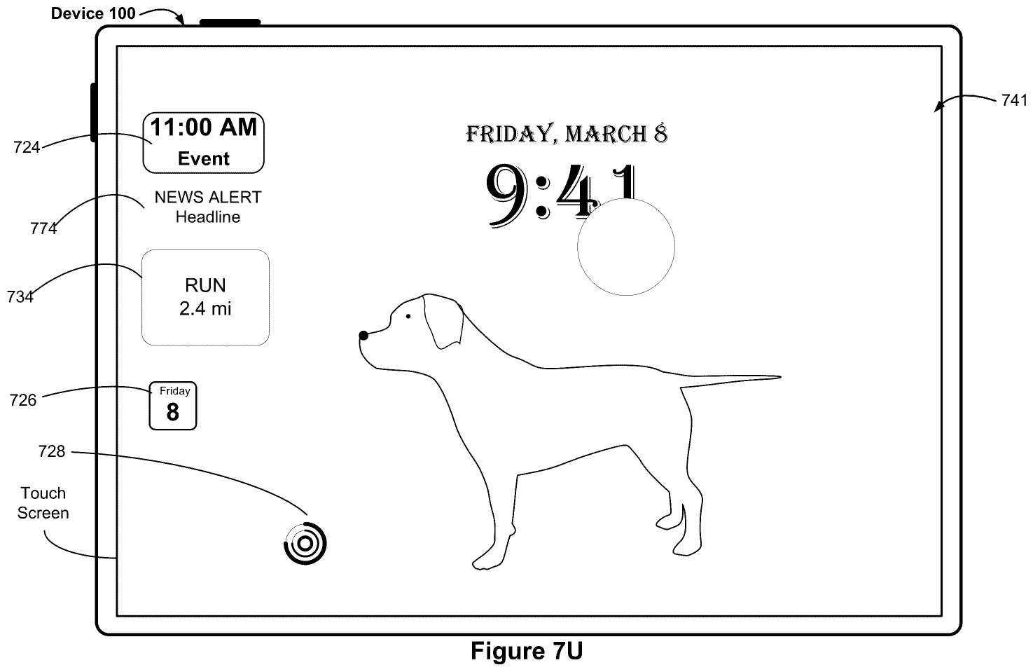

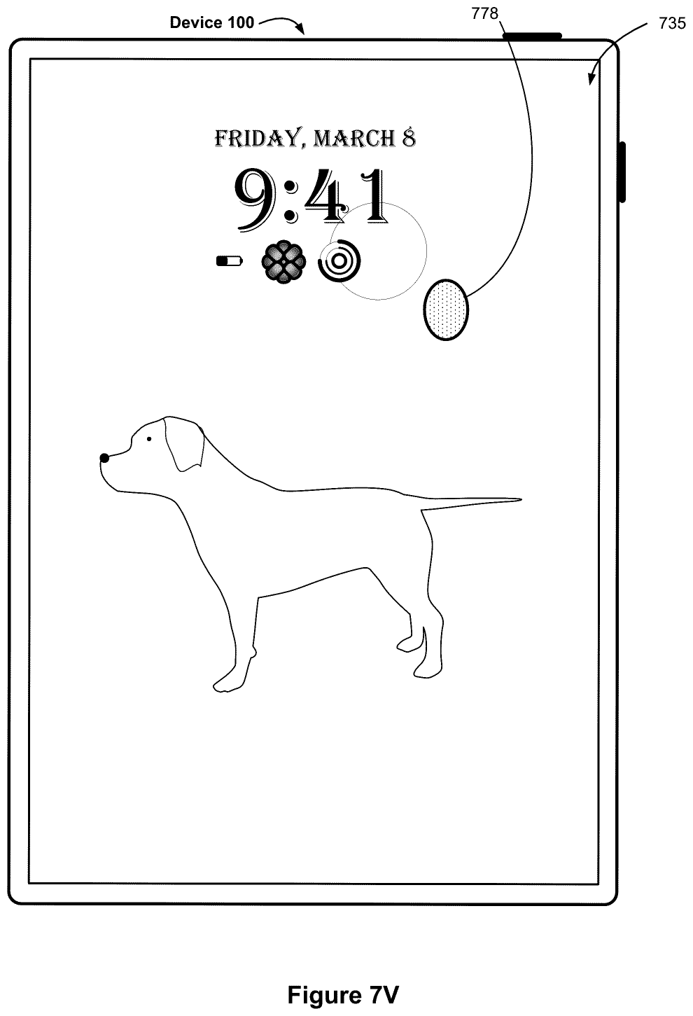

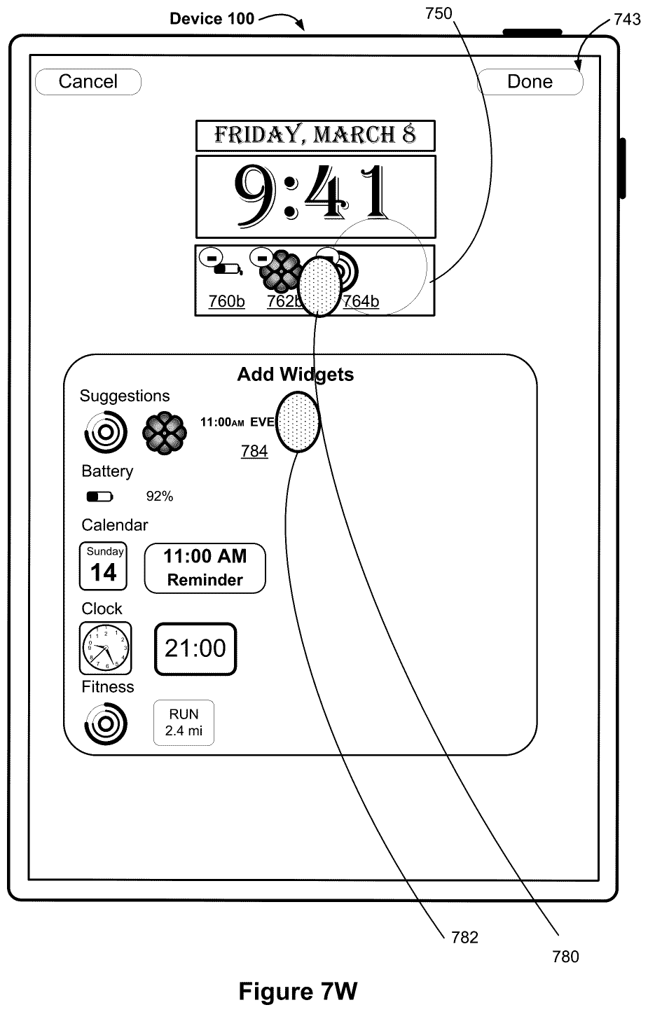

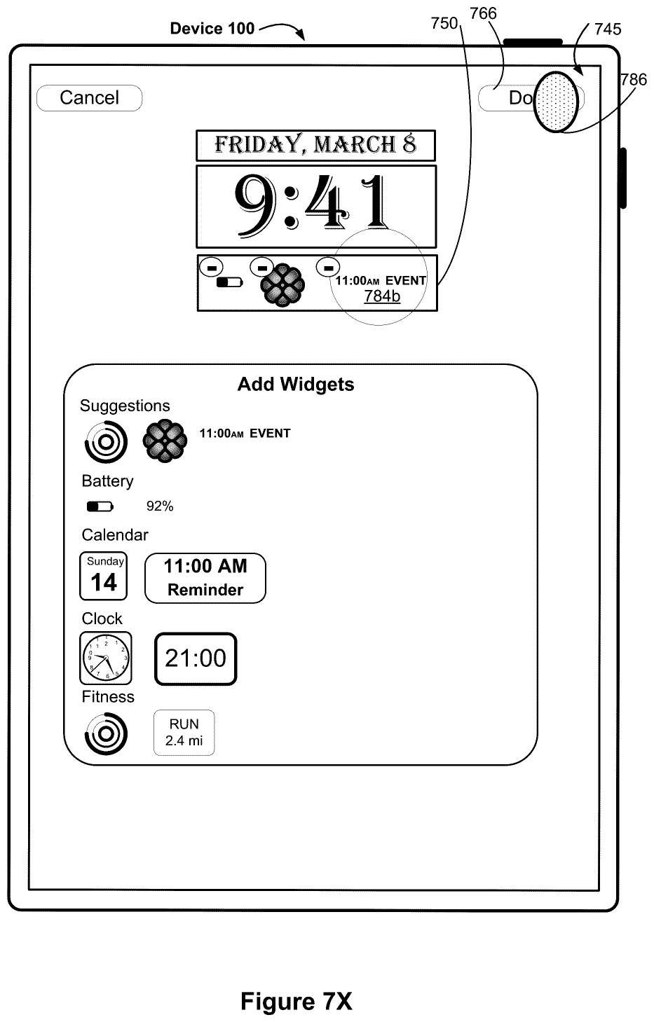

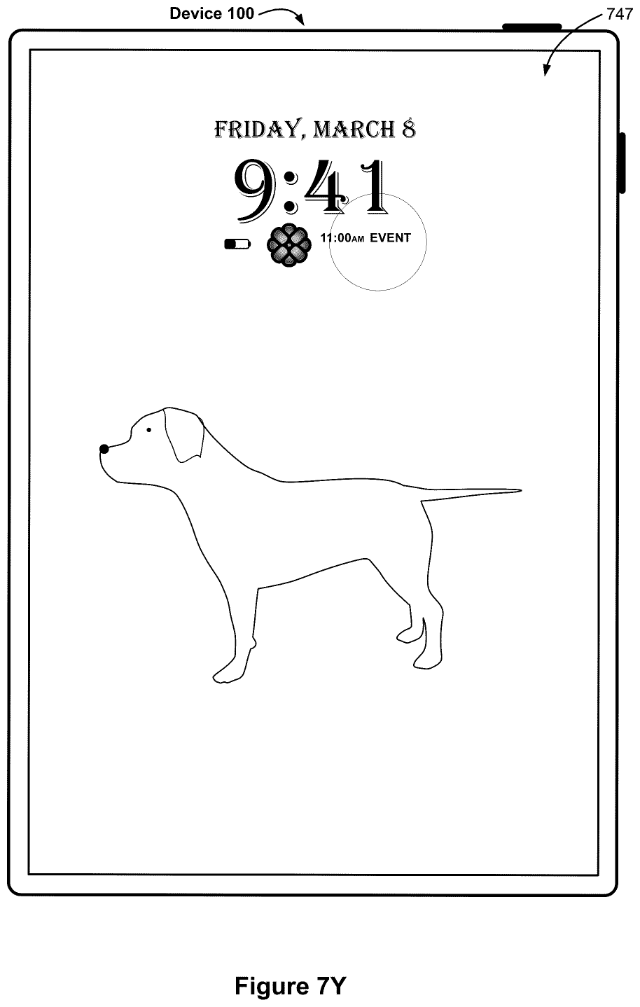

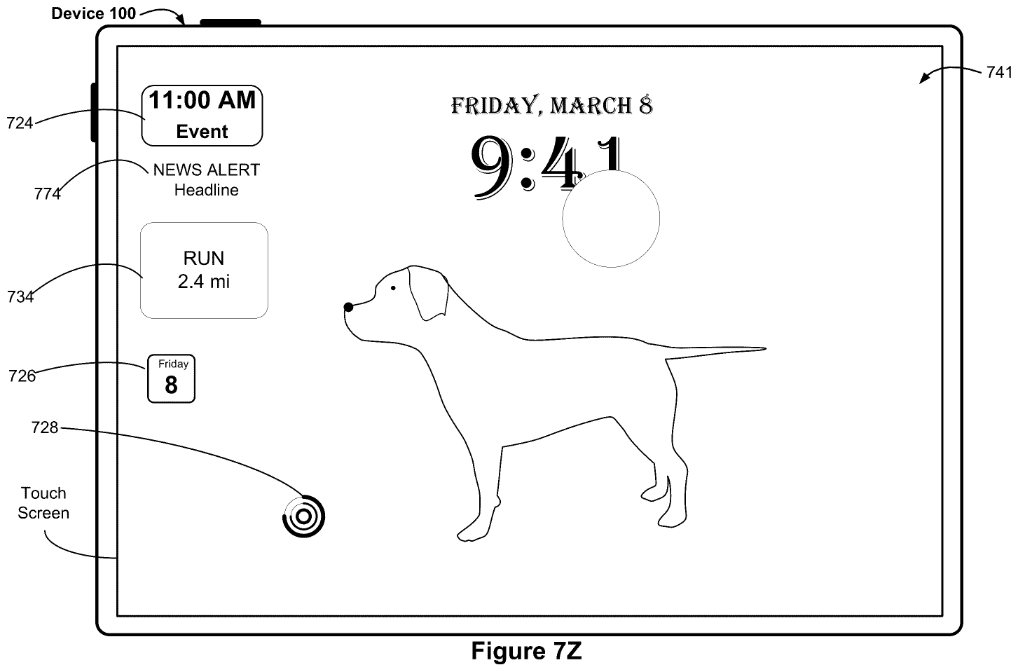

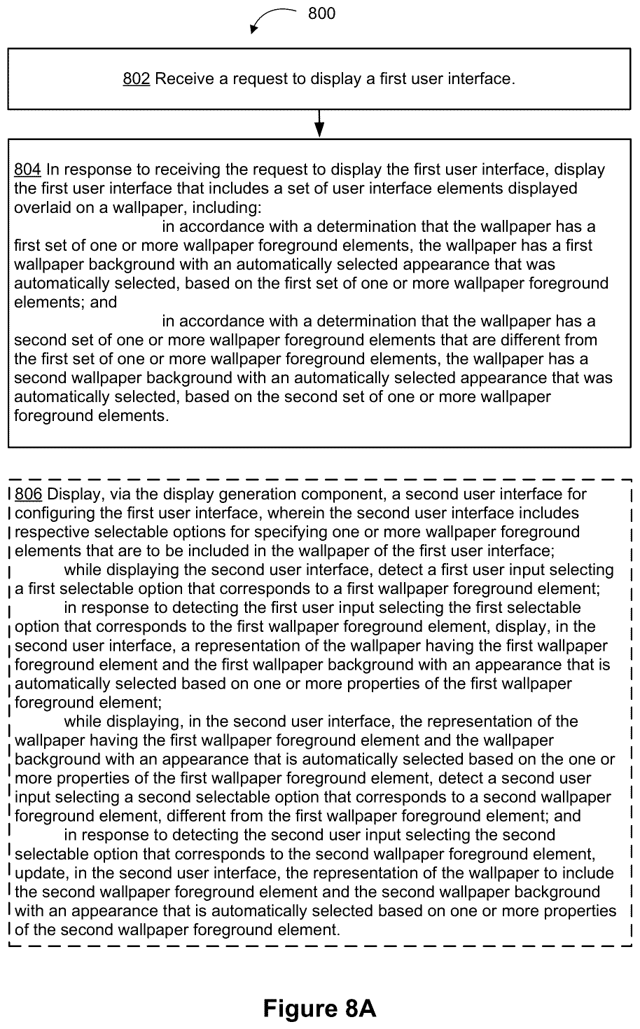

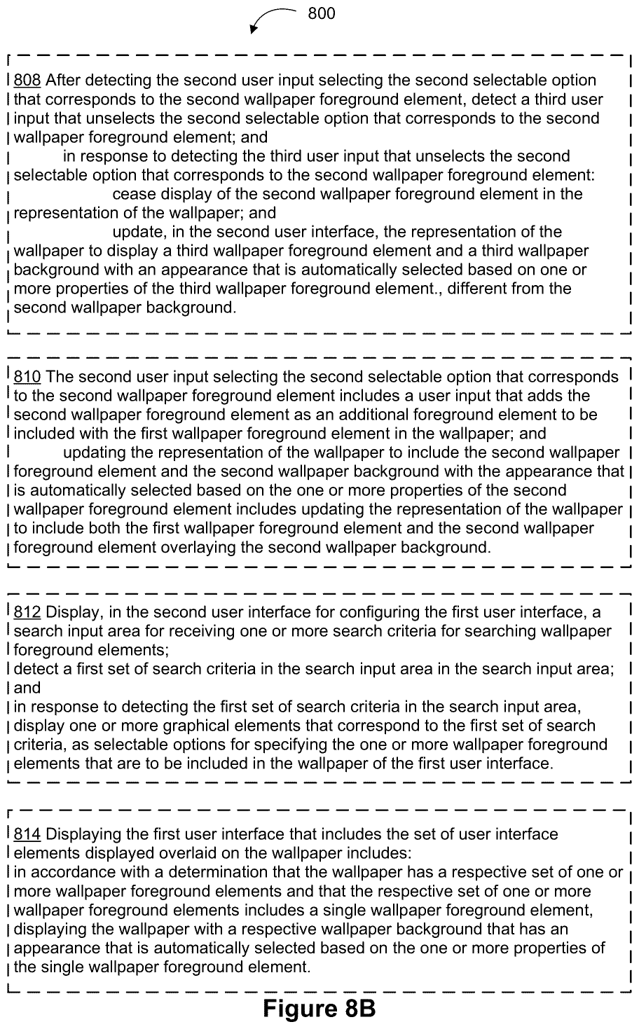

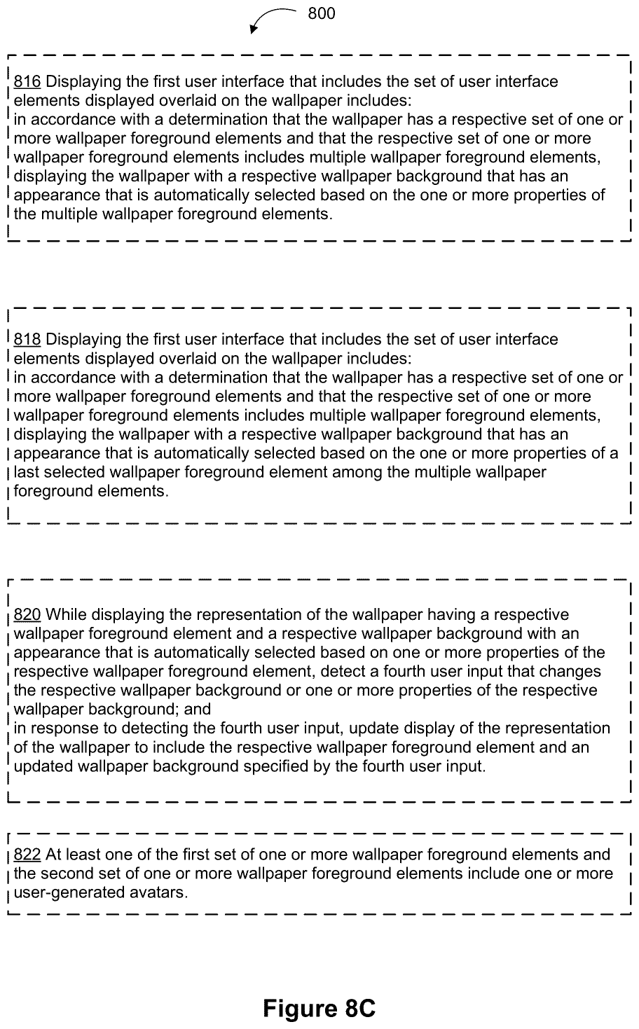

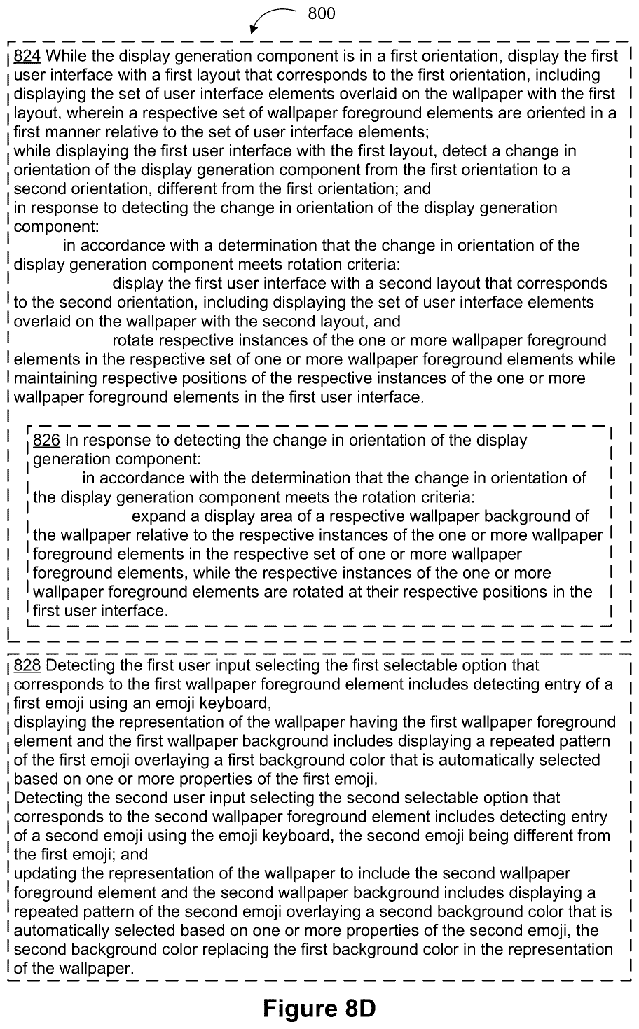

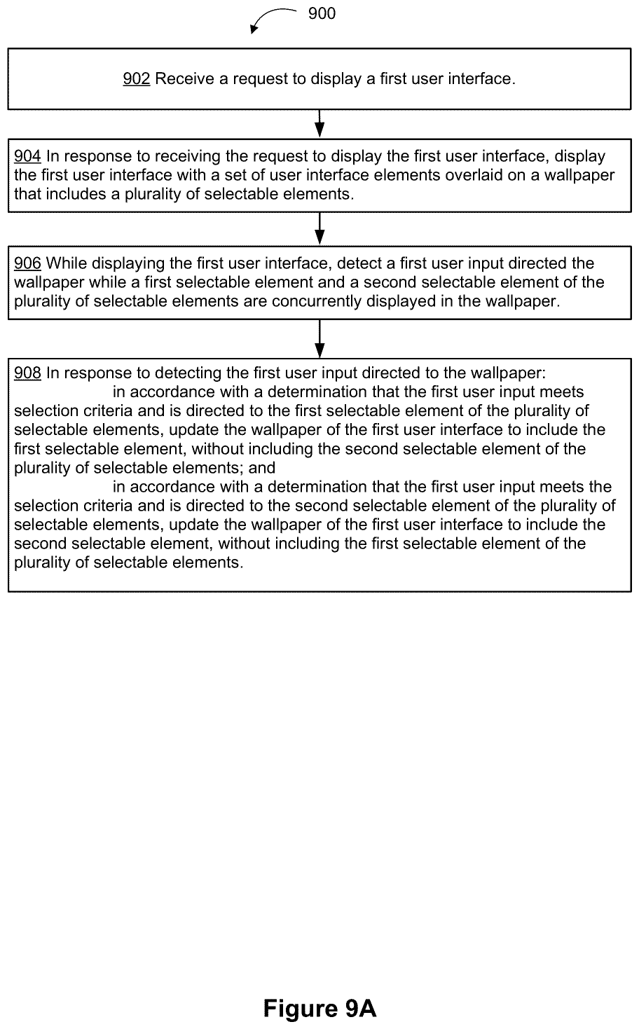

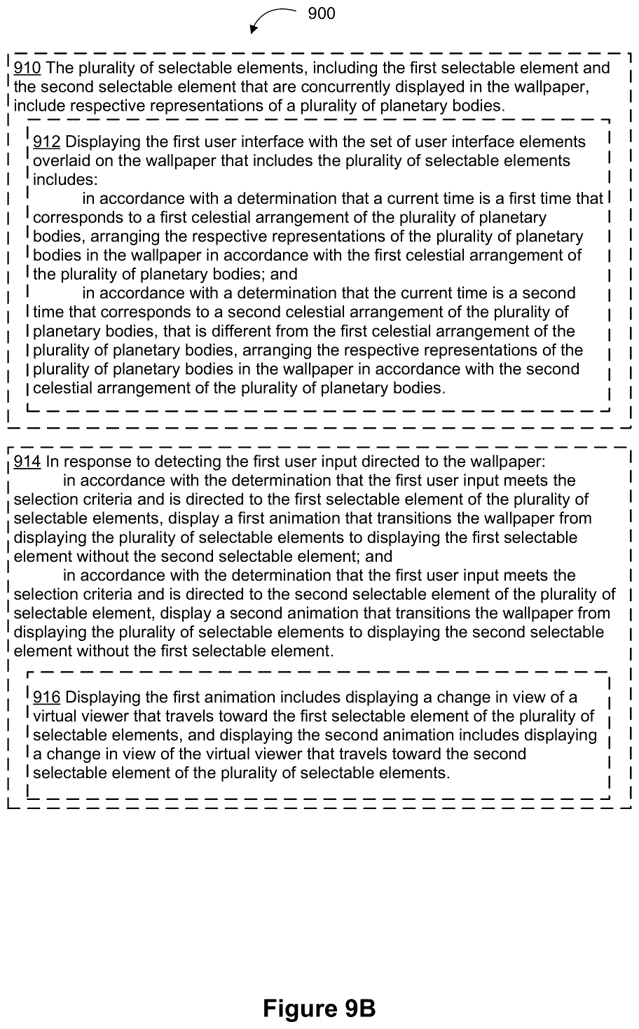

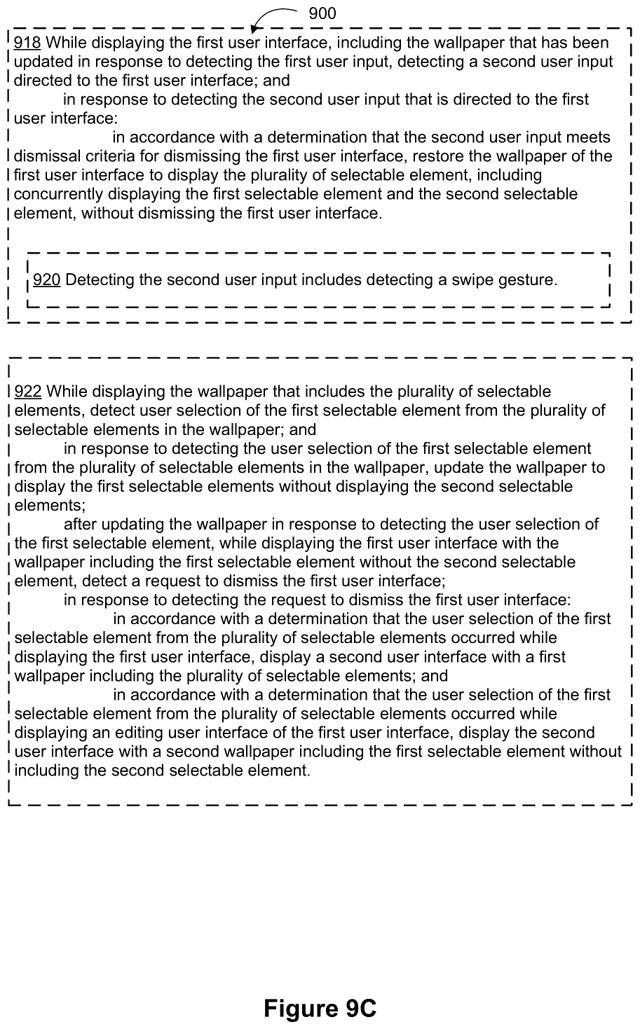

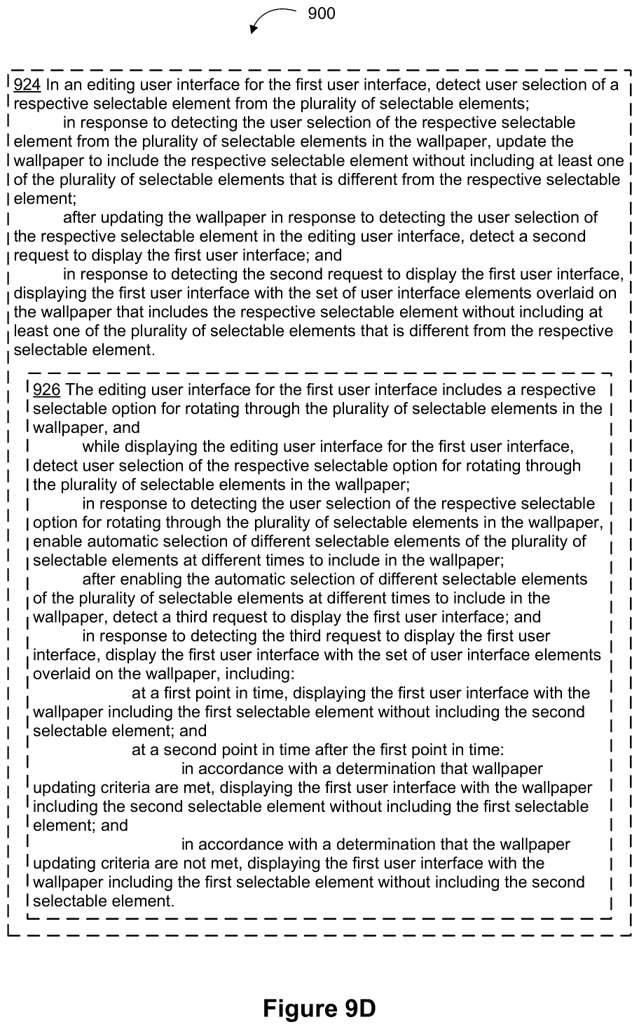

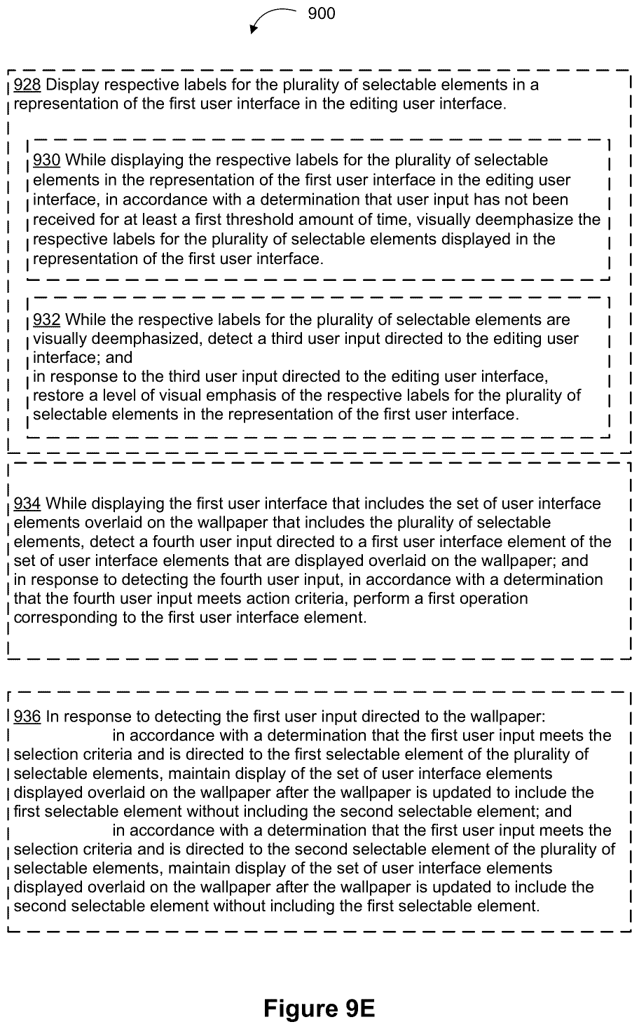

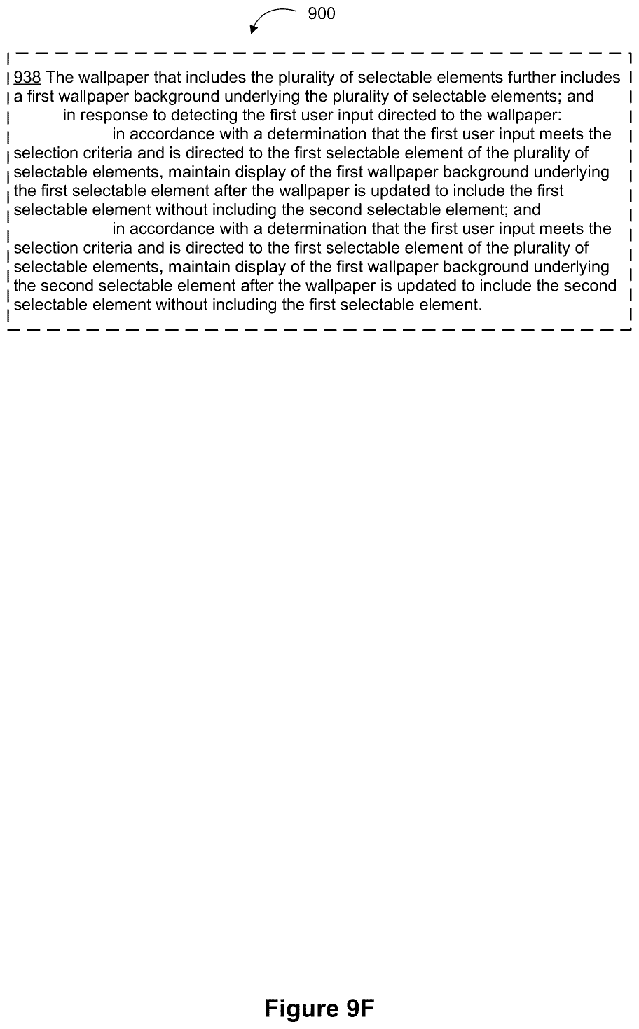

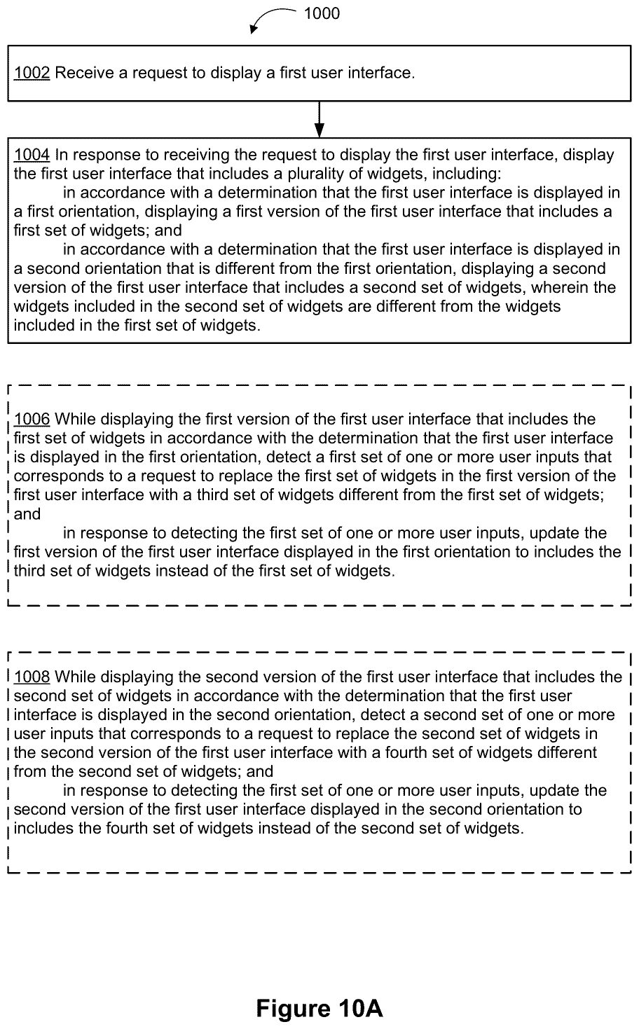

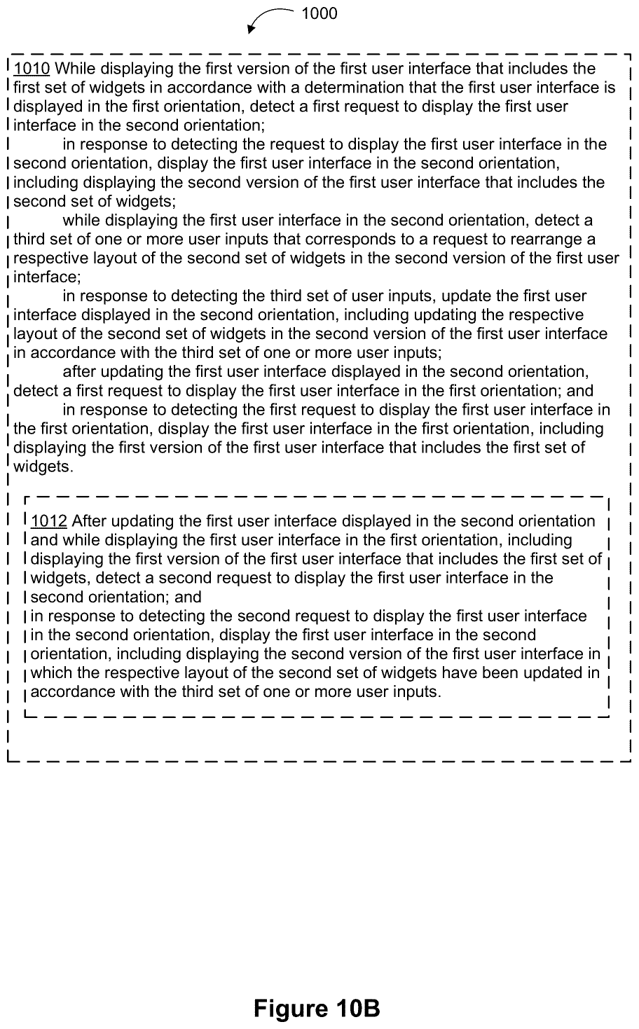

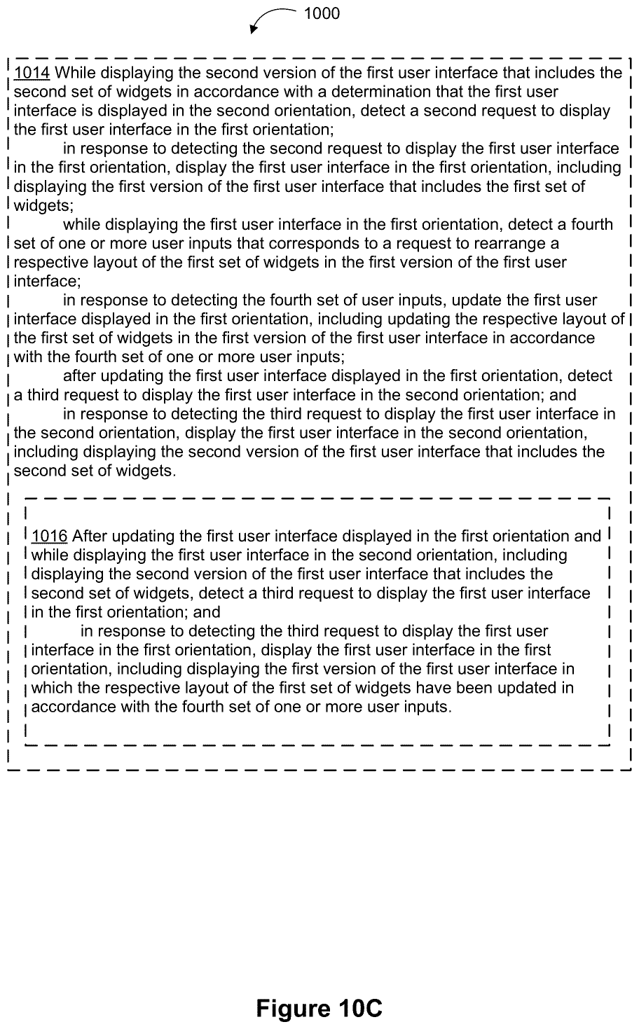

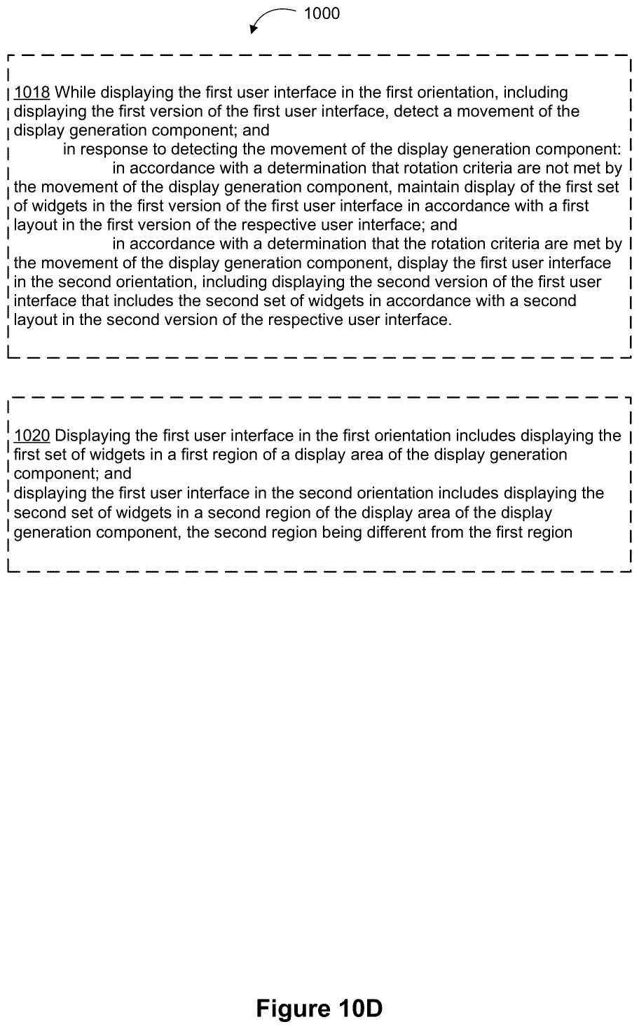

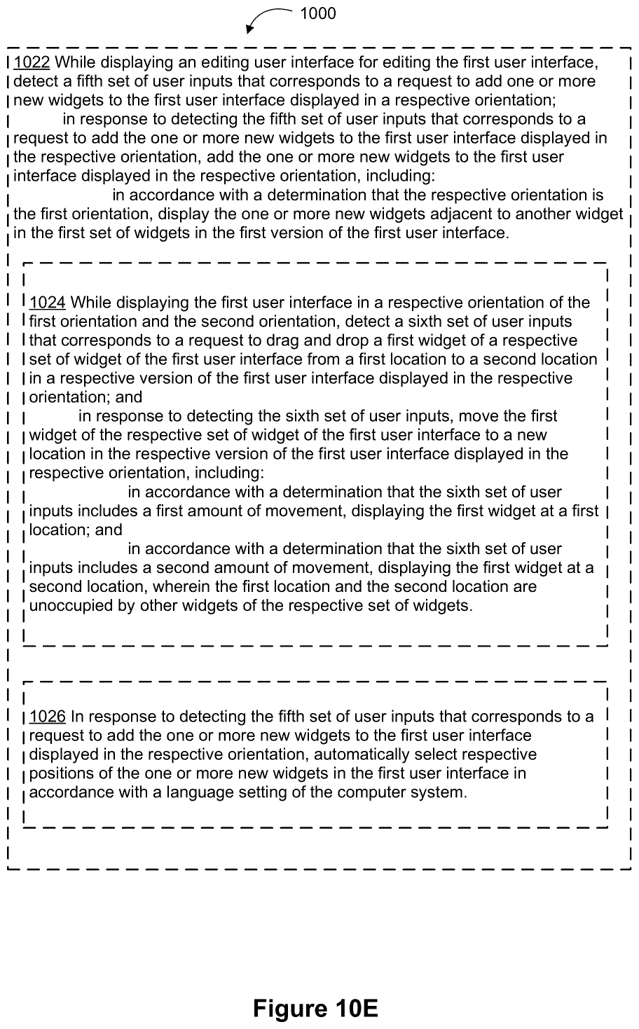

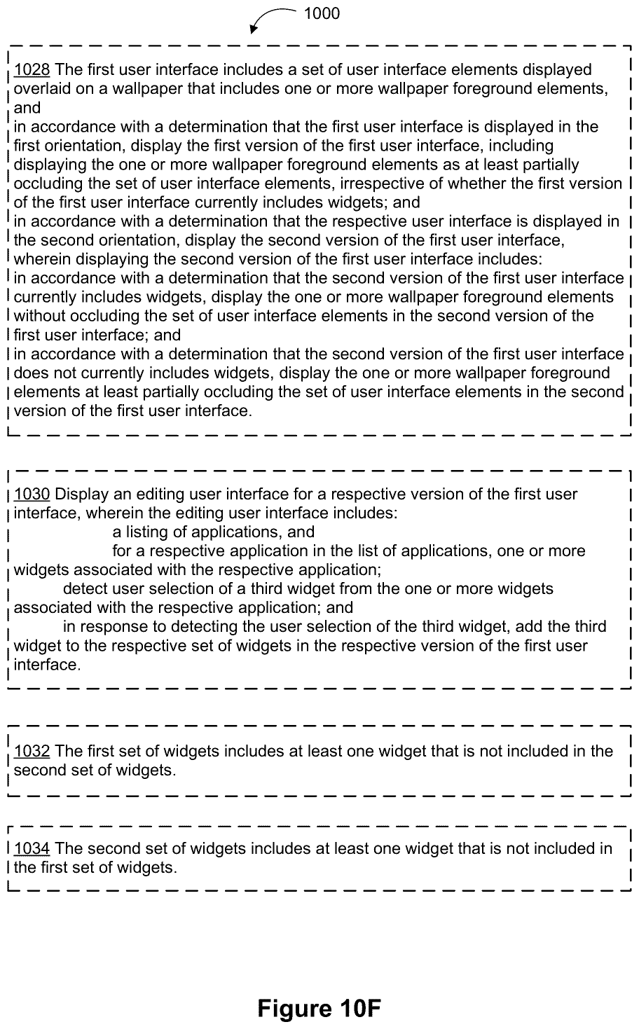

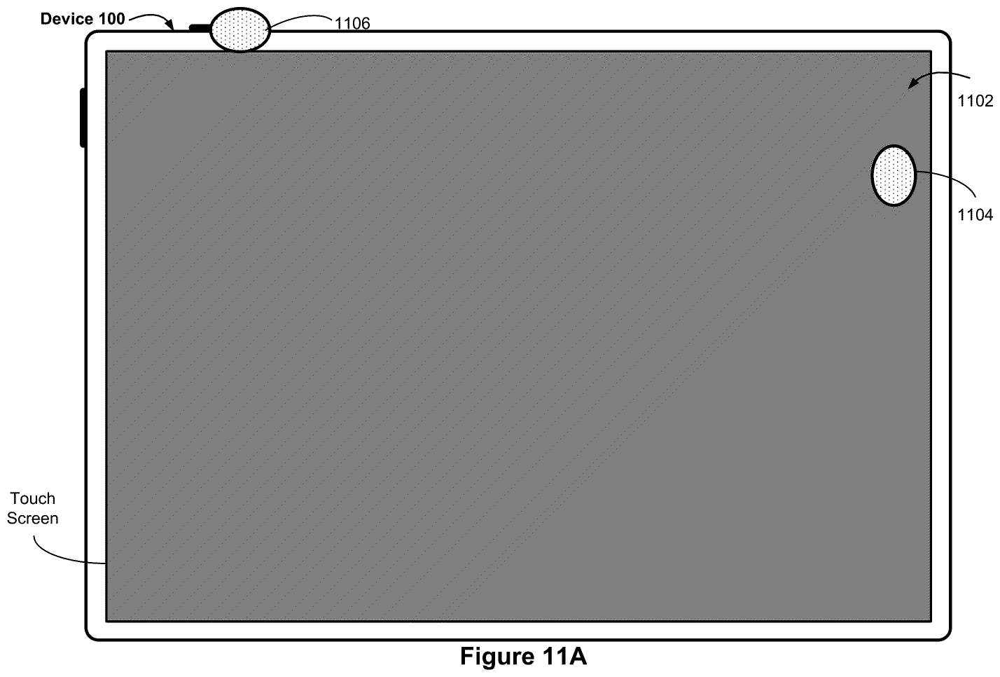

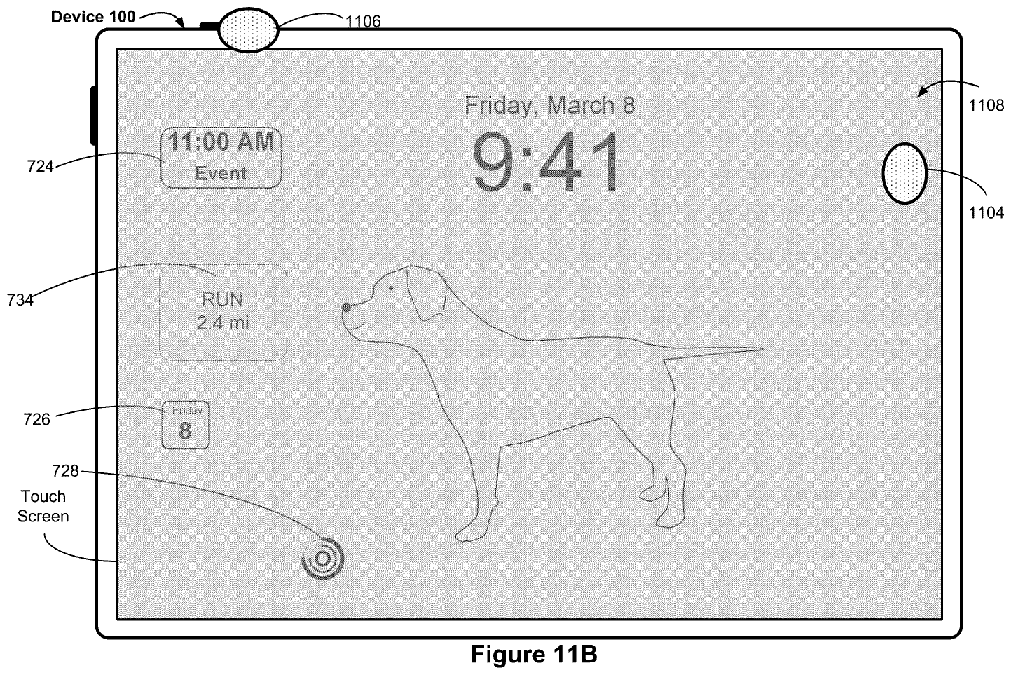

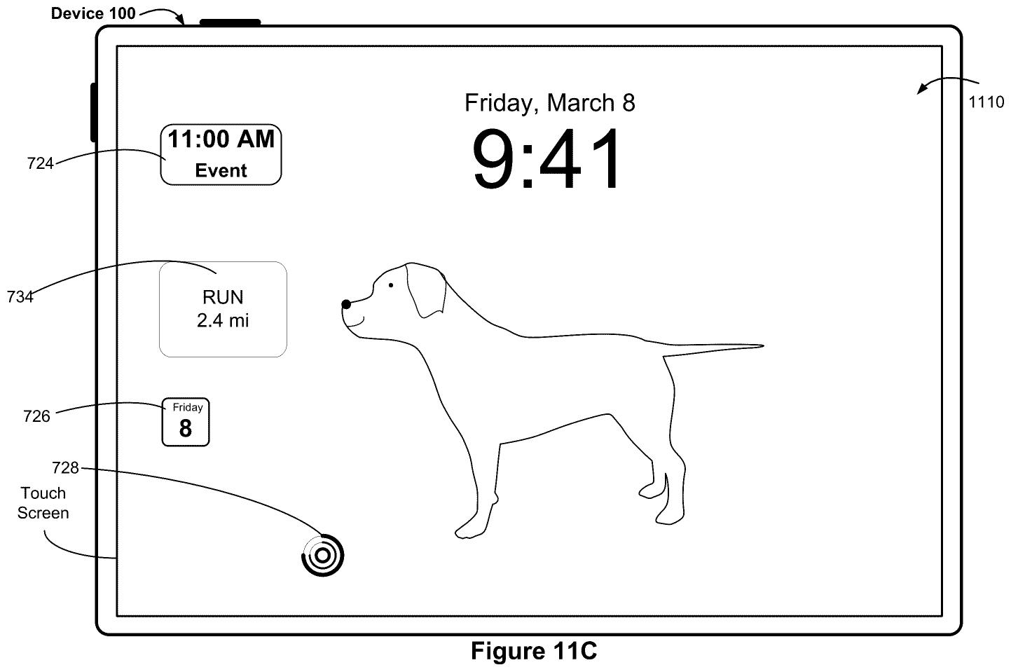

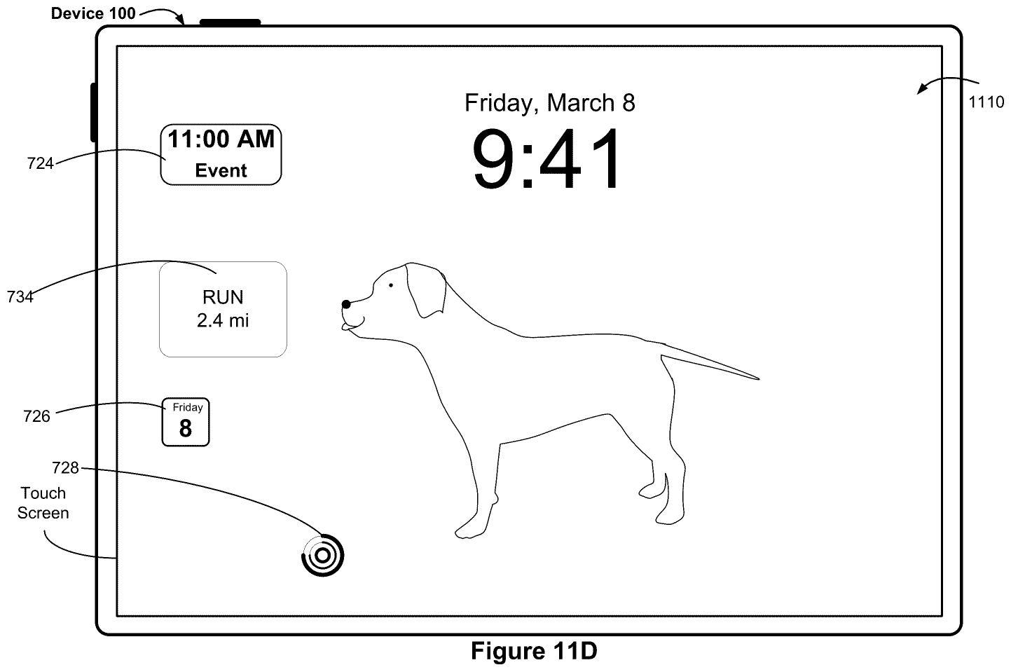

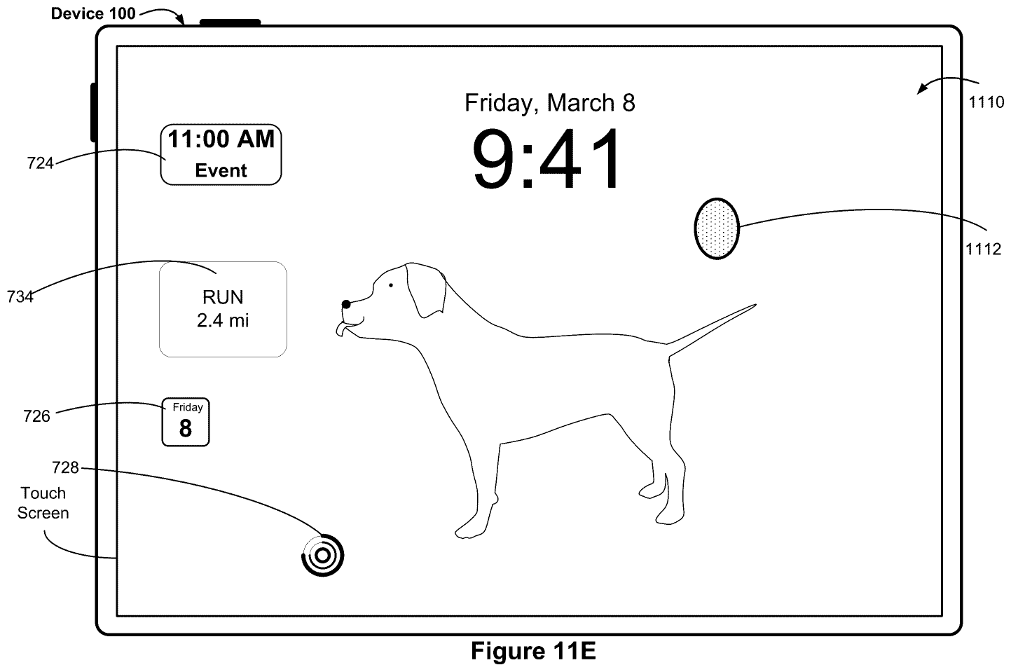

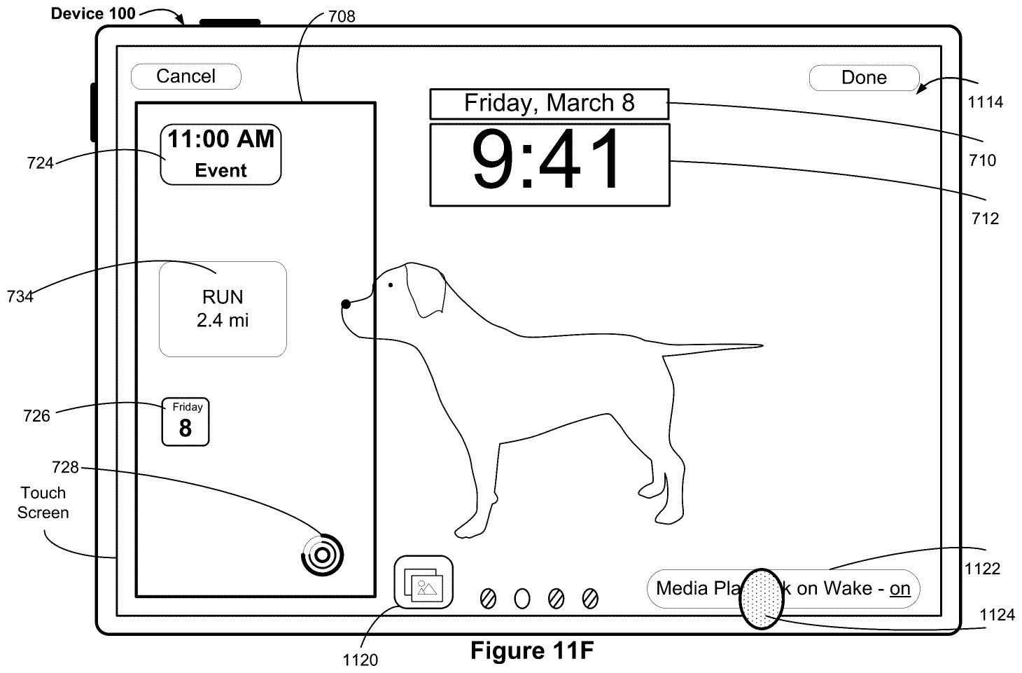

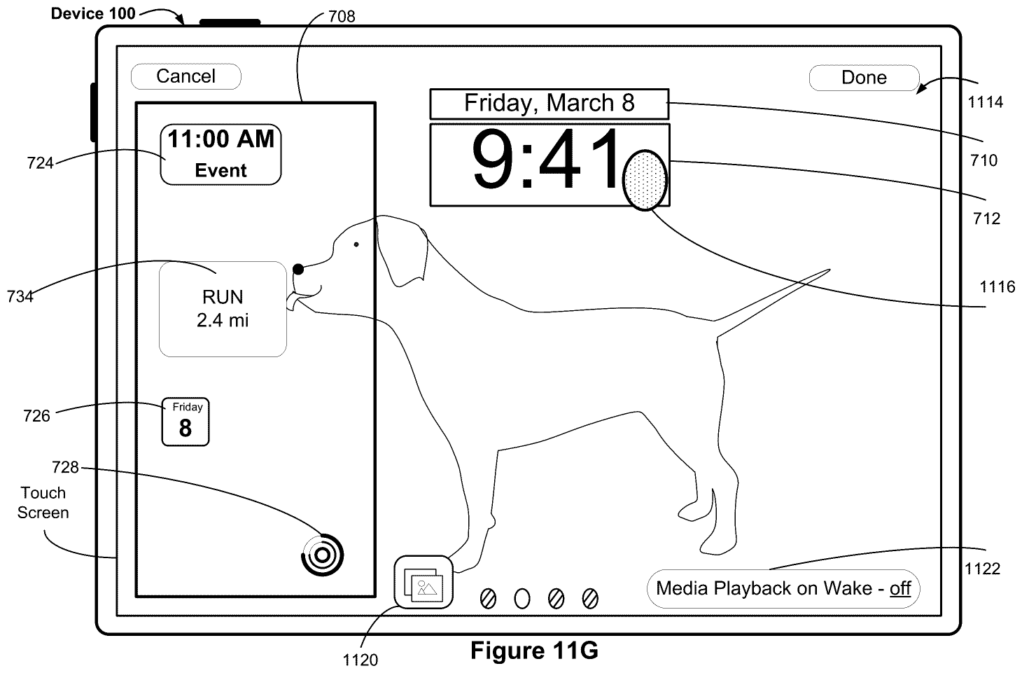

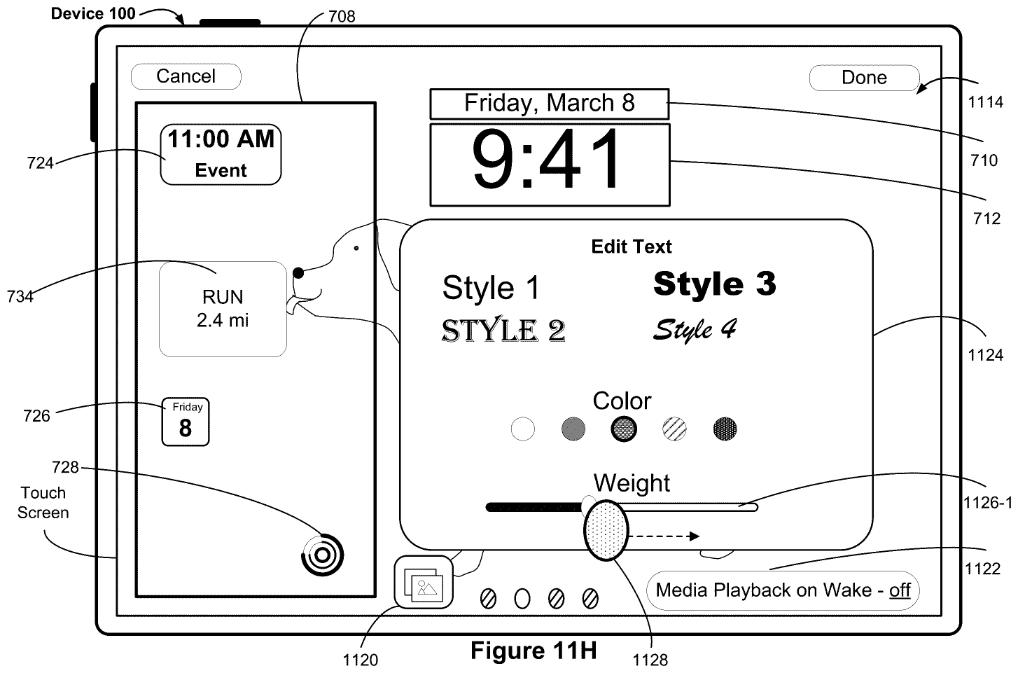

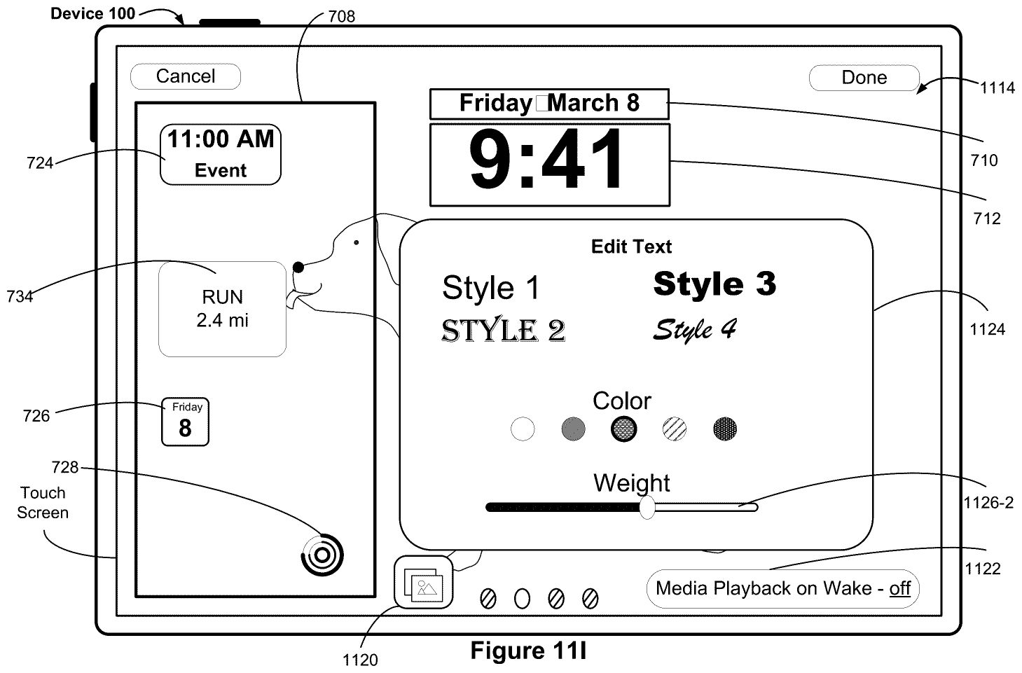

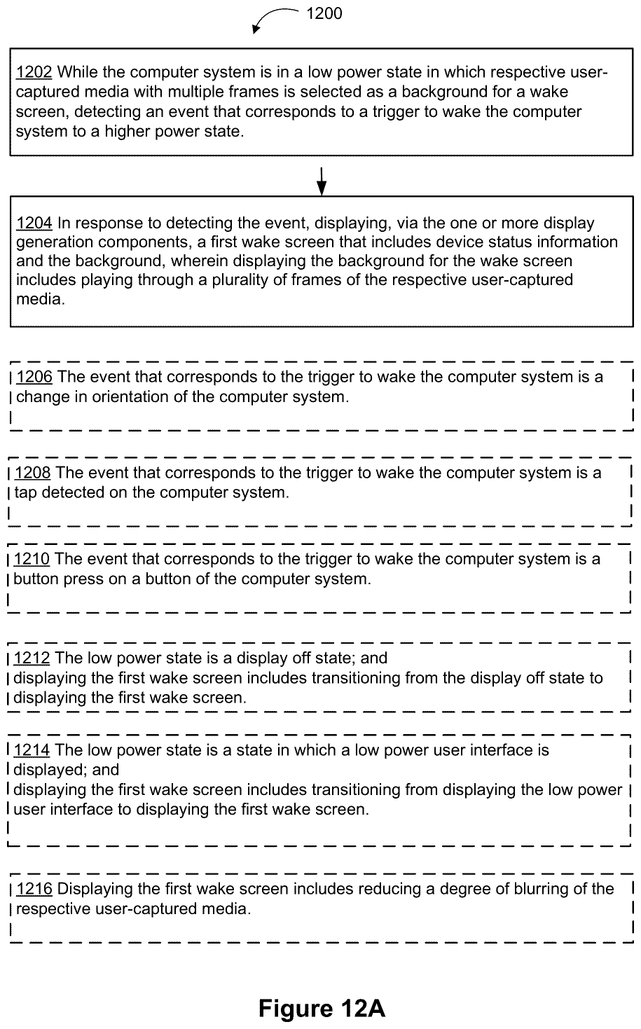

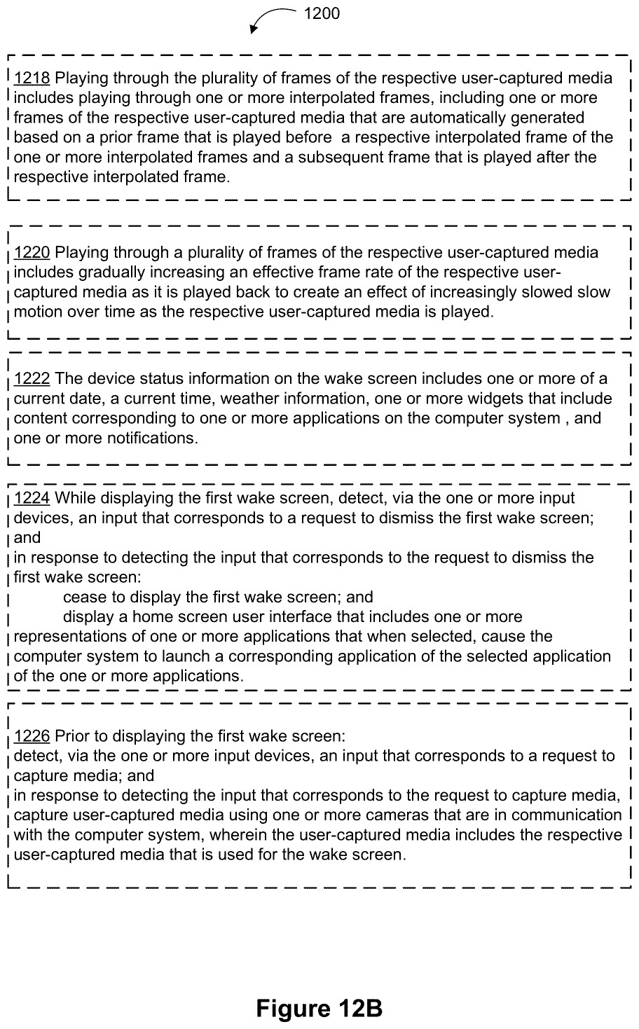

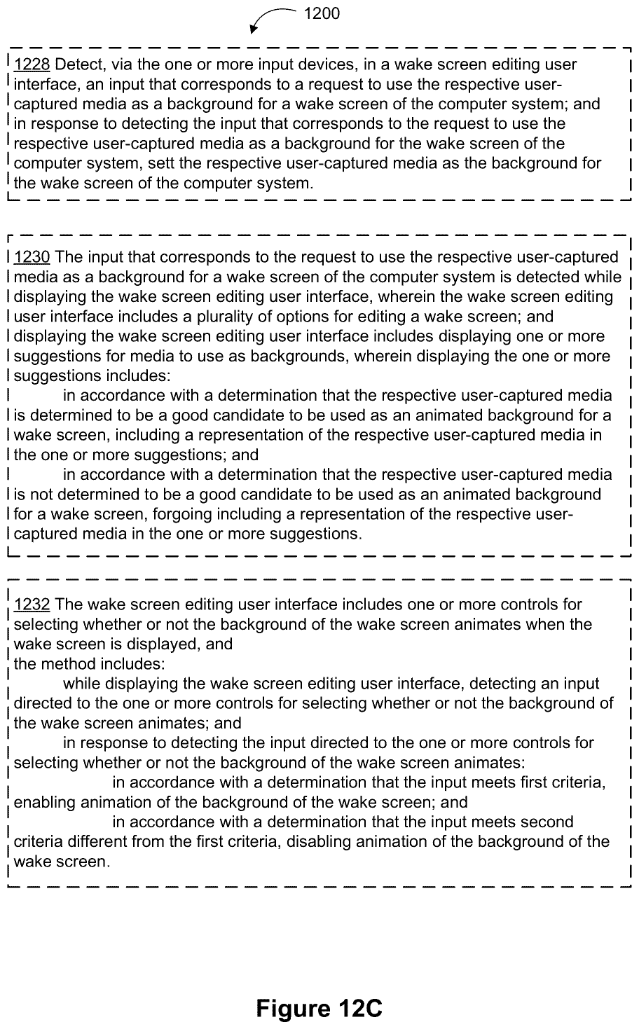

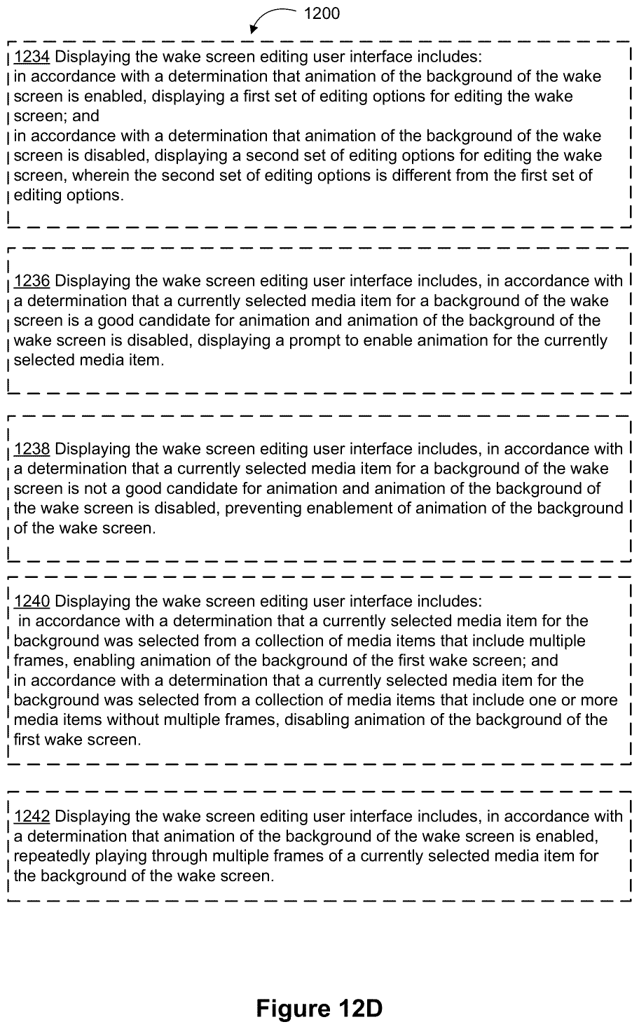

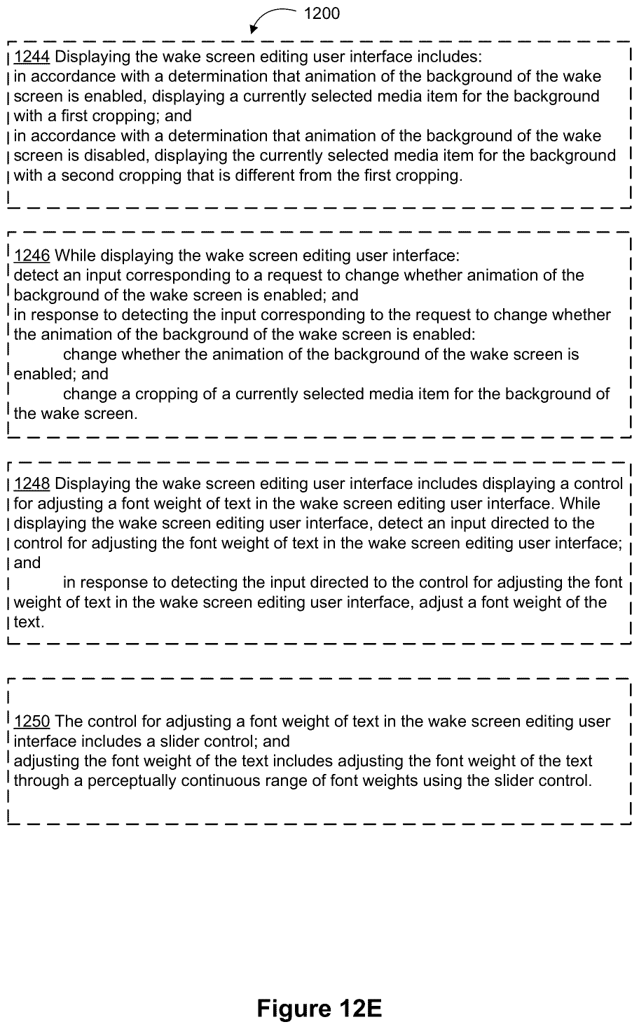

Below, FIGS. 1A-1B, 2, and 3 provide a description of example devices. FIGS. 4A-4C2 and FIGS. 5A-5S illustrate example user interfaces for updating a wallpaper background of a user interface in accordance with a selected wallpaper foreground element, in accordance with some embodiments. FIGS. 6A-6V illustrate example user interfaces for selecting a user interface object displayed in a wallpaper of a user interface and updating the user interface in accordance with the selection in accordance with some embodiments. FIGS. 7A-7Z illustrate example user interfaces for configuring a user interface while the device is in different orientations in accordance with some embodiments. FIGS. 8A-8D illustrate a flow diagram of a method of automatically updating a wallpaper background of a user interface in accordance with a selected wallpaper foreground element in accordance with some embodiments. FIGS. 9A-9F illustrate a flow diagram of a method of automatically updating a wallpaper displayed in a user interface in response to a user selecting a user interface object from a set of user interface objects displayed in the wallpaper in accordance with some embodiments. FIGS. 10A-10F illustrate a flow diagram of a method of displaying different configurations of a user interface while the device is in different orientations in accordance with some embodiments. FIGS. 11A-11I illustrate example user interfaces for displaying and editing a background that includes media with multiple frames in accordance with some embodiments. FIGS. 12A-12E illustrate a flow diagram of waking a device from a low power state and displaying a wake screen with a background that includes media with multiple frames in accordance with some embodiments. The user interfaces in FIGS. 5A-5S, 6A-6V and 7A-7Z an 11A-11I are used to illustrate the processes in FIGS. 8A-8D, 9A-9F, 10A-10F and 12A-12E.

### Example Devices

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices (and computer systems more generally), user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, a computer system in the form of an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a note taking application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of computer systems such as portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensities of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user. Using tactile outputs to provide haptic feedback to a user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, a tactile output pattern specifies characteristics of a tactile output, such as the amplitude of the tactile output, the shape of a movement waveform of the tactile output, the frequency of the tactile output, and/or the duration of the tactile output.

When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device. Thus, the waveform, frequency and amplitude can be adjusted to indicate to the user that different operations have been performed. As such, tactile outputs with tactile output patterns that are designed, selected, and/or engineered to simulate characteristics (e.g., size, material, weight, stiffness, smoothness, etc.); behaviors (e.g., oscillation, displacement, acceleration, rotation, expansion, etc.); and/or interactions (e.g., collision, adhesion, repulsion, attraction, friction, etc.) of objects in a given environment (e.g., a user interface that includes graphical features and objects, a simulated physical environment with virtual boundaries and virtual objects, a real physical environment with physical boundaries and physical objects, and/or a combination of any of the above) will, in some circumstances, provide helpful feedback to users that reduces input errors and increases the efficiency of the user's operation of the device. Additionally, tactile outputs are, optionally, generated to correspond to feedback that is unrelated to a simulated physical characteristic, such as an input threshold or a selection of an object. Such tactile outputs will, in some circumstances, provide helpful feedback to users that reduces input errors and increases the efficiency of the user's operation of the device.

In some embodiments, a tactile output with a suitable tactile output pattern serves as a cue for the occurrence of an event of interest in a user interface or behind the scenes in a device. Examples of the events of interest include activation of an affordance (e.g., a real or virtual button, or toggle switch) provided on the device or in a user interface, success or failure of a requested operation, reaching or crossing a boundary in a user interface, entry into a new state, switching of input focus between objects, activation of a new mode, reaching or crossing an input threshold, detection or recognition of a type of input or gesture, etc. In some embodiments, tactile outputs are provided to serve as a warning or an alert for an impending event or outcome that would occur unless a redirection or interruption input is timely detected. Tactile outputs are also used in other contexts to enrich the user experience, improve the accessibility of the device to users with visual or motor difficulties or other accessibility needs, and/or improve efficiency and functionality of the user interface and/or the device. Tactile outputs are optionally accompanied with audio outputs and/or visible user interface changes, which further enhance a user's experience when the user interacts with a user interface and/or the device, and facilitate better conveyance of information regarding the state of the user interface and/or the device, and which reduce input errors and increase the efficiency of the user's operation of the device.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

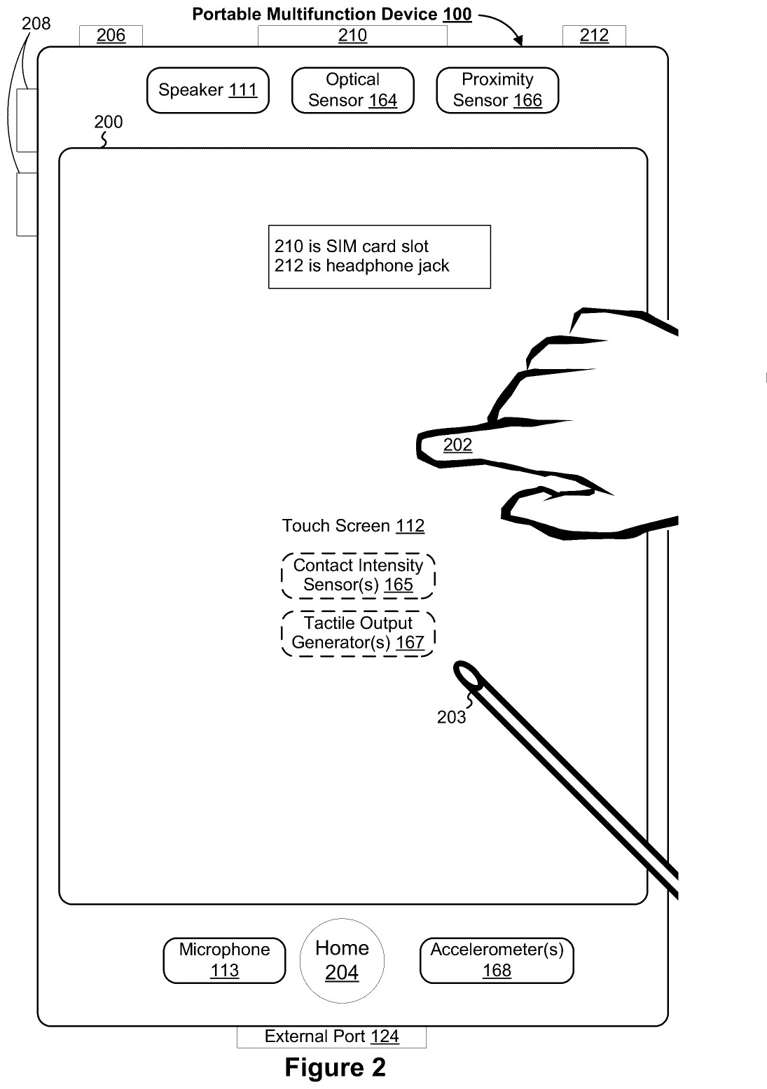

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button (e.g., a single button that rocks in opposite directions, or separate up button and down button) for volume control of speaker 111 and/or microphone 113. The one or more buttons optionally include a push button (e.g., 206, FIG. 2).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

Touch-sensitive display system 112 has a touch-sensitive surface, sensor or set of sensors that accepts input from the user based on haptic and/or tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In some embodiments, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In some embodiments, projected mutual capacitance sensing technology is used, such as that found in the iPhone®, iPod Touch®, and iPad® from Apple Inc. of Cupertino, California.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164 (e.g., as part of one or more cameras). FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's ear (e.g., when the user is making a phone call).

Device 100 optionally also includes one or more tactile output generators 167. FIG. 1A shows a tactile output generator coupled with haptic feedback controller 161 in I/O subsystem 106. In some embodiments, tactile output generator(s) 167 include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 167 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 168. FIG. 1A shows accelerometer 168 coupled with peripherals interface 118. Alternately, accelerometer 168 is, optionally, coupled with an input controller 160 in I/O subsystem 106. In some embodiments, information is displayed on the touch-screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

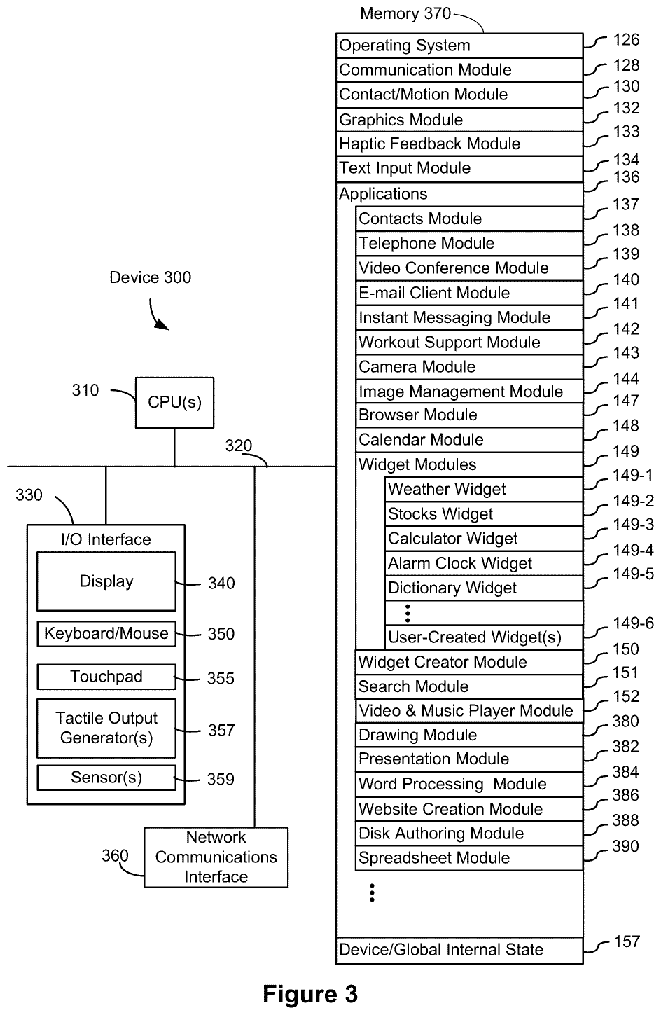

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, California. In some embodiments, the external port is a Lightning connector that is the same as, or similar to and/or compatible with the Lightning connector used in some iPhone®, iPod Touch®, and iPad® devices from Apple Inc. of Cupertino, California. In some embodiments, the external port is a USB Type-C connector that is the same as, or similar to and/or compatible with the USB Type-C connector used in some electronic devices from Apple Inc. of Cupertino, California.

Contact/motion module 130 optionally detects contact with touch-sensitive display system 112 (in conjunction with display controller 156) and other touch-sensitive devices (e.g., a touchpad or physical click wheel). Contact/motion module 130 includes various software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

In some embodiments, detecting a finger tap gesture depends on the length of time between detecting the finger-down event and the finger-up event, but is independent of the intensity of the finger contact between detecting the finger-down event and the finger-up event. In some embodiments, a tap gesture is detected in accordance with a determination that the length of time between the finger-down event and the finger-up event is less than a predetermined value (e.g., less than 0.1, 0.2, 0.3, 0.4 or 0.5 seconds), independent of whether the intensity of the finger contact during the tap meets a given intensity threshold (greater than a nominal contact-detection intensity threshold), such as a light press or deep press intensity threshold. Thus, a finger tap gesture can satisfy particular input criteria that do not require that the characteristic intensity of a contact satisfy a given intensity threshold in order for the particular input criteria to be met. For clarity, the finger contact in a tap gesture typically needs to satisfy a nominal contact-detection intensity threshold, below which the contact is not detected, in order for the finger-down event to be detected. A similar analysis applies to detecting a tap gesture by a stylus or other contact. In cases where the device is capable of detecting a finger or stylus contact hovering over a touch sensitive surface, the nominal contact-detection intensity threshold optionally does not correspond to physical contact between the finger or stylus and the touch sensitive surface.

The same concepts apply in an analogous manner to other types of gestures. For example, a swipe gesture, a pinch gesture, a depinch gesture, and/or a long press gesture are optionally detected based on the satisfaction of criteria that are either independent of intensities of contacts included in the gesture, or do not require that contact(s) that perform the gesture reach intensity thresholds in order to be recognized. For example, a swipe gesture is detected based on an amount of movement of one or more contacts; a pinch gesture is detected based on movement of two or more contacts towards each other; a depinch gesture is detected based on movement of two or more contacts away from each other; and a long press gesture is detected based on a duration of the contact on the touch-sensitive surface with less than a threshold amount of movement. As such, the statement that particular gesture recognition criteria do not require that the intensity of the contact(s) meet a respective intensity threshold in order for the particular gesture recognition criteria to be met means that the particular gesture recognition criteria are capable of being satisfied if the contact(s) in the gesture do not reach the respective intensity threshold, and are also capable of being satisfied in circumstances where one or more of the contacts in the gesture do reach or exceed the respective intensity threshold. In some embodiments, a tap gesture is detected based on a determination that the finger-down and finger-up event are detected within a predefined time period, without regard to whether the contact is above or below the respective intensity threshold during the predefined time period, and a swipe gesture is detected based on a determination that the contact movement is greater than a predefined magnitude, even if the contact is above the respective intensity threshold at the end of the contact movement. Even in implementations where detection of a gesture is influenced by the intensity of contacts performing the gesture (e.g., the device detects a long press more quickly when the intensity of the contact is above an intensity threshold or delays detection of a tap input when the intensity of the contact is higher), the detection of those gestures does not require that the contacts reach a particular intensity threshold so long as the criteria for recognizing the gesture can be met in circumstances where the contact does not reach the particular intensity threshold (e.g., even if the amount of time that it takes to recognize the gesture changes).

Contact intensity thresholds, duration thresholds, and movement thresholds are, in some circumstances, combined in a variety of different combinations in order to create heuristics for distinguishing two or more different gestures directed to the same input element or region so that multiple different interactions with the same input element are enabled to provide a richer set of user interactions and responses. The statement that a particular set of gesture recognition criteria do not require that the intensity of the contact(s) meet a respective intensity threshold in order for the particular gesture recognition criteria to be met does not preclude the concurrent evaluation of other intensity-dependent gesture recognition criteria to identify other gestures that do have criteria that are met when a gesture includes a contact with an intensity above the respective intensity threshold. For example, in some circumstances, first gesture recognition criteria for a first gesture—which do not require that the intensity of the contact(s) meet a respective intensity threshold in order for the first gesture recognition criteria to be met—are in competition with second gesture recognition criteria for a second gesture—which are dependent on the contact(s) reaching the respective intensity threshold. In such competitions, the gesture is, optionally, not recognized as meeting the first gesture recognition criteria for the first gesture if the second gesture recognition criteria for the second gesture are met first. For example, if a contact reaches the respective intensity threshold before the contact moves by a predefined amount of movement, a deep press gesture is detected rather than a swipe gesture. Conversely, if the contact moves by the predefined amount of movement before the contact reaches the respective intensity threshold, a swipe gesture is detected rather than a deep press gesture. Even in such circumstances, the first gesture recognition criteria for the first gesture still do not require that the intensity of the contact(s) meet a respective intensity threshold in order for the first gesture recognition criteria to be met because if the contact stayed below the respective intensity threshold until an end of the gesture (e.g., a swipe gesture with a contact that does not increase to an intensity above the respective intensity threshold), the gesture would have been recognized by the first gesture recognition criteria as a swipe gesture. As such, particular gesture recognition criteria that do not require that the intensity of the contact(s) meet a respective intensity threshold in order for the particular gesture recognition criteria to be met will (A) in some circumstances ignore the intensity of the contact with respect to the intensity threshold (e.g. for a tap gesture) and/or (B) in some circumstances still be dependent on the intensity of the contact with respect to the intensity threshold in the sense that the particular gesture recognition criteria (e.g., for a long press gesture) will fail if a competing set of intensity-dependent gesture recognition criteria (e.g., for a deep press gesture) recognize an input as corresponding to an intensity-dependent gesture before the particular gesture recognition criteria recognize a gesture corresponding to the input (e.g., for a long press gesture that is competing with a deep press gesture for recognition).

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions (e.g., instructions used by haptic feedback controller 161) to produce tactile outputs using tactile output generator(s) 167 at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and video and music player module 152, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating example components for event handling in accordance with some embodiments. In some embodiments, memory 102 (in FIG. 1A) or 370 (FIG. 3) includes event sorter 170 (e.g., in operating system 126) and a respective application 136-1 (e.g., any of the aforementioned applications 136, 137-155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video and music player module 152. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In these embodiments, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display, or as a system gesture such as an upward edge swipe.

In some embodiments, device 100 includes the touch-screen display, menu button 204 (sometimes called home button 204), push button 206 for powering the device on/off and locking the device, volume adjustment button(s) 208, Subscriber Identity Module (SIM) card slot 210, head set jack 212, and/or docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensities of contacts on touch-sensitive display system 112 and/or one or more tactile output generators 167 for generating tactile outputs for a user of device 100.

FIG. 3 is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch-screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above identified elements in FIG. 3 are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Attention is now directed towards embodiments of user interfaces (“UI”) that are, optionally, implemented on portable multifunction device 100.

FIG. 4A illustrates an example user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) for wireless communication(s), such as cellular and Wi-Fi signals;
Time;
a Bluetooth indicator;
a Battery status indicator;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, labeled “Music”; and
Icons for other applications, such as:
   Icon 424 for IM module 141, labeled “Messages”;
   Icon 426 for calendar module 148, labeled “Calendar”;
   Icon 428 for image management module 144, labeled “Photos”;
   Icon 430 for camera module 143, labeled “Camera”;
   Icon 432 for online video module 155, labeled “Online Video”;
   Icon 434 for stocks widget 149-2, labeled “Stocks”;
   Icon 436 for map module 154, labeled “Maps”;
   Icon 438 for weather widget 149-1, labeled “Weather”;
   Icon 440 for alarm clock widget 149-4, labeled “Clock”;
   Icon 442 for workout support module 142, labeled “Workout Support”;
   Icon 444 for notes module 153, labeled “Notes”; and
   Icon 446 for a settings application or module, which provides access to settings for device 100 and its various applications 136.

It should be noted that the icon labels illustrated in FIG. 4A are merely examples. For example, other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3) with a touch-sensitive surface 451 (e.g., a tablet or touchpad 355, FIG. 3) that is separate from the display 450. Although many of the examples that follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse based input or a stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

FIGS. 4C1-4C2 illustrate an example state diagram 4000 of navigation between various user interfaces of the multifunction device 100 in accordance with some embodiments. In some embodiments, the multifunction device 100 displays a respective user interface from a plurality of different user interfaces, including a wake screen user interface 490 (also referred to as a coversheet user interface 496), a home screen user interface 492, a widget user interface 491, a control user interface 498, a search user interface 494, an application library user interface 497, and an application user interface 493 of a respective application (e.g., a camera application (e.g., camera application user interface 495), a flashlight application, a settings application, a messaging application (e.g., application user interface 493), a telephony application, a maps application, a browser application, or another type of application) of a plurality of applications. In some embodiments, the multifunction device utilizes various portions of the display (e.g., touch-screen display 112, display 340 associated with a touch-sensitive surface, a head-mounted display, or another type of display) to display persistent content across multiple user interfaces. For example, in some embodiments, the display includes a dynamic status region 4002 for displaying alerts, status updates, and/or current states for various subscribed and/or ongoing events, and/or for various application activities, in real-time or substantially real-time. In some embodiments, the display includes a static status region 4022 for displaying status information for one or more system functions that is relatively stable over a period of time. In some embodiments, the dynamic status region 4002 changes (e.g., expands and/or shrinks) from a region that accommodate one or more hardware elements of the multifunction device (e.g., the camera lenses, microphone, and/or speakers). As described herein, although examples below are given with touch-gestures on a touch-screen display, similar functions can be implemented with a display that is associated with a touch-sensitive surface, where a location (e.g., a location on a top edge, a bottom edge, a left edge, a right edge, a top left portion, a bottom right portion, an interior portion, and/or another portion) on the touch-sensitive surface has a corresponding location (e.g., a location on a top edge, a bottom edge, a left edge, a right edge, a top left portion, a bottom right portion, an interior portion, and/or another portion) on the display (and/or on the user interface presented on the display). Furthermore, although the examples below are given with touch-gestures on a touch-screen display, similar functions can be implemented with a display that is associated with another type of input, such as a mouse inputs, a pointer inputs, gaze inputs (e.g., gazes with time and location characteristics that are directed to various portions of the displayed user interface and/or user interface elements) in conjunction with air gesture inputs (e.g., air tap, air swipe, air pinch, pinch and hold, pinch-hold and drag, and/or another type of air gestures). As described herein, although examples below are given with touch-gestures on a touch-screen display, similar functions can be implemented with a head-mounted display that displays the user interfaces in a three-dimensional environment and that is controlled with various input devices and sensors for detecting various types of user inputs (e.g., touch gestures, inputs provided by a pointer or controller, gaze inputs, voice inputs, and/or air gestures).

As shown in FIG. 4C1, when the multifunction device 100 is initially powered on (e.g., in response to a long press or other activation input 4100 on a power button 116a (FIG. 4A) of the multifunction device 100), the multifunction device displays (4100) the wake screen user interface 490 that is the initially displayed system user interface of the multifunction device 100 when the multifunction device transitions from a power off state to a power on state.

In some embodiments, while the wake screen user interface 490 is displayed after a period of time, the multifunction device 100 optionally transitions (4101) to a low power state, where the display of the multifunction device 100 is optionally turned off, or dimmed, as illustrated by user interface 489. In some embodiments, the wake screen user interface 490 remains displayed in a dimmed, always on state, while the multifunction device 100 is in the low power state. For example, in the low power state illustrated by user interface 489, the time indication and/or date indication continues to be displayed.

In some embodiments, the multifunction device 100 transitions (4101) into the low power state (e.g., turns off the display or displays the wake screen user interface 490 in the dimmed, always-on state) in response to activation of the power button 116a of the multifunction device 100 by a user input 4101 (e.g., while displaying the wake screen user interface 490, and/or any of the other user interfaces described herein).

In some embodiments, the multifunction device transitions (e.g., automatically after a period of inactivity, and/or in response to detecting a user input activating the power button 116a) into the low power state from the normal operating state in which any of a number of user interfaces (e.g., the wake screen user interface 490, the home screen user interface 492, the application user interface 493 of a respective application, or another system and/or application user interface) may be the last displayed user interface before the transition into the low power state.

In some embodiments, when the multifunction device 100 is in the low power state, the multifunction device continues to detect inputs via one or more sensors and input devices of the multifunction device (e.g., movement of the device, touch gestures (e.g., swipe, tap, or other touch input), gaze input, air gestures, impact on the device, press on the power button, rotation of a crown, or other types of inputs). In some embodiments, in response to detecting a user input via the one or more sensors and input devices of the multifunction device, the multifunction device transitions (4100) from the low power state to the normal operating state, and displays the wake screen user interface 490 in a normal, undimmed state.

In some embodiments, when the multifunction device 100 is in the low power state illustrated in user interface 489, the multifunction device continues to detect events, such as arrival of notifications and status updates (e.g., notification for messages, incoming communication requests, and/or other application-generated events and system-generated events, and status updates for sessions, subscribed events, and/or other status changes that require the user's attention). In some embodiments, in response to detecting an event that generates an alert, a notification, and/or a status update, the multifunction device transitions from the low power state to the normal operating state, and displays the alert, notification, and/or status update on the wake screen user interface 490 in the normal, undimmed state. In some embodiments, the multifunction device automatically returns to the low power mode after a short period of time after displaying the alert, notification, and/or the status update.

In some embodiments, the wake screen user interface 490 displayed in the dimmed always-on state includes the same or substantially the same set of user interface elements as the wake screen user interface 490 displayed in the normal operating state (e.g., as opposed to the dark screen shown in FIGS. 4C1 and 4C2). In some embodiments, the wake screen user interface 490 displayed in the dimmed, always-on state has fewer user interface elements than the wake screen user interface 490 displayed in the normal operating state. For example, in some embodiments, the wake screen user interface 490 displayed in the normal operating state includes a time element 4004 showing the current time, a date element 4006 showing the current date, one or more widgets 4008 that include content from respective applications that is updated from time to time without user intervention. In some embodiments, the wake screen user interface 490 displayed in the normal operating state includes one or more application icons corresponding to respective applications, such as an application icon 4010 for the flashlight application, an application icon 4012 for the camera application, or another system-recommended or user selected application. In some embodiments, the wake screen user interface 490 displayed in the normal operating state includes one or more shortcuts for accessing respective operations in one or more system-recommended and/or user-selected applications (e.g., shortcuts to play music using a media player application, to send a quick message using the messaging application, or turn on the DND or sleep mode using a system application). In some embodiments, the wake screen user interface 490 includes the dynamic status region 4002 that displays status updates or current state of an ongoing activity for one or more applications, such as a communication session, a charging session, a running timer, music playing session, delivery updates, navigation instructions, location sharing status, and/or status updates for subscribed application and system events. In some embodiments, the wake screen user interface 490 includes the static status region 4022 that displays status for one or more system functions, such as the network connection status, battery status, location sharing status, cellular signal and carrier information, and other system status information. In some embodiments, a dynamic status update (e.g., battery charging, screen recording, location sharing, and other status updates) is displayed in the dynamic status region 4002 first, and then moved to the static status region 4022 after a period of time. In some embodiments, in a dimmed always on state, the wake screen user interface 490 omits the dynamic status region 4002, static status region 4022, the application icons 4010 and 4012, and/or the shortcuts for application and/or system operations, and optionally disables interaction with remaining user interface elements (e.g., the wallpaper, the time element 4004, the date element 4006, and/or the widgets 4008) of the wake screen user interface 490.

In some embodiments, the wake screen user interface includes one or more recently received notifications (e.g., notifications 4016, or other newly received notification(s)) that correspond to one or more applications. In some embodiments, the wake screen user interface displayed in the dimmed always on state transitions into the wake screen user interface 490 in response to detecting receipt or generation of a new notification (e.g., notification 4018, FIG. 4C2, or another one or more newly received notification(s)) In some embodiments, the notifications 4016 are grouped or coalesced based on event types and/or applications corresponding to the notifications. In some embodiments, user can interact with the notifications to dismiss the notifications, sent the notifications to notification history, and/or expand the notifications to see additional notification content (e.g., optionally after valid authentication data has been requested and/or obtained).

In some embodiments, the wake screen user interface 490 may be displayed while the multifunction device is in a locked state or an unlocked state. In some embodiments, when the wake screen user interface 490 is displayed while the multifunction device is in the locked state, a locked symbol 4020a is optionally displayed in the status region (e.g., dynamic status region 4002, static status region in the upper right corner of the display) or elsewhere (e.g., below the dynamic status region 4002, in the upper left corner, or in another portion of the display) in the wake screen user interface 490 to indicate that the multifunction device is in the locked state (e.g., shown in wake screen user interface 490 in FIG. 4C1), and that authentication data is required to dismiss the wake screen user interface 490 to navigate to the home screen user interface 492 or last-displayed application user interface. In some embodiments, the multifunction device automatically attempts to obtain authentication data via biometric scan (e.g., facial, fingerprint, voiceprint, and/or iris) when the wake screen user interface 490 is displayed (e.g., in the low power state, and/or the normal operating state), and automatically transitions into the unlocked state if valid authentication data is successfully obtained. In some embodiments, in conjunction with transitioning into the unlocked state, the multifunction device replaces the locked symbol 4020a with an unlocked symbol 4020b to indicate that the multifunction device is now in the unlocked state (e.g., shown in wake screen user interface 490 in FIG. 4C2).

In some embodiments, the multifunction device allows user interaction with the user interface elements of the wake screen user interface 490 when the wake screen user interface 490 is displayed in the normal operating mode.

For example, in some embodiments, selecting (e.g., by tapping, clicking, and/or air tapping) on a user interface element, such as one of the widgets 4008, status region 4002, notification 4018, and/or application icons 4010 or 4012, causes the multifunction device to navigate away from the wake screen user interface 490 and displays a respective user interface of the application that corresponds to the selected user interface element, or an enlarged version of the user interface element to show additional information and/or controls related to the initially displayed content in the selected user interface element. For example, as shown in FIG. 4C2, in response to a user input 4113 selecting message notification 4018, the computer system displays (4113) the application user interface 493 for the messaging application.

In another example, in some embodiments, an enhanced selection input 4112 (e.g., a touch and hold gesture, a light press input, or another type of input) on a respective user interface element, such as the time element 4004, the date element 4006, or a wallpaper of the wake screen user interface 490, causes the multifunction device to display a configuration user interface for configuring one or more aspects of the wake screen user interface 490 (e.g., selecting a wallpaper, configuring a color or font scheme of the user interface element, configuring how to layout the different elements of the wake screen user interface, configuring additional wake screen, selecting a previously configured wake screen, and view additional customization options for the wake screen user interface). In some embodiments, configuration of the wake screen user interface 490 is partially applied to the home screen user interface 492, and vice versa.

In some embodiments, an enhanced selection input (e.g., a touch and hold gesture, a light press input, or another type of input) on the flashlight application icon 4010 or the camera application icon 4012 causes the multifunction device to activate the flashlight of the multifunction device or display the camera user interface 495 of the camera application. For example, in response to detecting selection input 4104a on the camera application icon 4012 in the wake screen user interface 490, the multifunction device activates the camera application and displays (4104a) the camera application UI 495 (e.g., as shown in FIG. 4C1).

In some embodiments, if the multifunction device detects user interaction with the user interface elements shown in the wake screen user interface 490 and determines that the wake screen user interface is in the locked state, the multifunction device attempts to obtain authentication data from the user by displaying an authentication user interface (e.g., a passcode entry interface, a password entry user interface, and/or a biometric scan user interface). The multifunction device proceeds to navigate away from the wake screen user interface 490 and performs the operation in accordance with the user's interaction after valid authentication data has been obtained from the user.

In some embodiments, in addition to performing operations (e.g., navigating to application user interfaces, displaying expanded versions of user interface elements that show additional information, and/or displaying configuration options for a respective user interface element or the wake screen user interface), the multifunction device allows the user to navigate from the wake screen user interface 490 to other user interfaces (optionally, after valid authentication data has been obtained) in response to navigation inputs (e.g., swipe gestures or other types of navigation inputs that are directed to regions of the wake screen user interface that are not occupied by a user interface element, and/or regions of the wake screen user interface that are occupied by user interface element (e.g., widgets, application icons, and/or time elements) that do not respond to swipe gestures or said other types of navigation inputs).

For example, in some embodiments, an upward swipe gesture 4105 that starts from the bottom edge of the wake screen user interface 490 causes (4105) the multifunction device to navigate away from the wake screen user interface 490 and display the home screen user interface 492 or the last-displayed application user interface (optionally, after requesting and obtaining valid authentication data).

In some embodiments, the upward swipe gesture 4105 is a representative example of a home gesture or dismissal gesture (e.g., other examples include upward swipe gestures 4103a, 4103c, 4103d, 4103e, 4110a, and 4111a) that causes the multifunction device to dismiss the currently displayed user interface (e.g., the wake screen user interface 490, an application user interface (e.g., camera user interface 495, messages user interface 493, or another application user interface), the control user interface 498, the search user interface 494, the application library user interface 497, or the home screen configuration user interface) and navigate to the home screen user interface 492 or a last-displayed user interface (e.g., the wake screen user interface 490, the wake screen configuration user interface, the search user interface 494, an application user interface, or the home screen user interface 492).

In some embodiments, a downward swipe from a top edge (e.g., the central portion of the top edge, or any portion of the top edge) or an interior region of the wake screen user interface 490 (e.g., downward swipe 4106a, or another downward swipe) causes (4106a) the multifunction device to display the search user interface 494 that includes a search input region 4030 and one or more applications icons 4032 for recommended applications (e.g., recently used applications, and/or relevant applications based on the current context), as shown in FIG. 4C1. In some embodiments, in response to detecting a search input in the search input region 4030, the multifunction device retrieves and displays search results that include relevant application content (e.g., messages, notes, media files, and/or documents) from the different applications that are installed on the multifunction device, relevant applications (e.g., applications that are installed on the multifunction device and/or applications that are available in the app store), relevant webpages (e.g., bookmarked webpages and/or webpages newly retrieved from the Internet), and/or search results from other sources (e.g., news, social media platforms, and/or reference websites). In some embodiments, different sets of search results are provided depending on the locked and unlocked state of the multifunction device, and more details or additional search results may be displayed if the multifunction device is in the unlocked state when the search is performed. In some embodiments, the multifunction device attempts to obtain valid authentication data in response to receiving the search input, and displays different sets of search results depending on whether valid authentication data is obtained. In some embodiments, an upward swipe gesture 4103d that starts from the bottom edge of the search user interface (or another type of dismissal input) causes (4103d) the multifunction device to dismiss the search user interface 494 and redisplays the wake screen user interface 490 (e.g., since the wake screen user interface was the last displayed user interface), as shown in FIG. 4C1. In some embodiments, in response to a downward swipe 4106b from an interior region of the home screen user interface 492 causes (4106b) the multifunction device to display the search user interface 494; and in response to a subsequent upward swipe gesture 4103d from the bottom edge of the search user interface 494, the home screen user interface 492 is (4103d) redisplayed (e.g., since the home screen user interface was the last displayed user interface), as shown in FIG. 4C1.

In some embodiments, as shown in FIG. 4C1, a rightward swipe gesture 4102a that starts from a left edge or interior region of the wake screen user interface 490 causes (4102a) the multifunction device to navigate from the wake screen user interface 490 to a widget user interface 491 (or another system user interface other than the home screen user interface, such as a control user interface, a search user interface, or a notification history user interface). In some embodiments, the widget user interface 491 includes a plurality of widgets 4026 (e.g., including widget 4026a, widget 4026b and widget 4026c) that are automatically selected by the operating system and/or selected by the user for inclusion in the widget user interface 491. In some embodiments, the widgets 4026 displayed in the widget user interface 491 have form factors that are larger than the widgets 4008 displayed under the time element 4004 in the wake screen user interface 490. In some embodiments, the widgets 4026 displayed in the widget user interface 491 and the widgets 4008 displayed in the wake screen user interface 490 are independently selected and/or configured from each other. In some embodiments, the widgets 4026 in the widget user interface 491 include content from their respective applications and the content is automatically updated from time to time as the updates to the content becomes available in the respective applications. In some embodiments, selection of a respective widget (e.g., tapping on the respective widget, or providing other selection input directed to the respective widget) in the widget user interface causes the multifunction device to navigate away from the widget user interface 491 and displays a user interface of the application that corresponds to the respective widget (optionally, after valid authentication data is requested and/or obtained).

In some embodiments, an upward swipe gesture 4103a that starts from the bottom edge of the widget user interface 491 and/or a leftward swipe gesture 4103b that starts from the right edge or the interior region of the widget user interface 491 causes (4103a-1/4103b-1) the multifunction device to dismiss the widget user interface 491 and redisplay the wake screen user interface 490, as shown in FIG. 4C1.

In some embodiments, a leftward swipe gesture 4104b that starts from the right edge or interior portion of the wake screen user interface 490 causes (4104b) the multifunction device to navigate from the wake screen user interface 490 to a camera user interface 495 of the camera application. In some embodiments, access to the photo library through the camera application is restricted in the camera user interface 495 unless valid authentication data has been obtained. In some embodiments, as shown in FIG. 4C1, an upward swipe gesture 4103c that starts from the bottom edge of the camera user interface 495 or another dismissal input causes (4103c) the multifunction device to navigate away from the camera user interface 495 and redisplay the wake screen user interface 490 (e.g., since the wake screen user interface 490 is the last displayed user interface prior to displaying the camera user interface 495).

In some embodiments, a downward swipe gesture 4109a that starts from the right portion of the top edge of the wake screen user interface (e.g., as illustrated in FIG. 4C2) causes (4109a) the multifunction device to display the control user interface 498 overlaying or replacing display of the wake screen user interface 490. In some embodiments, the control user interface 498 includes status information for one or more static status indicators displayed in the static status region 4022, and respective sets of controls 4028 (e.g., including control 4028a, control 4028b, and control 4028c) for various system functions, such as network connections (WiFi, cellular data, airplane mode, Bluetooth, and other connection types), media playback controls, display controls (e.g., display brightness, color temperature, night shift, true tone, and dark mode controls), audio controls (e.g., volume, and/or mute/unmute controls, focus mode controls (e.g., DND, work, study, sleep, and other modes in which generation of alerts and notifications are moderated based on context and configurations, and application icons (e.g., flashlight, timer, calculator, camera, screen recording, and/or other user-selected or system recommended applications))). In some embodiments, an upward swipe gesture 4110a that starts from the bottom edge of the control user interface 498 (or another dismissal input) causes the multifunction device to dismiss the control user interface 498 and redisplay (4110a-1) the wake screen user interface 490 (e.g., since the wake screen user interface 490 is the last displayed user interface prior to displaying the control user interface 498).

In some embodiments, an upward swipe gesture 4107 that starts from the interior region of the wake screen user interface 490 and/or an upward swipe gesture that starts from the interior of the coversheet user interface 496 (e.g., optionally, when there are no unread notifications displayed in the coversheet user interface) causes (4107) the multifunction device to display the notification history user interface that includes a plurality of previously saved notifications and notifications that have been sent directly to notification history without first being displayed on the wake screen user interface 490. In some embodiments, the notification history user interface can be scrolled to reveal additional notifications in response to an upward swipe gesture 4118 directed to the notification history in the wake screen user interface 490 and/or the coversheet user interface 496. In some embodiments, the notification history is displayed as part of the wake screen user interface 490 and/or coversheet user interface 496, and a downward swipe gesture 4103f that is directed to the interior portion of the notification history causes the notification history to cease to be displayed and causes the wake screen user interface 490 and/or coversheet user interface 496 to be redisplayed without the notification history.

As described above, after navigating from the wake screen user interface 490 to a respective user interface other than the home screen user interface (e.g., in response to a swipe gesture in the downward, leftward, or rightward directions), an upward swipe gesture 4103 (e.g., 4103a, and 4103c through 4103f) that starts from a bottom edge of the respective user interface (e.g., an upward swipe gesture that starts from the bottom edge of the touch-sensitive display that displays a respective user interface in full screen mode, or an upward swipe gesture that starts from the bottom edge of a touch-sensitive surface that corresponds to the display that displays the respective user interface) causes the multifunction device to dismiss the respective user interface and returns to the wake screen user interface 490. In contrast, an upward swipe gesture 4105 that starts from the bottom edge of the wake screen user interface 490 causes (4105) the multifunction device to navigate away from the wake screen user interface 490 and displays the home screen user interface 492, and another upward swipe gesture that starts from the bottom edge of the home screen user interface 492 does not cause the multifunction device to dismiss the home screen user interface 492 and return to the wake screen user interface 490. In other words, once the navigation from the wake screen user interface 490 to the home screen user interface 492 is completed, the multifunction device is no longer in the restricted state, and access to the application icons displayed on the home screen user interface 492 and access to the content and functions of the computer system are unrestricted to the user. The upward swipe gesture that starts from the bottom edge of the currently displayed user interface is a representative example of a dismissal input that dismisses the currently displayed user interface and redisplays the last displayed user interface. The upward swipe gesture that starts from the bottom edge of the currently displayed user interface is also a representative example of a home gesture that dismisses the currently displayed user interface and displays the home screen user interface (e.g., irrespective of whether the home screen user interface was the last displayed user interface prior to displaying the currently displayed user interface).

As shown in FIG. 4C2, once the multifunction device navigates away from the wake screen user interface 490 and displays the home screen user interface 492, the user can access the functions and applications of the multifunction device without restriction. For example, in some embodiments, the home screen user interface 492 includes multiple pages, and a respective page of the home screen user interface includes a respective set of application icons and/or widgets corresponding to different applications, and user selection of (e.g., by tapping on, clicking on, or otherwise selecting) a respective widget or application icon causes the multifunction device to display an application user interface of the application that corresponds to the respective widget or application icon.

In some embodiments, the home screen user interface 492 displays a search affordance 4034 (e.g., as illustrated in FIG. 4C1), and a tap on the search affordance 4034 causes the search user interface 494 described above to be displayed overlaying the home screen user interface 492. In some embodiments, in response to detecting an upward swipe gesture 4103d that starts from the bottom edge of the search user interface (or another dismissal input), the multifunction device dismisses the search user interface 494 and redisplays (4103d) the home screen user interface 492 (e.g., not the wake screen user interface 490, as the upward edge swipe gesture dismisses the currently displayed user interface and redisplays the last displayed system user interface).

In some embodiments, as shown in FIG. 4C1, a rightward swipe gesture 4102b that starts from the left edge of the first page of the home screen user interface 492 causes (4102b) the multifunction device to display the widget user interface 491 described above. In some embodiments, a leftward swipe gesture (e.g., gesture 4103b, or another leftward swipe gesture) that starts from the right edge or the interior region of the widget user interface or an upward swipe gesture (e.g., gesture 4103a, or another upward swipe gesture) that starts from the bottom edge of the widget user interface 491 causes (4103a-2/4103b-2) the multifunction device to navigate away from the widget user interface 491 and redisplays the first page of the home screen user interface 492 (e.g., when the home screen user interface 492 was the last displayed user interface prior to displaying the widget user interface 491).

In some embodiments, consecutive leftward swipe gestures 4116 on the home screen user interface 492, as shown in FIG. 4C2, navigates through consecutive pages of the home screen user interface 492 until the application library user interface 497 is (4116) displayed. In some embodiments, the application library user interface 497 displays application icons from multiple pages of the home screen user interface grouped into different categories. In some embodiments, the application library user interface 497 includes a search user interface element 4036 that accepts search criteria (e.g., keywords, image, and/or other search criteria) and returns application icons for relevant applications (e.g., applications that are stored on the multifunction device and/or available in the app store) as search results. In some embodiments, user selection of (e.g., by a tap input, a click input, or another type of selection input) on an application icon in the search results and/or in the application library causes the multifunction device to display the application user interface of the application that corresponds to the selected application icon.

In some embodiments, a downward swipe gesture 4109c that starts from the right portion of the top edge of the application library user interface 497 causes display of the control user interface 498 as described above. In some embodiments, an upward swipe gesture (e.g., upward swipe gesture 4110a, or another upward swipe gesture) that starts from the bottom edge of the control user interface 498 or another dismissal input causes the multifunction device to dismiss the control user interface 498 and redisplay the application library user interface 497 (e.g., since the application library user interface is the last displayed user interface before the display of the control user interface) (e.g., or redisplay another user interface (e.g., redisplay (4110a-1) the wake screen user interface 490 (e.g., if control user interface 498 is displayed in response to swipe gesture 4109a), redisplay (4110a-3) the home screen user interface 492 (e.g., if the control user interface is displayed in response to a downward swipe from the top right portion of the top edge of the display), or redisplay (4110a-2) the application user interface (e.g., if the control user interface is displayed in response to the downward swipe 4109b) that was the last displayed user interface prior to displaying the control user interface).

In some embodiments, a rightward swipe gesture 4115 that starts from the interior region or the left edge of the application library user interface 497 or an upward swipe gesture that starts from the bottom edge of the application library user interface 497 causes (4115) the multifunction device to dismiss the application library user interface 497 and redisplays the last page of the home screen user interface 492.

In some embodiments, a downward swipe gesture 4114 that starts from the interior region of the application library user interface 497 causes the multifunction device to display the application icons for applications stored on the multifunction device in a scrollable list (e.g., according to chronological or alphabetical order).

In some embodiments, an upward swipe gesture that starts from the bottom edge of the home screen user interface causes the multifunction device to display the first page of the home screen user interface 492 or display the multitasking user interface 488 (also referred to an application switcher user interface). In some embodiments, different criteria (e.g., criteria based on the speed, direction, duration, distance, intensity, and/or other characteristics) are used to determine whether to navigate to the first page of the home screen user interface 492 or to the multitasking user interface 488 in response to detecting the upward swipe gesture that starts from the bottom edge of the home screen user interface. For example, in some embodiments, a short flick and a slow and long swipe cause the multifunction device to navigate to the first page of the home screen user interface 492, while a slow and medium length swipe causes the multifunction device to display the multitasking user interface 488. In some embodiments, a navigation gesture is dynamically evaluated before the termination of the gesture is detected, and therefore, the estimated destination user interface of the navigation gesture continues to change and visual feedback regarding the estimated destination user interface continues to be provided to guide the user to conclude the gesture when the desired destination user interface is indicated by the visual feedback. In some embodiments, in response to a user input 4117 at a portion of the multitasking user interface 488 that does not correspond to an application, a last displayed user interface that is displayed before displaying the multitasking user interface 488 is displayed (e.g., home screen user interface 492 is displayed when the multitasking user interface 488 is displayed in response to user input 4111b).

In some embodiments, a reconfiguration mode of the home screen user interface 492 is displayed in which application icons and/or widgets can be repositioned in, removed from, or added to the different pages of the home screen user interface 492. In some embodiments, a touch and hold gesture or another enhanced selection input directed to the home screen user interface 492 for a respective threshold amount of time or another enhanced selection input directed to the home screen user interface 492 cause the multifunction device to display the home screen user interface 492 in the configuration mode. In some embodiments, selection of the search affordance 4034 in the home screen user interface 492 while the home screen user interface 492 is in the reconfiguration mode causes the multifunction device to display a page editing user interface for the home screen user interface in which pages of the home screen user interface may be reordered, deleted, hidden, or created. In some embodiments, a tap input on the home screen user interface in the reconfiguration mode, causes the home screen user interface to exit the reconfiguration mode. In some embodiments, a tap input on unoccupied portion of the page editing user interface causes the multifunction device to exist the page editing user interface and redisplays the home screen user interface in the reconfiguration mode. Another tap on the home screen user interface causes the home screen user interface to exit the reconfiguration mode and be redisplayed in the normal mode.

In some embodiments, while displaying the home screen user interface 492, a downward swipe gesture 4108a that starts from the top edge of the home screen user interface 492 causes (4108a) the multifunction device to cover the home screen user interface 492 with the coversheet user interface 496 (also referred to as the wake screen user interface 490 if the user interface is displayed when transitioning from a normal mode to a low-power mode, and/or vice versa (e.g., due to inactivity, due to activation of the power button, and/or due to user input that corresponds to a request to wake or lock the device)) and the access to the home screen user interface is temporarily restricted by the coversheet user interface 496. In some embodiments, while the coversheet user interface 496 is displayed, an upward swipe gesture 4103e that starts from the bottom edge of the coversheet user interface 496 dismisses (4103e) the coversheet user interface 496 and redisplays the home screen user interface 492 (e.g., since the home screen user interface is the last displayed user interface). In some embodiments, the coversheet user interface has responses to user inputs in a manner analogous to those described with respect to the wake screen user interface 490.

In some embodiments, an application user interface of a respective application can be displayed in response to user inputs in a number of scenarios, such as tapping on a widget displayed in the home screen user interface or the widget user interface; tapping on an application icon displayed in the home screen, in the widget user interface, in the search result or recommended application portion of the search user interface, in the application library user interface or in the search results provided in a search in the application library user interface; tapping on a notification on the wake screen user interface or in the notification history; tapping on a representation of an application in the multitasking user interface; or selecting a link to an application in a user interface of another application (e.g., a link to a document, a link to a phone number, a link to a message, a link to an image, and other types of links). In some embodiments, a user interface of a single application is displayed in a full-screen mode. In some embodiments, user interfaces of two or more applications are displayed in a concurrent-display configuration, such as in a side-by-side display configuration where the user interfaces of the applications are displayed adjacent to one another to fit within the display, or in an overlay display configuration where the user interface of a first application is displayed in the full-screen mode while the user interfaces of other applications are overlaid on portion(s) of the user interface of the first application (e.g., in a single stack or separately on different portions).

In some embodiments, while displaying a user interface of an application, an upward swipe gesture (e.g., upward swipe gesture 4111a, or another upward swipe gesture) that starts from the bottom edge of the application user interface (e.g., messages user interface 493, or another user interface of an application) or another dismissal input or home gesture causes (4111a-1, or 4111a-2) the multifunction device to dismiss the currently displayed application user interface, and display either the home screen user interface (e.g., shown as transition 4111a-1) or the multitasking user interface (e.g., shown as transition 4111a-1) depending on the characteristics of the upward swipe gesture. In some embodiments, while displaying home screen user interface 492, an upward swipe gesture 4111b that starts from the bottom edge of the home screen user interface causes (4111b) the multifunction device to dismiss the currently displayed home screen user interface 492, and display the multitasking user interface 488.

In some embodiments, a horizontal swipe gesture in the leftward and/or rightward direction that is performed within a bottom portion of the application use interface(s) causes the multifunction device to switch to another previously displayed application user interface of a different application. In some embodiments, the same swipe gesture that starts from the bottom portion of a respective application user interface is continuously evaluated, to determine and update an estimated destination user interface among the multitasking user interface 488, the home screen user interface 492, or a user interface of a previously displayed application, based on the characteristics of the swipe gesture (e.g., location, speed, direction, and/or change in one or more of the above), and a final destination user interface is displayed in accordance with the estimated destination user interface at the termination of the swipe gesture (e.g., lift off of the contact, reduction in intensity of the contact, a pause in movement, and/or another type of change in the input).

In some embodiments, while displaying an application user interface of a respective application (or displaying application user interfaces of multiple applications in a concurrent-display configuration), a downward swipe gesture 4108b that starts from the top edge of the application user interface(s) causes (4108b) the multifunction device to display the coversheet user interface 496 (FIG. 4C1) (or the wake screen user interface 490 in FIG. 4C2) over the application user interface(s). The multifunction device dismisses the coversheet user interface 496 (or the wake screen user interface 490) and redisplays the application user interface(s) in response to an upward swipe gesture that starts from the bottom edge of the coversheet user interface (or another dismissal input).

In some embodiments, as shown in FIG. 4C2, a downward swipe gesture 4109b that starts from the static status region 4022 on the display cause (4109b) the multifunction device to display the control user interface 498 over the application user interface(s), and an upward swipe gesture 4110a that starts from the bottom edge of the control user interface 498 (or another dismissal input) dismisses the control user interface 498 and causes (4110a-2) the application user interfaces to be redisplayed (e.g., or the last displayed user interface that is displayed before displaying the control user interface 498).

In some embodiments, rotation of the display causes the multifunction device to display a different version of the currently displayed user interface (e.g., application user interface, home screen user interface, wake screen user interface, control user interface, notification user interface, widget user interface, application library user interface, and other user interfaces described with respect to FIGS. 4C1-4C2) that have a differently layout (e.g., landscape version vs. portrait version). In some embodiments, rotation of the display has no effect on the orientation of the respective user interface that is currently displayed.

The above description of the navigation between user interfaces and exact appearances and components of the various user interfaces are merely illustrative and may be implemented with variations in various embodiments described herein. In addition, the transitions between pairs of user interfaces illustrated in FIGS. 4C1-4C2 are only a subset of all transitions that are possible between different pairs of user interfaces illustrated in FIGS. 4C1-4C2, and a transition to a respective user interface may be possible from any of multiple other user interfaces, in accordance with a respective user input of a same type, directed to a same interaction region of the display, and/or in accordance with a different type of input or directed to a different interactive region, in accordance with various embodiments.

### User Interfaces and Associated Processes

Attention is now directed towards embodiments of user interfaces (“UI”) and associated processes that may be implemented on an electronic device (or computer system more generally), such as portable multifunction device 100 or device 300, with a display, a touch-sensitive surface, (optionally) one or more tactile output generators for generating tactile outputs, and (optionally) one or more sensors to detect intensities of contacts with the touch-sensitive surface.

FIGS. 5A-5S illustrate example user interfaces for updating a wallpaper background of a user interface in accordance with a selected wallpaper foreground element, in accordance with some embodiments. FIGS. 6A-6V illustrate example user interfaces for selecting a user interface object displayed in a wallpaper of a user interface and updating the user interface in accordance with the selection in accordance with some embodiments. FIGS. 7A-7Z illustrate example user interfaces for configuring a user interface while the device is in different orientations in accordance with some embodiments. FIGS. 11A-11I illustrate example user interfaces for displaying and editing a background that includes media with multiple frames in accordance with some embodiments. FIGS. 12A-12E illustrate a flow diagram of waking a device from a low power state and displaying a wake screen with a background that includes media with multiple frames in accordance with some embodiments. The user interfaces in these figures are used to illustrate the processes described below, including the processes in FIGS. 8A-8D, 9A-9F, 10A-10F and 11A-11I. For convenience of explanation, some of the embodiments will be discussed with reference to operations performed on a device with a touch-sensitive display system 112. In such embodiments, the focus selector is, optionally: a respective finger or stylus contact, a representative point corresponding to a finger or stylus contact (e.g., a centroid of a respective contact or a point associated with a respective contact), or a centroid of two or more contacts detected on the touch-sensitive display system 112. However, analogous operations are, optionally, performed on a device with a display 450 and a separate touch-sensitive surface 451 in response to detecting the contacts on the touch-sensitive surface 451 while displaying the user interfaces shown in the figures on the display 450, along with a focus selector.

As used herein, the wallpaper of a user interface (e.g., the wallpaper of a wake screen user interface and/or the wallpaper of a home screen user interface) includes a wallpaper background (e.g., a background color, a background gradient, or a background texture) and/or one or more wallpaper foreground elements (e.g., foreground icons (e.g., emojis, avatars, or other icons), foreground subjects, and/or foreground images). In some embodiments, the one or more wallpaper foreground elements are repeated in a pattern (e.g., a small grid, a medium grid, a large grid, a spiral, or another layout) that is overlaid on the wallpaper background. In some embodiments, as described below, a user is enabled to configure the one or more wallpaper foreground elements and/or the wallpaper background to modify the appearance of the wallpaper. In some embodiments, changing the one or more wallpaper foreground elements causes the device 100 to automatically, without user input, update the wallpaper background (e.g., according to the new wallpaper foreground elements that are selected, the remaining wallpaper foreground elements after deletion of one or more foreground elements, and/or the combination of the wallpaper foreground elements that are chosen).

As used herein, a wake screen user interface is a user interface that is displayed after the display of device 100 exits a low power state during which the display is turned off or enters a dimmed always-on state. In some embodiments, a wake screen user interface is also referred to herein as a face. For example, actions described as being performed with respect to a wake screen user interface may also be described as being performed with respect to a face (e.g., “switching between wake screen user interfaces” may also be stated as “switching between faces” and “editing a wake screen user interface” may also be stated as “editing a face”). In some embodiments, an “expanded face switcher” user interface includes display of one or more faces (e.g., one or more wake screen user interfaces), wherein a size of a respective face (e.g., wake screen user interface) is less than a full size of the display area (e.g., as illustrated in FIG. 5B). In some embodiments, in the low power state, the display optionally displays an “always on” indicator of a time and/or date and the device displays the wake screen user interface when the device is prompted to come out of the low power state. In some embodiments, optionally in response to a user input and/or in response to a threshold amount of time elapsing, the device enters a locked state in which a password, passcode and/or biometric authentication is required to unlock the device, wherein the device has limited functionality in the locked state and must be unlocked before accessing respective applications and/or data stored on device 100. In some embodiments, the wake screen user interface is displayed regardless of whether the device is in the locked state or has already been unlocked (e.g., the wake screen user interface is displayed upon waking the device before the user accesses a home screen user interface and/or other application user interfaces). In some embodiments, as used herein, a cover sheet user interface includes the same characteristics as the wake screen user interface, but the device displays the cover sheet user interface optionally without entering the locked and/or low power state of the device. In some embodiments, one or more alerts (e.g., system alerts and/or notifications) are displayed on the wake screen user interface and/or the cover sheet user interface, optionally in response to a user input (e.g., a swipe gesture upward in the middle of the display or another gesture). More details and interactions with the wake screen user interface are described in FIG. 4C and accompanying descriptions.

As used herein, a home screen user interface includes application icons for navigating to respective applications of a plurality of applications that are executed by the device 100. In some embodiments, the device 100 detects and responds to interaction with the home screen user interface using one or more gestures, including touch inputs. For example, a tap input or other selection input on a respective application icon causes the respective application to launch, or otherwise open a user interface for the respective application, on the display area of device 100. In some embodiments, a plurality of pages for the home screen user interface is available. For example, the device detects and responds to user inputs such as swipe gestures or other inputs (e.g., inputs directed to the currently displayed page of the home screen user interface) that correspond to requests to navigate between the plurality of pages, wherein each page of the home screen user interface includes different sets of application icons for different applications. In some embodiments, the home screen user interface includes widgets that correspond to different applications and optionally have different sizes from the application icons. In some embodiments, a widget that corresponds to a respective application displays application content from the respective application, wherein the application content is updated from time to time based on updates in content in the application, without displaying the application. More details and interactions with the home screen user interface are described in FIG. 4C and accompanying descriptions.

As used herein, in some embodiments, widgets (also referred to as mini application objects) are user interface objects that provide a limited subset of functions and/or information available from their corresponding applications without requiring the applications to be launched. In some embodiments, mini-application objects (or widgets) contain application content that is dynamically updated based on the current context. In some embodiments, a tap input or other selection input on a mini-application object (widget) causes the corresponding application to be launched. In some embodiments, a respective mini application object operates as a standalone application residing in memory of the device, distinct from an associated application also residing in the memory of the device. In some embodiments, a respective mini application object operates as an extension or component of an associated application on the device. In some embodiments, a respective mini application object has a dedicated memory portion for temporary storage of information. In some embodiments, the memory portion is accessible by a corresponding full-featured application of the respective mini application object. In some embodiments, a mini application object is configured to perform a subset, less than all, of the functions of a corresponding application. In some embodiments, a mini application object displays an identifier for the corresponding application. In some embodiments, a mini application object displays a portion of the content from the corresponding application. For example, a map mini application object displays a portion of a map that is displayed in a map application that corresponds to the map mini application object. For example, a calendar mini application object displays a portion of a calendar that is displayed in a corresponding calendar application. In some embodiments, a predefined input on a mini application object launches the corresponding application. In some embodiments, a mini application object operates as a standalone application residing in memory of the device, distinct from an associated application also residing in the memory of the device. For example, a mini application object corresponding to a social networking application operates as a single-purpose or streamlined application with a subset, less than all, of the functionality of the corresponding application, but is associated with the full-featured social networking application. In this example, the mini application object operates independently of the social networking application, and in a scenario where the social networking application is not running, the mini application object continues to operate. In some embodiments, a mini application object operates as an extension or component of an associated application on the device. For example, a mini application object for a calendar application is a single feature or operational component of the full-featured calendar application. In this example, if the calendar application is not running (e.g., in the background), the calendar mini application object does not operate either. In some embodiments, a mini application object has a dedicated memory portion for temporary storage of information. In some embodiments, this memory portion can be accessed by the corresponding full-featured application. For example, a mini application object for an instant messaging application has a memory portion for temporary storage of partially written reply messages. In this example, if the user opens the corresponding application in the middle of writing a reply message, the contents of the reply message are retrieved from the temporary storage location and used by the full-featured application to allow the user to complete his reply message.

FIG. 5A illustrates user interface 501 that corresponds to a wake screen user interface that is displayed while device 100 is in a restricted state (e.g., restricting user access to the home screen user interface and/or application user interface that was last displayed). In some embodiments, user interface 501 includes a plurality of widgets, each widget corresponding to a respective application of device 100 that is updated in accordance with content from the respective application. For example, widget 502 and/or widget 510 correspond to a weather application. For example, widget 502 is displayed with an icon representing a forecast and/or current weather as determined using the weather application and widget 510 is displayed with a representation of a current air quality index. In some embodiments, widget 504 and/or widget 506 correspond to a fitness application. For example, widget 504 displays progress of fitness goals (e.g., a daily goal) as determined by the fitness application, and widget 506 displays a status for an activity (e.g., a run, a walk, a hike, or other activity), including a distance and/or amount of time of the activity. In some embodiments, widget 508 corresponds to a calendar application and displays one or more upcoming events with an indication of a scheduled time for the one or more upcoming events. It will be understood that additional and/or alternative widgets may be included in user interface 501, and that the respective applications associated with the respective widgets are described for example only. In some embodiments, other applications and/or other widgets for the applications are displayed. As illustrated in FIG. 5A, widgets are, in some embodiments, of different sizes and/or display different icons and information based on the particular widget selected for an application. In some embodiments, the widgets that are displayed in the user interface 501 are modified, as described in more detail with reference to FIGS. 7A-7Z.

In some embodiments, the wake screen user interface (e.g., user interface 501, or another wake screen user interface) includes one or more recently received notifications, a date and/or time indication for current date and time, and/or one or more status indicators (e.g., status for one or more system functions, such as network connections, battery level, and/or other system functions).

Although FIG. 5A illustrates user interface 501 as a wake screen user interface, it will be understood that the examples described below with respect to the wake screen user interface (e.g., including the wallpaper of the wake screen user interface) are also enabled for other types of user interfaces, such as a home screen user interface (e.g., including the wallpaper of the home screen user interface, and/or other aspects of the home screen user interface), in some embodiments.

FIG. 5A further illustrates user input 512 (e.g., a tap input, a tap and hold input, a swipe input, or another type of input) that is detected in user interface 501. In some embodiments, user input 512 corresponds to a request to edit or modify user interface 501 (e.g., edit or modify the wallpaper of the user interface 501 and/or to create a new wallpaper for user interface 501). In some embodiments, the user is enabled to edit the wallpaper of user interface 501 (e.g., including editing the wallpaper background and/or the one or more wallpaper foreground elements) and/or edit one or more system user interface objects of user interface 501 (e.g., edit the time and/or date indication, edit the widgets or other application icons displayed in the user interface 501). For example, during editing, the user is enabled to add, remove or change the widgets that are included in user interface 501. In some embodiments, in response to user input 512, the device displays user interface 513, as illustrated in FIG. 5B.

FIG. 5B illustrates user interface 513 (e.g., an expanded face switcher user interface) that displays options for selecting a face for a wake screen user interface from a set of faces for the wake screen user interfaces, options for creating a new face for the wake screen user interface and/or options for modifying an existing (e.g., previously created, and/or a currently used) face of the wake screen user interface of device 100. For example, user interface 513 includes a portion of another wake screen user interface 505 or face 505 that optionally includes a distinct wallpaper background, a distinct time and/or date indication, and/or a distinct set of widgets as compared to wake screen user interface 501 (e.g., represented by representation 514 in the user interface 513). In some embodiments, the user is enabled to select wake screen user interface 505 to be used as the current wake screen user interface (e.g., replacing user interface 501 as the current wake screen user interface) of device 100. For example, the user is enabled to scroll to various available wake screen user interfaces or faces, including wake screen user interface 505, as indicated by pagination dots 516.

In some embodiments, the user is enabled to create a new wake screen user interface, for example, by selecting (e.g., via user input 520, or another selection input) the plus icon in representation 524. For example, in response to user input 520, device 100 displays user interface 523, illustrated in FIG. 5C. In some embodiments, user interface 523 includes platter 526 that is displayed for creating and/or configuring a new wake screen user interface (e.g., and/or a new home screen user interface) for device 100, including creating and/or configuring the wallpaper for the new wake screen user interface (e.g., and/or the new home screen user interface). In some embodiments, platter 526 includes a plurality of recommended wallpapers to display in the new wake screen user interface, such as a photos wallpaper (e.g., where images from a photo library of a user are used as the wallpaper of the wake screen user interface), a people wallpaper (e.g., where images that include a particular person are used as the wallpaper of the wake screen user interface), an emoji wallpaper (e.g., where emoji, avatars, stickers, or other icons are used as the wallpaper of the wake screen user interface) and/or an astronomy wallpaper (e.g., where images of planets, stars or other images related to astronomy are used as the wallpaper of the wake screen user interface). It will be understood that the set of recommended wallpapers provided herein is for example only, and that other recommended wallpapers may be provided instead of, or in addition to, the examples listed above. For example, in response to user input 530 selecting the emoji wallpaper, a user interface for selecting one or more emoji (e.g., via platter 534, or another selection user interface) to use as the one or more wallpaper foreground elements for the wallpaper is displayed (e.g., in editing user interface 531, or another editing user interface), as illustrated in FIG. 5D.

In some embodiments, platter 526 further includes a set of selectable wake screen face designs 528-1 through 528-4. For example, different wake screen face design 528 include different wallpapers (e.g., as indicated by the shading in wallpaper designs 528-2 and 528-4), different visual properties of the time and/or date indications (e.g., different fonts, sizes, and/or colors), and/or different sets of widgets for the respective wake screen face design. As such, the user is enabled to select a wake screen face design, and optionally enabled to further customize and/or modify the selected wake screen face design, to use as the wake screen user interface of device 100.

In some embodiments, the user is enabled to modify the currently selected wake screen user interface (e.g., represented by the representation 514 corresponding to user interface 501) by selecting customize button 518 via user input 522. In some embodiments, in response to user input 522, editing user interface 531 is displayed, as illustrated in FIG. 5D. In some embodiments, editing user interface 531 includes widgets area 532 for adding, removing and/or changing the widgets to be included in the wake screen user interface 501, as described in more detail with reference FIGS. 7A-7Z. In some embodiments, editing user interface 531 includes a cancel button 546 that, when selected, causes device 100 to cease display of the editing user interface 531 and display a wake screen user interface (e.g., user interface 501, or another wake screen user interface that was being edited, that optionally does not reflect changes made while displaying the editing user interface). In some embodiments, done button 544 is displayed in editing user interface 531 that, when selected, causes the device to cease display of editing user interface 531 and display a wake screen user interface (e.g., user interface 501, or another wake screen user interface that was being edited, that optionally does reflect changes made while displaying the editing user interface).

For example, editing user interface 531 enables the user to edit the wake screen user interface by changing (e.g., selecting, adding, removing, and/or rearranging) the widgets that are included on the wake screen user interface, changing a wallpaper of the wake screen user interface, and/or changing visual properties of the time and/or date indication. In some embodiments, the wallpaper includes a set of one or more wallpaper foreground elements, such as one or more types of emoji (e.g., or other icons, such as avatars) that are displayed in a pattern, as described in more detail with reference to FIG. 5E. For example, the one or more wallpaper foreground elements includes a first type of emoji (e.g., a smiley face emoji, or another emoji or graphical element) that is repeated multiple times (e.g., multiple instance of the first type of emoji are displayed), optionally displayed in a pattern and/or layout that is configurable by the user.

In some embodiments, platter 534 is displayed in editing user interface 531 in response to selection of the emoji button by input 530 in user interface 526 (e.g., if the currently edited wake screen user interface does not include emojis in the wallpaper). In some embodiments, platter 534 is displayed in editing user interface 531 in response to selection of the customize button 518 in editing user interface 513 (e.g., if the currently edited wake screen user interface includes at least one emoji in the wallpaper). In some embodiments, selecting the customization button 518 causes the device to display a customization option for adding or editing emojis in the wallpaper of the currently edited wake screen user interface, and selection of the customization option causes the platter 534 to be displayed in the editing user interface 531. In some embodiments, platter 534 includes search bar 536 that enables the user to search, via a text input (e.g., input through a keyboard (e.g., a virtual or physical keyboard) and/or a voice command), for emoji that match the text input. In some embodiments, platter 534 includes an emoji keyboard that displays a plurality of selectable emoji, avatars, or other icons, including thumbs up emoji 548, plane emoji 552, smiley face emoji 550, and rocket emoji 554. It will be understood that additional and/or alternative emoji are also displayed in some embodiments and that the emoji keyboard illustrated in FIG. 5D is an example of displaying emoji that the user is enabled to select to add to the set of one or more wallpaper foreground elements. In some embodiments, in response to a user input selecting one or more respective emoji from the plurality of selectable emoji in the emoji keyboard, the one or more selected emoji are displayed in box 540 (e.g., wherein the set of one or more wallpaper foreground elements correspond to the emoji added to box 540), and the one or more selected emoji are added as wallpaper foreground elements to be displayed in the wallpaper of the wake screen user interface. For example, in response to user input 542 (e.g., a tap input or other selection input) selecting smiley face emoji 550, editing user interface 531 is updated to editing user interface 543, as illustrated in FIG. 5E, which includes displaying a plurality of instances of smiley face emoji 550 in a grid pattern in the wallpaper for the wake screen user interface that is being edited. As described herein, the editing user interface of a wake screen user interface or face that is being edited and/or configured may take on different appearances (and referred to herein with different reference labels) to reflect the changes (e.g., change in wallpaper foreground elements, wallpaper background, type of wallpaper, selection and layout of widgets, font, colors, and/or formats of time and date elements) that are made using the customization options provided by the editing user interface, before the changes are finally applied to the wake screen user interface upon saving the changes at the conclusion of the editing session (e.g., exiting the editing user interface using the done button, or a dismissal input other than the cancel button).

FIG. 5E illustrates that, in response to user input 542 selecting smiley face emoji 550, a representation of the smiley face emoji is displayed in box 540, and the wallpaper of the wake screen user interface is updated to display a plurality of instances of smiley face emoji in a small grid pattern (e.g., each smiley face emoji is spaced apart vertically and horizontally from another smiley face emoji, thereby forming a grid pattern). In some embodiments, an appearance of the wallpaper, including an appearance of the wallpaper background (e.g., a color, gradient and/or texture of the wallpaper background), is automatically, without additional user input, updated based at least in part on the selected smiley face emoji 550. For example, smiley face emoji 550 is associated with a first color that is optionally selected as the wallpaper background, based on one or more colors in the smiley face emoji. For example, the first color is selected to match or compliment one or more colors present in smiley face emoji 550, in accordance with some embodiments. As such, the instances of smiley face emoji are displayed as wallpaper foreground elements of the wallpaper that overlay the wallpaper background of the wallpaper having the first color.

In some embodiments, device 100 detects user input 560 selecting done button 544, and in response to user input 560, device 100 ceases to display editing user interface 543 and displays wake screen user interface 563, as illustrated in FIG. 5F1. In some embodiments, wake screen user interface 563 includes the wallpaper, as selected in the editing user interface 543, including the plurality of smiley face emojis in the grid pattern overlaying the wallpaper background having the first color and the widgets indicated in editing user interface 543.

FIG. 5F1 further illustrates user input 564 for dismissing wake screen user interface 563 to navigate to the home screen user interface. For example, user input 564 comprises a swipe input in a first direction (e.g., an upward swipe, a downward swipe, or another user input) that starts from an edge portion of the display (e.g., the bottom edge, the top edge, or another portion of the display). In some embodiments, in response to detecting user input 564, device 100 ceases display of wake screen user interface 563 and displays home screen user interface 565, as illustrated in FIG. 5F2. In some embodiments, a wallpaper of home screen user interface 565 in FIG. 5F2 is the same wallpaper as the wallpaper of wake screen user interface 563 (e.g., the wallpaper includes the instances of smiley face emoji (e.g., wallpaper foreground elements) in a grid pattern overlaying a wallpaper background with the first color). In some embodiments, the wallpaper of home screen user interface 565 is a different wallpaper (e.g., a solid color, a different image, a blurred version of the image, or other wallpaper that is configurable by the user) than the wallpaper of wake screen user interface 563. In some embodiments, the wallpaper of home screen user interface 565 takes on some characteristics (e.g., theme, color scheme, and/or subject matter) of the wallpaper of the wake screen user interface 563, but are not exactly the same as the wallpaper of the wake screen user interface 563.

In some embodiments, going back to FIG. 5E, user input 562 for selecting thumbs up emoji 548 is detected by device 100 after selection of the smiley face emoji. In some embodiments, in response to detecting user input 562, the wallpaper of the wake screen user interface that is being edited is updated to include a plurality of smiley face emoji and a plurality of thumbs up emoji, as illustrated in editing user interface 567 in FIG. 5G1. In some embodiments, in response to user input 562, the one or more wallpaper foreground elements includes smiley face emoji 550 and thumbs up emoji 548, and a plurality of instances of smiley face emoji and a plurality of instances of thumbs up emoji 548 are displayed, optionally, in an alternating order in a grid pattern over the wallpaper background of the wake screen user interface that is being edited.

In some embodiments, in response to user input 562 corresponding to a request to add thumbs up emoji 548 as a wallpaper foreground element for the wallpaper, the appearance of the wallpaper background (e.g., color, brightness, texture, or other visual properties) is automatically, without additional user input, updated (e.g., from the first color that is selected based only on smiley face emoji 550 to a second color that is distinct from the first color, and/or from a first brightness and/or texture to a second brightness and/or texture). In some embodiments, the first appearance is automatically selected based on the smiley face emoji, and the second appearance (e.g., the color, texture, brightness, and/or other visual properties) are automatically selected based at least in part on the newly added thumbs up emoji (e.g., based solely on the thumbs up emoji, or based on a combination of the smiley emoji and the thumbs up emoji). Using color as an example, in some embodiments, the second color used for the wallpaper background of the wallpaper is a color based at least in part on the selected thumbs up emoji 548. For example, thumbs up emoji 548 is optionally associated with the second color, wherein the second color is, in some embodiments, selected based on one or more colors in the thumbs up emoji. For example, the second color is selected to match or compliment one or more colors present in the thumbs up emoji 548. In some embodiments, the second color is based on the last (e.g., most recently) selected emoji (e.g., thumbs up emoji 548) only (e.g., and the second color is not based on previously selected emoji, such as smiley face emoji 550). In some embodiments, the second color is a color that is based at least in part on all of the currently selected emoji that are selected as wallpaper foreground elements (e.g., both smiley face emoji 550 and thumbs up emoji 548). For example, the second color is selected as color that is present in (e.g., or otherwise compliments) both smiley face emoji 550 and thumbs up emoji 548. In some embodiments, the second color is selected as a combination of colors associated with each of the wallpaper foreground elements (e.g., a combination of a color associated with smiley face emoji 550 and a color associated with thumbs up emoji 548). As such, in some embodiments the second color is based on a properties of all of the selected emoji (e.g., smiley face emoji 550 and the thumbs up emoji 548). Analogously, texture, brightness, and other visual properties of the wallpaper background can be automatically updated in accordance with various visual characteristics (e.g., unique characteristics, or shared characteristics) of the newly selected foreground element, and/or the combination of the newly selected and existing foreground elements, to complement and/or contrast the visual characteristics of the newly selected foreground element, and/or the combination of the newly selected and existing foreground elements, in accordance with various embodiments.

FIG. 5G1 further illustrates user input 566 selecting delete button 538 for removing an emoji from box 540 (e.g., and thus excluding the emoji from being included as a wallpaper foreground element in the wallpaper). In some embodiments, box 540 includes emojis that are already included in the wallpaper of the wake screen user interface, both from the current editing session and from previous editing sessions. In some embodiments, the deletion can start from any insertion point between adjacent emoji in box 540. In some embodiments, in response to the user input 566, the thumbs up emoji 548 is removed from box 540 and is removed as a wallpaper foreground element in the wallpaper, as illustrated in editing user interface 569 in FIG. 5G2. In some embodiments, in response to user input 566, the wallpaper background of the wallpaper in editing user interface 569 automatically, without additional user input, reverts to the first color that is selected based on smiley face emoji 550 (e.g., while the smiley face emoji 550 is the only emoji selected in FIG. 5G2). In some embodiments, in response to user input 566, the wallpaper background of the wallpaper in editing user interface 569 automatically, without additional user input, changes to another color, different from the first color and the second color, that is selected based on smiley face emoji 550 (e.g., while the smiley face emoji 550 is the only emoji selected in FIG. 5G2 and the smiley face emoji has multiple associated wallpaper background colors, or while there are other emojis remaining on the wallpaper background (e.g., from the current editing session, and/or from previous editing sessions)).

FIG. 5G2 further illustrates user input 568 selecting plane emoji 552 (e.g., after the thumbs up emoji is deleted and the color of the wallpaper background is updated accordingly). In some embodiments, in response to detecting user input 568 selecting plane emoji 552, plane emoji 552 is displayed in box 540, and is added as a wallpaper foreground element in the wallpaper of the wake screen user interface that is being edited in the editing user interface 571 (e.g., same editing user interface as editing user interface 569, 567, 543, and 531, but with a different appearance for the wallpaper of the currently edited wake screen user interface), as illustrated in FIG. 5H. In some embodiments, in response to user input 568 selecting plane emoji 552, the color (and/or other visual properties) of the wallpaper background of the wallpaper is updated from the first color (and/or first values of other visual properties) (illustrated in FIG. 5G2) to a third color (e.g., that is optionally distinct from the first color and the second color) (and/or third values of other visual properties different from the first values of other visual properties), where the third color (and/or third values of other visual properties) is/are based at least in part on selected plane emoji 552. Using color as an example, in some embodiments, the third color is selected as a color that complements and/or matches colors of smiley face emoji 550 and plane emoji 552, or the third color is based only on the last-selected emoji (e.g., plane emoji 552). In some embodiments, the third color is generated, in real-time, based on an analysis of the colors present in the currently selected emoji. In some embodiments, the third color is assigned (e.g., in a lookup table or otherwise stored in a database) as the wallpaper background color while the combination of plane emoji 552 and smiley face emoji 550 are concurrently selected. For example, a respective emoji is associated with (e.g., assigned to, and/or given a respective affinity score with respect to) a respective color, and/or a respective combination of emoji is associated with another respective color. In some embodiments, the third color is assigned to one of the two emoji (e.g., plane emoji 552) to be used as the wallpaper background color.

In some embodiments, selection of a same emoji, more than one time, to be included in the wallpaper foreground elements concurrently (e.g., if user reselects smiley face emoji 550 after selecting plane emoji 552, such that box 540 includes two smiley face emoji and one plane emoji), causes the color and/or other visual properties (e.g., texture, brightness, or other visual properties) of the wallpaper background of the wallpaper to update based on either (i) only the last-selected emoji (e.g., smiley face emoji 550) or (ii) a combination of all of the selected emoji, optionally with a greater amount of weight given to the emoji selected more than one time (e.g., smiley face emoji 550). Using color as an example of visual properties, while only one smiley face emoji and one plane emoji are selected in box 540, the third color of the wallpaper background is optionally based on a combination of two colors, one from each of the selected emoji, whereas, while two smiley face emoji 550 and one plane emoji 552 are selected, the color of the wallpaper background is optionally updated to a color that complements smiley face emoji 550 (e.g., without regard, or with less regard, to what color complements plane emoji 552).

FIG. 5H illustrates that, after the wallpaper is updated in response to the addition of the plane emoji, user input 570 detected outside of platter 534, optionally directed to an area of the wallpaper that is not occupied by any selectable options displayed in editing user interface 571. In some embodiments, in response to detecting user input 570, platter 534 ceases to be displayed in the editing user interface (e.g., now shown as editing user interface 573, but is the same editing user interface as editing user interface 571, 569, 567, 543, and 531), as illustrated in FIG. 5I.

In some embodiments, as illustrated in FIG. 5I, user input 572 is detected in editing user interface 573. In some embodiments, user input 572 is a swipe gesture in a horizontal direction or other user input for changing a layout (e.g., a pattern of the foreground elements, or other types of layout) of the wallpaper foreground elements displayed in the wallpaper. For example, in response to detecting user input 572, editing user interface 573 is updated from displaying the plurality of instances of smiley face emojis and plurality of instances of plane emojis in a small grid pattern (e.g., as indicated by user interface element 574a) to editing user interface 575, illustrated in FIG. 5J, that displays the plurality of instances of smiley face emojis and the plurality of instances of plane emojis in a spiral pattern (e.g., as indicated by user interface element 574b). In some embodiments, the user is enabled to swipe between, or otherwise change between, a plurality of different layouts (e.g., patterns or other arrangements) for instances of the wallpaper foreground elements (e.g., the instances of emojis, or other graphics or symbols used as the wallpaper foreground elements). For example, pagination dots 576a and 576b illustrate that different layouts (e.g., patterns or other arrangements) are available for the user to select.

FIG. 5J illustrates user input 578 corresponding to a swipe gesture (e.g., optionally in a direction opposite or substantially opposite of user input 572), and in response to detecting user input 578, the editing user interface is updated to show the last displayed face configuration for the wake screen user interface (e.g., shown as editing user interface 577 which has the same selection of emojis and emoji layout as editing user interface 573 in FIG. 5K), including redisplaying the plurality of instances of smiley face emojis and the plurality of instances of plane emojis in a small grid pattern, as illustrated in FIG. 5K.

In some embodiments, editing user interface 577 includes emoji button 584 that, when selected, causes device 100 to display the emoji platter (e.g., platter 534, or another selection interface for symbols and graphics to use as wallpaper foreground elements) for the user to select (e.g., modify and/or delete) emojis to be used as wallpaper foreground elements for the currently edited wallpaper. In some embodiments, editing user interface 577 includes wallpaper background button 580 that, when selected, displays a wallpaper background platter for the user to select and/or modify one or more properties of the wallpaper background (e.g., change a color, a pattern, texture, gradient, a respective combination of visual properties, filter, or other visual properties). For example, in response to user input 582 selecting wallpaper background button 580, the device displays wallpaper background platter 586 (or another configuration user interface for selection and/or modifying one or more properties of the wallpaper background) in editing user interface 579, as shown in FIG. 5L, where the wallpaper background platter 586 includes a plurality of selectable color options 590 (e.g., including color option 590a, color option 590b, color option 590c, and other color options) to use as the color of the wallpaper background. As described herein, color is used as a representative example of the visual properties of the wallpaper background that can be adjusted in the editing user interface. Other similar platters and/or controls can be implemented to adjust other visual properties of the wallpaper background in an analogous manner, in accordance with various embodiments. In some embodiments, for example, color option 590a corresponds to an automatically selected color of the wallpaper background (e.g., selected based on one or more of the emojis used as wallpaper foreground elements in the wallpaper, as described above). In some embodiments, color option 590a corresponds to a color that is automatically selected based on the one or more wallpaper foreground elements. Thus, color option 590a is automatically updated in response to the user selecting one or more different wallpaper foreground elements. In some embodiments, color option 590a is displayed as a representation of a plurality of colors (e.g., a multicolor or rainbow gradient) to indicate that color option 590a is dynamically updated (e.g., as opposed to assigned to a single color). In some embodiments, an indication, such as an outline, highlight, a glow, or other visual indication is provided on color option 590a to indicate that it is the currently selected color option.

FIG. 5L illustrates that, in some embodiments, the user is enabled to select a color, other than the automatically selected color option 590a, to use as the wallpaper background color of the wallpaper. For example, in response to user input 588 selecting color option 590c, the wallpaper background of the wallpaper is to be displayed with the color corresponding to color option 590c, as illustrated in editing user interface 581 in FIG. 5M. For example, color option 590c is displayed with an outline to illustrate that the color corresponding to color option 590c is currently selected as the wallpaper background color for the wallpaper. In some embodiments, the user is enabled to reselect the automatic color option 590a, such that the color of the wallpaper background continues to be automatically updated in accordance with the currently selected emoji as wallpaper foreground elements. In some embodiments, in response to a user selection of a respective color for a currently selected collection of emojis (optionally, as a final selection for a current editing session), the respective color is added to the set of colors that are associated with the currently selected collection of emojis, such that they are available to be automatically selected for the currently selected collection of emojis (e.g., either individually or as a group) if option 590a is selected.

FIG. 5M illustrates user input 592 selecting done button 544 after the color option 590c is selected. In some embodiments, in response to user input 592, device 100 ceases display of editing user interface 581 and displays wake screen user interface 583 (e.g., same wake screen user interface as shown in other figures, but with an updated wallpaper), as illustrated in FIG. 5N. The wake screen user interface 583 has a wallpaper that has been reconfigured (e.g., as compared to that shown in FIG. 5A and FIG. 5F) using the editing user interface (e.g., the editing user interface shown in FIGS. 5B-5E and FIGS. 5G1-5M).

FIGS. 5N-5O1 illustrate device 100 rotated from a first orientation (e.g., a landscape orientation, or another first canonical orientation associated with the device), illustrated in FIG. 5N, to a second orientation (e.g., a portrait orientation, or another second canonical orientation associated with the device), illustrated in FIG. 501, in accordance with some embodiments. In some embodiments, in response to determining that device 100 is in the second orientation (or that the amount of rotation and/or final orientation of the device meet interface rotation criteria), the user interface 585 (e.g., a version of the wake screen user interface corresponding to the first orientation of the device) updates to the wake screen user interface 589 (e.g., another version of the wake screen user interface corresponding to the second orientation of the device), as shown in FIG. 5P. In some embodiments, the change in orientation of the user interface (e.g., the wake screen user interface, the home screen user interface, or another currently displayed system user interface) includes displaying an animation for rotating user interface elements (e.g., the time and/or date indication and optionally one or more widgets) and/or rotating instances of wallpaper foreground elements on the wallpaper. For example, each instance of an emoji is displayed as rotating, in place, from the first orientation to the second orientation, as illustrated in FIGS. 501-502, without changing a position of the instance of the emoji. For example, smiley face emoji instance 550-a remains at a same position on the display but is displayed as gradually, over time, rotating, while plane emoji instance 550-b remains at a same position on the display but is displayed as gradually, over time, rotating. In some embodiments, smiley face emoji instance 550-c also remains at its same relative position while rotating, as illustrated in FIG. 502.

In some embodiments, the instances of emoji that are displayed as wallpaper foreground elements that are within the display area of the display in the first orientation and remain within the display area of the display in the second orientation continue to be displayed, and any additional instances of emoji that are displayed on the display in the second orientation but not on the display in the first orientation (e.g., or vice-versa) appear at their respective positions within the display area during the animation (e.g., during rotation of the device, the display, and the wake screen user interface (e.g., the wallpaper background, the time elements, and/or widgets)). For example, the instances of emoji in the corners of the display area of device 100 are displayed (e.g., as if the wallpaper is expanding or has additional regions that were not previously visible and that has now been revealed) during the transition between the first orientation and the second orientation, such that instances of emoji in the corners of the display area instantaneously appear according to the pattern of the wallpaper foreground elements. As such, the during the animated transition, display of blank areas of the wallpaper (e.g., areas that do not include wallpaper foreground elements and/or wallpaper background) is prevented.

In FIG. 5O1, device 100 is shown in the second orientation (e.g., portrait orientation, or another second canonical orientation of the device), in some embodiments, and the animation for rotating the emojis displayed in the wake screen user interface is initiated in response to detecting that the device 100 has satisfied the interface rotation criteria. For example, the interface rotation criteria include criteria that are met when the device 100 has been rotated by at least a threshold amount relative to the first orientation (e.g., landscape orientation, or another first canonical orientation of the device) and/or when device 100 (e.g., the display, touch-screen display, or other display generation component of device 100) is rotated with at least a threshold rate of rotational movement. In some embodiments, the interface rotation criteria include criteria that are met when the device has been rotated by the threshold angle that is less than 90 degrees (e.g., while the device is rotated between the first orientation and second orientation before the device is in the second orientation). For example, the animation described with reference to FIGS. 501-502 is optionally initiated in response to detecting that device 100 is rotated by the threshold angle (e.g., and/or meets other interface rotation criteria) but not yet in the second orientation.

FIG. 5P illustrates wake screen user interface 589 (e.g., same wake screen (e.g., same wallpaper, same wallpaper foreground elements and wallpaper background, and/or same wallpaper layout), but with a different orientation (and optionally, different sets of widgets) from those shown in FIGS. 5A, 5F, and 5N) while device 100 is in the second orientation, after the rotation from the orientation shown in FIG. 5N. In some embodiments, wake screen user interface 589 includes a plurality of widgets, including widget 594 and widget 595. In some embodiments, as described with reference to FIGS. 7A-7Z, widgets 502, 504, 506, 508, and 510 displayed in wake screen user interface 583 (FIG. 5N) while device 100 is in the first orientation are distinct from widget 594 and widget 595 displayed in the wake screen user interface 589 while device 100 is in the second orientation. In some embodiments, a same wallpaper (e.g., emojis overlaid on a wallpaper background color) is maintained after the device 100 rotates from the first orientation in FIG. 5N to the second orientation in FIG. 5P.

FIGS. 5P-5Q illustrate that, in response to detecting user input 596 (e.g., a touch and hold input on the wallpaper, or another type of user input) corresponding to a request to display an editing user interface for the currently displayed wake screen user interface, as illustrated in FIG. 5P, the device displays editing user interface 591 for wake screen user interface 589 while device 100 is in the second orientation, as illustrated in FIG. 5Q. In some embodiments, editing user interface 591 includes one or more of the features described with reference to editing user interface 531 (FIG. 5D), such as emoji platter 5006 (e.g., identical or analogous to emoji platter 534) and box 5004 (e.g., identical or analogous to box 540). In some embodiments, editing user interface 591 includes different features than editing user interface 531 (e.g., as an example of an editing user interface that is shown while the device is in the first orientation). For example, the widgets area in which the one or more widgets are displayed is at a different position and/or is displayed with a different size relative to the time element while the device is in the first orientation as compared to the widgets area that is displayed in the second orientation, as described with reference to FIGS. 7L and 7M1, below.

FIG. 5Q further illustrates user input 598 selecting rocket emoji 554 (e.g., using the same emoji selection platter described earlier with respect to FIGS. 5D-5E and 5G1-5H, or using a different emoji selection user interface element) in editing user interface 591, and in response to detecting user input 598, rocket emoji 554 is added to box 5004 (e.g., box 5004 is analogous to box 540 described earlier, and includes the currently selected group of emojis for the wallpaper of the currently edited user interface) and is included as a wallpaper foreground element of the wallpaper of the currently edited user interface shown in editing user interface 593, as shown in FIG. 5R. In some embodiments, in response to user input 598, a wallpaper background color of the wallpaper is automatically updated to a fourth color that is optionally selected based at least in part on rocket emoji 554 (e.g., the fourth color is selected to complement or match one or more colors of rocket emoji 554), as shown in FIG. 5R.

In some embodiments, in response to detecting user input 5012 on done button 5010, as shown in FIG. 5R, editing user interface 593 ceases to be displayed and wake screen user interface 597 is displayed, as configured in editing user interface 593, as illustrated in FIG. 5S. In some embodiments, if a user input is detected on cancel button 5008, as shown in FIG. 5R, editing user interface 593 would cease to be displayed and wake screen user interface 589 would be displayed, as the new configuration inputs made in editing user interface 593 would be discarded.

Although the above example describes the configuration process for configuring a wake screen user interface of the device, and various aspects of the editing user interface and how the foreground elements of the wallpaper and the wallpaper background can be configured may also apply to the configuration of other system user interfaces, such as the home screen user interface, the notification user interface, the widget user interface, and/or the control user interface of the device, using similar or the same editing user interface. In some embodiments, the editing user interface displays a preview of how the currently edited user interface would look in the background of the editing user interface (e.g., a view of the currently edited user interface, or a view of the wallpaper of the currently edited user interface remains visible during the editing process behind the user interface elements of the editing user interface) as new configuration options are selected and/or the currently selected configuration options are changed using the editing user interface. In some embodiments, other ways of displaying a preview of the currently edited user interface in the editing user interface may be used (e.g., displaying a reduced version of the currently edited user interface in the editing user interface to show how the change in configuration may affect the appearance of the currently edited user interface). More details of editing a user interface are provided below with respect to FIGS. 6A-6V and FIGS. 7A-7Z.

FIG. 6A illustrates a wake screen user interface 601 displayed with a first wallpaper. In some embodiments, wake screen user interface 601 includes time indication 604, a date indication, and optionally one or more widgets, such as calendar widget 606, activity widget 608 and news widget 610. In some embodiments, the first wallpaper includes an image of a solar system diagram that includes a plurality of planetary bodies 602 (e.g., including planets 602a-602f and/or star 602g (e.g., the Sun, or another star)). For example, the first wallpaper includes wallpaper foreground elements (e.g., planetary bodies, or other wallpaper foreground elements that corresponds to a respective theme or category) overlaid on a wallpaper background (e.g., a representation of space, night sky, or a view of another environment for the foreground elements). In some embodiments, the plurality of planets are selectable wallpaper foreground elements that, when selected, cause device 100 to update the wallpaper of the user interface from the first wallpaper to a second wallpaper that displays an image of the selected wallpaper foreground element (e.g., selected planet, optionally as an enlarged version of the selected element), as described below with reference to FIG. 6E. As described herein, the planets are used as illustrative examples for a group of wallpaper foreground elements. Other analogous examples include a group of movie characters, a group of galaxies, a group of landmarks in a country, a group of animals, and other similar groups of objects. As described herein, the wake screen user interface is used as an illustrative example as a user interface or a system user interface that includes an editable wallpaper that feature one or more foreground elements on a wallpaper background. Other analogous examples include a home screen user interface with application icons overlaying a wallpaper, a widget screen with widgets overlaying a wallpaper, a notification user interface with notifications overlaying a wallpaper, a control user interface with control affordances for device functions overlaying a wallpaper, in accordance with various embodiments.

Continuing with the example of the wake screen user interface 601 with the plurality of planetary bodies 602 as wallpaper foreground elements overlaying a wallpaper background of space (e.g., represented with spatial qualities of space and optionally rendering a starry environment surrounding the planetary bodies), in some embodiments, the plurality of planetary bodies 602 are arranged in a solar system diagram in the first wallpaper in accordance with a current time of day and/or a current date. For example, the respective positions of the planetary bodies 602 are updated, in real-time or substantial real-time, based on the actual positions of the planetary bodies 602 in space at the current date and/or time. As such, the planetary bodies 602 appear to move along their respective orbits (e.g., around the Sun (e.g., star 602g)) in the solar system diagram shown in the first wallpaper over time, in accordance with some embodiments.

FIG. 6A illustrates detecting user input 612 selecting planet 602a from the plurality of selectable planets displayed in the first wallpaper. In some embodiments, in response to detecting user input 612, device 100 initiates an animated transition from displaying the solar system diagram in user interface 601 to displaying an enlarged version of selected planet 602a in wake scree user interface 609 in FIG. 6E (e.g., same wake screen user interface as wake screen user interface 6A, but the wallpaper shows a different foreground element as a result of user input 612). For example, in FIG. 6B, as part of the animated transition, wake screen user interface 603 displays the solar system diagram increasing in size (e.g., as if moving closer toward the user, or the viewpoint of the user is flying toward the selected element) and/or shifting to bring selected planet 602a closer to the center of the display area of device 100.

FIG. 6C illustrates wake screen user interface 605 as the animated transition continues. In some embodiments, the animated transition comprises a travel animation that shifts the solar system diagram in a manner such that the viewpoint of the user is traveling towards the selected planet 602a. For example, in FIG. 6C, the planetary bodies 602 continue to increase in size during the animation, which continues to update, as illustrated in FIG. 6D, by changing a viewpoint from which the planets are portrayed (e.g., from a top view of the solar system to a side view along the orbit path of planet 602a), as illustrated in wake screen user interface 607. It will be understood that the example animation described with reference to FIGS. 6A-6E comprises a continuous animation that gradually, over time, updates the appearance of the wallpaper of the wake scree user interface. In some embodiments, the animation completes within 2 seconds, 5 seconds, or another amount of time (e.g., the animation quickly transitions between FIG. 6A and FIG. 6E) that simulates movement through space at warp speeds.

FIG. 6E illustrates wake screen user interface 609, including displaying a second wallpaper that displays an enlarged version of the selected planet 602a. In some embodiments, the widgets included on the wake screen user interface (e.g., widgets 606, 608, and 610 shown in wake screen user interface 601 in FIG. 6A) are optionally not displayed in wake screen user interface 609. In some embodiments, the widgets included on the wake screen user interface (e.g., widgets 606, 608, and 610 shown in wake screen user interface 601 in FIG. 6A) optionally continue to be displayed in wake screen user interface 609 (e.g., and are optionally also displayed during the animated transition described with reference to FIGS. 6B-6D). In some embodiments, the enlarged version of planet 602a partially occludes the time indication 604, such that a portion of the time indication 604 is covered by a portion of planet 602a, in wake screen user interface 609. As described in more detail with reference to FIG. 7L, in some embodiments, partial occlusion of time indication 604 is displayed while the device 100 is in a first orientation (e.g., a landscape orientation, or another first canonical orientation associated with the device) regardless of whether the wake screen user interface includes widgets, and partial occlusion of time indication 604 is displayed while the device 100 is in a second orientation (e.g., a portrait orientation, or another second canonical orientation associated with the device) if there are no widgets displayed below the time indication 604. For example, if widgets are displayed in the wake screen user interface while device 100 is in the second orientation, time indication 604 is not occluded and the enlarged version of planet 602a (e.g., or another wallpaper foreground element of the wallpaper that partially occludes the time indication in the first orientation) is displayed behind the time indication and the widgets.

In some embodiments, wake screen user interface 609 includes one or more different wallpaper foreground elements than wake screen user interface 601, optionally while maintaining a same wallpaper background. For example, the wallpaper of wake screen user interface 601 includes the plurality of planetary bodies 602 as wallpaper foreground elements and displays a representation of space (e.g., a black or dark area, optionally with stars distributed within space) as the wallpaper background, and the second wallpaper of wake screen user interface 609 includes a different wallpaper foreground element (e.g., only one planet of the plurality of planetary bodies 602 without the other planets) while maintaining the wallpaper background as the representation of space. As such, during the animation and after the transition from wake screen user interface 601 to wake screen user interface 609, the wallpaper background is maintained while updating the wallpaper foreground elements. In some embodiments, different portions of the wallpaper background are shown in the wallpaper of the wake screen user interface during the transition between wake screen user interface 601 and wake screen user interface 609. For example, a portion of space closer to the selected planet 602a is shown in the wallpaper background in wake screen user interface 609, while a portion of space surrounding the plurality of planets 602 as a whole is shown in the wallpaper background in wake screen user interface 601, in accordance with some embodiments.

FIG. 6E further illustrates detecting user input 614 corresponding to a request to dismiss the wake screen user interface 609 (e.g., detecting an upward swipe gesture that starts from a bottom edge of wakes screen user interface 609, or another type of user input that meets dismissal criteria). In some embodiments, in response to detecting user input 614, device 100 ceases display of wake screen user interface 609 and displays wake screen user interface 611 (e.g., redisplays wake screen user interface 601), which includes the plurality of planets 602 in the first wallpaper, and the one or more widgets 606, 608, and 610, and the time indication 604 overlaying the first wallpaper, as illustrated in FIG. 6F. In some embodiments, device 100 detects user input 616 selecting another planet, planet 602e, in the first wallpaper of wake screen user interface 611, and in response to detecting user input 616, device 100 displays an animated transition, illustrated in FIGS. 6G-6H similar to the animated transition described with reference to FIGS. 6B-6D, for example, to display an animation of the user traveling toward selected planet 602e.

In some embodiments, at the end of the animated transition shown in FIGS. 6G-6H, an enlarged version of planet 602e is displayed in wake screen user interface 617, as illustrated in FIG. 6I. Wake screen user interface 617 shown in FIG. 6I has features analogous to those described with respect to wake screen user interface 609 shown in FIG. 6E, except that different selected planets are shown as the wallpaper foreground elements of the wallpaper of the wake screen user interface. FIG. 61 further illustrates detecting user input 618 corresponding to a request to dismiss wake screen user interface 617 (e.g., an upward swipe gesture that starts from a bottom edge of wake screen user interface 617, or another type of input that meets dismissal criteria). In some embodiments, in response to detecting user input 618, device 100 ceases display of wake screen user interface 617 and displays wake screen user interface 619 (e.g., redisplays wake screen user interface 601), as illustrated in FIG. 6J.

In some embodiments, as illustrated in FIGS. 6A-6F, when a system user interface includes a wallpaper that displays a group of wallpaper foreground elements overlaying a wallpaper background (e.g., as illustrated by the wake screen user interface (e.g., labeled as wake screen user interface 601, 611, and 619) that includes a wallpaper showing a plurality of planets 602 overlaying a representation of space), user selection of a respective wallpaper foreground element from the wallpaper of the wake screen user interface, causes the device to temporarily display a different wallpaper for the wake screen user interface that features the selected foreground element without the other unselected foreground elements from the group of wallpaper foreground elements. In some embodiments, the wake screen user interface showing the selected foreground element in the wallpaper does not provide the same function as the wake screen user interface showing the whole ground of foreground elements in the wallpaper (e.g., the dismissal gesture does not cause navigation to the home screen user interface or the last displayed application user interface, and the widgets are not displayed in the wake screen user interface). Instead, the selection of the foreground element from the group of foreground elements in the wallpaper provides the user an opportunity to see a more detailed view of the selected foreground element, without persistently modify the wallpaper of the wake screen user interface. When the detailed view of the selected foreground element is dismissed via a dismissal input on the wake screen user interface, the original view of the wake screen user interface with the whole ground of wallpaper foreground elements in the wallpaper, is restored.

FIG. 6J illustrates a plurality of user inputs that may be detected while displaying wake screen user interface 619 to illustrate various ways that a user can interact with the wake screen user interface, in accordance with some embodiments.

In some embodiments, user input 624 (e.g., a swipe user input in a horizontal direction or another type of navigation input) corresponds to a request to open a camera application, and in response to detecting user input 624, the device 100 displays a user interface that includes a camera view such that the user is enabled to capture images using one or more cameras of device 100.

In some embodiments, user input 620 corresponds to a selection of news widget 610 (e.g., a tap input directed to news widget 610, or another type of selection input), and in response to detecting user input 620, a user interface for the application associated with news widget 610 (e.g., a news application, or another type of app that provides news content) is displayed at device 100 (e.g., replacing display of wake screen user interface 619, or another system user interface displaying the news widget 610). In some embodiments, selection of a different respective widget causes the device 100 to display a user interface for the respective application associated with the respective widget (e.g., replacing display of the wake screen user interface 619, or another system user interface displaying the respective widget). In some embodiments, before displaying the user interface for an application (e.g., a camera application, a news application, and/or another application), the device 100 optionally requires user authentication to unlock the device 100 before providing the user with access to the application.

In some embodiments, user input 626 is detected in user interface 619. In some embodiments, user input 626 corresponds to a request to dismiss the currently displayed user interface (e.g., wake screen user interface 619, or another system user interface other than the home screen user interface) (e.g., to dismiss the wake screen user interface and to display a home screen user interface, or a last displayed application user interface). For example, user input 626 corresponds to a swipe gesture in a respective direction (e.g., an upward swipe that starts from a bottom edge of the currently displayed user interface, or another type of dismissal input) that satisfies dismissal criteria for dismissing the currently dismissed user interface (e.g., wake screen user interface 619, or another currently displayed user interface other than the home screen user interface). In some embodiments, in response to detecting user input 626, device 100 ceases display of the wake screen user interface 619 and displays home screen user interface 621, as illustrated in FIG. 6K.

In some embodiments, as shown in FIG. 6K, home screen user interface 621 is displayed with a wallpaper that matches the wallpaper of wake screen user interface 619 in one or more aspects. In some embodiments, the wallpaper of home screen user interface 621 the same as the wallpaper of wake screen user interface 619. In some embodiments, the wallpaper of home screen user interface 621 is a modified version of the wallpaper of wake screen user interface 619. For example, the wallpaper of home screen user interface 621 includes a blurred or otherwise visually deemphasized version of the wallpaper of wake screen user interface 619, in some embodiments. In some embodiments, the wallpaper of home screen user interface 621 is configurable by the user of device 100. In some embodiments, the wallpaper of the wake screen user interface and the wallpaper of the home screen user interface are independently configurable by the user. For example, the user is enabled to select a wallpaper to be used as the wallpaper of home screen user interface 621 and is also enabled to select the same wallpaper or a different wallpaper to be used as the wallpaper of the wake screen user interface, in accordance with some embodiments.

FIG. 6J further illustrates user input 622 detected in wake screen user interface 619 corresponding to a request to modify, or configure, wake screen user interface 619. For example, user input 622 is a press and hold user input (e.g., that is held for a threshold amount of time) on a region of the wallpaper background that is not occupied by another selectable user interface element (e.g., widgets, notifications, shortcuts, and/or selectable wallpaper foreground elements), or another type of input satisfies enhanced selection criteria for displaying editing user interface 623 (e.g., also referred to herein as a configuration user interface), illustrated in FIG. 6L. For example, in some embodiments, editing user interface 623 includes a view of the wallpaper of wake screen user interface 619 that is being edited, including the wallpaper foreground elements (e.g., the plurality of planets or other wallpaper foreground elements) and the wallpaper background (e.g., the representation of space surrounding the plurality of planets, or another wallpaper background). In some embodiments, editing user interface 623 includes a plurality of labels for the plurality of wallpaper foreground elements, such as the labels for the planets in the wallpaper. For example, label 628 “Saturn” is displayed proximate to planet 602a corresponding to Saturn in the view of the wake screen user interface shown in the editing user interface 632. In some embodiments, the plurality of labels for the plurality of planets automatically, without user input, fade or otherwise are visually deemphasized over time (e.g., as the user continues to make changes to the wake screen user interface in editing user interface 623). For example, in FIG. 6M, the plurality of labels ceases to be displayed (e.g., optionally until the plurality of labels are redisplayed in response to a user input directed to the view of the wake screen user interface in editing user interface 623).

In some embodiments, editing user interface 623 includes the widgets of wake screen user interface 619, including calendar widget 606, activity widget 608, and news widget 610, in the view of the wake screen user interface 619. In some embodiments, the widgets displayed in editing user interface 623 are displayed in a widgets area. In some embodiments, the widgets area has a first size and is displayed at a first position relative to the wake screen user interface (e.g., at a position along the left edge, or at another position) of the display) while device 100 is in the first orientation (e.g., landscape orientation, or another first canonical orientation of the device). In some embodiments, the user is enabled to add, remove and/or modify the widgets displayed in the widgets area. In some embodiments, widgets are optionally confined within the widgets area (e.g., widgets cannot be placed outside of the widgets area) in the wake screen user interface. In some embodiments, the widgets are positioned freely within the widgets area, and may be separately by an arbitrary amount of spacing chosen by a user that repositions the widget(s) by dragging and dropping them around within the widgets area.

In some embodiments, in response to detecting user input 630 directed to the widgets area (e.g., a tap input or another type of selection input) while widgets area is displayed in editing user interface 623, as illustrated in FIG. 6L, widgets platter 634 is displayed in the editing user interface (now labeled as editing user interface 625), as illustrated in FIG. 6M. In some embodiments, widgets platter 634 provides a plurality of selectable widgets, such as widget 636a, widget 636b and widget 636c that the user is enabled to select to add to the widgets area. In some embodiments, in response to user input 638 selecting widget 636b from widget platter 634, an instance of widget 636b is added to the widgets area, as illustrated by widget 640 that is newly added to the widgets area in FIG. 6N. In some embodiments, widgets that are added to the widgets area are optionally automatically placed in the widgets area in an open placement location in accordance with one or more arrangement criteria (e.g., from left-to-right or right-to-left, and/or from top-to-bottom or bottom-to-top), as described in more detail with reference to FIG. 7C. In some embodiments, the user is enabled to place a newly selected widget directly at a respective position in the widgets area by dragging a copy of the widget from the widget platter and dropping the widget at the respective position in the widgets area.

In some embodiments, as shown in FIG. 6M, device 100 detects user input 632 that corresponds to a request to redisplay the labels of the plurality of wallpaper foreground elements that have ceased to be displayed over time. In some embodiments, user input 632 is a tap input or another type of selection input that is detected at an area of the editing user interface 625 that corresponds to negative space of the wallpaper background (e.g., portions of the wallpaper background that does not correspond to a wallpaper foreground element or to another interactive portion of the editing user interface 625, such as the widgets area or the time indication). In some embodiments, in response to detecting user input 632 and in accordance with a determination that user input 632 is detected in the negative space of the wallpaper background shown in editing user interface 625, device 100 redisplays the plurality of labels for the plurality of planets, as illustrated in FIG. 6N. In some embodiments, in response to user input 632, device 100 optionally ceases display of widgets platter 634, as illustrated in editing user interface 627 in FIG. 6N.

FIG. 6N illustrates that, while displaying the editing user interface 627, the device detects user input 646, such as a swipe user input in a horizontal direction or another type of navigation input, corresponding to a request to change the wallpaper in editing user interface 627 from the first wallpaper to a second wallpaper different from the first wallpaper. For example, in response to detecting user input 646 (and/or user input 650), device 100 displays editing user interface 629 (and/or editing user interface 631) that includes a view of the wake screen user interface with a different wallpaper. In some embodiments, the user is enabled to scroll, or otherwise navigate, through a plurality of wallpaper options, as indicated by pagination dots 648a indicating additional wallpapers that are available (e.g., and as the user scrolls, the pagination dots 648a are updated to pagination dots 648b). In some embodiments, the plurality of wallpaper options that are provided relate to a common theme or subject matter, e.g., astronomy, solar system, and/or planets. For example, the wallpaper options include a solar system wallpaper (e.g., illustrated in FIG. 6N), and/or one or more wallpapers with enlarged versions of planets (e.g., or moons, or the Sun, or other planetary bodies), such as the Earth illustrated in the wallpaper of wake screen user interface 629 (as shown in FIG. 6O) and Saturn illustrated in the wallpaper of wake screen user interface 631 (as shown in FIG. 6P).

FIG. 6P illustrates detecting user input 654 (e.g., a tap user input or another type of selection input) selecting done button 652 in editing user interface 631. In some embodiments, in response to detecting user input 654, the wallpaper displayed in editing user interface 631 is assigned as the wallpaper for the currently edited system user interface (e.g., started as wake screen user interface 619 in FIG. 6J, and ended as wake screen user interface 633 in FIG. 6Q). As such, the user is enabled to select and configure the wallpaper, widgets, and/or time indication in editing user interface 631 before setting the configured wallpaper, widgets and/or time indication in the wake screen user interface.

FIG. 6Q illustrates that, while displaying the wake screen user interface (e.g., wake screen user interface 633, or wake screen user interface of another configuration), the device detects user input 656 corresponding to a request to dismiss the wake screen user interface (e.g., an upward swipe gesture that starts from the bottom edge of the wake screen user interface, or another type of input that meets dismissal criteria). In some embodiments, in response to detecting user input 656, device 100 ceases display of the wake screen user interface and displays the home screen user interface (e.g., home screen user interface 635, or the home screen user interface with another configuration), as illustrated in FIG. 6R. In some embodiments, for example, the wallpaper of the home screen user interface 635 is automatically set to a zoomed in version of the planet that is selected as the wallpaper foreground element for the wallpaper of wake screen user interface 633. In a more specific example, the user configures the wallpaper of wake screen user interface 633 to include the planet Saturn as the wallpaper foreground element, and in accordance with the user's configuration of the wallpaper of wake screen user interface 633, the wallpaper of home screen user interface 635 that is displayed in response to a request to dismiss wake screen user interface 633 includes a zoomed in (e.g., enlarged, visually emphasized, or otherwise modified (e.g., blurred or visually deemphasized)) version of the planet Saturn as the wallpaper foreground element. Similarly, if the user assigns the wake screen user interface to have a wallpaper that includes the planet Earth, the home screen user interface that is displayed in response to a request to dismiss the wake screen user interface includes a zoomed-in (e.g., enlarged, visually emphasized, or otherwise modified (e.g., blurred or visually deemphasized)) version of the planet Earth as the wallpaper foreground element.

FIG. 6N illustrates user input 644 selecting button 642 in editing user interface 627 that corresponds to an option to automatically rotate through individual planets of the plurality of planets as the currently used wallpaper foreground element of the wallpaper of the currently edited user interface (e.g., the wake screen user interface, or another system user interface). For example, after detecting user input 644 selecting button 642, and the user concluding the editing session by selecting the done button 652 in the editing user interface (e.g., editing user interface 627 in FIG. 6N, or editing user interface showing other wallpaper foreground elements (e.g., other selected planets, or the solar system)), the wake screen user interface is redisplayed, as illustrated in FIG. 6S (e.g., initially with planet 602c-1 as the wallpaper foreground element in the wallpaper), and where the wallpaper of the wake screen user interface is automatically updated over time (e.g., with elapsed time, with reinvocation of the wake screen user interface at a different time, and/or in accordance with other switching conditions being met) to display a wallpaper with different planets selected from the plurality of planets as the currently used foreground wallpaper element in the wallpaper, as described with reference to FIGS. 6S-6V.

In some embodiments, as shown in FIG. 6S, wake screen user interface 637 is displayed with widgets 606, 608, 610 and 640 overlaid on a wallpaper that includes the planet Earth 602c-1 as the wallpaper foreground element (e.g., and the wallpaper background is a representation of space, such as a black or dark wallpaper background optionally including stars distributed within the representation of space). In some embodiments, while device 100 is in the first orientation (e.g., landscape orientation, or another first canonical orientation of the device), the widgets 606, 608, 610 and 640 are concurrently displayed with the wallpaper foreground element (e.g., planet Earth 602c-1) partially occluding time indication 604. For example, in accordance with a determination that the wake screen user interface is displayed in a first orientation that corresponds to the first orientation of the device, the wallpaper foreground element is placed in a display layer that is closer to the viewer than the widgets and the time indication in the wake screen user interface, in accordance with some embodiments.

In some embodiments, device 100 is rotated from the first orientation (e.g., landscape orientation) to a second orientation (e.g., portrait orientation, or another second canonical orientation of the device), as illustrated in FIG. 6T. In some embodiments, the appearance of the wallpaper is maintained (e.g., including maintaining the wallpaper foreground element of planet Earth 602c-2 (e.g., optionally a different version and/or size of planet Earth 602c-2 as compared to in the first orientation) and maintaining the wallpaper background of space). In some embodiments, at least one widget from the set of widgets 606, 608, 610 and 640 that are displayed in wake screen user interface 637 are automatically displayed in wake screen user interface 639 (FIG. 6T). For example, a subset of the set of widgets is automatically selected (e.g., the top-most widget(s) and/or the left-most widget(s)) from wake screen user interface 637 and are displayed in wake screen user interface 639 while the device is in the second orientation (e.g., without requiring the user to independently configure wake screen user interface 639 in the second orientation). For example, widget 606b in wake screen user interface 639 corresponds to widget 606 in wake screen user interface 637, widget 608b in wake screen user interface 639 corresponds to widget 608 in wake screen user interface 637, and widget 610b in wake screen user interface 639 corresponds to widget 610 in wake screen user interface 637. In some embodiments, the widgets displayed in wake screen user interface 639 while the device is in the second orientation are displayed below time indication 604 in the wake screen user interface. In some embodiments, while widgets 606b, 608b and 610b are displayed below time indication 604 in wake screen user interface 639, the wallpaper foreground element (e.g., planet Earth 602c-2, or another currently used wallpaper foreground element) does not occlude time indication 604. Instead, in some embodiments, the wallpaper foreground element appears behind the widgets and/or time indication in wake screen user interface 639 while the device is in the second orientation. In some embodiments, if no widgets are displayed in wake screen user interface 639 while device 100 is in the second orientation, the wallpaper foreground element partially occludes the time indication 604.

FIG. 6U illustrates that, over time (e.g., at certain time intervals, such as every 1-minute, 2-minutes, 5-minutes, 10-minutes, or another time interval), the wallpaper foreground element of the wake screen user interface is automatically updated to display a different planet (e.g., one planet at a time) (optionally, irrespective of the orientation of the wake screen user interface), as the foreground element of the wallpaper. For example, in FIG. 6U, the planet earth 602c-2 illustrated in FIG. 6T is automatically, without user input, replaced (e.g., after 5-minutes or another time interval) with the planet Saturn 602a-1 in user interface 641. In some embodiments, the device 100 continues to rotate through the different planets (e.g., including displaying planet 602e-1 after another 5-minute interval has passed), as illustrated in wake screen user interface 643 in FIG. 6V.

In some embodiments, the wallpaper foreground element of the wake screen user interface is automatically updated after detecting an interaction with the device. For example, in some embodiments, after device 100 has entered a sleep mode and/or low power mode in which the wake screen user interface ceases to be displayed or is displayed in a dimmed, always on state, upon exiting the sleep mode and/or low power mode (e.g., in response to a raise to wake input, an input on the touch screen, an input on a button of device 100, or another input), the wallpaper foreground element that was displayed prior to entering sleep mode and/or low power mode ceases to be displayed and is replaced with another wallpaper foreground element in the wallpaper of the wake screen user interface.

FIG. 7A illustrates a wake screen user interface (e.g., labeled as wake screen user interface 701, but may be the same wake screen user interface described in other portions of the present disclosure, optionally with a different configuration for the widgets, time indication, and/or wallpaper). In some embodiments, wake screen user interface 701 is displayed with a wallpaper that includes a wallpaper background and one or more wallpaper foreground elements (e.g., a representation of a dog and/or sun 702). In some embodiments, a portion of the one or more foreground elements at least partially occludes time indication 704 (e.g., a portion of sun 702 at least partially occludes time indication 704) in wake screen user interface (optionally, in accordance with a determination that the device is currently in a first orientation (e.g., landscape orientation, or another first canonical orientation of the device)).

In some embodiments, device 100 (e.g., the touch-screen display of device 100, or other display generation component of the device) is situated in a first orientation (e.g., a landscape orientation, or another canonical orientation of the device and/or display) in FIG. 7A. In some embodiments, a current orientation of the device 100 is determined using one or more sensors (e.g., accelerometers 168, magnetometer and/or GPS receiver for obtaining information concerning the location and orientation (e.g., portrait or landscape) of device 100). For example, device 100 is determined to be in the first orientation (e.g., a landscape orientation, or another first canonical orientation of the device) in accordance with a determination that a long edge or long axis of the device (e.g., if the device 100 and/or its display has a rectangular shape or oval shape) is substantially parallel to the floor and/or the ground, and/or that the long edges of the device should otherwise be considered as the top and/or bottom edges of the device and/or display (e.g., if the device and/or its display has a rectangular shape). For example, if the user is holding device 100 at a position where one of the long edges is perceived as the bottom edge of the device 100 to the user. In some embodiments, device 100 is determined to be in a second orientation (e.g., a portrait orientation, or another second canonical orientation of the device) in accordance with a determination that a short edge of the device (e.g., if the display of device 100 has a rectangular shape, or oval shape) is relatively parallel to the floor and/or the ground. In some embodiments, the device has a default upright orientation based on the hardware positions relative to the display (e.g., the power button is located at the upper right portion of right side edge, and/or the charging port is located on the bottom edge of the device, when the display is facing toward the user) and the default upright orientation is treated as the first orientation of the device, irrespective of the relative length of the edges of the device (e.g., when the display or the device is a square shape, a polygonal shape, or an oval or circular shape). In some embodiments, an orientation that is rotated from the default upright orientation of the device by approximately 90 degrees about an axis that penetrates perpendicularly through the surface of the display is treated as the second orientation. In some embodiments, as the device 100 changes orientation (e.g., in response to the user rotating or otherwise moving the device 100), the user interface that is displayed at device 100 automatically updates in accordance with the change in orientation of the device, for example, such that the user interface is perceived by the user as right-side-up. In some embodiments, the user interface automatically updates in accordance with a determination that the device 100 has been rotated by at least a threshold amount (e.g., by at least a threshold angle, and/or with at least a threshold rate of change in orientation), even if the device 100 has not been rotated by a full 90 degrees between the two orientations (e.g., so long as device 100 satisfies rotation criteria describe above with reference to FIG. 501.

Although the terms first orientation and second orientation used herein to describe a landscape orientation and a portrait orientation, respectively, these terms are only used to distinguish one orientation from another. For example, a first orientation could be termed a second orientation, and, similarly, a second orientation could be termed a first orientation, without departing from the scope of the various described embodiments.

In some embodiments, in response to detecting user input 706 directed to wake screen user interface 701 displaying with the first orientation, where user input 706 corresponds to a request to configure wake screen user interface 701 (e.g., user input 706 is a touch-hold input on an unoccupied portion of the wallpaper of wake screen user interface 701, or another user input that meets configuration criteria), device 100 displays editing user interface 703, where editing user interface 703 shows various selectable options overlaying a view of wake screen user interface 701 that is being edited, as illustrated in FIG. 7B. In some embodiments, editing user interface 703 includes a selection box 710 for the date indication and/or a selection box 712 for the time indication, wherein a user input on a respective selection box enables the user to modify the date and/or time indication in the wake screen user interface, including changing one or more visual properties (e.g., color, size, font, or other properties) and/or changing the information displayed in the respective selection box (e.g., displaying a widget in selection box 710 and/or changing the date format that is displayed).

In some embodiments, editing user interface 703 includes widgets area 708 that corresponds to an area of the display to which one or more widgets may be added. For example, in response to user input 714 directed to widgets area 708, widgets platter 716 is displayed that includes a plurality of selectable widgets to be added to widgets area 708, as illustrated in FIG. 7C. In some embodiments, widgets platter 716 includes indications of one or more applications associated with respective widgets and/or one or more suggestions of widgets to add to widgets area 708. In some embodiments, a plurality of widget options are provided for a respective application. For example, widgets platter 716 includes a list of one or more applications, including: battery, calendar, clock, and fitness, and a respective application has a corresponding set of one or more widgets listed next to the identifier and/or name of the respective application (e.g., widgets 730c and 730d are associated with the calendar application, and two widgets showing different battery indicators are associated with the battery application). In some embodiments, the list is scrollable such that additional applications, and associated widgets for the applications, are also displayed in widgets platter 716 (e.g., in response to a user input to scroll to the additional applications).

FIG. 7C illustrates multiple user inputs (e.g., tap inputs, or other types of selection inputs) respectively selecting widgets to be added to the widgets area 708, in accordance with some embodiments. For example, user input 718 is a selection input of widget 730a, user input 720 is a selection input of widget 730c, and user input 722 is a selection input of widget 730d.

In some embodiments, in response to a user input selecting a respective widget in widget platter 716, the respective widget is added to widgets area 708. For example, in response to detecting user input 718, widget 728 is added to widgets area 708; in response to detecting user input 720, widget 726 is added to widgets area 708; and/or in response to detecting user input 722, widget 724 is added to widgets area 708. In some embodiments, in accordance with a determination that the user input selecting the respective widget is a tap input, the respective widget is automatically added to a position in the widgets area 708 according to one or more arrangement criteria. In some embodiments, the one or more arrangement criteria cause the device 100 to add a newly added widget to an open position in widgets area 708 at which another widget is not already displayed. For example, newly added widgets are added to open areas within widgets area 708 in an order that they have been selected from the widget platter. In some embodiments, the one or more arrangement criteria cause device 100 to add newly added widgets based on a size of the respective widget (e.g., according to where the newly added widget can fit without overlapping and/or moving a widget that is already in widgets area 708). In some embodiments, the one or more arrangement criteria are based at least in part on a language setting for a device. For example, the one or more arrangement criteria cause device 100 to add newly added widgets from left-to-right in the open placement locations of the widget area if the language setting corresponds to a language that reads from left-to-right, while the one or more arrangement criteria cause device 100 to add newly added widgets from right-to-left in the open placement locations of the widget area if the language setting corresponds to a language that reads from right-to-left. In some embodiments, the one or more arrangement criteria cause device 100 to add newly added widgets from top-to-bottom and/or from bottom-to-top (e.g., in the first available open area in widgets area 708 determined from top-to-bottom and/or from bottom-to-top of the widget area).

For example, in FIGS. 7C-7D, the first user input detected by the device 100 corresponds to user input 722 selecting widget 730d, and thus widget 724 is added to the top left of the widgets area 708 (e.g., following the one or more arrangement criteria that add new widgets from left-to-right and top-to-bottom). The second user input, detected after the first user input (e.g., user input 722), corresponds to user input 720 selecting widget 730c, and thus widget 726 is added below widget 724 that was already added to widgets area 708 via user input 722. In some embodiments, the third user input corresponds to user input 718 selecting widget 730a, and thus widget 728 is added to the right of widget 726 in widgets area 708 (e.g., in the first open and/or negative space available in the widgets area 708, determined from left-to-right and top-to-bottom at which widget 728 can fit).

FIG. 7D illustrates user input 732a selecting widget 730e from widget platter 716. In some embodiments, user input 732a is a drag user input, such that user input 732a moves while maintaining contact with the touch screen of device 100, and a representation of widget 734 moves with the detected movement of user input 732b, as illustrated in FIG. 7E. As such, user input 732 (e.g., user input 732a-732b) drags the widget 734 into widgets area 708, as illustrated in FIG. 7F, and widget 734 is positioned in widgets area 708 at a position that corresponds to an end of user input 732 (e.g., at a liftoff position of the user input, or another indication of termination (e.g., a press, a release, and/or a pause in movement) of the user input). In some embodiments, the user is enabled to drag widget 734 and place widget 734 into any position in the widgets area 708 (e.g., even where the placement of widget 734 does not follow the one or more arrangement criteria). For example, device 100 automatically shifts (e.g., moves by a distance smaller than a width of a placement location, or hops by whole widget placement locations) overlapping widgets already within widgets area 708 to a different position to avoid overlap with the selected position for widget 734.

FIG. 7F illustrates user input 736a selecting widget 726 in widgets area 708 (e.g., after widget 734 is placed below widget 726 in widget area 708, or optionally, without first placing widget 734 below widget 726). In some embodiments, user input 736a is a drag input that moves (e.g., same continuous user input by a single contact, relabeled as user input 736b and 736c during movement of the contact) widget 726 within widgets area 708 in FIG. 7G. In some embodiments, user input 736c (FIG. 7H) moves widget 726 to a position that is lower in widget area 708 (e.g., a region below widget 734, optionally, irrespective of whether widget 734 is present in widget area at the time). As such, the user is enabled to manually rearrange the widgets in widgets area 708 without satisfying the one or more arrangement criteria that device 100 uses to automatically place widgets in widgets area 708. For example, the user is enabled to create open and/or negative space between widgets in widgets area 708 by moving and placing widgets are user-selected positions.

FIG. 7I illustrates user input 738a selecting widget 728. In some embodiments, user input 738a is a drag input, or other movement input, for moving widget 728 to a different position within widgets area 708. In some embodiments, the user input 738a is a touch-hold input on widget 728 to select widget 728, followed by continued movement while maintaining contact to drag widget 728, followed by liftoff or other indications of termination of the user input to place widget 728 at a position corresponding to the termination of the user input. For example, FIG. 7J illustrates widget 728 is moved, via user input 738b (e.g., a continuation of user input 738a after widget 728 is selected by user input 738a), to a lower right side corner of widgets area 708. In some embodiments, widget 728 is displayed at the position in widgets area 708 that corresponds to a termination of the drag input (e.g., a position where user input 738b ceases to be detected, a position at liftoff of user input 738b, and/or a position that corresponds to an indication of a termination of the user input 738b). For example, as illustrated in FIG. 7K, widget 728 is displayed at the lower right corner of widgets area 708. As described above, the user is enabled to place and/or move widget 728 within widgets area 708 that does not satisfy the one or more arrangement criteria (e.g., by creating open and/or negative space between the widgets in widgets area 708). In some embodiments, although the user is enabled to place and/or move the widgets, the widgets are snapped, or locked, to a closest position defined by a grid or other pattern of widgets area 708. For example, the users are enabled to move the widgets to different positions of a set of predefined available positions within widgets area 708, although the available positions do not have to be occupied or fully filled sequentially in accordance with some ordering rule (e.g., top-to-bottom, left-to-right, or right-to-left).

FIG. 7K illustrates user input 742 selecting done button 740 to conclude the editing session described above. In some embodiments, in response to detecting user input 742, device 100 ceases display of editing user interface 721 and redisplays the wake screen user interface as edited, now labeled as wake screen user interface 723, as illustrated in FIG. 7L.

FIG. 7L illustrates that, in some embodiments, wake screen user interface 723 displays the edits that were made while displaying the editing user interface, as described with reference to FIGS. 7B-7K. For example, wake screen user interface 723 displays display widgets 724, 734, 726 and 728 in their respective positions that were configured in the editing user interfaces described with reference to FIGS. 7B-7K.

As illustrated in FIG. 7L, while device 100 is in the first orientation (e.g., landscape orientation, or another first canonical orientation of the device), widgets 724, 734, 726 and 728 are displayed in an area of the display proximate to an edge of the display (e.g., a left side of the display, or another edge of the display associated with the first orientation of the display) (e.g., corresponding to widgets area 708 shown in the final view of the wake screen user interface that was displayed in the editing user interface) and/or to the left of time indication 704. In some embodiments, because the area of display of the widgets is not overlapping with the wallpaper foreground element (e.g., sun 702, or another wallpaper foreground element), the wallpaper foreground element (e.g., sun 702, or another wallpaper foreground element) continues to partially occlude time indication 704 (e.g., as described with reference to FIG. 7A), while concurrently displaying widgets 724, 734, 726 and 728 in the widgets area to the left of time indication 704 along a left edge of the display of device 100.

In some embodiments, while device 100 is in the second orientation (e.g., portrait orientation, or another second canonical orientation of the device), the area in which widgets are displayed is a different area of the display from the area in which widgets are displayed while the device 100 is in the first orientation (e.g., landscape orientation, or another first canonical orientation of the device). For example, FIG. 7M1 illustrates the display of device 100 after it has been rotated to the second orientation (e.g., portrait orientation, or another second canonical orientation of the device).

In some embodiments, in the second orientation (e.g., portrait orientation, or another second canonical orientation of the device), widgets 724a, 734a, and 726a are displayed in a widgets area that is below the time indication 746 (e.g., wherein the time indication 746 in the second orientation corresponds to time indication 704 in the first orientation). In some embodiments, the widgets area for the first orientation has a first size that is distinct from a second size of the widgets area for the second orientation, and/or the widgets area for the first orientation has a first position in the display area (e.g., relative to the time indication 704) of the device 100 while the device 100 is in the first orientation that is distinct from a second position in the display area (e.g., relative to the time indication 746) of device 100 that includes the widgets area while the device 100 is in the second orientation. For example, the widgets area in landscape orientation is a larger size than the widgets area in portrait orientation, in accordance with some embodiments.

In some embodiments, in response to device 100 rotating from the first orientation to the second orientation in FIGS. 7L-7M1, widgets 724a, 734a, and 726a (e.g., corresponding to widgets 724, 734, and 726) are automatically displayed (e.g., in the widgets area for the second orientation) in the wake screen user interface. As such, wake screen user interface 725 displayed in the second orientation is automatically, without user input, configured with widgets that the user has added to wake screen user interface 723 in the first orientation.

FIG. 7M2 illustrates that, in some embodiments, widgets that are added to wake screen user interface 723 in the first orientation are not automatically added to wake screen user interface 727 in the second orientation. For example, wake screen user interface 727 show in the second orientation is independently configurable (e.g., using a respective editing user interface) from wake screen user interface 723 in the first orientation (e.g., the wake screen user interface in the first orientation is configurable separately and independently from the configuration of wake screen user interface in the second orientation, and the wake screen user interface in the second orientation is configurable separately and independently from the configuration of the wake screen user interface in the first orientation).

FIG. 7M2 illustrates user input 748 (e.g., a touch and hold input or a light press input directed to an unoccupied portion of the wallpaper, or another type of input that meets editing criteria) corresponding to a request to display an editing user interface for the wake screen user interface, detected in wake screen user interface 727. In some embodiments, in response to detecting user input 748, device 100 displays editing user interface 729, as illustrated in FIG. 7N. In some embodiments, editing user interface 729 enables the user to configure wake screen user interface 727 while device 100 is in the second orientation. In some embodiments, editing user interface 729 is provided while device 100 is in the second orientation, and editing user interface 703 (FIG. 7B) is provided while device 100 is in the first orientation. Accordingly, different editing user interfaces are provided based on the current orientation of the device 100, and the different editing user interfaces optionally include the same or substantially the same customization options with a view of the user interface that is being edited in a respective orientation.

FIG. 7N illustrates detecting user input 752 corresponding to a request to add widgets to widgets area 750 (e.g., user input 752 includes a tap input or a press input directed to widget area 750, or another type of selection input directed to widget area 750 in the view of the wake screen user interface shown in the editing user interface). In some embodiments, in response to detecting user input 752, device 100 displays widgets platter 744 in the editing user interface (labeled as editing user interface 731) for the wake screen user interface, as illustrated in FIG. 7O. In some embodiments, widgets platter 744 has a distinct appearance (e.g., size, shape, and/or layout) than widgets platter 716 (e.g., described with reference to FIG. 7C) that is provided in the editing user interface 705 in the first orientation. In some embodiments, widgets platter 744 has the same functionality (e.g., for the user to select and/or add widgets to the respective widgets area in the editing user interface) as widgets platter 716.

FIG. 7O illustrates various user input selecting widgets to add to the widgets area 750, including, for example, detecting a first user input 754 selecting battery widget 760a, a second user input 756 selecting suggested widget 762a, and a third user input selecting fitness widget 764a. In some embodiments, the selected widgets are added (e.g., as widgets 760b, 762b, and 764b) to widgets area 750, which is displayed below time indication 746, as illustrated in FIG. 7P. In some embodiments, the widgets are added to widgets area 750 in accordance with one or more arrangement criteria (e.g., optionally the same or different than the one or more arrangement criteria for widgets area 708). For example, the widgets are added from left-to-right in widgets area 750 (e.g., in accordance with a determination that a language setting of the device is a language that reads left-to-right), in accordance with some embodiments.

FIG. 7P illustrates user input 768 selecting done button 766 to exit editing user interface 733 and return to the wake screen user interface (e.g., shown as wake screen user interface 735), as illustrated in FIG. 7Q. In some embodiments, in response to user input 768, device 100 ceases display of editing user interface 733 and displays wake screen user interface 735, including displaying the widgets that were added to widgets area 750 during editing.

FIG. 7Q illustrates that, while device 100 is in the second orientation, while one or more widgets are displayed in wake screen user interface 735, time indication 746 is no longer partially occluded by the wallpaper foreground element located at the same position (e.g., as compared to wake screen user interface 727 in FIG. 7M2 that does not include widgets and shows the sun overlapping (e.g., partially occluding) a portion of time indication 746).

FIG. 7R following FIG. 7Q illustrate that device 100 has rotated back to the first orientation from the second orientation, after the wake screen user interface was configured while device 100 was in the second orientation. In some embodiments, in response to detecting that device 100 is rotated back to the first orientation, device 100 redisplays wake screen user interface 723 (e.g., the wake screen user interface that was configured while device 100 was previously in the first orientation, as described with reference to FIGS. 7B-7L). As such, in response to the device 100 changing between orientations, the wake screen user interface is displayed for the current respective orientation based on the configuration for the wake screen user interface in that respective orientation, in accordance with some embodiments.

FIG. 7R illustrates that, while the wake screen user interface is displayed in the first orientation, device 100 detects user input 770 (e.g., a press and hold input on the time indication, a light press input on the wallpaper, or another user input that meets editing criteria) corresponding to a request to edit wake screen user interface 723, in accordance with some embodiments. In some embodiments, in response to detecting user input 770, device 100 displays editing user interface 737 with a view of the wake screen user interface in the first orientation. As such, the user is enabled to further edit and/or configure wake screen user interface 723 while device 100 is in the first orientation. For example, FIG. 7S illustrates detecting user input 772 (e.g., a tap input or other selection input) selecting widget 730f from widgets platter 716 in editing user interface 737, corresponding to a request to add the widget 730f to the widgets area 708 in the view of the wake screen user interface in the first orientation.

In some embodiments, in response to detecting user input 772, the selected widget 730f is added to widgets area 708 as widget 774, as illustrated in editing user interface 739 in FIG. 7T. In some embodiments, widget 774 is displayed in widgets area 708 in accordance with the one or more arrangement criteria described above with reference to FIG. 7C.

FIG. 7T illustrates user input 776 selecting done button 740 in editing user interface 739. In some embodiments, in response to detecting user input 776, device 100 ceases display of editing user interface 739 and redisplays wake screen user interface in the first orientation (e.g., shown as wake screen user interface 741), as illustrated in FIG. 7U. In some embodiments, as illustrated in FIG. 7U, wake screen user interface 741 includes the widgets added in editing user interface 739 (e.g., including displaying widget 774 in the widgets area), along with other existing widgets added during previous editing session(s).

FIG. 7V following FIG. 7T illustrate that the device 100 has rotated from the first orientation to the second orientation (e.g., portrait orientation, or another second canonical orientation of the device) after the user configured and/or reconfigured the wake screen user interface in the first orientation (e.g., wake screen user interface 741 in FIG. 7T). In some embodiments, wake screen user interface 735 is redisplayed in accordance with the rotation of device 100 from the first orientation to the second orientation. For example, the changes in the configuration made to the wake screen user interface in the first orientation do not affect the configuration of wake screen user interface 735 while device 100 is in the second orientation, in accordance with some embodiments.

FIG. 7V illustrates detection of user input 778 corresponding to a request to edit (e.g., and/or reconfigure) wake screen user interface 735 displayed in the second orientation. In some embodiments, in response to detecting user input 778, device 100 displays editing user interface 743, as illustrated in FIG. 7W. In some embodiments, editing user interface 743 includes the same functionality as editing user interfaces 729 and/or 731, described with reference to FIGS. 7N-7O. For example, the user is enabled to add, remove, and/or rearrange widgets in widgets area 750.

FIG. 7W illustrates that, in some embodiments, widgets that are displayed in widgets area 750 (e.g., widget 760b, widget 762b and widget 764b) are optionally displayed with respective controls to remove the corresponding widgets from the widgets area 750. For example, respective minus symbols and/or x-symbols or other close affordances are optionally displayed for individual widgets in widgets area 750. In some embodiments, a similar control to remove a respective widget is displayed for each widget in widgets area 708 (e.g., shown in FIG. 7B).

FIG. 7W illustrates detecting user input 780 selecting the option to remove widget 764b from widgets area 750 (e.g., detecting a tap input or another selection input on the minus symbol displayed next to widget 764b). In some embodiments, in response to detecting user input 780, widget 764b is removed from widgets area 750, as illustrated in editing user interface 745 (FIG. 7X).

FIG. 7W further illustrates detecting user input 782 selecting widget 784 from the widget platter to be added to widgets area 750 (e.g., detecting a tap input or another selection input on the widget 784, either after detecting user input 780 and removal of widget 764b from widget area 750, or before detecting user input 780 and while widget 764b still exists in widget area 750). In some embodiments, in response to detecting user input 782, device 100 adds widget 784b to widgets area 750, as illustrated in editing user interface 745 in FIG. 7X.

FIG. 7X further illustrates device 100 detecting user input 786 selecting done button 766 after modifying the widgets that are included in widgets area 750 (after widget 784b has been added and widget 764b have been removed from the widget area 750 (e.g., in response to user input 782 and user input 780, respectively)). In some embodiments, in response to detecting user input 786, editing user interface 745 ceases to be displayed and wake screen user interface 747 is displayed, as illustrated in FIG. 7Y, including displaying the modified sets of widgets below the time indication in the wake screen user interface while the device 100 is in the second orientation.

FIG. 7Z illustrates that, after displaying the wake screen user interface 747 with the modified sets of widgets while device 100 is in the second orientation, device 100 is rotated back to the first orientation. In some embodiments, in accordance with device 100 being in the first orientation, device 100 redisplays wake screen user interface 741 having the configuration selected by the user as described with reference to FIGS. 7S-7T (e.g., without regard to the changes to the configuration of the wake screen user interface 747 while the device 100 is in the second orientation).

FIGS. 8A-8D are flow diagrams illustrating method 800 of automatically updating a wallpaper background of a user interface in accordance with a selected wallpaper foreground element in accordance with some embodiments. Method 800 is performed at a computer system (e.g., an electronic device, device 300, FIG. 3, or portable multifunction device 100, FIG. 1A) with a display and a touch-sensitive surface. In some embodiments, the display is a touch-screen display and the touch-sensitive surface is on or integrated with the display. In some embodiments, the display is separate from the touch-sensitive surface. Some operations in method 800 are, optionally, combined and/or the order of some operations is, optionally, changed.

As described below, method 800 automatically updates a wallpaper background of a user interface in accordance with a selected wallpaper foreground element, thereby providing real-time feedback to the user in response to a user input to change the wallpaper foreground elements without requiring the user to manually configure the wallpaper background, which performs an operation automatically when a set of conditions has been met without requiring further user input and provides improved feedback to the user.

The computer system receives (802) a request to display a first user interface. In some embodiments, the first user interface is a system user interface that includes a wallpaper and a plurality of system user interface objects (e.g., time, widgets, application icons, status indicators, or other system user interface objects), where the wallpaper includes one or more foreground elements (e.g., a pattern, an image, or other graphical elements) overlaying a background (e.g., a background color, a background gradient, or a background texture), optionally in a respective layout arrangement. In some embodiments, the first user interface is a wake screen user interface (e.g., wake screen user interface 490) that is displayed when the device is in a low-power mode (e.g., with the displayed turned off or with the display in a dimmed always-on state, as described with reference to user interface 489), when the device is transitioned from a low-power mode to a regular operating mode (e.g., with the display turned on to a regular brightness level), when the device is transitioned from a regular operating mode (e.g., with the display lit at the regular brightness level) to a low-power mode (e.g., with the display turned off or dimmed), and/or when the device transitions from an application UI (e.g., application user interface 493) and home screen to a locked and/or restricted state. In some embodiments, the first user interface is a home screen user interface (e.g., home screen user interface 492). In some embodiments, the wake screen user interface and the home screen user interface are configured together as a pair, so a change to the wake screen configuration is applied to the configuration of the home screen user interface, and, optionally, vice versa. In some embodiments, receiving the request to display the first user interface includes detecting a raise to wake input or detecting generation of a notification or alert, while the device is in a low-power mode. In some embodiments, receiving the request to display the first user interface includes detecting a power-off input or device sleep input (e.g., a press on the power button, prolonged inactivity by the user, or other event or input that puts the device in a low power mode) while the device is in a regular operating mode. In some embodiments, detecting the request to display the first user interface includes detecting an input that corresponds to a request to close an open application (e.g., an upward edge swipe gesture, a press on the home button, or other inputs), or an input that corresponds to a request to display the coversheet user interface and put the device in a restricted mode (e.g., a downward edge swipe gesture, a press on the power button, or other inputs) that is displayed while an application user interface is displayed.

The computer system, in response to receiving the request to display the first user interface, displays (804) the first user interface that includes a set of user interface elements (e.g., wake screen features such as notifications, a date/time, widgets, and/or status indicators or home screen features such as widgets and/or application icons) displayed overlaid on a wallpaper. In some embodiments, the wallpaper comprises an image, pattern, design, canvas, or other background that is displayed in the user interface with one or more application icons and/or system user interface objects that are displayed as at least partially occluding the wallpaper. For example, the wallpaper is an image, pattern, design, canvas or other background that is displayed behind system information (e.g., an indication of a date, an indication of a time, notifications, or other text) and/or behind application icons and/or other user interface elements displayed in the user interface. In some embodiments, at least a portion of the wallpaper is displayed in front of system information (e.g., a portion of the wallpaper partially occludes the indication of the time). In some embodiments, the wallpaper is configurable by the user, whereby the user selects an image, pattern and/or design of the wallpaper. In some embodiments, the wallpaper includes a wallpaper background and/or one or more wallpaper foreground elements. For example, the wallpaper includes a color (e.g., or a pattern, such as a gradient of color) with objects (e.g., foreground elements, such as emoji, planets, or other objects) that are displayed, within the wallpaper, in front of the color that serves as the wallpaper background. As such, both the wallpaper background and wallpaper foreground elements make up the wallpaper that is displayed behind system information, application icons and/or other user interface elements. Displaying the first user interface includes: in accordance with a determination that the wallpaper has a first set of one or more wallpaper foreground elements (e.g., the determination of which wallpaper foreground elements are on the wallpaper is, optionally, made at a time while the user is configuring the wallpaper (e.g., in an edit mode of the wallpaper in which the user selects one or more foreground elements (e.g., emoji or other elements) to be displayed in the wallpaper), at a time right after the completion of the configuration process, and/or a time after the request to display the first user interface is received), the wallpaper has a first wallpaper background with an automatically selected appearance that was automatically selected (e.g., by the computer system, without user intervention at the time of displaying the first user interface), based on the first set of one or more wallpaper foreground elements. For example, as described with reference to FIGS. 5E-5F1, the wallpaper background is displayed with a color that is selected based at least in part on the selected smiley face emoji 550 to be used as the wallpaper foreground element. Displaying the first user interface further includes: in accordance with a determination that the wallpaper has a second set of one or more wallpaper foreground elements that are different from the first set of one or more wallpaper foreground elements (e.g., the determination of which wallpaper foreground elements are on the wallpaper is, optionally, made at a time while the user is configuring the wallpaper (e.g., in an edit mode of the wallpaper in which the user selects one or more foreground elements (e.g., emoji or other elements) to be displayed in the wallpaper), at a time right after the completion of the configuration process, and/or a time after the request to display the first user interface is received), the wallpaper has a second wallpaper background with an automatically selected appearance that was automatically selected (e.g., by the computer system, without user intervention at the time of displaying the first user interface), based on the second set of one or more wallpaper foreground elements (e.g., the second wallpaper background is different in appearance from the first wallpaper background in appearance, because the wallpaper foreground elements is used by the electronic device to determine the appearance of the wallpaper background of the wallpaper without user intervention). For example, as described with reference to FIGS. 5E and 5G1, in response to the user input selecting thumbs up emoji 548 to be included in the set of wallpaper foreground elements (e.g., in addition to smiley face emoji 550), the wallpaper background is displayed with a second color that is selected based at least in part on the thumbs up emoji 548 (e.g., and is optionally further selected based at least in part on the smiley face emoji 550).

In some embodiments, the computer system displays (806), via the display generation component, a second user interface for configuring the first user interface, wherein the second user interface includes respective selectable options for specifying one or more wallpaper foreground elements (e.g., symbols, emojis, stickers, icons, and other graphical elements or patterns that are repeated on a wallpaper background) that are to be included in the wallpaper of the first user interface (e.g., the wallpaper includes an emoji wallpaper, a cartoon character wallpaper, or another type of background with repeated symbols or graphics as the foreground elements overlaying an automatically selected wallpaper background color or texture). In some embodiments, while displaying the second user interface, the computer system detects a first user input selecting a first selectable option that corresponds to a first wallpaper foreground element (e.g., a first emoji, a first symbol, a first icon, or a first graphical element) (e.g., without displaying a corresponding wallpaper background underlying a selectable wallpaper foreground element, and/or while a set of multiple possible wallpaper backgrounds are independently selectable at a different time from the wallpaper foreground elements). In some embodiments, in response to detecting the first user input selecting the first selectable option that corresponds to the first wallpaper foreground element (e.g., without specifying a corresponding wallpaper background for the first wallpaper foreground element, and without presenting the first wallpaper foreground element with a corresponding wallpaper background as an option for selecting both as a combination), the computer system displays, in the second user interface, a representation of the wallpaper having the first wallpaper foreground element and the first wallpaper background with an appearance that is automatically selected based on one or more properties of the first wallpaper foreground element (e.g., the wallpaper background is selected based on the color(s) and style, and other characteristics of the first wallpaper foreground element). In some embodiments, the wallpaper background is displayed as part of a representation of the first user interface in the second user interface. In some embodiments, the computer system updates, in response to the selection of the first wallpaper foreground element, the wallpaper background and the set of foreground elements of an existing wallpaper that is currently shown in the first user interface, such that the wallpaper of the first user interface now comprises the first foreground element (e.g., in addition to, or instead of the previously displayed foreground element(s)) and the wallpaper background with an appearance that is automatically selected based on the first foreground element. In some embodiments, while displaying, in the second user interface, the representation of the wallpaper having the first wallpaper foreground element and the wallpaper background with an appearance that is automatically selected based on the one or more properties of the first wallpaper foreground element, the computer system detects a second user input selecting a second selectable option that corresponds to a second wallpaper foreground element, different from the first wallpaper foreground element. In some embodiments, in response to detecting the second user input selecting the second selectable option that corresponds to the second wallpaper foreground element (e.g., without specifying a corresponding wallpaper background for the second wallpaper foreground element, and without presenting the second wallpaper foreground element with a corresponding wallpaper background as an option for selecting both as a combination), the computer system updates, in the second user interface, the representation of the wallpaper to include the second wallpaper foreground element (e.g., in addition to the first foreground element, or instead of the first foreground element) and the second wallpaper background with an appearance that is automatically selected based on one or more properties of the second wallpaper foreground element (e.g., the second wallpaper background is selected, at least in part, based on the color(s) and style, and other characteristics of the second wallpaper foreground element). In some embodiments, the second wallpaper background is further based on the one or more properties of the first wallpaper foreground element, in conjunction with the one or more properties of the second wallpaper foreground element, if the first wallpaper foreground element is not deselected and will be used together with the second wallpaper foreground element in the wallpaper. In some embodiments, the second wallpaper background is only based on the second wallpaper foreground element, without regard to the first wallpaper foreground element (e.g., the second wallpaper foreground element completely replaces the first wallpaper foreground element in the wallpaper). For example, editing user interface 543 (FIG. 5E) is displayed with an appearance that includes the first color as the wallpaper background and instances of the smiley face emoji 550 repeated in a small grid pattern as the wallpaper foreground elements. In some embodiments, in response to user input 562 selecting a second wallpaper foreground element (e.g., thumbs up emoji 548), the editing user interface 567 (FIG. 5G1) is displayed, including automatically updating the wallpaper background that includes the second color as the wallpaper background and instances of the smiley face emoji 550 and instances of the thumbs up emoji 550 repeated in a small grid pattern as the wallpaper foreground elements. Automatically changing one or more visual features of a wallpaper based on a selected set of wallpaper foreground elements, including updating the visual features of the wallpaper in response to the user changing the set of wallpaper foreground elements, without requiring the user to manually select the one or more visual features of the wallpaper, provides improved feedback that indicates a different set of wallpaper foreground elements has been selected and reduces a number of inputs needed to design or edit the wallpaper.

In some embodiments, after detecting the second user input selecting the second selectable option that corresponds to the second wallpaper foreground element (e.g., and updating the respective representation of the wallpaper to include the second wallpaper foreground element and the second wallpaper background with an appearance that is automatically selected based on the one or more properties of the second wallpaper foreground element), the computer system detects (808) a third user input that unselects the second selectable option that corresponds to the second wallpaper foreground element (e.g., the third user input deletes the second wallpaper foreground element from the set of selected wallpaper foreground elements, without providing an input to delete or changing a corresponding wallpaper background for the second wallpaper foreground element, and without deleting or changing the second wallpaper foreground element and a corresponding wallpaper background together as a selectable combination). In some embodiments, in response to detecting the third user input that unselects the second selectable option that corresponds to the second wallpaper foreground element: the computer system ceases display of the second wallpaper foreground element in the representation of the wallpaper (e.g., and removes the second foreground element from the foreground of the wallpaper, so that when the first user interface is displayed, the wallpaper of the first user interface is displayed without the second foreground element) and updates, in the second user interface, the representation of the wallpaper to display a third wallpaper foreground element and a third wallpaper background with an appearance that is automatically selected based on one or more properties of the third wallpaper foreground element (e.g., and when the first user interface is displayed, the wallpaper of the first user interface is displayed with the third wallpaper background and the third wallpaper foreground element). In some embodiments, the third wallpaper background is the same as the first wallpaper background. For example, if the first and second wallpaper foreground elements were both selected, and the second foreground element is then deleted by the third user input, the wallpaper background reverts back to the first wallpaper background that is automatically determined in accordance with one or more properties of the first wallpaper foreground element. In some embodiments, the third wallpaper background is distinct from the first wallpaper background and the second wallpaper background (e.g., based on properties of any of the currently selected wallpaper foreground elements (e.g., if any) that remain after deleting the second wallpaper foreground element), different from the second wallpaper background. For example, as described with reference to FIG. 5G1, in response to user input 566 corresponding to a request to delete thumbs up emoji 548 from the set of wallpaper foreground elements, the wallpaper background color is automatically, without additional user input, updated to a different color (e.g., the first color that was selected based on the smiley face emoji 550), as illustrated in editing user interface 569 in FIG. 5G2. Automatically changing one or more visual features of a wallpaper based on a selected set of wallpaper foreground elements, including updating the visual features of the wallpaper in response to the user removing a wallpaper foreground element from the set of wallpaper foreground elements, without requiring the user to manually select the one or more visual features of the wallpaper, provides improved feedback that indicates a wallpaper foreground element has been deleted and reduces a number of inputs needed to design or edit the wallpaper.

In some embodiments, the second user input selecting the second selectable option that corresponds to (810) the second wallpaper foreground element includes a user input that adds the second wallpaper foreground element as an additional foreground element to be included with the first wallpaper foreground element in the wallpaper (e.g., the user adds additional emoji or other wallpaper foreground elements to be displayed in the wallpaper). In some embodiments, updating the representation of the wallpaper to include the second wallpaper foreground element and the second wallpaper background with the appearance that is automatically selected based on the one or more properties of the second wallpaper foreground element includes updating the representation of the wallpaper to include both the first wallpaper foreground element and the second wallpaper foreground element overlaying the second wallpaper background. In some embodiments, the second wallpaper background has an appearance that is automatically selected based on one or more properties of the second wallpaper foreground element as well as one or more properties of the first wallpaper foreground element, or an interrelationship between the one or more properties of the first and second wallpaper foreground elements. For example, as described with reference to FIG. 5G2, in response to user input 568 corresponding to a request to add plane emoji 552 to the set of wallpaper foreground elements, the wallpaper background is updated to include instances of smiley face emoji 550 and instances of plane emoji 552 repeated in a grid pattern as the wallpaper foreground elements, and the wallpaper background is updated to display a color that is selected based at least in part on one or more properties of plane emoji 552 (e.g., the color of the wallpaper background is optionally selected to complement and/or match one or more colors of plane emoji 552). Automatically changing one or more visual features of a wallpaper based on a selected set of wallpaper foreground elements, including updating the visual features of the wallpaper in response to the user adding a wallpaper foreground element to the set of wallpaper foreground elements, without requiring the user to manually select the one or more visual features of the wallpaper, provides improved feedback that indicates a wallpaper foreground element has been added and reduces a number of inputs needed to design or edit the wallpaper.

In some embodiments, the computer system displays (812), in the second user interface for configuring the first user interface, a search input area for receiving one or more search criteria for searching wallpaper foreground elements (e.g., a search bar for searching for wallpaper foreground elements using text-base or image-based search criteria). In some embodiments, the computer system detects a first set of search criteria in the search input area (e.g., detecting the user typing on a keyboard to input the text and/or a voice search command that corresponds to search criteria) in the search input area; and in response to detecting the first set of search criteria in the search input area, displays one or more graphical elements (e.g., images, icons, emojis, symbols, and/or other objects suitable for serving as a wallpaper foreground element) that correspond to the first set of search criteria, as selectable options for specifying the one or more wallpaper foreground elements that are to be included in the wallpaper of the first user interface (e.g., without displaying other foreground elements that do not match the search criteria). For example, a plurality of emoji (e.g., or other icons, stickers, avatars, or foreground elements) are displayed as search results in response to the user input. For example, as described with reference to FIG. 5E, search bar 536 is provided in platter 534 to enable the user to search, via a text input, for emoji that match the text input. Providing an option for the user to search for emojis, stickers, avatars, or other icons that are used as wallpaper foreground elements using search criteria reduces the number of inputs needed to browse through available emojis, stickers, avatars, or other icons.

In some embodiments, displaying the first user interface that includes the set of user interface elements displayed overlaid on the wallpaper includes (814): in accordance with a determination that the wallpaper has a respective set of one or more wallpaper foreground elements and that the respective set of one or more wallpaper foreground elements includes a single wallpaper foreground element (e.g., as a standalone object, or as a pattern that is repeated multiple times throughout the wallpaper background), displaying the wallpaper with a respective wallpaper background that has an appearance that is automatically selected based on the one or more properties of the single wallpaper foreground element (e.g., automatically selecting a color of the wallpaper background based on the single wallpaper foreground element, wherein the selected color is associated with (e.g., assigned to or otherwise selected for) the single wallpaper foreground element). In some embodiments, different wallpaper foreground elements are associated with different wallpaper backgrounds by default, and of a respective wallpaper foreground element is the only wallpaper foreground element that has been specified for a wallpaper, the wallpaper is displayed with the respective wallpaper foreground element overlaying a wallpaper background that is associated with the respective wallpaper foreground element. There is no need for the user to separately specify the wallpaper background in addition to specifying the wallpaper foreground element in the configuration user interface. When a new wallpaper foreground element is selected to replace a previously selected wallpaper foreground element, the device displays the newly selected wallpaper foreground element overlaid on a new wallpaper background that is associated with the newly selected wallpaper foreground element. In some embodiments, a respective wallpaper foreground element has more than one wallpaper backgrounds that is available for use with the respective wallpaper foreground, and the device selects one based on one or more other factors, such as the time of day, and/or visual properties of other foreground elements on the first user interface. For example, as described with reference to FIGS. 5D-5E, in response to user input 542 selecting smiley face emoji 550, in some embodiments, the color of the wallpaper background is automatically updated, as illustrated in FIG. 5E, to a color that is associated with (e.g., preassigned to and/or stored in a lookup table and/or database) smiley face emoji 550. Automatically changing a color of a wallpaper background to a color that is associated with an emoji, sticker, avatar or icon that is used in the set of wallpaper foreground elements, without requiring the user to manually select the color of the wallpaper background, provides improved feedback that indicates a wallpaper foreground element has been added and reduces a number of inputs needed to design or edit the wallpaper background.

In some embodiments, displaying the first user interface that includes the set of user interface elements displayed overlaid on the wallpaper includes (816): in accordance with a determination that the wallpaper has a respective set of one or more wallpaper foreground elements and that the respective set of one or more wallpaper foreground elements includes multiple wallpaper foreground elements (e.g., as standalone objects, or as patterns that are repeated multiple times throughout the wallpaper background), displaying the wallpaper with a respective wallpaper background that has an appearance that is automatically selected based on the one or more properties of the multiple wallpaper foreground elements. For example, in some embodiments, in accordance with a determination that the wallpaper includes at least one foreground element from the first set of one or more wallpaper foreground elements and at least one foreground element from the second set of the one or more wallpaper foreground elements, the wallpaper has a wallpaper background with an automatically selected appearance that was automatically selected based on both of the at least one foreground element from the first set of one or more wallpaper foreground elements and the at least one foreground element from the second set of the one or more wallpaper foreground elements. In some embodiments, the automatically selected appearance is automatically selected based on one or more properties that the at least one foreground element from the first set of one or more wallpaper foreground elements and the at least one foreground element from the second set of the one or more wallpaper foreground elements share (e.g., a color that is in both foreground elements). In some embodiments, the automatically selected appearance is automatically selected based on a combination of properties of the at least one foreground element from the first set of one or more wallpaper foreground elements and the at least one foreground element from the second set of the one or more wallpaper foreground elements (e.g., a color that complements and/or accents both foreground elements, such as a blended color of colors that occur in each of the foreground elements). For example, as described with reference to FIG. 5G1, in some embodiments, the second color of wallpaper background of editing user interface 567 is a color that is based at least in part on all of the currently selected emoji that are selected as wallpaper foreground elements (e.g., both smiley face emoji 550 and thumbs up emoji 548). For example, the second color is selected as color that is present in (e.g., or otherwise complements) both smiley face emoji 550 and thumbs up emoji 548. Automatically changing a color of a wallpaper background to a color that is associated with at least two different emoji, sticker, avatar or icon that are used in the set of wallpaper foreground elements, without requiring the user to manually select the color of the wallpaper background, provides improved feedback that updates a wallpaper background color to match two or more wallpaper foreground elements have been selected and reduces a number of inputs needed to design or edit the wallpaper.

In some embodiments, displaying the first user interface that includes the set of user interface elements displayed overlaid on the wallpaper includes (818): in accordance with a determination that the wallpaper has a respective set of one or more wallpaper foreground elements and that the respective set of one or more wallpaper foreground elements includes multiple wallpaper foreground elements (e.g., as standalone objects, or as patterns that are repeated multiple times throughout the wallpaper background), displaying the wallpaper with a respective wallpaper background that has an appearance that is automatically selected based on the one or more properties of a last selected wallpaper foreground element among the multiple wallpaper foreground elements. For example, in some embodiments, if the multiple wallpaper foreground elements include the first wallpaper foreground element selected by the first user input and the second wallpaper foreground element selected by the second user input, the wallpaper has a wallpaper background with an automatically selected appearance that was automatically selected based on the second foreground element and not based on the first wallpaper foreground element. For example, as described with reference to FIG. 5G1, in some embodiments, the second color of wallpaper background of editing user interface 567 is based on the last (e.g., most recently) selected emoji (e.g., thumbs up emoji 548) only (e.g., and the second color is not based on previously selected emoji, such as smiley face emoji 550). For example, as described with reference to FIGS. 5Q-5R, the wallpaper background of editing user interface 593 is automatically selected based on the last picked emoji (e.g., rocket emoji 554). Automatically changing a color of a wallpaper background to a color that is associated with the most recently selected emoji, sticker, avatar or icon that is added to the set of wallpaper foreground elements, even when other wallpaper foreground elements are also used, without requiring the user to manually update the color of the wallpaper background as new wallpaper foreground elements are selected, provides improved feedback that updates a wallpaper background color to match the most recently selected wallpaper foreground element and reduces a number of inputs needed to design or edit the wallpaper.

In some embodiments, while displaying the representation of the wallpaper having a respective wallpaper foreground element (e.g., the first wallpaper foreground element, the second wallpaper foreground element, and/or another wallpaper foreground element) and a respective wallpaper background (e.g., the first wallpaper background, the second wallpaper background, or another wallpaper background) with an appearance that is automatically selected based on one or more properties of the respective wallpaper foreground element, the computer system detects (820) a fourth user input that changes the respective wallpaper background (e.g., switching to another wallpaper background as a whole) or one or more properties of the respective wallpaper background (e.g., color, layout, brightness, hue, translucency, texture, and/or other properties). In some embodiments, in response to detecting the fourth user input, the computer system updates display of the representation of the wallpaper to include the respective wallpaper foreground element and an updated wallpaper background specified by the fourth user input. In some embodiments, the user is enabled to reselect the automatically selected appearance for the wallpaper background to switch between the user-selected appearance (e.g., the color selected by the user) and the automatically selected appearance (e.g., the color selected automatically based on the foreground elements) for the wallpaper background. For example, in some embodiments, when the representation of the wallpaper is displayed with the user-specified wallpaper background, a second user interface includes a selectable option that corresponds to the wallpaper background having the automatically selected appearance. In response to detecting a fifth user input that selects that selectable option, the device updates display of the representation of the wallpaper to include the respective wallpaper foreground element and the original automatically selected wallpaper background that is automatically selected based on the one or more properties of the respective wallpaper foreground element. For example, as described with reference to FIG. 5L, the user is enabled to select a color, other than the automatically selected color option 590a, to use as the wallpaper background color of the wallpaper. For example, in response to user input 588 selecting color option 590c, the wallpaper background of the wallpaper is to be displayed with the color corresponding to color option 590c, as illustrated in editing user interface 581 in FIG. 5M. Enabling the user to switch between using the automatically selected wallpaper background color that is selected and updated based on a currently selected set of wallpaper foreground elements and using a manually selected background color from a set of background color options provided to the user, reduces a number of inputs needed to design or edit the wallpaper.

In some embodiments, at least one of the first set of one or more wallpaper foreground elements and the second set of one or more wallpaper foreground elements include (822) one or more user-generated avatars (e.g., animated characters, models, icons, and/or emoji that are generated based on an appearance of a user (e.g., a user of the device, and/or one or more contacts of the user in one or more communication applications) or are otherwise configured by the user). In some embodiments, available foreground elements are stored in a library that can be searched and browsed in the second user interface. In some embodiments, a user is enabled to add to and/or create foreground elements in the library of available foreground elements. For example, as described with reference to FIG. 5A, in some embodiments, the one or more wallpaper foreground elements include foreground icons (e.g., emojis, avatars, or other icons), foreground subjects, and/or foreground images. Displaying a sticker or icon that corresponds to an avatar that is designed by the user as a wallpaper foreground element to be displayed in the wallpaper, provides improved visual feedback and allows the user to further customize the wallpaper by using the avatar that is designed by the user.

In some embodiments, while the display generation component is in a first orientation (e.g., a portrait orientation, a landscape orientation, or another orientation specified relative to the display or the physical environment), the computer system displays (824) the first user interface with a first layout that corresponds to the first orientation, including displaying the set of user interface elements overlaid on the wallpaper with the first layout, wherein a respective set of wallpaper foreground elements are oriented in a first manner relative to the set of user interface elements (e.g., oriented with the same up and down directions, oriented at a first angle relative to the up and down direction of the set of user interface elements). In some embodiments, while displaying the first user interface with the first layout, the computer system detects a change in orientation of the display generation component from the first orientation to a second orientation, different from the first orientation; and in response to detecting the change in orientation of the display generation component: in accordance with a determination that the change in orientation of the display generation component meets rotation criteria (e.g., criteria based on the amount, speed, rate of change, and/or direction of the change in orientation of the display generation component), the computer system displays the first user interface with a second layout that corresponds to the second orientation, including displaying the set of user interface elements overlaid on the wallpaper with the second layout (e.g., displaying an animation that shows the set of user interface elements rotating and/or moving in the first user interface from the first layout to the second layout), and rotates respective instances of the one or more wallpaper foreground elements in the respective set of one or more wallpaper foreground elements (e.g., such that the respective set of wallpaper foreground elements are oriented in the first manner relative to the set of user interface elements in the second layout (e.g., oriented with the same up and down directions, oriented at the first angle relative to the up and down direction of the set of user interface elements)) while maintaining respective positions of the respective instances of the one or more wallpaper foreground elements in the first user interface (e.g., individual instances of the wallpaper foreground element(s) are rotated in place such that the instances of the wallpaper foreground elements are rotated without shifting them relative to the display or the wallpaper background). In some embodiments, additional instances of the wallpaper foreground elements are displayed in some portions of the display area when the first user is displayed with the second layout, while some instances of the wallpaper foreground elements are no longer displayed in other display areas (e.g., corners and/or sides of the display generation component). For example, as described with reference to FIGS. 501-502, in response to detecting a change in orientation of the user interface (e.g., of device 100), an animation is displayed that rotates one or more user interface elements (e.g., the time and/or date indication and optionally one or more widgets) and/or rotates instances of wallpaper foreground elements on the wallpaper (e.g., including each instance of the smiley face emoji and each instance of the plane emoji). Automatically updating the user interface in response to detecting that the device has been rotated, such that the user interface, including the individual wallpaper foreground elements, are animated to rotate in-place, provides improved visual feedback in response to the device rotating and enables the wallpaper displayed in the user interface to be updated without displaying additional controls.

In some embodiments, in response to detecting the change in orientation of the display generation component: in accordance with the determination that the change in orientation of the display generation component meets the rotation criteria (e.g., criteria based on the amount, speed, rate of change, and/or direction of the change in orientation of the display generation component), the computer system: expands (826) a display area of a respective wallpaper background (e.g., the first wallpaper background, the second wallpaper background, or another automatically selected wallpaper background or manually selected wallpaper background) of the wallpaper relative to the respective instances of the one or more wallpaper foreground elements in the respective set of one or more wallpaper foreground elements, while the respective instances of the one or more wallpaper foreground elements are rotated at their respective positions in the first user interface (e.g., the expanded display area of the wallpaper background includes one or more areas that were previously outside of the display area covered by the wallpaper background corresponding to the first orientation (e.g., corners, and/or edges)). For example, as described with reference to FIGS. 501-502, additional emojis that are displayed in the second orientation but not the first orientation (e.g., or vice-versa) appear at their respective positions within the display area during the animation (e.g., during rotation), such that, during the animated transition, blank areas of the wallpaper (e.g., areas that do not include wallpaper foreground elements and/or wallpaper background) are prevented. Automatically updating the user interface in response to detecting that the device has been rotated, such that the wallpaper foreground elements are displayed in each displayed area of the wallpaper, such as the corners of the wallpaper, even as the displayed area of the wallpaper changes in response to rotating the device, provides improved visual feedback in response to the device rotating and enables the wallpaper displayed in the user interface to be updated without displaying additional controls.

In some embodiments, detecting the first user input selecting the first selectable option that corresponds to the first wallpaper foreground element includes (828) detecting entry of a first emoji using an emoji keyboard, displaying the representation of the wallpaper having the first wallpaper foreground element and the first wallpaper background includes displaying a repeated pattern of the first emoji overlaying a first background color that is automatically selected based on one or more properties of the first emoji; and detecting the second user input selecting the second selectable option that corresponds to the second wallpaper foreground element includes detecting entry of a second emoji using the emoji keyboard, the second emoji being different from the first emoji. In some embodiments, updating the representation of the wallpaper to include the second wallpaper foreground element and the second wallpaper background includes displaying a repeated pattern of the second emoji (e.g., in place of or in addition to the first emoji, depending on whether the first emoji is replaced or remains selected) overlaying a second background color that is automatically selected based on one or more properties of the second emoji, the second background color replacing the first background color in the representation of the wallpaper. For example, as described with reference to FIG. 5D, editing user interface 531 displays platter 534 that includes an emoji keyboard that displays a plurality of selectable emoji, avatars, or other icons, including thumbs up emoji 548, plane emoji 552, smiley face emoji 550, and rocket emoji 554. In some embodiments, in response to a user input selecting one of the plurality of selectable emoji, the wallpaper background is automatically updated to display a plurality of instances of the selected emoji (e.g., smiley face emoji 550) with an automatically selected wallpaper background color, as described with reference to FIG. 5E. Automatically changing a color of a wallpaper background preview to a color that is associated with an emoji, sticker, avatar or icon that is used in the set of wallpaper foreground elements in response to user selection of the emoji, sticker, avatar or icon, without requiring the user to manually select the color of the wallpaper background, provides improved feedback that indicates to the user, in the wallpaper background preview, the color of the wallpaper background that has been automatically selected in response to selection of the emoji, sticker, avatar or icon and reduces a number of inputs needed to design or edit the wallpaper background.

It should be understood that the particular order in which the operations in FIGS. 8A-8D have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 900, 1000 and 1200) are also applicable in an analogous manner to method 800 described above with respect to FIGS. 8A-8D. For example, the user interface objects, wallpapers and user inputs described above with reference to method 800 optionally have one or more of the characteristics of the user interface objects, wallpapers and user inputs described herein with reference to other methods described herein (e.g., methods 900, 1000 and 1200). For brevity, these details are not repeated here.

FIGS. 9A-9F are flow diagrams illustrating a method 900 of automatically updating a wallpaper displayed in a user interface in response to a user selecting a user interface object from a set of user interface objects displayed in the wallpaper in accordance with some embodiments. Method 900 is performed at a computer system (e.g., an electronic device, device 300, FIG. 3, or portable multifunction device 100, FIG. 1A) with a display and a touch-sensitive surface. In some embodiments, the display is a touch-screen display and the touch-sensitive surface is on or integrated with the display. In some embodiments, the display is separate from the touch-sensitive surface. Some operations in method 900 are, optionally, combined and/or the order of some operations is, optionally, changed.

As described below, method 900 automatically updates a wallpaper displayed in a user interface in response to a user selecting a user interface object from a set of user interface objects displayed in the wallpaper, thereby displaying an updated wallpaper for the user without requiring the user to manually configure the wallpaper, which provides additional control options without cluttering the user interface with additional displayed controls and provides improved feedback to the user.

The computer system receives (902) a request to display a first user interface. In some embodiments, the first user interface is a system user interface that includes a wallpaper and a plurality of system user interface objects (e.g., time, widgets, application icons, status indicators, or other system user interface objects), where the wallpaper includes one or more foreground elements (e.g., a pattern, an image, or other graphical elements) overlaying a background (e.g., a background color, a background gradient, or a background texture), optionally in a respective layout arrangement. In some embodiments, the first user interface is a wake screen user interface (e.g., wake screen user interface 490) that is displayed when the device is in a low-power mode (e.g., with the displayed turned off or with the display in a dimmed always-on state), when the device is transitioned from a low-power mode to a regular operating mode (e.g., with the display turned on to a regular brightness level), when the device is transitioned from a regular operating mode (e.g., with the display lit at the regular brightness level) to a low-power mode (e.g., with the display turned off or dimmed), and/or when the device transitions from an application UI (e.g., application user interface 493) and home screen to a locked and/or restricted state. In some embodiments, the first user interface is a home screen user interface (e.g., home screen user interface 492). In some embodiments, the wake screen user interface and the home screen user interface are configured together as a pair, so a change to the wake screen configuration is applied to the configuration of the home screen user interface, and, optionally, vice versa. In some embodiments, receiving the request to display the first user interface includes detecting a raise to wake input or detecting generation of a notification or alert, while the device is in a low-power mode. In some embodiments, receiving the request to display the first user interface includes detecting a power-off input or device sleep input (e.g., a press on the power button, prolonged inactivity by the user, or other event or input that puts the device in a low power mode) while the device is in a regular operating mode. In some embodiments, detecting the request to display the first user interface includes detecting an input that corresponds to a request to close an open application (e.g., an upward edge swipe gesture, a press on the home button, or other inputs), or an input that corresponds to a request to display the coversheet user interface and put the device in a restricted mode (e.g., a downward edge swipe gesture, a press on the power button, or other inputs) that is displayed while an application user interface is displayed.

In response to receiving the request to display the first user interface, the computer system displays (904) the first user interface with a set of user interface elements (e.g., wake screen features such as notifications, a date/time, widgets, and/or status indicators or home screen features such as widgets and/or application icons) overlaid on a wallpaper that includes a plurality of selectable elements (e.g., the wallpaper includes selectable representations of planets in a solar system, or the wallpaper includes selectable avatars of the user's family members, or other selectable representations of a group of subjects). For example, FIG. 6A illustrates user interface 601 (e.g., a wake screen user interface) that is displayed with a first wallpaper that includes time indication 604, a date indication and optionally one or more widgets.

While displaying the first user interface, the computer system detects (906) a first user input directed the wallpaper while a first selectable element and a second selectable element of the plurality of selectable elements are concurrently displayed in the wallpaper. For example, in FIG. 6A, user input 612 is detected in user interface 601 that includes the wallpaper displaying the plurality of planetary bodies 602.

In response to detecting the first user input directed to the wallpaper, the computer system (908): in accordance with a determination that the first user input meets selection criteria and is directed to the first selectable element of the plurality of selectable elements, updates the wallpaper of the first user interface to include the first selectable element, without including the second selectable element of the plurality of selectable elements (e.g., and without including other selectable elements of the plurality of selectable elements). For example, as described with reference to FIGS. 6A-6E, in response to user input 612 selecting planet 602a, planet 602a is displayed in user interface 609 without displaying the other planetary bodies of the plurality of planetary bodies 602. In response to detecting the first user input directed to the wallpaper, the computer system: in accordance with a determination that the first user input meets the selection criteria and is directed to the second selectable element of the plurality of selectable elements, updates the wallpaper of the first user interface to include the second selectable element, without including the first selectable element of the plurality of selectable elements (e.g., and without including other selectable elements of the plurality of selectable elements). In some embodiments, the computer system maintains the same background in the wallpaper and the same set of objects (e.g., widgets, time indication, and other user interface objects) overlaying the wallpaper, in the first user interface, while updating the selectable wallpaper foreground element(s) of the wallpaper. In some embodiments, the computer system also changes the wallpaper background in the wallpaper and/or the set of objects overlaying the wallpaper, in the first user interface, while updating the selectable wallpaper foreground element(s) of the wallpaper. For example, as described with reference to FIGS. 6F-6I, in response to user input 616 selecting planet 602e, an enlarged version of planet 602e is displayed in user interface 617 without displaying the other planetary bodies of the plurality of planetary bodies 602.

In some embodiments, the plurality of selectable elements, including the first selectable element and the second selectable element that are concurrently displayed in the wallpaper, include (910) respective representations of a plurality of planetary bodies (e.g., planets of our solar system, or planets of other solar systems). In some embodiments, the plurality of selectable elements include selectable images of planets in the solar system. In some embodiments, the plurality of selectable elements are arranged in the wallpaper in accordance with their relative positions in the solar system. For example, as described with reference to FIG. 6A, planets 602a-602f are displayed in wake screen user interface 601 as selectable elements. Displaying a plurality of planets in the wallpaper, such that the user is enabled to select a planet from the plurality of planets to view the selected planet (e.g., without viewing the other plurality of planets), provides improved visual feedback and causes the device to display a zoomed-in view of the planet in response to the user input selecting the planet without displaying additional controls.

In some embodiments, displaying the first user interface with the set of user interface elements (e.g., wake screen features such as notifications, a date/time, widgets, and/or status indicators or home screen features such as widgets and/or application icons) overlaid on the wallpaper that includes the plurality of selectable elements includes (912): in accordance with a determination that a current time is a first time that corresponds to a first celestial arrangement of the plurality of planetary bodies, arranging the respective representations of the plurality of planetary bodies in the wallpaper in accordance with the first celestial arrangement of the plurality of planetary bodies; and in accordance with a determination that the current time is a second time that corresponds to a second celestial arrangement of the plurality of planetary bodies, that is different from the first celestial arrangement of the plurality of planetary bodies, arranging the respective representations of the plurality of planetary bodies in the wallpaper in accordance with the second celestial arrangement of the plurality of planetary bodies. For example, in some embodiments, the representations of the planets in the wallpaper are concurrently displayed in a solar system diagram (e.g., an orrery, a representation of a solar system or other planetary model) in accordance with the current time (e.g., and/or a current date) and updated over time to represent the respective positions of the respective planets along their orbits around the Sun. For example, as described with reference to FIG. 6A, the respective positions of the planetary bodies 602 are updated, in real-time, based on the positions of the planetary bodies 602 in space at the current time. As such, the planetary bodies 602 appear to move along their respective orbits (e.g., around the Sun (e.g., star 602g)) over time. Displaying a plurality of planets arranged in a solar system diagram as the wallpaper of a user interface, such that the plurality of planets are arranged in the solar system diagram according to a current date and/or time, provides improved visual feedback indicating a current state of the planets in real-time without requiring additional user input to update the wallpaper over time.

In some embodiments, in response to detecting the first user input directed to the wallpaper, the computer system (914): in accordance with the determination that the first user input meets the selection criteria and is directed to the first selectable element of the plurality of selectable elements, displays a first animation that transitions the wallpaper (e.g., over a period of time) from displaying the plurality of selectable elements to displaying the first selectable element without the second selectable element; and in accordance with the determination that the first user input meets the selection criteria and is directed to the second selectable element of the plurality of selectable element, displays a second animation that transitions the wallpaper (e.g., over a period of time) from displaying the plurality of selectable elements to displaying the second selectable element without the first selectable element. In some embodiments, the animation that is displayed includes a simulated view of a viewer traveling through space across the plurality of selectable elements to the final position occupied by the selected element. In some embodiments, the animation includes moving the respective selected element forward in the user interface as if the selected element is traveling toward the user, while moving the other selectable elements in the plurality of selectable elements out of a display area of the display generation component. For example, as described with reference to FIGS. 6B-6E, an animation is displayed in response to user input 612 selecting planet 602a to transition to displaying an enlarged version of planet 602a (FIG. 6E) without displaying the other planetary bodies displayed in FIG. 6A. Displaying an animation to transition the wallpaper from displaying the plurality of planets to displaying a zoomed-in version of the selected planet, provides improved visual feedback about a state of the device.

In some embodiments, displaying the first animation includes (916) displaying a change in view of a virtual viewer that travels toward the first selectable element of the plurality of selectable elements, and displaying the second animation includes displaying a change in view of the virtual viewer that travels toward the second selectable element of the plurality of selectable elements (e.g., visually deemphasizing the elements that are not selected and visually emphasizing the selected element, such as enlarging and/or moving the selected element towards a center of the field of view provided by the display, as if the viewer is traveling closer to the selected element from his/her initial position). For example, as described with reference to FIG. 6C, the animated transition comprises a travel animation that shifts the solar system diagram in a manner such that the user feels as if the user is traveling towards selected planet 602a. Displaying an animation that transitions the wallpaper from displaying the plurality of planets to the zoomed-in version of the selected planet as if traveling closer, within space, to the selected planet, provides improved visual feedback about a state of the device.

In some embodiments, while displaying the first user interface, including the wallpaper that has been updated in response to detecting the first user input (e.g., the wallpaper displaying the first selectable element without the second selectable element, or the wallpaper displaying the second selectable element without the first selectable element), the computer system detects (918) a second user input directed to the first user interface; and in response to detecting the second user input that is directed to the first user interface: in accordance with a determination that the second user input meets dismissal criteria for dismissing the first user interface (e.g., the second user input includes an upward edge swipe gesture, a press on the home button, or another user input that is used to dismiss the first user interface), restores the wallpaper of the first user interface to display the plurality of selectable element, including concurrently displaying the first selectable element and the second selectable element, without dismissing the first user interface. In some embodiments, while displaying the first user interface with the wallpaper that has been restored in response to the second user input, the computer system detects a third user input directed to the first user interface; and in response to detecting the third user input and in accordance with a determination that the third user input also meets the dismissal criteria for dismissing the first user interface, the computer system dismisses the first user interface and display a home screen user interface, wherein the home screen user interface includes an arrangement of application icons overlaid on a wallpaper that includes the plurality of selectable elements. For example, as described with reference to FIGS. 6E-6F, in response to user input 614 corresponding to a request to dismiss user interface 609, device 100 displays user interface 611 (e.g., redisplays user interface 601) that includes the plurality of planetary bodies 602. Enabling the user to dismiss the wallpaper that displays a zoomed-in version of a selected planet back to the wallpaper that displays the plurality of planets, provides improved visual feedback about a state of the device and enables the user to navigate back to the wallpaper that displays the plurality of planets without displaying additional controls.

In some embodiments, detecting the second user input includes (920) detecting a swipe gesture. In some embodiments, the swipe gesture that meets the dismissal criteria is a swipe in a first direction (e.g., an upward swipe, a downward swipe, and/or a side swipe). In some embodiments, the swipe gesture that meets the dismissal criteria is an edge swipe gesture that starts from a first edge of a touch-sensitive surface that is associated with the display generation component. For example, as described with reference to FIG. 6E, in some embodiments, user input 614 is a swipe gesture in a first direction. Enabling the user to perform a swipe gesture to dismiss the wallpaper that displays a zoomed-in version of a selected planet back to the wallpaper that displays the plurality of planets, provides improved visual feedback about a state of the device and enables the user to navigate back to the wallpaper that displays the plurality of planets without displaying additional controls.

In some embodiments, while displaying the wallpaper that includes the plurality of selectable elements (e.g., in the first user interface, or in a representation of the first user interface shown in an editing user interface), the computer system detects (922) user selection of the first selectable element from the plurality of selectable elements in the wallpaper; and in response to detecting the user selection of the first selectable element from the plurality of selectable elements in the wallpaper, the computer system updates the wallpaper (e.g., in the first user interface, or in the representation of the first user interface shown in the editing user interface) to display the first selectable elements without displaying the second selectable elements (and without displaying other selectable elements of the plurality of selectable elements). In some embodiments, after updating the wallpaper in response to detecting the user selection of the first selectable element, while displaying the first user interface with the wallpaper including the first selectable element without the second selectable element, the computer system detects a request to dismiss the first user interface (e.g., an upward edge swipe gesture or a press on the home button to dismiss the wake screen user interface and displaying a home screen user interface, as described with reference to FIGS. 4C1-4C2). In some embodiments, in response to detecting the request to dismiss the first user interface, the computer system: in accordance with a determination that the user selection of the first selectable element from the plurality of selectable elements occurred while displaying the first user interface, displays a second user interface (e.g., the home screen user interface, or another user interface that has a wallpaper that is coordinated with the wallpaper of the first user interface) with a first wallpaper including the plurality of selectable elements; and in accordance with a determination that the user selection of the first selectable element from the plurality of selectable elements occurred while displaying an editing user interface of the first user interface, displays the second user interface with a second wallpaper including the first selectable element without including the second selectable element. For example, as described with reference to FIGS. 6P-6R, planet 602a is selected as the wallpaper in editing user interface 631 to be used as the wallpaper for wake screen user interface 633 such that, in response to user input 656 to dismiss wake screen user interface 633, home screen user interface 635 is displayed with a wallpaper that includes planet 602a. In some embodiments, as described with reference to FIGS. 6I-6K, in accordance with a determination that planet 602e is selected in user interface 611 (e.g., not in the editing user interface), in response to user input 618 (e.g., and/or user input 626) to dismiss a wake screen user interface, the wallpaper of the user interface 619 and/or home screen user interface 621 includes the plurality of planetary bodies. Automatically assigning a wallpaper for a home screen user interface that is displayed upon dismissing a wake screen user interface based on the wallpaper of the wake screen user interface that is selected by the user, including displaying an enlarged version of a planet as the wallpaper of the home screen user interface if the user selects the planet as the wallpaper for the wake screen user interface, or displaying a solar system diagram as the wallpaper of the home screen user interface if the user selects the solar system as the wallpaper of the wake screen user interface (e.g., even after the user has selected a planet to view from the displayed solar system in the wake screen user interface), provides improved visual feedback about a state of the device and causes the device to automatically display a respective wallpaper of a home screen user interface in response to the user navigating from the wake screen user interface to the home screen user interface without displaying additional control options for the user.

In some embodiments, in an editing user interface for the first user interface, the computer system detects (924) user selection of a respective selectable element from the plurality of selectable elements (e.g., from a representation of the wallpaper while displaying the representation of the wallpaper that includes the plurality of selectable elements (e.g., in a representation of the first user interface shown in an editing user interface, or in a representation of the wallpaper in an editing user interface)). In some embodiments, in response to detecting the user selection of the respective selectable element from the plurality of selectable elements in the wallpaper, the computer system updates the wallpaper (e.g., in the first user interface, or in the representation of the first user interface shown in the editing user interface) to include the respective selectable element without including at least one of the plurality of selectable elements (e.g., without including the first selectable element, or the second selectable elements, and/or other selectable elements of the plurality of selectable elements that is not selected) that is different from the respective selectable element. In some embodiments, after updating the wallpaper in response to the computer system detects the user selection of the respective selectable element in the editing user interface, detecting a second request to display the first user interface. In some embodiments, in response to detecting the second request to display the first user interface, the computer system displays the first user interface with the set of user interface elements (e.g., wake screen features such as notifications, a date/time, widgets, and/or status indicators or home screen features such as widgets and/or application icons) overlaid on the wallpaper that includes the respective selectable element without including at least one of the plurality of selectable elements that is different from the respective selectable element (e.g., including the first selectable element without including the second selectable element, or including the second selectable element without including the first selectable element, or including one of the selectable elements without including other elements of the plurality of selectable elements). For example, as described with reference to FIGS. 6N-6P, the user is enabled to scroll (e.g., via user input 646) through a plurality of wallpaper options, including different planets, in the editing user interfaces (e.g., editing user interface 627, editing user interface 629, and editing user interface 631), and is able to select from the plurality of wallpaper options to assign a respective wallpaper as the wallpaper of wake screen user interface 633 (FIG. 6Q), while maintaining the time indication and/or widgets that are overlaid on the wallpaper. Enabling the user to select which planet or planets to be included in the wallpaper from a set of wallpaper options, provides improved visual feedback about a state of the device and allows the user to customize the wallpaper by selecting from the set of wallpaper options without displaying additional controls.

In some embodiments, the editing user interface for the first user interface includes (926) a respective selectable option for rotating through the plurality of selectable elements in the wallpaper. In some embodiments, while displaying the editing user interface for the first user interface, the computer system detects user selection of the respective selectable option for rotating through the plurality of selectable elements in the wallpaper (e.g., a toggle switch for turning on or off the automatic rotation through the selectable elements in the wallpaper). In some embodiments, in response to detecting the user selection of the respective selectable option for rotating through the plurality of selectable elements in the wallpaper, the computer system enables automatic selection of different selectable elements of the plurality of selectable elements at different times (e.g., in response to a set of conditions being met at a time that the first user interface is displayed or requested to be displayed, such as time-based conditions, a schedule, trigger-based conditions, or other conditions) to include in the wallpaper. In some embodiments, after enabling the automatic selection of different selectable elements of the plurality of selectable elements at different times to include in the wallpaper, the computer system detects a third request to display the first user interface; and in response to detecting the third request to display the first user interface, displays the first user interface with the set of user interface elements (e.g., wake screen features such as notifications, a date/time, widgets, and/or status indicators or home screen features such as widgets and/or application icons) overlaid on the wallpaper, including: at a first point in time, displaying the first user interface with the wallpaper including the first selectable element without including the second selectable element; and at a second point in time after the first point in time: in accordance with a determination that wallpaper updating criteria are met (e.g., a previous selectable element has been used for more than a threshold amount of time, the first user interface has been re-invoked after the device was in a low-power mode, location of the device has changed, or other conditions for switching the selectable element in the wallpaper have been met), displaying the first user interface with the wallpaper including the second selectable element without including the first selectable element; and in accordance with a determination that the wallpaper updating criteria are not met, displaying the first user interface with the wallpaper including the first selectable element without including the second selectable element. For example, as described with reference to FIG. 6N and FIGS. 6S-6V, in response to user input 644 selecting button 642 that corresponds to an option to rotate through (e.g., over time) displaying each planet of the plurality of planets as the wallpaper of the user interface, wake screen user interface 637 is displayed, as illustrated in FIG. 6S, and is automatically updated to display a different wallpaper (e.g., that includes a different planet), as described with reference to FIGS. 6T-6V. Enabling the user to select a wallpaper option that automatically rotates through the different planets, provides improved visual feedback about a state of the device and reduces the number of inputs needed to update the wallpaper over time.

In some embodiments, the computer system displays (928) respective labels for the plurality of selectable elements in a representation of the first user interface in the editing user interface (e.g., a name of the planet is displayed adjacent to and/or overlapping the representation of the planet in the solar system view). For example, as described with reference to FIG. 6L, a plurality of labels are displayed proximate to the plurality of planetary bodies in editing user interface 623. For example, label 628 “Saturn” is displayed proximate to planet 602a corresponding to Saturn. Displaying labels for the planets while the user is configuring the wallpaper, provides improved visual feedback about a state of the device to help the user identify the planets without requiring the user to manually lookup or research the planets, thereby reducing the number of inputs needed to view information about the planets.

In some embodiments, while displaying the respective labels for the plurality of selectable elements in the representation of the first user interface in the editing user interface (e.g., a name of the planet is displayed adjacent to and/or overlapping the representation of the planet in the solar system view), in accordance with a determination that user input has not been received for at least a first threshold amount of time, the computer system visually deemphasizes (930) the respective labels for the plurality of selectable elements displayed in the representation of the first user interface. In some embodiments, the plurality of labels fade over time. In some embodiments, the plurality of labels cease to be displayed after a period of inactivity on the representation of the first user interface. For example, as described with reference to FIG. 6M, the plurality of labels cease to be displayed (e.g., fade or otherwise are visually deemphasized over time (e.g., as the user continues to make changes to the user interface in editing user interface 623)) in editing user interface 625. Automatically fading the labels for the planets while the user is configuring the wallpaper, provides improved visual feedback about a state of the device by providing the user with information about the planets before removing the labels to reduce clutter displayed in the user interface as the user configures the wallpaper.

In some embodiments, while the respective labels for the plurality of selectable elements are visually deemphasized, the computer system detects (932) a third user input directed to the editing user interface (e.g., the respective user input is a tap input directed to an unoccupied space in the editing user interface (e.g., an area that is not occupied by an affordance or the selectable elements); and in response to the third user input directed to the editing user interface, the computer system restores a level of visual emphasis of the respective labels for the plurality of selectable elements in the representation of the first user interface. For example, as described with reference to FIG. 6M, in response to user input 632 and in accordance with a determination that user input 632 is detected in negative space of the wallpaper background, device 100 redisplays (e.g., or otherwise visually emphasizes) the plurality of labels for the plurality of planets, as illustrated in FIG. 6N. Redisplaying the labels for the planets in response to a user input detected in negative space in the editing user interface while the user is configuring the wallpaper, provides improved visual feedback about a state of the device by providing the user with information about the planets in response to a user input in the editing user interface, without displaying additional controls or requiring the user to navigate complex menu hierarchies, thereby reducing the number of inputs needed to redisplay the information about the planets.

In some embodiments, while displaying the first user interface that includes the set of user interface elements overlaid on the wallpaper that includes the plurality of selectable elements (e.g., concurrently displaying the first selectable element and the second selectable element, and/or other selectable elements of the plurality of selectable elements), the computer system detects (934) a fourth user input directed to a first user interface element of the set of user interface elements that are displayed overlaid on the wallpaper; and in response to detecting the fourth user input, in accordance with a determination that the fourth user input meets action criteria (e.g., criteria for detecting a long press, a light press, a double tap, or other types of input), performs a first operation corresponding to the first user interface element. In some embodiments, the first user interface element corresponds to a widget associated with a respective application; and in response to the fourth user input selecting the widget, the respective application associated with the widget is opened and/or displayed. In some embodiments, the first user interface element corresponds to an application shortcut (e.g., for accessing the flashlight, camera, or other application); and in response to the fourth user input, the application for the application shortcut is opened and/or displayed. In some embodiments, the first user interface element includes a time indication and in response to the fourth user input, an editing user interface for the first user interface is displayed. For example, as described with reference to FIG. 6J, a plurality of inputs, each input corresponding to a different operation, is detected in user interface 619. For example, user input 622 detected in user interface 619 corresponds to a request to modify, or configure, user interface 619, user input 620 corresponds to a selection of news widget 610, and in response to detecting user input 620, a user interface for the application associated with widget 610 (e.g., a news application) is displayed at device 100, and user input 624 corresponds to a request to open a camera application, and in response to detecting user input 624, the device 100 displays a user interface that includes a camera view such that the user is enabled to capture images using one or more cameras of device 100. Performing one of a plurality of possible operations that is selected based on a type of user input (e.g., a tap input, a swipe input, and/or a location of the device at which the input is detected), in response to a user input that is detected while displaying the wallpaper of a user interface, including navigating to other user interfaces, reduces the number of inputs needed to access various applications and functions of the device without displaying additional controls.

In some embodiments, in response to detecting the first user input directed to the wallpaper, the computer system (936): in accordance with a determination that the first user input meets the selection criteria and is directed to the first selectable element of the plurality of selectable elements, maintains display of the set of user interface elements displayed overlaid on the wallpaper after the wallpaper is updated to include the first selectable element without including the second selectable element; and in accordance with a determination that the first user input meets the selection criteria and is directed to the second selectable element of the plurality of selectable elements, maintains display of the set of user interface elements displayed overlaid on the wallpaper after the wallpaper is updated to include the second selectable element without including the first selectable element (e.g., the wake screen date and/or time indications and optionally widgets displayed on the wake screen are maintained while the wallpaper changes (e.g., to show different planets as the wallpaper)). For example, the same wake screen elements continue to be displayed even as the user changes the planet (or other element) that is featured as the wallpaper background. For example, as described with reference to FIGS. 6A-6E, the date and/or time indication, and optionally one or more widgets, optionally continue to be displayed as the user interface transitions from displaying the plurality of planetary bodies 602 to selected planet 602a. Maintaining display of user interface elements, such as system controls, a date and/or time indication, widgets, or other elements displayed in the wallpaper, even as the wallpaper is updated to display different planets, continues to provide feedback about a state of the device as the wallpaper updates and reduces the number of inputs needed for the user navigate back to the wallpaper in order to view the user interface elements.

In some embodiments, the wallpaper that includes the plurality of selectable elements further includes (938) a first wallpaper background underlying the plurality of selectable elements (e.g., a wallpaper background of space, such as black with stars or other entities); and in response to detecting the first user input directed to the wallpaper, the computer system: in accordance with a determination that the first user input meets the selection criteria and is directed to the first selectable element of the plurality of selectable elements, maintains display of the first wallpaper background underlying the first selectable element after the wallpaper is updated to include the first selectable element without including the second selectable element; and in accordance with a determination that the first user input meets the selection criteria and is directed to the first selectable element of the plurality of selectable elements, maintains display of the first wallpaper background underlying the second selectable element after the wallpaper is updated to include the second selectable element without including the first selectable element. In some embodiments, the updated wallpaper displayed while maintaining the wallpaper background comprises maintaining the background of space, although a different portion of space is displayed in the updated background (e.g., a portion of space that corresponds to the space around the selectable element that has been selected). For example, as described with reference to FIG. 6E, user interface 601 includes plurality of planetary bodies 602 as wallpaper foreground elements and displays a representation of space (e.g., a black or dark area, optionally with stars distributed within space) as the wallpaper background, and the second wallpaper of user interface 609 includes a different wallpaper foreground element (e.g., only one planet of the plurality of planetary bodies 602 without the other planets) while maintaining the wallpaper background as the representation of space. Maintaining a background of the wallpaper, such as a representation of space that surrounds the planets displayed in the wallpaper, even as the wallpaper is updated to display different planets, provides feedback about a state of the device without requiring the user to provide inputs to configure the wallpaper background.

It should be understood that the particular order in which the operations in FIGS. 9A-9F have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 800, 1000 and 1200) are also applicable in an analogous manner to method 900 described above with respect to FIGS. 9A-9F. For example, the user interface objects, wallpapers and user inputs described above with reference to method 900 optionally have one or more of the characteristics of the user interface objects, wallpapers and user inputs described herein with reference to other methods described herein (e.g., methods 800, 1000 and 1200). For brevity, these details are not repeated here.

FIGS. 10A-10F are flow diagrams illustrating method 1000 for displaying different configurations of a user interface while the device is in different orientations in accordance with some embodiments. Method 1000 is performed at a computer system (e.g., an electronic device, device 300, FIG. 3, or portable multifunction device 100, FIG. 1A) with a display and a touch-sensitive surface. In some embodiments, the display is a touch-screen display and the touch-sensitive surface is on or integrated with the display. In some embodiments, the display is separate from the touch-sensitive surface. Some operations in method 1000 are, optionally, combined and/or the order of some operations is, optionally, changed.

As described below, method 1000 enables a user to configure a user interface while the device is in different orientations, thereby providing the user with options to add different application widgets in different configurations that can be accessed by rotating the device, which provides additional control options without cluttering the user interface with additional displayed controls.

The computer system receives (1002) a request to display a first user interface. In some embodiments, the first user interface is a system user interface that includes a wallpaper and a plurality of system user interface objects (e.g., time, widgets, application icons, status indicators, or other system user interface objects), where the wallpaper includes one or more foreground elements (e.g., a pattern, an image, or other graphical elements) overlaying a background (e.g., a background color, a background gradient, or a background texture), optionally in a respective layout arrangement. In some embodiments, the first user interface is a wake screen user interface (e.g., wake screen user interface 490) that is displayed when the device is in a low-power mode (e.g., with the displayed turned off or with the display in a dimmed always-on state), when the device is transitioned from a low-power mode to a regular operating mode (e.g., with the display turned on to a regular brightness level), when the device is transitioned from a regular operating mode (e.g., with the display lit at the regular brightness level) to a low-power mode (e.g., with the display turned off or dimmed), and/or when the device transitions from an application UI (e.g., application user interface 493) and home screen to a locked and/or restricted state. In some embodiments, the first user interface is a home screen user interface (e.g., home screen user interface 492). In some embodiments, the wake screen user interface and the home screen user interface are configured together as a pair, so a change to the wake screen configuration is applied to the configuration of the home screen user interface, and, optionally, vice versa. In some embodiments, receiving the request to display the first user interface includes detecting a raise to wake input or detecting generation of a notification or alert, while the device is in a low-power mode. In some embodiments, receiving the request to display the first user interface includes detecting a power-off input or device sleep input (e.g., a press on the power button, prolonged inactivity by the user, or other event or input that puts the device in a low power mode) while the device is in a regular operating mode. In some embodiments, detecting the request to display the first user interface includes detecting an input that corresponds to a request to close an open application (e.g., an upward edge swipe gesture, a press on the home button, or other inputs), or an input that corresponds to a request to display the coversheet user interface and put the device in a restricted mode (e.g., a downward edge swipe gesture, a press on the power button, or other inputs) that is displayed while an application user interface is displayed.

In response to receiving the request to display the first user interface, the computer system displays (1004) the first user interface (e.g., a wake screen user interface, a home screen user interface, or another system user interface) that includes a plurality of widgets (e.g., along with one or more other user interface elements such as wake screen features such as notifications, a date/time, and/or status indicators or home screen features such as application icons), including: in accordance with a determination that the first user interface is displayed in a first orientation (e.g., a landscape orientation, an upright orientation, or another canonical orientation of the user interface or display), displaying a first version of the first user interface that includes a first set of widgets (e.g., the first version of the first user interface is displayed in the first orientation relative to the display and the first set of widget). For example, as described with reference to FIG. 7L, while the device 100 is in the landscape orientation, the user interface 723 is displayed with a first set of widgets that includes widget 724, widget 734, widget 726 and widget 728. In accordance with a determination that the first user interface is displayed in a second orientation (e.g., a portrait orientation, an upward facing orientation in which a screen of the device is facing upward, or another canonical orientation of the user interface or display) that is different from the first orientation, the computer system displays a second version of the first user interface that includes a second set of widgets, wherein the widgets included in the second set of widgets are different from the widgets included in the first set of widgets (e.g., the first set of widgets includes one or more widgets not included in the second set of widgets and/or the second set of widgets includes one or more widgets not included in the first set of widgets) (e.g., the second version of the first user interface is displayed in the second orientation relative to the display and the second set of widget). For example, as described with reference to FIG. 7Q, while the device 100 is in the portrait orientation, the user interface 735 is displayed with a second set of widgets, including widgets 760b, 762b and 764b that are different from the first set of widgets displayed in user interface 723 (FIG. 7L) that is displayed while the device 100 is in the landscape orientation. In some embodiments, while the display generation component has the first orientation that meets first orientation criteria (e.g., the first orientation is recognized as a landscape orientation, as opposed to a portrait orientation, or vice versa), the first version of the first user interface is displayed. In some embodiments, the first user interface is a wake screen user interface, a lock screen user interface, or another user interface that corresponds to a restricted state of the computer system. In some embodiments, the first user interface is an initial user interface that is displayed when the computer system transitions from a power-saving mode to a normal operation mode, and/or is a basic limited function user interface that needs to be dismissed before a home screen or application launching user interface is displayed. In some embodiments, the first user interface is a home screen user interface that includes both application icons and widgets corresponding to different applications.

In some embodiments, the device includes sensors that detects a change in the orientation of the display generation component, and in response to detecting movement of the display generation component: in accordance with a determination that the movement of the display generation component caused the display generation component to rotate from the first orientation to a second orientation that meets second orientation criteria, different from the first orientation criteria (e.g., the second orientation is recognized as a portrait orientation, as opposed to the landscape orientation, or vice versa), the computer system displays a second version of the first user interface. In some embodiments, the first version of the first user interface includes a first set of widgets arranged in accordance with a first layout corresponding to the first orientation of the display generation component, the second version of the first user interface includes a second set of widgets arranged in accordance with a second layout corresponding to the second orientation of the display generation component, and wherein: at least the first set of widgets and the second set of widgets, or the first layout and the second layout, are separately configurable by a user. In some embodiments, the user is enabled to configure the first set of widgets into a first layout in the portrait orientation and the second, different, set of widgets into a second, different, layout, in the landscape orientation; or the user is enabled to configure the first set of widgets and the second set of widgets differently, and the computer system automatically arranges them into the first layout and the second layout in the two different orientations. In some embodiments, the user is enabled to select the same set of widgets for both orientations, and separately configure the layouts (e.g., sequence, and spatial arrangement) for the two orientations. In some embodiments, for each of the orientations, the user can separately configure the set of widgets and their spatial arrangement in a configuration mode (e.g., the user is enabled to move, reorder, add, delete, and/or change the set of widgets (e.g., to include different user interface objects) in an arrangement while a respective version of the first user interface is displayed based on the current orientation of the display generation component.

In some embodiments, while displaying the first version of the first user interface that includes the first set of widgets in accordance with the determination that the first user interface is displayed in the first orientation, the computer system detects (1006) a first set of one or more user inputs that corresponds to a request to replace (e.g., add, remove, reorder or otherwise change) the first set of widgets in the first version of the first user interface with a third set of widgets different from the first set of widgets. In some embodiments, the first set of one or more user inputs include a tap and hold input on the first set of widgets to invoke display of a widget picker to add additional widgets into the existing set of widgets on the first version of the first user interface followed by subsequent inputs that select widgets using the widget picker to add widgets into the existing set of widgets on first version of the first user interface, a tap and hold input on one of the widgets in the first set of widgets to invoke display of deletion affordances for the respective widgets of the first set of widgets followed by selection of the deletion affordances for one or more of the first set of widgets to delete the corresponding widgets from the first version of the first user interface. In some embodiments, in response to detecting the first set of one or more user inputs, the computer system updates the first version of the first user interface displayed in the first orientation to includes the third set of widgets instead of the first set of widgets. For example, as described with reference to FIGS. 7A-7K, the user is enabled to configure user interface 723 while device 100 is in a landscape orientation, including adding and rearranging widgets in widgets area 708. Enabling a user to direct inputs to objects at different locations in an editing user interface while the device is in a landscape orientation (e.g., or a portrait orientation), including to arrange widgets that are periodically updated with content from associated active applications, enables the user to customize different widgets in the user interface while the device is in the landscape orientation (e.g., or a portrait orientation) and causes the device to automatically display a set of selectable widgets that are periodically updated with content from associated active applications on the user interface while the device is in the landscape orientation (e.g., or a portrait orientation).

In some embodiments, while displaying the second version of the first user interface that includes the second set of widgets in accordance with the determination that the first user interface is displayed in the second orientation, the computer system detects (1008) a second set of one or more user inputs that corresponds to a request to replace (e.g., add, remove, reorder or otherwise change) the second set of widgets in the second version of the first user interface with a fourth set of widgets different from the second set of widgets. In some embodiments, the second set of one or more user inputs include a tap and hold input on the second set of widgets to invoke display of a widget picker to add additional widgets into the existing set of widgets on the second version of the first user interface and subsequent inputs to select widgets from the widget picker to add to the existing set of widgets in the second version of the first user interface, a tap and hold input on one of the widgets in the second set of widgets to invoke display of deletion affordances for the respective widgets of the second set of widgets followed by selection of the deletion affordances for one or more of the second set of widgets to delete the corresponding widgets from the second version of the first user interface. In some embodiments, in response to detecting the first set of one or more user inputs, the computer system updates the second version of the first user interface displayed in the second orientation to includes the fourth set of widgets instead of the second set of widgets. For example, as described with reference to FIGS. 7M2-7Q, the user is enabled to configure the user interface 735, including adding widgets to widgets area 750 in an editing user interface while the device 100 is in a portrait orientation. Enabling a user to direct inputs to objects at different locations in an editing user interface while the device is in a portrait orientation (e.g., or a landscape orientation), including to arrange widgets that are periodically updated with content from associated active applications, enables the user to customize different widgets in the user interface while the device is in the portrait orientation (e.g., or a landscape orientation) and causes the device to automatically display a set of selectable widgets that are periodically updated with content from associated active applications on the user interface while the device is in the portrait orientation (e.g., or a landscape orientation).

In some embodiments, while displaying the first version of the first user interface that includes the first set of widgets in accordance with a determination that the first user interface is displayed in the first orientation, the computer system detects (1010) a first request to display the first user interface in the second orientation (e.g., including detecting a first movement of the display generation component that causes the display generation component to rotate from the first orientation to the second orientation, or other inputs that causes the first user interface to be displayed in the second orientation). In some embodiments, in response to detecting the request to display the first user interface in the second orientation, the computer system displays the first user interface in the second orientation, including displaying the second version of the first user interface that includes the second set of widgets. In some embodiments, while displaying the first user interface in the second orientation, the computer system detects a third set of one or more user inputs that corresponds to a request to rearrange a respective layout of the second set of widgets in the second version of the first user interface. In some embodiments, in response to detecting the third set of user inputs, the computer system updates the first user interface displayed in the second orientation, including updating the respective layout of the second set of widgets in the second version of the first user interface in accordance with the third set of one or more user inputs (e.g., moving and/or reordering the widgets in the second set of widgets while the second version of the first user interface is displayed). In some embodiments, after updating the first user interface displayed in the second orientation (e.g., while displaying the second version of the first user interface that includes the second set of widgets in the updated layout), the computer system detects a first request to display the first user interface in the first orientation (e.g., including detecting a second movement of the display generation component that causes the display generation component to rotate from the second orientation to the first orientation, or other inputs that causes the first user interface to be displayed in the first orientation); and in response to detecting the first request to display the first user interface in the first orientation, the computer system displays the first user interface in the first orientation, including displaying the first version of the first user interface that includes the first set of widgets (e.g., without the effect of the changes made in the second version of the first user interface). For example, in FIG. 7L, user interface 723 is configured to include a first set of widgets while the device 100 is in a landscape orientation, and in FIGS. 7M1 and 7M2, a different set of widgets (e.g., a subset of widgets and/or different sized widgets) and/or no widgets (FIG. 7M2) are displayed while the device 100 is in a portrait orientation. In some embodiments, after the user modifies the widgets while in portrait orientation, as described with reference to FIGS. 7N-7Q, the device 100 is rotated back to the landscape orientation in FIG. 7R and redisplays the first set of widgets in user interface 723 without regard to the configuration of the user interface 735 while the device 100 was in the portrait orientation. Automatically switching between the user interface configured with a first set of widgets in the landscape orientation (e.g., or the portrait orientation) to the user interface configured with a second set of widgets in the portrait orientation (e.g., or landscape orientation) that are different from the first set of widgets in the landscape orientation in response to the device changing orientations, such that when the device switches back to the landscape orientation, the user interface configured with the first set of widgets in the landscape orientation is redisplayed, enables the user to access different sets of widgets without displaying additional controls and reduces a number of inputs needed to navigate between the sets of widgets.

In some embodiments, after updating the first user interface displayed in the second orientation and while displaying the first user interface in the first orientation, including displaying the first version of the first user interface that includes the first set of widgets, the computer system detects (1012) a second request to display the first user interface in the second orientation. In some embodiments, in response to detecting the second request to display the first user interface in the second orientation, the computer system displays the first user interface in the second orientation, including displaying the second version of the first user interface in which the respective layout of the second set of widgets have been updated in accordance with the third set of one or more user inputs. For example, as described with reference to FIG. 7V, the device 100 is rotated back to the portrait orientation, and redisplays user interface 735, including displaying the same widgets that are displayed according to the user's configuration of the widgets in the portrait orientation in FIG. 7P, without regard to the modifications made to the user interface while device 100 was in the landscape orientation in FIGS. 7R-7U. Automatically switching between the user interface configured with a first set of widgets in the landscape orientation to the user interface configured with a second set of widgets in the portrait orientation that are different from the first set of widgets in the landscape orientation in response to the device changing orientations enables the user to access different sets of widgets without displaying additional controls and reduces a number of inputs needed to navigate between the sets of widgets.

In some embodiments, while displaying the second version of the first user interface that includes the second set of widgets in accordance with a determination that the first user interface is displayed in the second orientation, the computer system detects (1014) a second request to display the first user interface in the first orientation (e.g., including detecting a third movement of the display generation component that causes the display generation component to rotate from the second orientation to the first orientation, or other inputs that causes the first user interface to be displayed in the first orientation). In some embodiments, in response to detecting the second request to display the first user interface in the first orientation, the computer system displays the first user interface in the first orientation, including displaying the first version of the first user interface that includes the first set of widgets. In some embodiments, while displaying the first user interface in the first orientation, the computer system detects a fourth set of one or more user inputs that corresponds to a request to rearrange a respective layout of the first set of widgets in the first version of the first user interface. In some embodiments, in response to detecting the fourth set of user inputs, the computer system updates the first user interface displayed in the first orientation, including updating the respective layout of the first set of widgets in the first version of the first user interface in accordance with the fourth set of one or more user inputs (e.g., moving and/or reordering the widgets in the first set of widgets while the first version of the first user interface is displayed). In some embodiments, after updating the first user interface displayed in the first orientation (e.g., while displaying the first version of the first user interface that includes the first set of widgets in the updated layout), the computer system detects a third request to display the first user interface in the second orientation (e.g., including detecting a fourth movement of the display generation component that causes the display generation component to rotate from the first orientation to the second orientation, or other inputs that causes the first user interface to be displayed in the second orientation). In some embodiments, in response to detecting the third request to display the first user interface in the second orientation, the computer system displays the first user interface in the second orientation, including displaying the second version of the first user interface that includes the second set of widgets (e.g., without the effect of the changes made in the first version of the first user interface). For example, as described with reference to FIGS. 7V-7Y, the user updates the set of widgets displayed in user interface 747 from the set of widgets displayed in user interface 735 while device 100 is in the portrait orientation. In some embodiments, as described with reference to FIG. 7Z, in response to the device 100 rotating into the landscape orientation, the user interface 741 is redisplayed with the set of widgets configured for the landscape orientation without regard to the changes the user made to the set of widgets displayed in user interface 747 while the device 100 is in the portrait orientation. Enabling the user to configure the first set of widgets while the user interface is configured in the landscape orientation without modifying the user interface configured with the second set of widgets in the portrait orientation, such that the device displays different sets of widgets in response to the device switching between orientations, allows the user to independently configure the user interface in different orientations and provides the user with access to different sets of widgets without displaying additional controls and reduces a number of inputs needed to navigate between the sets of widgets.

In some embodiments, after updating the first user interface displayed in the first orientation and while displaying the first user interface in the second orientation, including displaying the second version of the first user interface that includes the second set of widgets, the computer system detects (1016) a third request to display the first user interface in the first orientation; and in response to detecting the third request to display the first user interface in the first orientation, displays the first user interface in the first orientation, including displaying the first version of the first user interface in which the respective layout of the first set of widgets have been updated in accordance with the fourth set of one or more user inputs. For example, after rotating the device 100 into the landscape orientation in FIG. 7Z, in some embodiments, in response to detecting the device 100 is rotated back into the portrait orientation, the user interface 747 (FIG. 7Y) is redisplayed, including displaying the set of widgets that was previously configured while the device 100 is in the portrait orientation (e.g., as described with reference to FIGS. 7V-7Y). Automatically switching between the user interface configured with the second set of widgets in the portrait orientation to the user interface configured with the first set of widgets in the landscape orientation that are different from the second set of widgets in the portrait orientation in response to the device changing orientations enables the user to access different sets of widgets without displaying additional controls and reduces a number of inputs needed to navigate between the sets of widgets.

In some embodiments, while displaying the first user interface in the first orientation, including displaying the first version of the first user interface, the computer system detects (1018) a movement of the display generation component; and in response to detecting the movement of the display generation component: in accordance with a determination that rotation criteria (e.g., the display generation component has not been rotated into the second orientation, and/or maintained in the second orientation for a threshold amount of time) are not met by the movement of the display generation component, the computer system maintains display of the first set of widgets in the first version of the first user interface in accordance with a first layout (e.g., with a first order, first size and/or a first spacing between the widgets in the first set of widgets) in the first version of the respective user interface; and in accordance with a determination that the rotation criteria are met by the movement of the display generation component, the computer system displays the first user interface in the second orientation, including displaying the second version of the first user interface that includes the second set of widgets in accordance with a second layout (e.g., with a second order, second size and/or a second spacing between the widgets in the second set of widgets that is different than the order, size and/or spacing of the first set of widgets) in the second version of the respective user interface. In some embodiments, the first set of widgets and the second set of widgets have at least one widget in common. In some embodiments, the widget that is in both the first set of widgets and the second set of widgets are not located at the same location (e.g., does not have the same spatial relationship to other widgets and/or other elements of the first user interface) in the first version and the second version of the first user interface. For example, in FIG. 7Y, user interface 747 (e.g., a wake screen user interface) is displayed with a set of widgets while the device 100 is in the portrait orientation, and in response to device 100 rotating to the landscape orientation in FIG. 7Z, a distinct set of widgets is displayed in user interface 741 (e.g., a wake screen user interface) while the device 100 is in the landscape orientation. Providing a different arrangement for the first set of widgets in the landscape orientation than an arrangement for the second set of widgets in the portrait orientation provides visual feedback about a state of the device and enables the user to access different sets of widgets by rotating the device without requiring additional user inputs.

In some embodiments, displaying the first user interface in the first orientation includes (1020) displaying the first set of widgets in a first region (e.g., at a first position, or along a first side edge) (e.g., having a first layout) of a display area of the display generation component; and displaying the first user interface in the second orientation includes displaying the second set of widgets in a second region (e.g., at a second position, or within an interior region, such as below a time indication) (e.g., having a second layout) of the display area of the display generation component, the second region being different from the first region. In some embodiments, the second region and the first region differ in size, location, overall grid size, individual grid size, maximum numbers of widgets that can be accommodated, widget reflow behavior, widget position snapping behavior, and/or other appearance and behavior attributes. In some embodiments, the first region and/or the second region are defined relative to the edges or center of the display area of the display generation component. In some embodiments, the first region and/or the second region are defined relative to other elements of the first user interface (e.g., the time indication, or the date indication). For example, a time indication is displayed in both the first orientation and the second orientation, wherein the time indication is displayed in an upper middle portion of the display in the respective orientation. In some embodiments, the first region is below the time indication and the second region is to the left and/or right of the time indication (e.g., along an edge of the display generation component). For example, as described with reference to FIG. 7B, widgets area 708 corresponds to an area of the display (e.g., to the left of the time indication) to which one or more widgets may be added while the device 100 is in a landscape orientation, and as described with reference to FIG. 7N, widgets area 750 corresponds to an area of the display (e.g., below the time indication) to which one or more widgets may be added while the device 100 is in a portrait orientation. Providing a different arrangement for the first set of widgets in the landscape orientation within a first area of the user interface than an arrangement for the second set of widgets in the portrait orientation within a second area, distinct from the first area, of the user interface provides visual feedback about a state of the device and enables the user to access different sets of widgets that are displayed within a respective area of the user interface to reduce cluttering of the display.

In some embodiments, while displaying an editing user interface for editing the first user interface, the computer system detects (1022) a fifth set of user inputs that corresponds to a request to add one or more new widgets to the first user interface displayed in a respective orientation (e.g., the first orientation or the second orientation). In some embodiments, in response to detecting the fifth set of user inputs that corresponds to a request to add the one or more new widgets to the first user interface displayed in the respective orientation, the computer system adds the one or more new widgets to the first user interface displayed in the respective orientation, including: in accordance with a determination that the respective orientation is the first orientation, displaying the one or more new widgets adjacent to another widget in the first set of widgets in the first version of the first user interface. In some embodiments, adding the one or more new widgets to the first user interface displayed in the respective orientation includes, in accordance with a determination that the respective orientation is the second orientation, displaying the one or more new widgets adjacent to another widget in the second set of widgets in the second version of the first user interface. For example, as described with reference to FIG. 7C, a selected widget is automatically added to a position in the widgets area 708 according to one or more arrangement criteria, such that the newly added widget is placed adjacent to other widget in the widgets area 708. Automatically placing added widgets proximate to the other widgets that are included in the user interface, without requiring the user to manually adjust or place the added widgets, reduces the number of inputs needed to configure the widgets in the user interface.

In some embodiments, while displaying the first user interface (e.g., in an editing user interface for editing the first user interface, or displaying the first user interface in an editing mode) (e.g., in a first orientation or a second orientation) in a respective orientation of the first orientation and the second orientation, the computer system detects (1024) a sixth set of user inputs that corresponds to a request to drag and drop a first widget of a respective set of widget of the first user interface from a first location to a second location in a respective version (e.g., the first version or the second version) of the first user interface displayed in the respective orientation (e.g., the first orientation or the second orientation). In some embodiments, in response to detecting the sixth set of user inputs, the computer system moves the first widget of the respective set of widget of the first user interface to a new location in the respective version (e.g., the first version or the second version) of the first user interface displayed in the respective orientation (e.g., the first orientation or the second orientation), including: in accordance with a determination that the sixth set of user inputs includes a first amount of movement, displaying the first widget at a first location; and in accordance with a determination that the sixth set of user inputs includes a second amount of movement, displaying the first widget at a second location, wherein the first location and the second location are unoccupied by other widgets of the respective set of widgets (e.g., the space between the first location and the second location are able to accommodate one or more widgets, but is not currently occupied by any widgets during the movement of the first widget). For example, as described with reference to FIGS. 7D-7F, user input 732a is a drag user input, such that user input 732a moves while maintaining contact with the touch screen of device 100, and a representation of widget 734 moves with the detected movement of user input 732b, as illustrated in FIG. 7E, to be placed in widgets area 708. Enabling the user to select and/or adjust locations of the widgets by dragging and dropping the widgets that are included in the user interface such that there is space between widgets in the user interface provides the user with additional control options to customize the user interface.

In some embodiments, in response to detecting the fifth set of user inputs that corresponds to a request to add the one or more new widgets to the first user interface displayed in the respective orientation, the computer system automatically selects (1026) respective positions of the one or more new widgets in the first user interface in accordance with a language setting of the computer system. In some embodiments, an added widget is automatically placed to the first open space that the widget will fit in the top left (e.g., or bottom left) for languages that read text from left to right, whereas an added widget is automatically placed in the first open space that the widget will fit in the top right (e.g., or bottom right) for languages that read text from right to left. In some embodiments, another placement rule for automatic arrangement of widgets is provided. For example, as described with reference to FIG. 7C, in some embodiments, the one or more arrangement criteria cause device 100 to add newly added widgets from left-to-right if the language setting corresponds to a language that reads from left-to-right, while the one or more arrangement criteria cause device 100 to add newly added widgets from right-to-left if the language setting corresponds to a language that reads from right-to-left (e.g., or vice-versa). Automatically placing added widgets proximate to the other widgets from right-to-left or left-to-right depending on a language setting of the device, without requiring the user to manually adjust or place the added widgets, reduces the number of inputs needed to configure the widgets in the user interface.

In some embodiments, the first user interface includes (1028) a set of user interface elements (e.g., time indication, widgets, and other user interface objects of the first user interface) displayed overlaid on a wallpaper that includes one or more wallpaper foreground elements (e.g., the wallpaper foreground elements include one or more planets, one or more image or graphics overlaid on a wallpaper background). In some embodiments, in accordance with a determination that the first user interface is displayed in the first orientation, the computer system displays the first version of the first user interface (that, optionally, includes the first set of widgets among the set of user interface elements), including displaying the one or more wallpaper foreground elements as at least partially occluding the set of user interface elements, irrespective of whether the first version of the first user interface currently includes widgets. For example, in some embodiments, the wallpaper foreground elements include a planet that partially covers up a time indication that is displayed in a wake screen user interface when the wake screen user interface is displayed in the landscape orientation. In some embodiments, the one or more wallpaper foreground elements are displayed in front of portions of one or more user interface elements to provide a sense of depth (e.g., depth of field) of the respective user interface. In some embodiments, the one or more wallpaper foreground elements are displayed as at least partially occluding the set of user interface elements regardless of whether there are widgets displayed in the first user interface in the first orientation. In some embodiments, in accordance with a determination that the respective user interface is displayed in the second orientation, the computer system displays the second version of the first user interface, wherein displaying the second version of the first user interface includes: in accordance with a determination that the second version of the first user interface currently includes widgets (e.g., the second set of widgets, or another set of widgets), displaying the one or more wallpaper foreground elements without occluding the set of user interface elements in the second version of the first user interface. In some embodiments, in accordance with a determination that the second version of the first user interface does not currently includes widgets, the computer system displays the one or more wallpaper foreground elements at least partially occluding the set of user interface elements in the second version of the first user interface. For example, in some embodiments, the wallpaper foreground elements include a planet that does not occlude the time indication that is displayed in the wake screen user interface in the portrait orientation if there are widgets in the wake screen user interface; and the planet does occlude the time indication if there is no widget in the wake screen user interface. In some embodiments, the widgets in the wake screen user interface are displayed as overlaid on the one or more wallpaper foreground elements in the wake screen user interface displayed in the portrait orientation. For example, as described with reference to FIG. 7L, while device 100 is in the first orientation (e.g., landscape orientation), widgets 724, 734, 726 and 728 are displayed in an area of the display proximate to an edge of the display (e.g., a left side of the display) (e.g., corresponding to widgets area 708 that is displayed in the editing user interface) and/or to the left of time indication 704. In some embodiments, as described with reference to FIG. 7Q, while device 100 is in the second orientation (e.g., the portrait orientation), while one or more widgets are displayed in wake screen user interface 735, time indication 746 is no longer partially occluded (e.g., as compared to wake screen user interface 727 in FIG. 7M2 that does not include widgets and shows the sun overlapping (e.g., partially occluding) a portion of time indication 746). Displaying a wallpaper foreground element that partially occludes a time indication, with or without widgets in the user interface, when the device is in landscape orientation and displaying a wallpaper foreground element that partially occludes a time indication, only without displaying widgets in the user interface, when the device is in portrait orientation, causes the device to automatically give visual emphasis to portions of the wallpaper foreground element while providing feedback about a state of the device.

In some embodiments, the computer system displays (1030) an editing user interface for a respective version of the first user interface, wherein the editing user interface includes: a listing of applications, and for a respective application in the list of applications, one or more widgets associated with the respective application. In some embodiments, the computer system detects user selection of a third widget from the one or more widgets associated with the respective application; and in response to detecting the user selection of the third widget, the computer system adds the third widget to the respective set of widgets in the respective version of the first user interface. For example, as described with reference to FIG. 7C, widget platter 716 includes a plurality of selectable widgets to be added to widgets area 708. Enabling a user to direct inputs to objects at different locations in a configuration user interface to bring up different sets of selectable options, including selecting widgets from a widget picker, enables the user to customize different objects in the user interface and causes the device to automatically display a set of selectable options that is appropriate for the particular object that the user wants to edit.

In some embodiments, the first set of widgets includes (1032) at least one widget that is not included in the second set of widgets (e.g., the first set of widgets includes a fourth widget and a fifth widget, and the second set of widgets includes the fourth widget and does not include the fifth widget). For example, in FIG. 7L, the user interface 723 includes widget 724, widget 734, widget 726 and widget 728 while the device 100 is in the landscape orientation, while in FIG. 7M1, the user interface 725 includes widget 724a (e.g., corresponding to widget 724 in FIG. 7L), widget 734a (e.g., corresponding to widget 734 in FIG. 7L), and widget 726a (e.g., corresponding to widget 726 in FIG. 7L) while the device 100 is in the portrait orientation. Thus, widget 728 is displayed (e.g., does not have a corresponding widget) in the user interface 723 and is not displayed in the user interface 725. Providing a first set of widgets displayed in the landscape orientation that includes at least one widget that is not included in a second set of widgets displayed in the portrait orientation provides visual feedback about a state of the device and enables the user to access different widgets that are associated with different applications without requiring additional user inputs.

In some embodiments, the second set of widgets includes (1034) at least one widget that is not included in the first set of widgets (e.g., the second set of widgets includes a sixth widget and a seventh widget and the first set of widgets includes the sixth widget and does not include the seventh widget). For example, in FIG. 7Q, the user interface 735 includes widget 760b, widget 762b and widget 764b while the device 100 is in the portrait orientation, and the user interface 723 in FIG. 7R includes widget 724, widget 734, widget 726 and widget 728 (e.g., corresponding to widget 764b). Thus, widget 760b and widget 764b are included in the user interface 735 in the second orientation (e.g., portrait orientation) but not included in the user interface 723 in the first orientation (e.g., landscape orientation). Providing a second set of widgets displayed in the portrait orientation that includes at least one widget that is not included in a first set of widgets displayed in the landscape orientation provides visual feedback about a state of the device and enables the user to access different widgets that are associated with different applications without requiring additional user inputs.

It should be understood that the particular order in which the operations in FIGS. 10A-10F have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 800, 900 and 1200) are also applicable in an analogous manner to method 1000 described above with respect to FIGS. 10A-10F. For example, the user interface objects, wallpapers and user inputs described above with reference to method 1000 optionally have one or more of the characteristics of the user interface objects, wallpapers and user inputs described herein with reference to other methods described herein (e.g., methods 800, 900 and 1200). For brevity, these details are not repeated here.

The operations described above with reference to FIGS. 8A-8D, 9A-9F and 10A-10F are, optionally, implemented by components depicted in FIGS. 1A-1B. For example, display operation 804, detect operation 906, and update operation 1008 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

FIGS. 11A-11I illustrate example user interfaces of waking a device from a low power state and displaying a wake screen with a background that includes media with multiple frames, in accordance with some embodiments.

FIG. 11A illustrates device 100 in a low power state. For example, as described with reference to FIG. 4C1, in some embodiments, device 100 optionally transitions to a low power state after a period of time with absence of user interaction with the device, where the display of the multifunction device 100 is optionally turned off, or dimmed, while in the low power state, as illustrated by user interface 489 (e.g., and user interface 1102 in FIG. 11A). In some embodiments, the device 100 transitions into the low power state in response to a user input activating the power button while the device is in a higher power state.

In some embodiments, device 100 detects a user input or other trigger corresponding to a request to wake the device 100 from the low power state. In some embodiments, the user input comprises a raising of the device (e.g., a change in position, orientation, and/or other movement of the device) in a manner that satisfies wake criteria (e.g., the device is raised at a threshold angle and/or speed that satisfies the wake criteria). In some embodiments, the user input corresponding to a request to wake the device 100 from the low power state is a tap input or other type of input that is detected on a touch screen of device 100. For example, user input 1104 is a tap input on the touch screen of device 100 while device 100 is in the low power state. In some embodiments, the user input corresponding to a request to wake the device 100 from the low power state is an activation of one or more buttons of the device, such as user input 1106 on the power button or another button of the device.

In some embodiments, the trigger is a trigger other than a user input, such as the device receiving a notification and/or alert. For example, device 100 wakes from the low power state in response to receiving a message communication, a phone communication, a notification from an application, and/or a system alert.

In some embodiments, the low power state corresponds to a dimmed, always on state, as illustrated in FIG. 11B. In some embodiments, in the low power state that corresponds to a dimmed, always on state, a subset less than all (e.g., or all) of the system information that is available on the wake screen user interface (e.g., while the device 100 is not in the low power state) continues to be displayed in the dimmed. For example, a time indication and/or date indication, and optionally one or more widgets are displayed in the low power state that corresponds to the dimmed, always on state, optionally without displaying the wallpaper background and/or without displaying one or more notifications and/or application icons (e.g., widgets, flashlight application icon, a camera application icon, and/or other icons). In some embodiments, device 100 detects user input 1104 and/or user input 1106 (e.g., and/or another trigger corresponding to a request to wake the device), as described with reference to FIG. 11A while the device is in the low power state that corresponds to the dimmed, always on state illustrated in user interface 1108 in FIG. 11B. As such, when the device is in the low power state, the display is optionally blank (e.g., without displaying any system information), as illustrated in FIG. 11A, or is in a dimmed, always on state, as illustrated in FIG. 11B.

In some embodiments, user interface 1108 illustrated in FIG. 11B corresponds to an intermediary state that transitions between the low power state (e.g., in which the display is blank) illustrated by user interface 1102 in FIG. 11A to the normal operating state illustrated in FIG. 11C.

In some embodiments, the transition between the low power state to the normal operating state includes displaying the wallpaper background of the wake screen user interface 1110. In some embodiments, the wallpaper background of the wake screen user interface 1110 corresponds to a media item (e.g., a photo and/or video). In some embodiments, the media item is captured by the device 100 (e.g., using one or more cameras of device 100) (e.g., prior to the media item being set as the wallpaper background). For example, the user of the device 100 previously captured the media item and set the wallpaper background of the wake screen user interface 1110 after capturing the media item. In some embodiments, the media item is captured by another device, different from device 100, and is sent to or otherwise shared with device 100 such that device 100 is enabled to save and/or set the media item as the wallpaper background of the wake screen user interface 1110 of device 100. In some embodiments, the media item includes multiple frames. For example, the media item is a photo that includes a plurality of frames that are captured at or near a time when the shutter button is pressed to take the photo, sometimes referred to herein as a lively photo.

In some embodiments, the device 100 interpolates frames between two or more frames that are captured in the media item. For example, the media item includes a first frame and a second frame that are captured while the media item is captured, and device 100 adds a third frame between the first frame and the second frame based at least in part on the image content of the first frame and the second frame (e.g., such that the third frame includes image content that shows an intermediary amount of movement between the first frame and the second frame). As such, the third frame is interpolated and/or inserted between the first frame and the second frame such that playback of the media item (e.g., to generate an animation of the media item) includes playing back the first frame, then the third frame, then the second frame. In some embodiments, device 100 adds additional interpolated frames to playback of the media item in order to generate a slow motion effect.

In some embodiments, displaying the wallpaper background of the wake screen includes displaying the multiple frames of the media item. For example, the wallpaper background is updated to display an animation and/or other movement that is created by displaying the multiple frames of the media item in succession. For example, as illustrated in FIGS. 11C-11E, the wallpaper background includes a lively photo of a dog, where the dog moves (e.g., the tail and/or tongue of the dog moves) between successive frames in the photo. In some embodiments, device 100 automatically (e.g., optionally in accordance with a determination that a “Media Playback on Wake” setting is set to “on,” as described below), without additional user input, plays through the multiple frames of the media item while transitioning from the low power state to the normal operating state, as illustrated in FIGS. 11C-11E.

In some embodiments, as the device 100 wakes in response to the user input or other trigger, the wallpaper background is gradually updated from a first level of visual deemphasis to a second level of visual deemphasis. For example, the wallpaper background is initially displayed with a first level of blurring (e.g., or fading or other type of visual deemphasis) and, over time, as the plurality of frames progress, the wallpaper background is displayed with a second level of blurring, optionally less than the first level (e.g., optionally without any blurring). As such, the wallpaper background is updated to be displayed with less visual deemphasis over time as the device 100 wakes to its normal operating state illustrated in FIG. 11E. For example, the animation includes gradually unblurring and/or unfading, over time, the media item that is set as the wallpaper background.

In some embodiments, as the device 100 wakes in response to the user input or other trigger, the successive frames of the multiple frames of the media item used as the wallpaper background are updated at a plurality of different frame rates, optionally by inserting more and more interpolated frames between subsequent pairs of captured frames of the respective user-captured media. For example, the device 100 plays through the multiple frames of the media item such that playback of the media item is displayed as increasingly slowed slow motion over time. For example, in FIGS. 11C-11E, the dog's tail in the wallpaper background is initially displayed as wagging quickly and is, over time, displayed as wagging at a slower pace.

In some embodiments, as illustrated in FIGS. 11B-11E, the wake screen user interface 1110 includes one or more widgets 724, 734, 726, and 728. In some embodiments, widgets 724, 734, 726 and 728 correspond to one or more widgets 4008 that include content from respective applications that is updated from time to time without user intervention (e.g., as described with reference to FIG. 4C1). In some embodiments, the wake screen user interface 1110 includes additional content, such as one or more notifications, one or more application icons for launching applications, and/or a time and/or date indication.

In some embodiments, as described with reference to FIGS. 4C1-4C2, the user is enabled to navigate from the wake screen to a home screen, an application user interface, and/or another user interface using one or more gestures. For example, in response to a swipe gesture in a first direction (e.g., an upward swipe, a downward swipe, or a side swipe), or another type of user input, the device 100 replaces display of the wake screen use interface with a home screen user interface.

In some embodiments, in response to a user input 1112 (e.g., a press and hold or other user input) corresponding to a request to edit the wake screen user interface, the device 100 displays editing user interface 1114 (e.g., editing user interface 531 illustrated in FIG. 5D, editing user interface 623 illustrated in FIG. 6L, editing user interface 703 illustrated in FIG. 7B, or another editing user interface). In some embodiments, in response to turning the setting for “Media Playback on Wake” to “off,” the media item that is set as the wallpaper background ceases to be played back in the editing user interface 1114. For example, a single frame of the multiple frames of the media item is selected and displayed as a static image in the editing user interface 1114 (e.g., and is displayed in the wake screen user interface upon waking the device 100). In some embodiments, the static image corresponds to a different image frame than the first image frame in the media item. For example, in FIG. 11F, the first image frame in the media item includes the dog without the dog's tongue sticking out, while in FIG. 11G, the static image corresponds to a frame in the media item that includes the dog's tongue sticking out (e.g., or another image frame that is selected from the multiple frames of the media item).

In some embodiments, a cropping of the media item (e.g., as displayed as the wallpaper background upon wake and/or as displayed in the editing user interface 1114) is also changed based on whether the “Media Playback on Wake” setting is toggled on or off. For example, as illustrated in FIG. 11F, while the “Media Playback on Wake” setting is toggled “on,” a first amount of cropping and/or zooming is applied to the media item that includes the dog, while in FIG. 11G, while the “Media Playback on Wake” setting is toggled “off,” a second amount of cropping and/or zooming, different than (e.g., more or less than) the first amount of cropping and/or zooming, is applied to the media item that includes the dog (e.g., the dog appears more zoomed in and/or larger in FIG. 11G as compared to FIG. 11F). In some embodiments, the cropping of the media item that is displayed as the wallpaper background is also updated based on whether the “Media Playback on Wake” setting is toggled on or off. For example, the wallpaper background displays the media item (e.g., in the wake screen user interface 1110) with the same amount of cropping and/or zooming that is displayed in the preview of the wallpaper background in the editing user interface 1114.

In some embodiments, in accordance with a determination that the “Media Playback on Wake” setting is toggled “off,” one or more settings for editing the wake screen user interface become disabled such that the user is not enabled to modify the one or more settings. For example, while the “Media Playback on Wake” setting is toggled “on”, the user is enabled to change a color filter that is applied to the wallpaper background and/or is enabled to turn a depth effect of the media item on and/or off. In some embodiments, while the “Media Playback on Wake” setting is toggled to “off,” the settings to change the color filter and/or to toggle the depth effect on and/or off are no longer displayed and/or editable by the user.

In some embodiments, while the “Media Playback on Wake” setting is toggled to “off,” the device 100 detects a user input selecting the media library icon 1120, and in response to the user input, displays a plurality of selectable media items that the user is enabled to select to be used as the wallpaper background. In some embodiments, as explained above, device 100 displays a set of recommended media items, selected from the media library, that are determined as good candidates to be used as the wallpaper background. In some embodiments, the device 100 detects a user input selecting a recommended media item from the set of recommended media items (e.g., or selecting another media item that is not displayed in the set of recommended media items but is still considered a good candidate to be used as the wallpaper background), and in response to the user input and in accordance with a determination that the user has selected a media item from the set of recommended media items that is considered a good candidate to be used as the wallpaper background, the device 100 displays a prompt (e.g., a text notification or other prompt) indicating that the “Media Playback on Wake” setting is currently toggled to “off” and/or otherwise prompting and/or recommending that the user toggle the “Media Playback on Wake” setting to “on” for the selected media item.

In some embodiments, while the “Media Playback on Wake” setting is toggled “off,” the device 100 detects a user input selecting a media item from the media library is not considered a good candidate to be used as the wallpaper background (e.g., the selected media item is not displayed in the set of recommended media items), and in response to the user input and in accordance with a determination that the user has selected a media item from that is not considered a good candidate to be used as the wallpaper background, the device 100 disables button 1122 such that the user is not enabled to turn the “Media Playback on Wake” setting to “on” for the selected media item.

In some embodiments, in accordance with a determination that the selected media item from the media item is selected from a library (e.g., a collection and/or a set) of media items that include multiple frames (e.g., each of the media items in the library includes at least two or more frames, or at least another minimum number of frames, such as at least 4 frames, 10 frames, or another number of frames), the “Media Playback on Wake” setting is automatically, without user input, set to “on” (e.g., optionally without regard to what the setting was toggled to before selecting the media item) for the selected media item. For example, if the media item is selected from a library of video items and/or from a library of lively photos (e.g., and/or is selected from the set of recommended media items), the Media Playback on Wake” setting is automatically, without user input, set to “on”. In some embodiments, in accordance with a determination that the selected media item from the media item is selected from a library (e.g., a collection and/or a set) of media items that do not include multiple frames (e.g., each of the media items in the library includes less than the minimum number of frames), for example, the media item is selected from a library of still images (e.g., static and/or non-lively photos), the “Media Playback on Wake” setting is automatically, without user input, set to “off” (e.g., and, optionally, the “Media Playback on Wake” setting is disabled for the still image such that the user is not enabled to toggle the setting to “on”).

In some embodiments, the device 100 detects user input 1116 directed to selection box 712 for the time indication, and in response to detecting the user input 1116, the device 100 displays an editing platter 1124 for editing the time indication, as illustrated in FIG. 11H. In some embodiments, the editing platter 1124 includes one or more options for changing a text style, changing a color of the text and/or changing a weight of the text. In some embodiments, changes made to the text style, color and/or weight of the text is applied to the time indication and/or the date indication.

In some embodiments, the option to change the weight of the text optionally includes a slider 1126-1, or other user interface element, that enables the user to change a weight (e.g., thickness and/or boldness) of the text through continuously variable values. For example, the user perceives the weight of the text to change continuously based on an amount of adjustment via the slider. In some embodiments, as used herein, a “continuously variable” set of font weight includes a substantially continuous set of font weights or a plurality of discrete font weights where a difference between two adjacent discrete font weights is not visually perceptible to a user of the device, which makes the set of discrete font weights appear, perceptually, to be continuous during adjustment. For example, in FIG. 11H, the device 100 detects a drag user input 1128 (e.g., or other type of user input, such as a tap input at another position on slider 1126-1) for adjusting the position on slider 1126-1.

In some embodiments, in response to user input 1128 for adjusting the position on slider 1126-1, the weight of the text is updated in accordance with the user input (e.g., in accordance with the new position of slider 1126-2) without changing a size of the text, as illustrated in FIG. 11I. For example, in FIG. 11I, the text of the date indication and/or of the time indication is updated to have an increased weight as compared to the text in FIG. 11H. In some embodiments, the new position of slider 1126-2 is determined in response to detecting an end of the user input 1128 (e.g., liftoff of user input 1128 and/or ceasing to continue moving and/or dragging the user input 1128) at the new position.

FIGS. 12A-12E are flow diagrams illustrating method 1200 for displaying an animated background in a wake screen user interface while the device transitions from a low power state in accordance with some embodiments. Method 1200 is performed at a computer system (e.g., an electronic device, device 300, FIG. 3, or portable multifunction device 100, FIG. 1A) with a display and a touch-sensitive surface. In some embodiments, the display is a touch-screen display and the touch-sensitive surface is on or integrated with the display. In some embodiments, the display is separate from the touch-sensitive surface. Some operations in method 1200 are, optionally, combined and/or the order of some operations is, optionally, changed.

Method 1200 enables the device to automatically animate a wallpaper background upon waking the device from a low power state, while increasing a luminance of the display, indicates to the user when the device is transitioning out of a low power mode and enables the user to customize the wallpaper background to include an animation without requiring the user to define complicated animations and/or modifying the media manually, thereby providing improved feedback about a state of the device and reducing a number of user inputs required to display an animation in the wallpaper background.

While the computer system is in a low power state (e.g., a power-saving state, a state that the computer system transitions into after prolonged inactivity or in response to a user input turning off the display to conserve battery charge) in which respective user-captured media with multiple frames (e.g., a video or a photo with auxiliary frames that were captured at or near a time when a shutter button was pressed, sometimes referred to as a lively photo) is selected as a background (e.g., a wallpaper) for a wake screen (e.g., a wake screen user interface, a lock screen user interface, an always-on user interface that has a dimmed state in the low power state and a lit state when transitioned out of the low power state, and/or another system user interface that corresponds to a restricted state of the computer system), the computer system detects (1202) an event that corresponds to a trigger to wake the computer system to a higher power state (e.g., movement of the computer system, raising the computer system from a resting position, and/or impact and/or contact by a user on the computer system or touch-screen of the computer system). For example, as described with reference to FIGS. 11A-11B, a user input (e.g., a touch input 1104 on the touch-screen, or press input 1106 on the power button) or other trigger corresponding to a request to wake the device is detected, in accordance with some embodiments.

In response to detecting the event, the computer system displays (1204), via the one or more display generation components, a first wake screen that includes device status information (e.g., indicators for WiFi signal strength, cellular signal strength, location tracking status, battery level, mobile carrier, the locked/unlocked state of the computer system, the current date and time, and/other device status information, that were not displayed in the low power mode prior to detecting the event and displaying the first wake screen) and the background, wherein displaying the background for the wake screen includes playing through a plurality of frames of the respective user-captured media. For example, as described with reference to FIGS. 11A-11C, in response to detecting the user input (e.g., touch input 1104 on the touch-screen, press input 1106 on the power button, or other input that are enabled to wake the device 100) or other trigger corresponding to the request to wake the device, the device 100 displays wake screen user interface 1110 (FIG. 11C). In some embodiments, as described with reference to FIGS. 11C-11E, the wake screen user interface 1110 includes a wallpaper background that includes a media item (e.g., a photo and/or video) that includes multiple frames.

In some embodiments, the event that corresponds to the trigger to wake the computer system is (1206) a change in orientation of the computer system (e.g., detected via one or more sensors of the computer system that optionally matches a movement or orientation profile for the computer system having been lifted or raised from a resting position and/or orientation). For example, as described with reference to FIGS. 11A-11B, in some embodiments, the trigger to corresponding to a request to wake the device 100 comprises a raising of the device (e.g., a change in position, orientation, and/or other movement of the device) in a manner that satisfies wake criteria (e.g., the device is raised at a threshold angle and/or speed that satisfies the wake criteria). Enabling the user to wake the device from a low power state by lifting the device, causes the device to initiate display of an animation of the wake screen in response to a user input corresponding to lifting the device, thereby providing additional control options for the user and providing improved visual feedback in response to a user input.

In some embodiments, the event that corresponds to the trigger to wake the computer system is (1208) a tap detected on the computer system (e.g., detected on a touch-sensitive surface such as a touch-sensitive display or detected on a housing of the computer system using one or more motion or vibration sensors). For example, as described with reference to FIGS. 11A-11B, in some embodiments, the trigger to corresponding to a request to wake the device 100 comprises user input 1104 (e.g., a tap input or other type of touch input) that is detected on a touch screen of device 100. Enabling the user to wake the device from a low power state using a tap input, causes the device to initiate display of an animation of the wake screen user interface in response to a user input corresponding to a tap input, thereby providing additional control options for the user and providing improved visual feedback in response to a user input.

In some embodiments, the event that corresponds to the trigger to wake the computer system is (1210) a button press on a button of the computer system (e.g., a mechanical button or a solid-state button that is activated based on an intensity of an input meeting an intensity threshold and optionally provides haptic feedback when activation has occurred indicating that activation has occurred). For example, as described with reference to FIGS. 11A-11B, in some embodiments, the trigger to corresponding to a request to wake the device 100 comprises user input 1106 or another user input that activates one or more buttons of the device. Enabling the user to wake the device from a low power state using a button press, causes the device to initiate display of an animation of the wake screen user interface in response to a user input corresponding to a button press, thereby providing additional control options for the user and providing improved visual feedback in response to a user input.

In some embodiments, the low power state is (1212) a display off state (e.g., display is dark, turned off, and/or does not display any content); and displaying the first wake screen includes transitioning (e.g., gradually increasing a brightness of the display and/or displaying an animation for waking the display) from the display off state to displaying the first wake screen. For example, as described with reference to FIG. 11A, in some embodiments, while the device 100 is in the low power state, the display is blank (e.g., without displaying any system information), as illustrated by user interface 1102. Enabling the user to wake the device from a low power state in which the display of the device is off, causes the device to initiate display of an animation of the wake screen user interface in response to a user input, thereby providing additional control options for the user and providing improved visual feedback in response to a user input.

In some embodiments, the low power state is (1214) a state in which a low power user interface is displayed (e.g., a user interface that is dimmer, has fewer user interface elements and/or which is updated less frequently than the wake screen). In some embodiments, displaying the first wake screen includes transitioning from displaying the low power user interface to displaying the first wake screen. For example, as described with reference to FIG. 11B, in some embodiments, while the device 100 is in the low power state, the display is in a dimmed, always on state, as illustrated in user interface 1108, and the display transitions out of the dimmed, always on state, into the wake screen user interface 1110 (FIG. 11C), in response to detecting the user input (e.g., user input 1104, the button press 1106, or another type of wake input). Enabling the user to wake the device from a low power state in which the device displays a low power user interface, such as a dimmed user interface and/or a user interface displaying limited system information, causes the device to initiate display of an animation of the wake screen user interface in response to a user input, thereby providing additional control options for the user and providing improved visual feedback in response to a user input.

In some embodiments, displaying the first wake screen includes (1216) reducing a degree of blurring of the respective user-captured media (e.g., while playing through a plurality of frames of the respective user-captured media, before playing through the plurality of frames of the respective user-captured media, and/or after playing through the plurality of frames of the respective user-captured media). For example, as described with reference to FIGS. 11C-11E, in some embodiments, the wallpaper background is initially displayed with a first level of blurring (e.g., or fading or other type of visual deemphasis) and, over time, as the plurality of frames progress, the wallpaper background is displayed with a second level of blurring, optionally less than the first level (e.g., optionally without any blurring). Providing an animation that displays a media item that includes reducing a level of blurring or other visual deemphasis of the media item as the animation progresses, enables the device to indicate to the user a current state of the device in response to the user input to wake the device, thereby improving feedback for the state of the device.

In some embodiments, playing through the plurality of frames of the respective user-captured media includes (1218) playing through one or more interpolated frames, including one or more frames of the respective user-captured media that are automatically generated based on a prior frame that is played before a respective interpolated frame of the one or more interpolated frames and a subsequent frame that is played after the respective interpolated frame. In some embodiments there are multiple interpolated frames between two captured frames of the respective user-captured media. For example, as described with reference to FIGS. 11C-11E, in some embodiments, the device 100 interpolates frames between two or more frames that are captured in the media item. For example, the media item includes a first frame and a second frame that are captured while the media item is captured, and device 100 adds a third frame between the first frame and the second frame based at least in part on the image content of the first frame and the second frame (e.g., such that the third frame includes image content that shows an intermediary amount of movement between the first frame and the second frame). Providing an animation that displays a media item by adding interpolated frames between frames of the media item, enables the device to provide an animation that displays the media item continuously moving, by supplementing the frames of the media item as captured, which indicates to the user a current state of the device in response to the user input to wake the device, thereby improving feedback for the state of the device.

In some embodiments, playing through a plurality of frames of the respective user-captured media includes (1220) gradually (e.g., over a period of time) increasing an effective frame rate of the respective user-captured media as it is played back to create an effect (e.g., a visual effect and/or animation) of increasingly slowed slow motion over time as the respective user-captured media is played (e.g., optionally by inserting more and more interpolated frames between subsequent pairs of captured frames of the respective user-captured media). For example, upon waking the device from the low power state, the user-captured media (e.g., a lively photo or video) is initially displayed as progressing through the multiple frames at a first frame rate, and the frame rate decreases to a second frame rate that is slower than the first frame rate, as the wake animation continues. For example, as described with reference to FIGS. 11-11E, in some embodiments, the dog's tail in the wallpaper background is initially displayed as wagging quickly and is, over time, displayed as wagging at a slower pace. Providing an animation that displays a media item that includes reducing a frame rate of playing back frames of the media item to achieve a slow motion visual effect as the animation progresses, enables the device to indicate to the user a current state of the device in response to the user input to wake the device, thereby improving feedback for the state of the device.

In some embodiments, the device status information on the wake screen includes (1222) one or more of a current date, a current time, weather information, one or more widgets that include content corresponding to one or more applications on the computer system (e.g., wherein a respective widget includes status information for a respective application that is updated over time, in accordance with a current status of the respective application), and one or more notifications. In some embodiments, the wake screen includes function controls for initiating a corresponding function (e.g., a flashlight control for initiating a flashlight function of the device and/or a camera control for initiating a camera function of the device that can be used to capture respective user-captured media such as a video or lively photo). For example, as described with reference to FIGS. 11B-11E, the wake screen user interface 1110 includes one or more widgets 724, 734, 726, and 728, one or more notifications, one or more application icons for launching applications, and/or a time and/or date indication. Providing a user interface that displays, and animates, a media item as the background in response to a user input to wake the device, while concurrently displaying system information that provides information such as a time, a date, and/or one or more widgets that include status information for respective applications, enables the device to continue displaying information that is pertinent to the user while also providing feedback to the user, thereby improving visual feedback.

In some embodiments, while displaying the first wake screen, the computer system detects (1224), via the one or more input devices, an input that corresponds to a request to dismiss the first wake screen (e.g., a swipe gesture or button press that corresponds to a request to display a home screen user interface). In some embodiments, in response to detecting the input that corresponds to the request to dismiss the first wake screen, the computer system: ceases to display the first wake screen; and displays a home screen user interface that includes one or more representations of one or more applications that when selected, cause the computer system to launch a corresponding application of the selected application of the one or more applications (and, optionally, one or more widgets that include information for corresponding applications). For example, as described with reference to FIGS. 4C1-4C2 and FIG. 11E, the user is enabled to navigate from the wake screen to a home screen, an application user interface, and/or another user interface using one or more gestures (e.g., one or more navigation gestures, such as an upward edge swipe to navigate to the home screen user interface, a leftward edge swipe detected at the bottom portion of the screen to navigate to the camera user interface, and/or a rightward edge swipe detected at the bottom portion of the screen to navigate to the widget user interface). Displaying, in a home screen user interface, a plurality of user interface objects that are used to open respective applications, enables the user to control an application and/or navigate between applications, thereby reducing the amount of time that is needed for the user to find and select applications using complex menu hierarchies.

In some embodiments, prior to displaying the first wake screen, the computer system detects (1226), via the one or more input devices, an input that corresponds to a request to capture media (e.g., a press of a hardware or virtual shutter button while a camera user interface is displayed). In some embodiments, in response to detecting the input that corresponds to the request to capture media, the computer system captures user-captured media using one or more cameras that are in communication with the computer system, wherein the user-captured media includes the respective user-captured media that is used for the wake screen. In some embodiments, the user-captured media is captured using a camera application of the computer system, wherein the camera application includes options for capturing lively photos and/or videos using the one or more cameras that are in communication with the computer system. In some embodiments, the one or more cameras are internal to the computer system. In some embodiments, the captured media is not captured with the camera of the device. For example, the captured media is optionally captured by a different device and is shared and/or sent to the computer system. For example, as described with reference to FIG. 11C, in some embodiments, the user of the device 100 previously captured the media item (e.g., the lively photo of the dog or another media item) and set the wallpaper background of the wake screen user interface 1110 to include the media item as the wallpaper background after capturing the media item. Allowing a user to capture a media item and set the captured media item as the wallpaper background of the wake screen user interface, before displaying an animation of the wake screen user interface upon waking the device, provides additional control options for the user, thereby reducing the amount of time required to configure the wake screen user interface and providing improved feedback about the state of the device.

In some embodiments, the computer system detects (1228), via the one or more input devices, in a wake screen editing user interface (e.g., editing user interface 1114 in FIG. 11F, or another editing user interface), an input that corresponds to a request to use the respective user-captured media as a background for a wake screen of the computer system (e.g., a currently selected background for a currently selected wake screen, a newly selected background for a currently selected wake screen, or a newly selected background for a newly selected wake screen) (e.g., after capturing the respective user-captured media using the one or more cameras in communication with the computer system or based on user-captured media added to a user media library that includes a collection of multiple user-capture media items). In some embodiments, in response to detecting the input that corresponds to the request to use the respective user-captured media as a background for the wake screen of the computer system, the computer system sets the respective user-captured media as the background for the wake screen of the computer system. For example, as described with reference to FIG. 11F, in some embodiments, the user is enabled to select and/or modify the wallpaper background in the editing user interface 1114. For example, the user is enabled to select a media item to be used as the wallpaper background. Enabling a user to direct inputs to objects at different locations in a wake screen editing user interface to bring up different sets of selectable options enables the user to customize different objects in the wake screen, including the wallpaper background of the wake screen, and causes the device to automatically display a set of selectable options that is appropriate for the particular object that the user wants to edit.

In some embodiments, the input that corresponds to the request to use the respective user-captured media as a background for a wake screen of the computer system is detected (1230) while displaying the wake screen editing user interface, wherein the wake screen editing user interface includes a plurality of options for editing a wake screen (e.g., adding or removing widgets, selecting a background, selecting a visual effect for a background, selecting a style for text displayed on the wake screen such as a color, font, line weight, and/or other selectable editing options for configuring a wake screen). In some embodiments, displaying the wake screen editing user interface includes displaying one or more suggestions for media to use as backgrounds, wherein displaying the one or more suggestions includes: in accordance with a determination that the respective user-captured media is determined to be a good candidate to be used as an animated background for a wake screen (e.g., based on a quality of the motion in the respective user-captured media item, based on a number of frames in the user-captured media item, and/or based on the presence of information such as metadata or frame information that enables interpolation between frames of the respective user-captured media item to generate a slow motion effect for the respective user-captured media item), including a representation of the respective user-captured media in the one or more suggestions (e.g., along with one or more other suggested media items, which optionally include other user-captured media items); and in accordance with a determination that the respective user-captured media is not determined to be a good candidate to be used as an animated background for a wake screen, forgoing including a representation of the respective user-captured media in the one or more suggestions (e.g., and suggesting one or more other user-captured media items instead of the respective user-captured media item). In some embodiments, the user is enabled to request the respective user-captured media to be used as a background for the wake screen even when the representation of the respective user-captured media is not included in the one or more suggestions. For example, the user is enabled to select from a photo and/or video library that includes additional user-captured media items that are not included in the one or more suggestions. For example, as described with reference to FIG. 11F, the device 100 displays (e.g., optionally in response to a user input selecting the media library icon 1120) a set of recommended media items, selected from the media library, that are determined as good candidates to be used as the wallpaper background. Automatically identifying media items that are good candidates to be used as a wallpaper background based on frame information of the media items, enables the device to automatically select and present media items that are likely to be of interest to the user to use as a wallpaper background without requiring the user to manually identify media items, thereby reducing a number of inputs and an amount of time that is needed for the user to select a media item to use as the wallpaper background for the wake screen user interface of the device.

In some embodiments, the wake screen editing user interface includes (1232) one or more controls (e.g., a selection box, a toggle control, or another type of control) for selecting whether or not the background of the wake screen animates when the wake screen is displayed. In some embodiments, while displaying the wake screen editing user interface, the computer system detects an input directed to the one or more controls for selecting whether or not the background of the wake screen animates. In some embodiments, in response to detecting the input directed to the one or more controls for selecting whether or not the background of the wake screen animates: in accordance with a determination that the input meets first criteria (e.g., an input directed to an enable option or an input directed to a toggle that is currently sent to disabling animation of the background of the wake screen), the computer system enables animation of the background of the wake screen (e.g., wherein the animation of the background of the wake screen includes playing through a plurality of frames of the respective user-captured media) and in accordance with a determination that the input meets second criteria different from the first criteria (e.g., an input directed to a disable option or an input directed to a toggle that is currently sent to enabling animation of the background of the wake screen), the computer system disables animation of the background of the wake screen. In some embodiments, when the wake screen of the computer system is displayed (e.g., as described in greater detail with reference to FIGS. 11C-11E) in accordance with a determination that animation is enabled, the background plays through a plurality of frames. In some embodiments, when the wake screen of the computer system is displayed (e.g., as described in greater detail with reference to claim 1) in accordance with a determination that animation is disabled, the background does not play through the plurality of frames. For example, as described with reference to FIGS. 11F-11G, the user is enabled to select button 1122 to toggle between (i) automatically playing the multiple frames of the media item that is set as the wallpaper background upon waking the device 100 and (ii) forgoing playing the multiple frames (e.g., using a static image of the media item as the wallpaper background without animation). Providing an option to the user enabled or disable a wake screen user interface from automatically displaying an animation of the media item used as the wallpaper background, enables the device to automatically update the wake screen user interface according to the selected option to enable or disable the animation, without requiring the user to navigate to system settings and manually update the wake screen user interface, thereby reducing a number of inputs required to change the current display of a device.

In some embodiments, displaying the wake screen editing user interface includes (1234): in accordance with a determination that animation of the background of the wake screen is enabled, displaying a first set of editing options for editing the wake screen; and in accordance with a determination that animation of the background of the wake screen is disabled, displaying a second set of editing options for editing the wake screen, wherein the second set of editing options is different from the first set of editing options. In some embodiments, the second set of editing options includes an option for changing and/or selecting a color filter, an option for turning a depth effect on and/or off. In some embodiments, the second set of editing options includes the first set of editing options and one or more additional editing options that are only available if the animation is disabled. For example, as described with reference to FIG. 11F, the button 1122 indicating “Media Playback on Wake” is set to “on.” As such, upon waking the device 100 (e.g., as described with reference to FIGS. 11A-11C), the wallpaper background automatically animates to playback the multiple frames of the media item set as the wallpaper background. Presenting a plurality of system user interface options while the user is in an editing mode for the system user interface, the plurality of system user interface options being different depending on whether an animation for playing back a media item upon waking the device is turned on or off, enables the device to automatically only allow the user to configure the user interface options that are applicable to an animated or a non-animated wake screen, thereby reducing a number of inputs needed to configure the settings of the wake screen user interface based the currently selected wallpaper background.

In some embodiments, displaying (1236) the wake screen editing user interface includes, in accordance with a determination that a currently selected media item for a background of the wake screen is a good candidate for animation and animation of the background of the wake screen is disabled, displaying a prompt to enable animation for the currently selected media item. In some embodiments, in accordance with a determination that a currently selected media item for a background of the wake screen is a good candidate for animation and animation of the background of the wake screen is enabled, the computer system forgoes displaying the prompt to enable animation for the currently selected media item. In some embodiments, in accordance with a determination that a currently selected media item for a background of the wake screen is not a good candidate for animation and animation of the background of the wake screen is disabled, the computer system forgoes displaying the prompt to enable animation for the currently selected media item. For example, as described with reference to FIG. 11G, in accordance with a determination that the user has selected a media item from that is considered a good candidate to be used as the wallpaper background, the device 100 displays a prompt (e.g., a text notification or other prompt) indicating that the “Media Playback on Wake” setting is currently toggled to “off” and/or otherwise prompting and/or recommending that the user toggle the “Media Playback on Wake” setting to “on” for the selected media item. Providing the user with an option, after the user has selected a media item to be used as the wallpaper background of the wake screen user interface, if the selected media item is a good candidate for animation, to toggle a setting that enables the animation of the selected media item on when the device wakes, provides the user with additional control options for enabling an animation of the wake screen user interface, thereby reducing a number of inputs required to enable the animation of the wake screen user interface.

In some embodiments, displaying the wake screen editing user interface includes (1238), in accordance with a determination that a currently selected media item for a background of the wake screen is not a good candidate for animation and animation of the background of the wake screen is disabled, preventing enablement of animation of the background of the wake screen (e.g., forgoing display of the control for enabling animation of the background of the wake screen or displaying the control for enabling animation of the background with a visual effect indicating that the control is inactive). In some embodiments, in accordance with a determination that a currently selected media item for a background of the wake screen is a good candidate for animation and animation of the background of the wake screen is disabled, the computer system permits enablement of animation of the background of the wake screen (e.g., displays the control for enabling animation of the background of the wake screen or displaying the control for enabling animation of the background with a visual effect indicating that the control is active). For example, as described with reference to FIG. 11G, in accordance with a determination that the user has selected a media item from that is not considered a good candidate to be used as the wallpaper background, the device 100 disables button 1122 such that the user is not enabled to turn the “Media Playback on Wake” setting to “on” for the selected media item. Automatically disabling the option to display an animation upon wake, after the user has selected a media item to be used as the wallpaper background of the wake screen user interface, if the selected media item is not a good candidate for animation, enables the user to configure the wake screen user interface more efficiently without having to select whether or not to enable the animation, thereby reducing a number of inputs required to forgo performing an animation of the wake screen user interface when the selected media item for the wallpaper background is not a good candidate for animation.

In some embodiments, displaying the wake screen editing user interface includes (1240): in accordance with a determination that a currently selected media item for the background was selected from a collection of media items that include multiple frames, enabling animation of the background of the first wake screen (e.g., by default, automatically, and/or otherwise without additional user input); and in accordance with a determination that a currently selected media item for the background was selected from a collection of media items that include one or more media items without multiple frames, disabling animation of the background of the first wake screen (e.g., by default, automatically, and/or otherwise without additional user input). For example, as described with reference to FIG. 11G, if the media item is selected from a library of video items and/or from a library of lively photos (e.g., and/or is selected from the set of recommended media items), the Media Playback on Wake” setting is automatically, without user input, set to “on”. Automatically turning an animation upon wake on or off, based at least in part on an analysis of the media item selected as the wallpaper background, and whether the selected media item is selected from a library of media items with multiple frames or from a library of media items with still images, causes the device to automatically display the animation when the media item is suited for the animation without requiring the user to manually turn the animation on and/off, thereby reducing a number of inputs required to configure the wake screen user interface.

In some embodiments, displaying the wake screen editing user interface includes (1242), in accordance with a determination that animation of the background of the wake screen is enabled, repeatedly playing (e.g., looping, cross-fading, and/or cycling through in other manners) through multiple frames of a currently selected media item for the background of the wake screen. In some embodiments, in accordance with a determination that animation of the background of the wake screen is disabled, the computer system displays a still image corresponding to the currently selected media item for the background of the wake screen (e.g., forgoes playing through multiple frames of the currently selected media item for the background of the wake screen). For example, as described with reference to FIG. 11F, while the setting for animating the wallpaper background is set to on, the media item that is set as the wallpaper background is automatically played back (e.g., and optionally repeated (e.g., looped)) while the editing user interface 1114 is displayed. Automatically displaying, in an editing user interface, a preview of the animation of the media item selected as the wallpaper background, including repeating the animation over time, causes the device to automatically display the animation when the media item is suited for the animation, and provides the user with a preview of the entirety of the animation such that the user is not surprised by content that is included in the animation, without requiring the user to manually request to view a preview of the animation, thereby reducing a number of inputs required to configure and view the animation of the wake screen user interface and improving privacy and/or security of the user's wallpaper background upon wake by making the user aware of the full animation of the wallpaper background.

In some embodiments, displaying the wake screen editing user interface includes (1244): in accordance with a determination that animation of the background of the wake screen is enabled, displaying a currently selected media item for the background with a first cropping (e.g., or first zoom). In some embodiments, when animation of the background of the wake screen is enable, a crop is selected that centers a focal point of movement (e.g., movement detected by the computer system using image processing) in the plurality of frames of the currently selected media item. In some embodiments, in accordance with a determination that animation of the background of the wake screen is disabled, the computer system displays the currently selected media item for the background with a second cropping that is different from the first cropping (e.g., or second zoom that is different from the first zoom). In some embodiments, when animation of the background of the wake screen is disabled, a crop is selected that centers a focal point of the still image corresponding to the currently selected media item. For example, as described with reference to FIG. 11F, while the “Media Playback on Wake” setting is toggled “on,” a first amount of cropping and/or zooming is applied to the media item that includes the dog, while in FIG. 11G, while the “Media Playback on Wake” setting is toggled “off,” a second amount of cropping and/or zooming, different than (e.g., more or less than) the first amount of cropping and/or zooming, is applied to the media item that includes the dog (e.g., the dog appears more zoomed in and/or larger in FIG. 11G as compared to FIG. 11F). Automatically changing display of a media item by changing a crop, zoom and/or size of the media item, in the editing user interface, based on whether an animation is applied to the media item or not, causes the device to automatically display a best-sized frame of the media item in an efficient way in the display area, thereby reducing an amount of time that is needed for the user to view and access system information that is also displayed in the editing user interface.

In some embodiments, while displaying the wake screen editing user interface, the computer system detects (1246) an input corresponding to a request to change whether animation of the background of the wake screen is enabled; and in response to detecting the input corresponding to the request to change whether the animation of the background of the wake screen is enabled (e.g., from enabled to unenabled, or from unenabled to enabled), the computer system changes whether the animation of the background of the wake screen is enabled; and changes a cropping (or, zoom, and/or center) of a currently selected media item for the background of the wake screen (e.g., that is displayed in the wake screen editing user interface). For example, as described with reference to FIGS. 11F-11G, the cropping of the media item that is displayed as the wallpaper background is also updated based on whether the “Media Playback on Wake” setting is toggled on or off. Automatically changing display of a media item by changing a crop, zoom and/or size of the media item as displayed on the wake screen user interface, and automatically enabling and/or disabling an animation that is applied to the media item in accordance with a user-selected setting, causes the device to automatically display a best-sized frame of the media item in an efficient way in the display area, thereby reducing an amount of time that is needed for the user to view and access system information that is also displayed in the wake screen user interface.

In some embodiments, displaying the wake screen editing user interface includes (1248) displaying a control (e.g., a slider control, a selection menu, or another type of control) for adjusting a font weight of text (e.g., text that is an indication of date and/or time or other computer system status information) in the wake screen editing user interface. In some embodiments, while displaying the wake screen editing user interface, the computer system detects an input (e.g., a swipe and/or drag input, a tap input at a different position on the slider and/or another type of input) directed to the control for adjusting the font weight of text in the wake screen editing user interface. In some embodiments, in response to detecting the input directed to the control for adjusting the font weight of text in the wake screen editing user interface, the computer system adjusts a font weight of the text (e.g., increasing or decreasing the font weight of the text). For example, as described with reference to FIG. 11H, the editing platter 1124 includes one or more options for changing a text style, changing a color of the text and/or changing a weight of the text displayed in editing user interface 1114. In some embodiments, changes made to the text style, color and/or weight of the text is applied to the time indication and/or the date indication. In response to an input selecting system-generated text in a wake screen for editing, displaying a set of selectable options for the system-generated text causes the device to automatically display a set of selectable options that is appropriate for the particular object that the user wants to edit.

In some embodiments, the control for adjusting a font weight of text in the wake screen editing user interface includes (1250) a slider control. In some embodiments, adjusting the font weight of the text includes adjusting the font weight of the text through a perceptually continuous range of font weights (e.g., continuous set of font weights, a substantially continuous set of font weights, or a plurality of discrete font weights where a difference between two adjacent discrete font weights is not visually perceptible to a user of the device, which makes the set of discrete font weights appear, perceptually, to be continuous during adjustment) using the slider control. For example, as described with reference to FIGS. 11H-11I, slider 1126-1 enables the user to change a weight (e.g., thickness and/or boldness) of the text in editing user interface 1114. In response to an input selecting, for editing in a wake screen, system-generated text, displaying a set of selectable options for the system-generated text that includes selection of continuously variable size options for the system-generated text provides the user with additional control options for selecting a size of the system-generated text that the user wants to edit.

It should be understood that the particular order in which the operations in FIGS. 12A-12E have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 800, 900 and 1000) are also applicable in an analogous manner to method 1200 described above with respect to FIGS. 12A-12E. For example, the user interface objects, wallpapers and user inputs described above with reference to method 1200 optionally have one or more of the characteristics of the user interface objects, wallpapers and user inputs described herein with reference to other methods described herein (e.g., methods 800, 900 and 1000). For brevity, these details are not repeated here.

The operations described above with reference to FIGS. 8A-8D, 9A-9F, 10A-10F and 12A-12E are, optionally, implemented by components depicted in FIGS. 1A-1B. For example, display operation 804, detect operation 906, and update operation 1008 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method comprising:
at a computer system that is in communication with a display generation component:
receiving a request to display a first user interface;
in response to receiving the request to display the first user interface, displaying the first user interface that includes a plurality of widgets, including:
in accordance with a determination that the first user interface is displayed in a first orientation, displaying a first version of the first user interface that includes a first set of widgets; and
in accordance with a determination that the first user interface is displayed in a second orientation that is different from the first orientation, displaying a second version of the first user interface that includes a second set of widgets, wherein the widgets included in the second set of widgets are different from the widgets included in the first set of widgets.

2. The method of claim 1, including:
while displaying the first version of the first user interface that includes the first set of widgets in accordance with the determination that the first user interface is displayed in the first orientation, detecting a first set of one or more user inputs that corresponds to a request to replace the first set of widgets in the first version of the first user interface with a third set of widgets different from the first set of widgets; and
in response to detecting the first set of one or more user inputs, updating the first version of the first user interface displayed in the first orientation to includes the third set of widgets instead of the first set of widgets.

3. The method of claim 1, including:
while displaying the second version of the first user interface that includes the second set of widgets in accordance with the determination that the first user interface is displayed in the second orientation, detecting a second set of one or more user inputs that corresponds to a request to replace the second set of widgets in the second version of the first user interface with a fourth set of widgets different from the second set of widgets; and
in response to detecting the first set of one or more user inputs, updating the second version of the first user interface displayed in the second orientation to includes the fourth set of widgets instead of the second set of widgets.

4. The method of claim 1, including,
while displaying the first version of the first user interface that includes the first set of widgets in accordance with a determination that the first user interface is displayed in the first orientation, detecting a first request to display the first user interface in the second orientation;
in response to detecting the request to display the first user interface in the second orientation, displaying the first user interface in the second orientation, including displaying the second version of the first user interface that includes the second set of widgets;
while displaying the first user interface in the second orientation, detecting a third set of one or more user inputs that corresponds to a request to rearrange a respective layout of the second set of widgets in the second version of the first user interface;
in response to detecting the third set of user inputs, updating the first user interface displayed in the second orientation, including updating the respective layout of the second set of widgets in the second version of the first user interface in accordance with the third set of one or more user inputs;
after updating the first user interface displayed in the second orientation, detecting a first request to display the first user interface in the first orientation; and
in response to detecting the first request to display the first user interface in the first orientation, displaying the first user interface in the first orientation, including displaying the first version of the first user interface that includes the first set of widgets.

5. The method of claim 4, including:
after updating the first user interface displayed in the second orientation and while displaying the first user interface in the first orientation, including displaying the first version of the first user interface that includes the first set of widgets, detecting a second request to display the first user interface in the second orientation; and
in response to detecting the second request to display the first user interface in the second orientation, displaying the first user interface in the second orientation, including displaying the second version of the first user interface in which the respective layout of the second set of widgets have been updated in accordance with the third set of one or more user inputs.

6. The method of claim 1, including,
while displaying the second version of the first user interface that includes the second set of widgets in accordance with a determination that the first user interface is displayed in the second orientation, detecting a second request to display the first user interface in the first orientation;
in response to detecting the second request to display the first user interface in the first orientation, displaying the first user interface in the first orientation, including displaying the first version of the first user interface that includes the first set of widgets;
while displaying the first user interface in the first orientation, detecting a fourth set of one or more user inputs that corresponds to a request to rearrange a respective layout of the first set of widgets in the first version of the first user interface;
in response to detecting the fourth set of user inputs, updating the first user interface displayed in the first orientation, including updating the respective layout of the first set of widgets in the first version of the first user interface in accordance with the fourth set of one or more user inputs;
after updating the first user interface displayed in the first orientation, detecting a third request to display the first user interface in the second orientation; and
in response to detecting the third request to display the first user interface in the second orientation, displaying the first user interface in the second orientation, including displaying the second version of the first user interface that includes the second set of widgets.

7. The method of claim 6, including:
after updating the first user interface displayed in the first orientation and while displaying the first user interface in the second orientation, including displaying the second version of the first user interface that includes the second set of widgets, detecting a third request to display the first user interface in the first orientation; and
in response to detecting the third request to display the first user interface in the first orientation, displaying the first user interface in the first orientation, including displaying the first version of the first user interface in which the respective layout of the first set of widgets have been updated in accordance with the fourth set of one or more user inputs.

8. The method of claim 1, including:
while displaying the first user interface in the first orientation, including displaying the first version of the first user interface, detecting a movement of the display generation component; and
in response to detecting the movement of the display generation component:
in accordance with a determination that rotation criteria are not met by the movement of the display generation component, maintaining display of the first set of widgets in the first version of the first user interface in accordance with a first layout in the first version of the respective user interface; and
in accordance with a determination that the rotation criteria are met by the movement of the display generation component, displaying the first user interface in the second orientation, including displaying the second version of the first user interface that includes the second set of widgets in accordance with a second layout in the second version of the respective user interface.

9. The method of claim 1, wherein:
displaying the first user interface in the first orientation includes displaying the first set of widgets in a first region of a display area of the display generation component; and
displaying the first user interface in the second orientation includes displaying the second set of widgets in a second region of the display area of the display generation component, the second region being different from the first region.

10. The method of claim 1, including:
while displaying an editing user interface for editing the first user interface, detecting a fifth set of user inputs that corresponds to a request to add one or more new widgets to the first user interface displayed in a respective orientation;
in response to detecting the fifth set of user inputs that corresponds to a request to add the one or more new widgets to the first user interface displayed in the respective orientation, adding the one or more new widgets to the first user interface displayed in the respective orientation, including:
in accordance with a determination that the respective orientation is the first orientation, displaying the one or more new widgets adjacent to another widget in the first set of widgets in the first version of the first user interface.

11. The method of claim 10, including:
while displaying the first user interface in a respective orientation of the first orientation and the second orientation, detecting a sixth set of user inputs that corresponds to a request to drag and drop a first widget of a respective set of widget of the first user interface from a first location to a second location in a respective version of the first user interface displayed in the respective orientation; and
in response to detecting the sixth set of user inputs, moving the first widget of the respective set of widget of the first user interface to a new location in the respective version of the first user interface displayed in the respective orientation, including:
in accordance with a determination that the sixth set of user inputs includes a first amount of movement, displaying the first widget at a first location; and
in accordance with a determination that the sixth set of user inputs includes a second amount of movement, displaying the first widget at a second location, wherein the first location and the second location are unoccupied by other widgets of the respective set of widgets.

12. The method of claim 10, including:
in response to detecting the fifth set of user inputs that corresponds to a request to add the one or more new widgets to the first user interface displayed in the respective orientation, automatically selecting respective positions of the one or more new widgets in the first user interface in accordance with a language setting of the computer system.

13. The method of claim 1, the first user interface includes a set of user interface elements displayed overlaid on a wallpaper that includes one or more wallpaper foreground elements, and the method includes:
in accordance with a determination that the first user interface is displayed in the first orientation, displaying the first version of the first user interface, including displaying the one or more wallpaper foreground elements as at least partially occluding the set of user interface elements, irrespective of whether the first version of the first user interface currently includes widgets; and
in accordance with a determination that the respective user interface is displayed in the second orientation, displaying the second version of the first user interface, wherein displaying the second version of the first user interface includes:
in accordance with a determination that the second version of the first user interface currently includes widgets, displaying the one or more wallpaper foreground elements without occluding the set of user interface elements in the second version of the first user interface; and
in accordance with a determination that the second version of the first user interface does not currently includes widgets, displaying the one or more wallpaper foreground elements at least partially occluding the set of user interface elements in the second version of the first user interface.

14. The method of claim 1, including:
displaying an editing user interface for a respective version of the first user interface, wherein the editing user interface includes:
a listing of applications, and
for a respective application in the list of applications, one or more widgets associated with the respective application;
detecting user selection of a third widget from the one or more widgets associated with the respective application; and
in response to detecting the user selection of the third widget, adding the third widget to the respective set of widgets in the respective version of the first user interface.

15. The method of claim 1, wherein the first set of widgets includes at least one widget that is not included in the second set of widgets.

16. The method of claim 1, wherein the second set of widgets includes at least one widget that is not included in the first set of widgets.

17. An electronic device, comprising:
a display;
a touch-sensitive surface;
one or more processors; and
memory storing one or more programs, wherein the one or more programs are configured to be executed by the one or more processors, the one or more programs including instructions for:
receiving a request to display a first user interface;
in response to receiving the request to display the first user interface, displaying the first user interface that includes a plurality of widgets, including:
in accordance with a determination that the first user interface is displayed in a first orientation, displaying a first version of the first user interface that includes a first set of widgets; and
in accordance with a determination that the first user interface is displayed in a second orientation that is different from the first orientation, displaying a second version of the first user interface that includes a second set of widgets, wherein the widgets included in the second set of widgets are different from the widgets included in the first set of widgets.

18. A computer readable storage medium storing one or more programs, the one or more programs comprising instructions that, when executed by an electronic device with a display, and a touch-sensitive surface, cause the electronic device to:
receive a request to display a first user interface;
in response to receiving the request to display the first user interface, display the first user interface that includes a plurality of widgets, including:
in accordance with a determination that the first user interface is displayed in a first orientation, display a first version of the first user interface that includes a first set of widgets; and
in accordance with a determination that the first user interface is displayed in a second orientation that is different from the first orientation, display a second version of the first user interface that includes a second set of widgets, wherein the widgets included in the second set of widgets are different from the widgets included in the first set of widgets.

19-83. (canceled)
